(19) United States
(12) Patent Application Publication
(10) Pub. No.: US 2014/0122261 A1
(43) Pub. Date: May 1, 2014

(54) Food Supply Chain Automation Residential Information System And Method

(71) Applicant: ELWHA LLC, Bellevue, WA (US)

(72) Inventors: Edward K.Y. Jung, Bellevue, WA (US); Royce A. Levien, Lexington, MA (US); Mark A. Malamud, Seattle, WA (US)

(73) Assignee: Elwha LLC, Bellevue, WA (US)

(21) Appl. No.: 13/771,664

(22) Filed: Feb. 20, 2013

Related U.S. Application Data
(63) Continuation-in-part of application No. 13/755,308, filed on Jan. 31, 2013.
Application No. 13/755,308 is a continuation of application No. 13/755,095, filed on Jan. 31, 2013.
Application No. 13/755,095 is a continuation-in-part of application No. 13/724,062, filed on Dec. 21, 2012.
Application No. 13/724,062 is a continuation of application No. 13/721,558, filed on Dec. 20, 2012.
Application No. 13/721,558 is a continuation-in-part of application No. 13/721,357, filed on Dec. 20, 2012.
Application No. 13/721,357 is a continuation of application No. 13/715,309, filed on Dec. 14, 2012.
Application No. 13/715,309 is a continuation-in-part of application No. 13/720,572, filed on Dec. 19, 2012.
Application No. 13/720,572 is a continuation of application No. 13/709,831, filed on Dec. 10, 2012.
Application No. 13/709,831 is a continuation-in-part of application No. 13/687,382, filed on Nov. 28, 2012.
Application No. 13/687,382 is a continuation of application No. 13/682,939, filed on Nov. 21, 2012.
Application No. 13/682,939 is a continuation-in-part of application No. 13/669,018, filed on Nov. 5, 2012.
Application No. 13/669,018 is a continuation of application No. 13/668,977, filed on Nov. 5, 2012.
Application No. 13/668,977 is a continuation-in-part of application No. 13/663,137, filed on Oct. 29, 2012.
Application No. 13/663,137 is a continuation of application No. 13/663,095, filed on Oct. 29, 2012.
Application No. 13/663,095 is a continuation of application No. 13/771,506, filed on Feb. 20, 2013.

(51) Int. Cl. G06Q 50/12; G06Q 10/10

(52) U.S. Cl. CPC G06Q 50/12; G06Q 10/10
USPC 705/15

(57) ABSTRACT

A computationally implemented system and method that is designed to, but is not limited to: electronically accumulating residential food management information including one or more food related residential conditions affecting residential service of one or more residential food items; and electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items. In addition to the foregoing, other method aspects are described in the claims, drawings, and text forming a part of the present disclosure.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority application(s)). In addition, the present application is related to the “Related applications,” if any, listed below.

### PRIORITY APPLICATIONS

For purposes of the USPTO extra-statutory requirements, the present application constitutes a continuation-in-part of U.S. patent application Ser. No. 13/755,308, entitled FOOD SUPPLY CHAIN AUTOMATION GROCERY OPERATIONS INTERFACE INFORMATION SYSTEM AND METHOD, naming Edward K. Y. Jung, Royce A. Levien, and Mark A. Malamud as inventors, filed 31 Jan. 2013 with attorney docket no. 0712-003-008-C00001, which is currently co-pending or is an application of which a currently co-pending application is entitled to the benefit of the filing date, and which is a continuation of U.S. patent application Ser. No. 13/755,095, entitled FOOD SUPPLY CHAIN AUTOMATION GROCERY OPERATIONS INTERFACE INFORMATION SYSTEM AND METHOD, naming Edward K. Y. Jung, Royce A. Levien, and Mark A. Malamud as inventors, filed 31 Jan. 2013 with attorney docket no. 0712-003-008-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/724,062, entitled FOOD SUPPLY CHAIN AUTOMATION GROCERY INFORMATION SYSTEM AND METHOD, naming Edward K. Y. Jung, Royce A. Levien, and Mark A. Malamud as inventors, filed 21 Dec. 2012 with attorney docket no. 0712-003-007-C000001, which is currently co-pending or is an application of which a currently co-pending application is entitled to the benefit of the filing date, and which is a continuation of U.S. patent application Ser. No. 13/721,558, entitled FOOD SUPPLY CHAIN AUTOMATION GROCERY INFORMATION SYSTEM AND METHOD, naming Edward K. Y. Jung, Royce A. Levien, and Mark A. Malamud as inventors, filed 20 Dec. 2012 with attorney docket no. 0712-003-007-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/721,357, entitled FOOD SUPPLY CHAIN AUTOMATION FOOD SERVICE INFORMATION INTERFACE SYSTEM AND METHOD, naming Edward K. Y. Jung, Royce A. Levien, and Mark A. Malamud as inventors, filed 20 Dec. 2012 with attorney docket no. 0712-003-006-C000001, which is currently co-pending or is an application of which a currently co-pending application is entitled to the benefit of the filing date, and which is a continuation of U.S. patent application Ser. No. 13/715,309, entitled FOOD SUPPLY CHAIN AUTOMATION FOOD SERVICE INFORMATION INTERFACE SYSTEM AND METHOD, naming Edward K. Y. Jung, Royce A. Levien, and Mark A. Malamud as inventors, filed 14 Dec. 2012 with attorney docket no. 0712-003-006-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/720,572, entitled FOOD SUPPLY CHAIN AUTOMATION FOOD SERVICE INFORMATION SYSTEM AND METHOD, naming Edward K. Y. Jung, Royce A. Levien, and Mark A. Malamud as inventors, filed 19 Dec. 2012 with attorney docket no. 0712-003-005-000001, which is currently co-pending or is an application of which a currently co-pending application is entitled to the benefit of the filing date, and which is a continuation of U.S. patent application Ser. No. 13/709,831, entitled FOOD SUPPLY CHAIN AUTOMATION FOOD SERVICE INFORMATION SYSTEM AND METHOD, naming Edward K. Y. Jung, Royce A. Levien, and Mark A. Malamud as inventors, filed 10 Dec. 2012 with attorney docket no. 0712-003-005-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/687,382, entitled FOOD SUPPLY CHAIN AUTOMATION FARM INTERFACE SYSTEM AND METHOD, naming Edward K. Y. Jung, Royce A. Levien, and Mark A. Malamud as inventors, filed 28 Nov. 2012 with attorney docket no. 0712-003-004-C000001, which is currently co-pending or is an application of which a currently co-pending application is entitled to the benefit of the filing date, and which is a continuation of U.S. patent application Ser. No. 13/682,939, entitled FOOD SUPPLY CHAIN AUTOMATION FARM INTERFACE SYSTEM AND METHOD, naming Edward K. Y. Jung, Royce A. Levien, and Mark A. Malamud as inventors, filed 21 Nov. 2012 with attorney docket no. 0712-003-004-000000.

For purposes of the USPTO extra-statutory requirements, the present application constitutes a continuation-in-part of U.S. patent application Ser. No. 13/669,018, entitled FOOD SUPPLY CHAIN AUTOMATION FARM TESTING SYSTEM AND METHOD, naming Edward K. Y. Jung, Royce A. Levien, and Mark A. Malamud as inventors, filed 5 Nov. 2012 with attorney docket no. 0712-003-003-C00001, which is currently co-pending or is an application of which a currently co-pending application is entitled to the benefit of the filing date, and which is a continuation of U.S. patent application Ser. No. 13/668,977, entitled FOOD SUPPLY CHAIN AUTOMATION FARM TESTING SYSTEM AND METHOD, naming Edward K. Y. Jung, Royce A. Levien, and Mark A. Malamud as inventors, filed 5 Nov. 2012 with attorney docket no. 0712-003-003-000000.

For purposes of the USPTO extra-statutory requirements, the present application constitutes a continuation-in-part of U.S. patent application Ser. No. 13/663,137, entitled FOOD SUPPLY CHAIN AUTOMATION FARM TRACKING SYSTEM AND METHOD, naming Edward K. Y. Jung, Royce A. Levien, and Mark A. Malamud as inventors, filed 29 Oct. 2012 with attorney docket no. 0712-003-002-C000001, which is currently co-pending or is an application of which a currently co-pending application is entitled to the benefit of the filing date, and which is a continuation of U.S. patent application Ser. No. 13/663,095, entitled FOOD SUPPLY CHAIN AUTOMATION FARM TRACKING SYSTEM AND METHOD, naming Edward K. Y. Jung, Royce A. Levien, and Mark A. Malamud as inventors, filed 29 Oct. 2012 with attorney docket no. 0712-003-002-000000.

### RELATED APPLICATIONS

None

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority applications section of the ADS and to each application that appears in the Priority applications section of this application.

All subject matter of the Priority applications and the Related applications and of any and all parent, grandparent, great-grandparent, etc. applications of the Priority applications and the Related applications, including any priority claims, is incorporated herein by reference to the extent such subject matter is not inconsistent herewith.

### SUMMARY

In one aspect, a computationally-implemented method includes, but is not limited to electronically accumulating residential food management information including one or more food related residential conditions affecting residential service of one or more residential food items; and electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items. In addition to the foregoing, other method aspects are described in the claims, drawings, and text forming a part of the disclosure set forth herein.

In one or more various aspects, related machines, compositions of matter, or manufactures of systems may include, but are not limited to, circuitry and/or programming for effecting the herein-referenced method aspects; the circuitry and/or programming can be virtually any combination of hardware, software, and/or firmware configured to effect the herein-referenced method aspects depending upon the design choices of the system designer (limited to patentable subject matter under 35 USC 101).

A computationally-implemented system includes, but is not limited to: means for electronically accumulating residential food management information including one or more food related residential conditions affecting residential service of one or more residential food items; and means for electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items. In addition to the foregoing, other system aspects are described in the claims, drawings, and text forming a part of the disclosure set forth herein.

A computationally-implemented system includes, but is not limited to a electronically accumulating electrical circuitry arrangement for electronically accumulating residential food management information including one or more food related residential conditions affecting residential service of one or more residential food items; and an electronically indicating connection electrical circuitry arrangement for electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items. In addition to the foregoing, other system aspects are described in the claims, drawings, and text forming a part of the disclosure set forth herein.

A system includes, but is not limited to a electronically accumulating module configured to operate in accordance with electronically accumulating residential food management information including one or more food related residential conditions affecting residential service of one or more residential food items; and an electronically indicating connection module configured to operate in accordance with electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items. In addition to the foregoing, other system aspects are described in the claims, drawings, and text forming a part of the disclosure set forth herein.

An article of manufacture including one or more non-transitory signal-bearing storage medium bearing one or more instructions for electronically accumulating residential food management information including one or more food related residential conditions affecting residential service of one or more residential food items; and one or more instructions for electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items. In addition to the foregoing, other computer program product aspects are described in the claims, drawings, and text forming a part of the disclosure set forth herein.

A system including one or more computing devices; and one or more instructions when executed on the one or more computing devices cause the one or more computing devices to perform electronically accumulating residential food management information including one or more food related residential conditions affecting residential service of one or more residential food items; and electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items. In addition to the foregoing, other computer program product aspects are described in the claims, drawings, and text forming a part of the disclosure set forth herein.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise.

With reference now to the figures, shown are one or more examples of is an example of residential information system that may provide context, for instance, in introducing one or more processes and/or devices described herein.

FIG. 1 is a schematic view depicting farm-test co. info hub aspects as related with a residential information system.

FIG. 2 is a schematic view depicting farm-tracking aspects as related with the residential information system.

FIG. 3 is a schematic view depicting farm-track co. info hub aspects as related with the residential information system.

FIG. 4 is a schematic view depicting farm-tracking aspects as related with the residential information system.

FIG. 5 is a schematic view depicting shipping aspects as related with the residential information system.

FIG. 6 is a schematic view depicting grocery test and track co. info hub aspects as related with the residential information system.

FIG. 7 is a schematic view depicting grocery tracking aspects as related with the residential information system.

FIG. 8 is a schematic view depicting home-test and track co. info hub aspects as related with the residential information system.

FIG. 9 is a schematic view depicting home tracking aspects as related with the residential information system.

FIG. 10 is a schematic view depicting restaurant-test and track co. info hub aspects as related with the residential information system.

FIG. 11 is a schematic view depicting restaurant tracking aspects as related with the residential information system.

FIG. 12 is a block diagram depicting an exemplary implementation of the residential information system 10 of FIG. 1 including exemplary subsystems.

FIG. 13 is a block diagram depicting a control and information processing subsystem s100 of an exemplary implementation of the residential information system 10 of FIG. 1.

FIG. 14 is a block diagram depicting an information storage subsystem s200 of an exemplary implementation of the residential information system 10 of FIG. 1.

FIG. 15 is a block diagram depicting an information user interface subsystem s300 of an exemplary implementation of the residential information system 10 of FIG. 1.

FIG. 16 is a block diagram depicting a sensing subsystem s400 of an exemplary implementation of the residential information system 10 of FIG. 1.

FIG. 17 is a block diagram depicting an electronic communication subsystem s500 of an exemplary implementation of the residential information system 10 of FIG. 1.

FIG. 18 is a block diagram depicting a power subsystem s600 of an exemplary implementation of the residential information system 10 of FIG. 1.

FIG. 19 is a block diagram depicting a material processing subsystem s700 of an exemplary implementation of the residential information system 10 of FIG. 1.

FIG. 20 is a block diagram depicting an operations subsystem s800 of an exemplary implementation of the residential information system 10 of FIG. 1.

FIG. 21 is a block diagram depicting one or more exemplary electrical circuitry arrangements of the residential information system 10 of FIG. 1.

FIG. 22 is a block diagram depicting one or more exemplary electrical circuitry arrangements of the residential information system 10 of FIG. 1.

FIG. 23 is a block diagram depicting one or more exemplary electrical circuitry arrangements of the residential information system 10 of FIG. 1.

FIG. 24 is a block diagram depicting one or more exemplary electrical circuitry arrangements of the residential information system 10 of FIG. 1.

FIG. 25 is a block diagram depicting one or more exemplary electrical circuitry arrangements of the residential information system 10 of FIG. 1.

FIG. 26 is a block diagram depicting one or more exemplary electrical circuitry arrangements of the residential information system 10 of FIG. 1.

FIG. 27 is a block diagram depicting one or more exemplary electrical circuitry arrangements of the residential information system 10 of FIG. 1.

FIG. 28 is a block diagram depicting one or more exemplary instructions of the information storage subsystem s200 of the residential information system 10 of FIG. 1.

FIG. 29 is a block diagram depicting one or more exemplary instructions of the information storage subsystem s200 of the residential information system 10 of FIG. 1.

FIG. 30 is a block diagram depicting one or more exemplary instructions of the information storage subsystem s200 of the residential information system 10 of FIG. 1.

FIG. 31 is a block diagram depicting one or more exemplary instructions of the information storage subsystem s200 of the residential information system 10 of FIG. 1.

FIG. 32 is a block diagram depicting one or more exemplary instructions of the information storage subsystem s200 of the residential information system 10 of FIG. 1.

FIG. 33 is a block diagram depicting one or more exemplary instructions of the information storage subsystem s200 of the residential information system 10 of FIG. 1.

FIG. 34 is a block diagram depicting one or more exemplary instructions of the information storage subsystem s200 of the residential information system 10 of FIG. 1.

FIG. 35 is a block diagram depicting one or more exemplary modules of the residential information system 10 of FIG. 1.

FIG. 36 is a block diagram depicting one or more exemplary modules of the residential information system 10 of FIG. 1.

FIG. 37 is a block diagram depicting one or more exemplary modules of the residential information system 10 of FIG. 1.

FIG. 38 is a block diagram depicting one or more exemplary modules of the residential information system 10 of FIG. 1.

FIG. 39 is a block diagram depicting one or more exemplary modules of the residential information system 10 of FIG. 1.

FIG. 40 is a block diagram depicting one or more exemplary modules of the residential information system 10 of FIG. 1.

FIG. 41 is a block diagram depicting one or more exemplary modules of the residential information system 10 of FIG. 1.

FIG. 42 is a high-level flowchart illustrating an operational flow o10 representing exemplary operations related to electronically accumulating residential food management information including one or more food related residential conditions affecting residential service of one or more residential food items, and electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items at least associated with the depicted exemplary implementations of the system.

FIG. 43 is a high-level flowchart including exemplary implementations of operation o11 of FIG. 42.

FIG. 44 is a high-level flowchart including exemplary implementations of operation o11 of FIG. 42.

FIG. 45 is a high-level flowchart including exemplary implementations of operation o11 of FIG. 42.

FIG. 46 is a high-level flowchart including exemplary implementations of operation o11 of FIG. 42.

FIG. 47 is a high-level flowchart including exemplary implementations of operation o11 of FIG. 42.

FIG. 48 is a high-level flowchart including exemplary implementations of operation o11 of FIG. 42.

FIG. 49 is a high-level flowchart including exemplary implementations of operation o11 of FIG. 42.

FIG. 50 is a high-level flowchart including exemplary implementations of operation o11 of FIG. 42.

FIG. 51 is a high-level flowchart including exemplary implementations of operation o11 of FIG. 42.

FIG. 52 is a high-level flowchart including exemplary implementations of operation o11 of FIG. 42.

FIG. 53 is a high-level flowchart including exemplary implementations of operation o11 of FIG. 42.

FIG. 54 is a high-level flowchart including exemplary implementations of operation o11 of FIG. 42.

FIG. 55 is a high-level flowchart including exemplary implementations of operation o11 of FIG. 42.

FIG. 56 is a high-level flowchart including exemplary implementations of operation o11 of FIG. 42.

FIG. 57 is a high-level flowchart including exemplary implementations of operation o11 of FIG. 42.

FIG. 58 is a high-level flowchart including exemplary implementations of operation o11 of FIG. 42.

FIG. 59 is a high-level flowchart including exemplary implementations of operation o11 of FIG. 42.

FIG. 60 is a high-level flowchart including exemplary implementations of operation o11 of FIG. 42.

FIG. 61 is a high-level flowchart including exemplary implementations of operation o11 of FIG. 42.

FIG. 62 is a high-level flowchart including exemplary implementations of operation o11 of FIG. 42.

FIG. 63 is a high-level flowchart including exemplary implementations of operation o11 of FIG. 42.

FIG. 64 is a high-level flowchart including exemplary implementations of operation o11 of FIG. 42.

FIG. 65 is a high-level flowchart including exemplary implementations of operation o11 of FIG. 42.

FIG. 66 is a high-level flowchart including exemplary implementations of operation o11 of FIG. 42.

FIG. 67 is a high-level flowchart including exemplary implementations of operation o11 of FIG. 42.

FIG. 68 is a high-level flowchart including exemplary implementations of operation o11 of FIG. 42.

FIG. 69 is a high-level flowchart including exemplary implementations of operation o11 of FIG. 42.

FIG. 70 is a high-level flowchart including exemplary implementations of operation o12 of FIG. 42.

FIG. 71 is a high-level flowchart including exemplary implementations of operation o12 of FIG. 42.

FIG. 72 is a high-level flowchart including exemplary implementations of operation o12 of FIG. 42.

FIG. 73 is a high-level flowchart including exemplary implementations of operation o12 of FIG. 42.

FIG. 74 is a high-level flowchart including exemplary implementations of operation o12 of FIG. 42.

FIG. 75 is a high-level flowchart including exemplary implementations of operation o12 of FIG. 42.

FIG. 76 is a high-level flowchart including exemplary implementations of operation o12 of FIG. 42.

FIG. 77 is a high-level flowchart including exemplary implementations of operation o12 of FIG. 42.

FIG. 78 is a high-level flowchart including exemplary implementations of operation o12 of FIG. 42.

FIG. 79 is a high-level flowchart including exemplary implementations of operation o12 of FIG. 42.

FIG. 80 is a high-level flowchart including exemplary implementations of operation o12 of FIG. 42.

FIG. 81 is a high-level flowchart including exemplary implementations of operation o12 of FIG. 42.

FIG. 82 is a high-level flowchart including exemplary implementations of operation o12 of FIG. 42.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The present application may use formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

Generally, both commercial and consumer interests are becoming more concerned regarding origins of their food and other ingestible materials. Thus, tracking and testing systems to provide in depth information concerning provenance and other data associated with food and other ingestible materials including farming related production and other handling and processing can also be of interest.

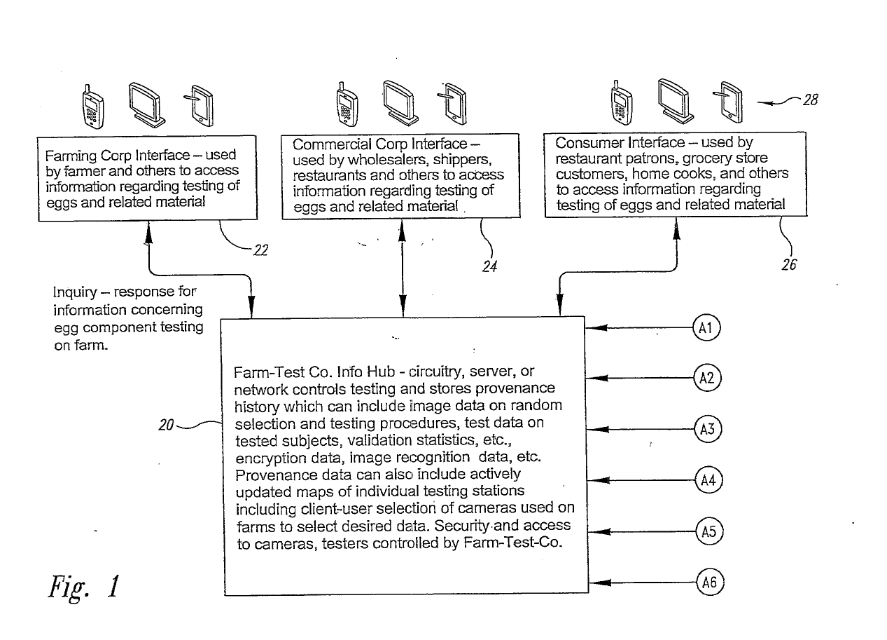

With reference now to the Figures, FIGS. 1-11 depict a schematic diagram of an environment(s) and/or an implementation(s) of technologies described herein. FIGS. 1-11 depict that including physical flows generally including indications as such by use of dashed arrows, the physical flows including that involving handling, testing, worker behavior, animal behavior, and other involvement of items, which can include feed, chicken, egg, carton, containers, transit, grocery store, receiving of containers, unpacking of cartons, shelving of cartons, shopping for cartons, in-store transit of cartons, purchase of carton, transit of carton to home, receiving carton at home, storage of carton at home, removal of egg and preparation of such, etc. Other physical flows are depicted to include transit of container to restaurant, receiving, unpacking, storage, etc. of container at restaurant, unpacking of egg and preparation of in dish, serving and purchasing of dish containing egg, etc. Physical flows are depicted to include testing of grain, chicken, egg, or other items.

FIGS. 1-11 depict that including information flows generally including indications as such by use of solid arrows, the information flows including image data sent from various imaging devices to information hubs, the image data including imaging of various stages of the physical flows. Information flows depicted also include inquiry-responses, initiating of devices, financial data, testing, etc. The information hubs are depicted to include those directed to information flows involving information obtained at farm, transit, restaurant, grocery, home or other locations. The information hubs are depicted to include interchange of information between each other. The information hubs are depicted to communicate with various interfaces to allow for communication therebetween by farming, commercial, restaurant, consumer and other interests. Information in information hubs can allow for research and other activities including determinations of compliance, noncompliance or errors made during one or more physical flows. The examples depicted in FIGS. 1-11 are for illustrative purposes but are not intended to limit aspects to only these examples. Rather they serve to exemplify how data on food provenance and other ingestible material and other sorts of source data can be acquired through various tracking and testing for retrieval and inquiry through such as interfaces shown.

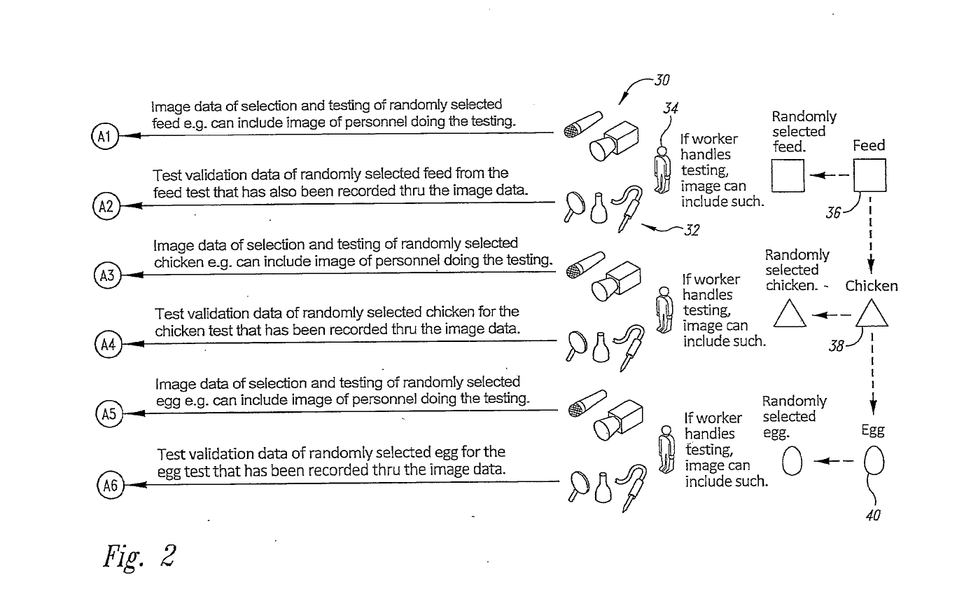

In particular, as shown in FIG. 1, interfaces 22, 24, and 26 are used to interact with Farm-Test Co. Info Hub 20 containing various information related to test of production factors and other items concerning one or more farming related production factors or other items. As shown in FIG. 2, production factors or ingestible material such as feed 36, chicken 38, and egg 40 can be monitored and tested through various sensors 30, 32 further described herein. Behavior of workers 34 can also be monitored.

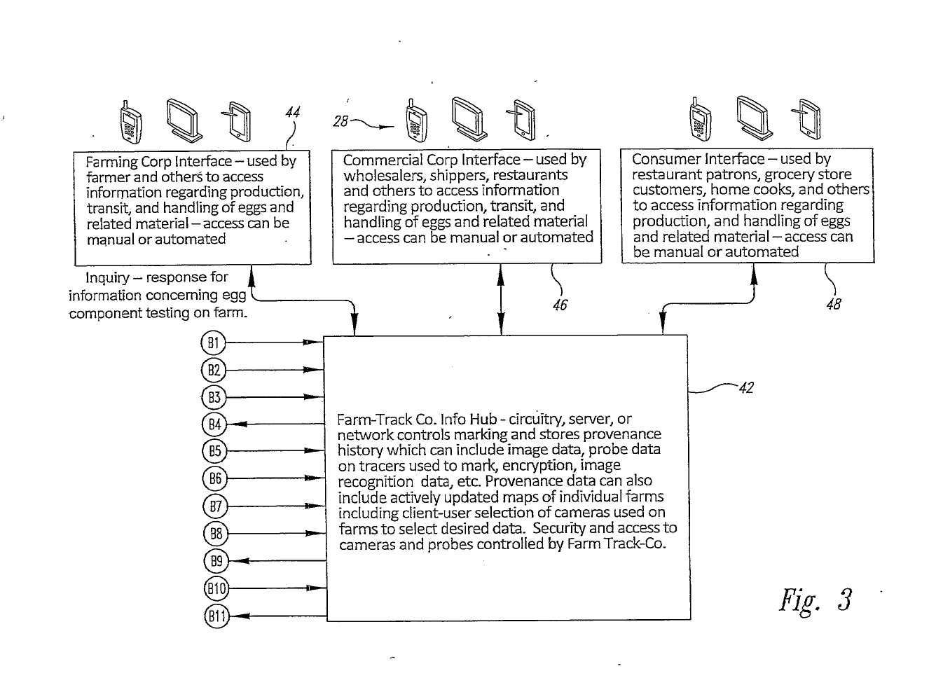

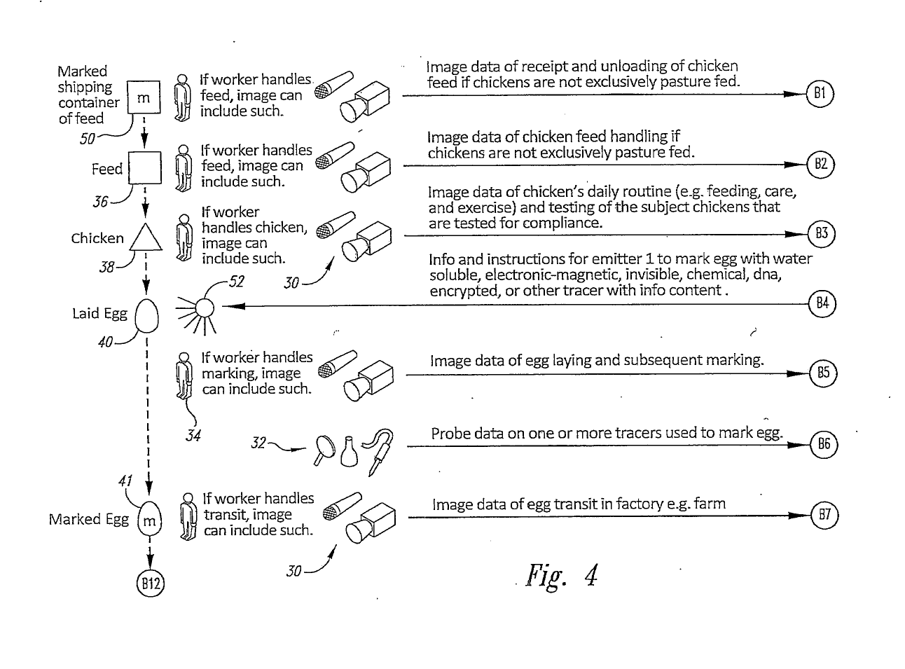

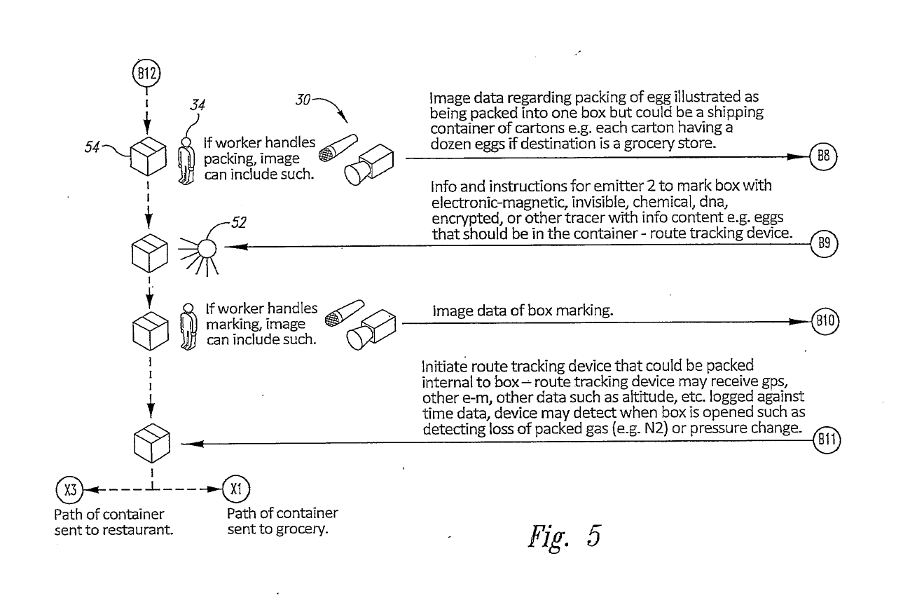

As shown in FIG. 3, interfaces 44, 46, and 48 are used to interact with Farm-Track Co. Info Hub 42 containing various information related to monitoring of production factors and other items concerning one or more farming related production factors or other items. As ingestible material is produced such as egg 40 later becoming marked egg 41 is packed, all such activity involved with such can also be monitored as shown in FIG. 4. The monitoring can be associated with tracers or other labels or marks and also identifiers or other identification information. These associations can be used to access monitoring or testing information through use of tracers and associated identifiers. The tracers can be located at least momentarily in proximity to ingestible material or other production factors to assist in accessing monitoring or testing information. Packing of ingestible material into shipping containers 54 such as shown in FIG. 5 can also be subject to monitoring and labeling of containers through emitters 52.

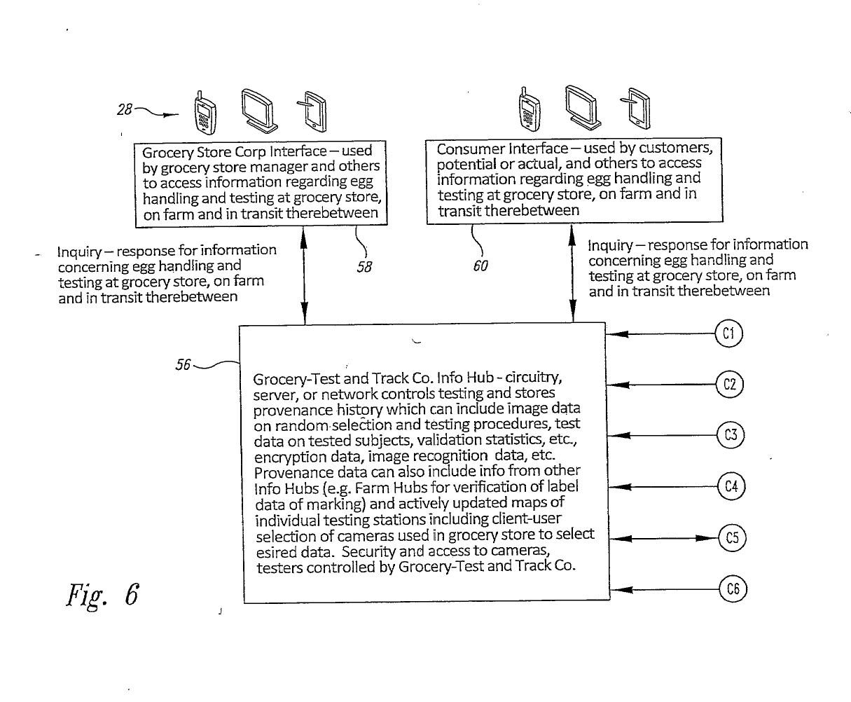

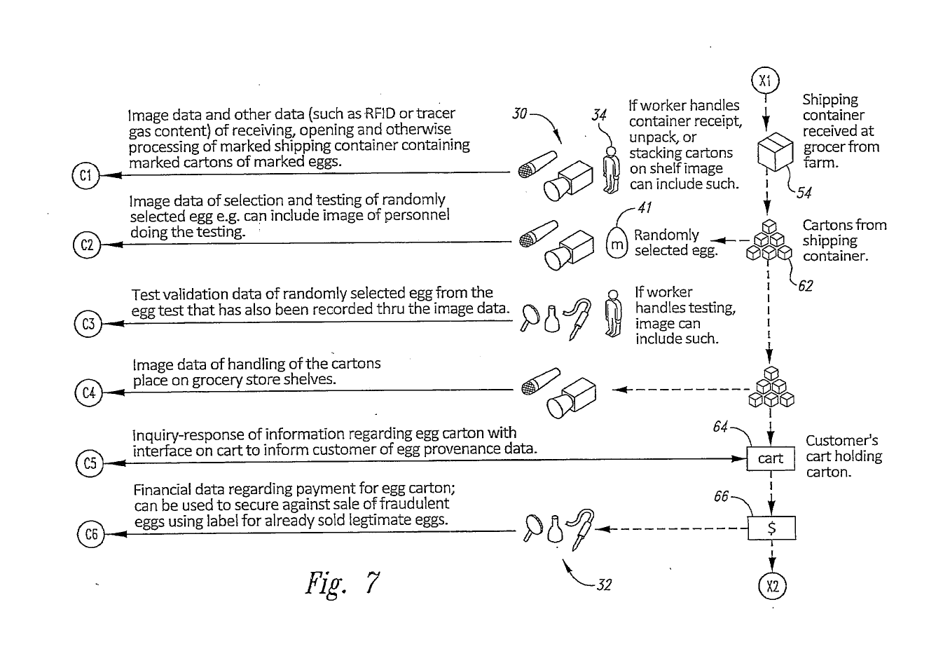

Further monitoring and testing can be performed at commercial locations with information stored on other information hubs such as grocery-test and track co info hub 56 as shown in FIG. 6. Monitoring of grocery activities, such as unpacking cartons 62, use of customer shopping carts 64, and purchase activity 66 shown in FIG. 7, can also be performed.

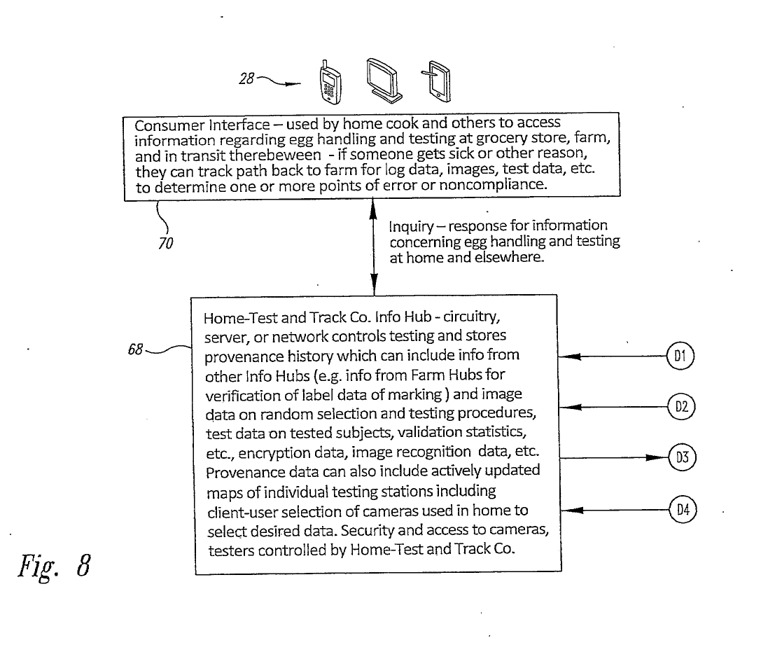

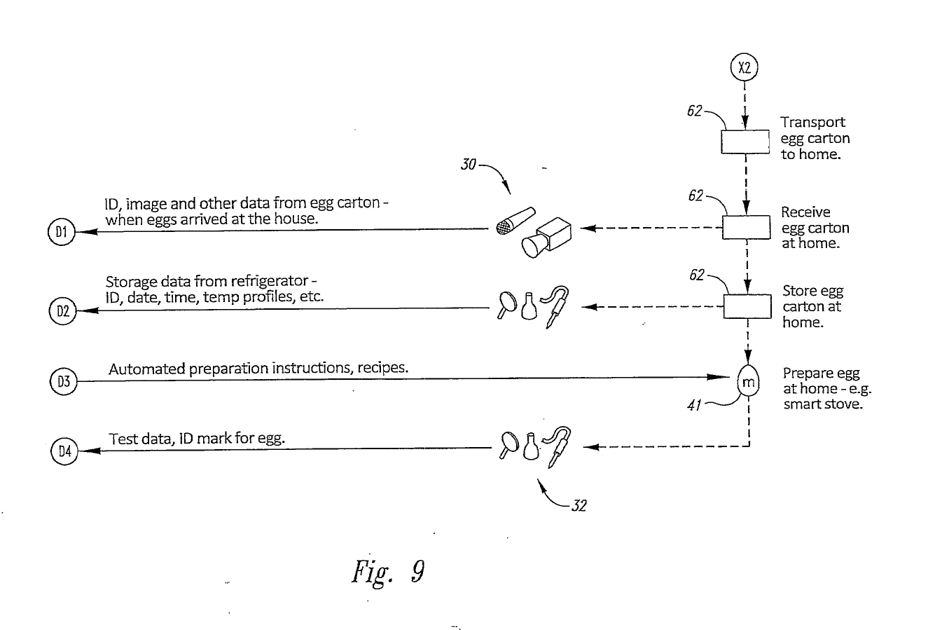

Monitoring, testing and accessing of data can be accomplished at home as well as depicted in FIG. 8 through use of a home-test track co. info hub 68 and consumer interfaces 28. Further illustrative home activities that can be monitored are shown in FIG. 9 to include transporting, receiving, storing and preparing ingestible material.

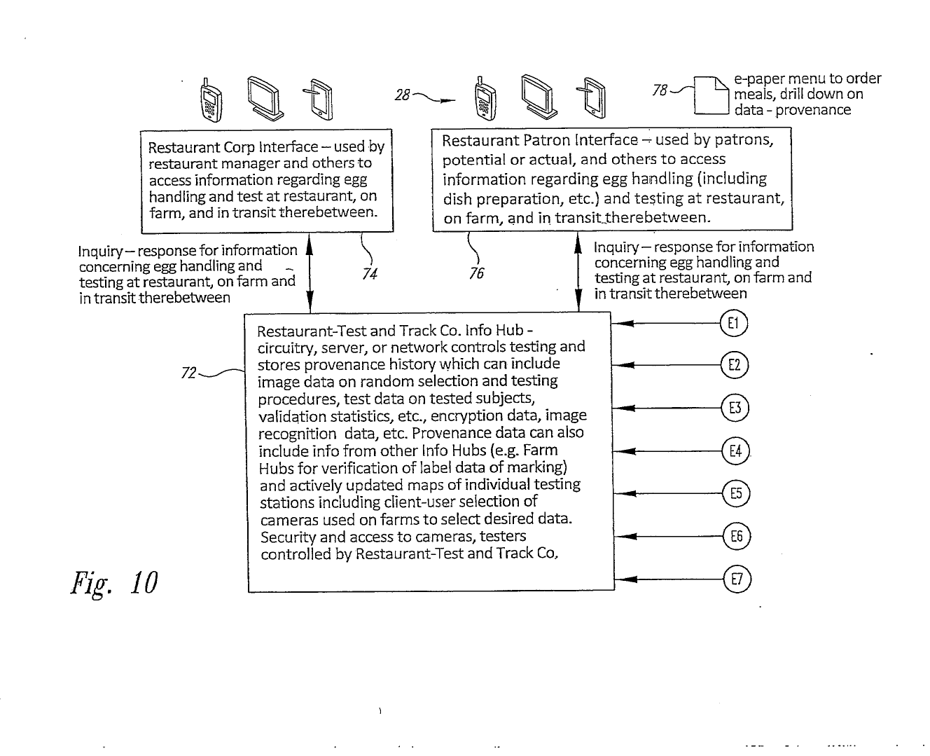

Other commercial venues for monitoring and testing can include restaurants as illustrated in FIG. 10 to include restaurant-test and track co. info hub 72 that can be used for storage and access of provenance data and also monitoring data of activities conducted at a restaurant. This data can be access by both restaurant personnel and restaurant patrons such as through interfaces 74, 76, and 78 to include menuing systems for the patrons.

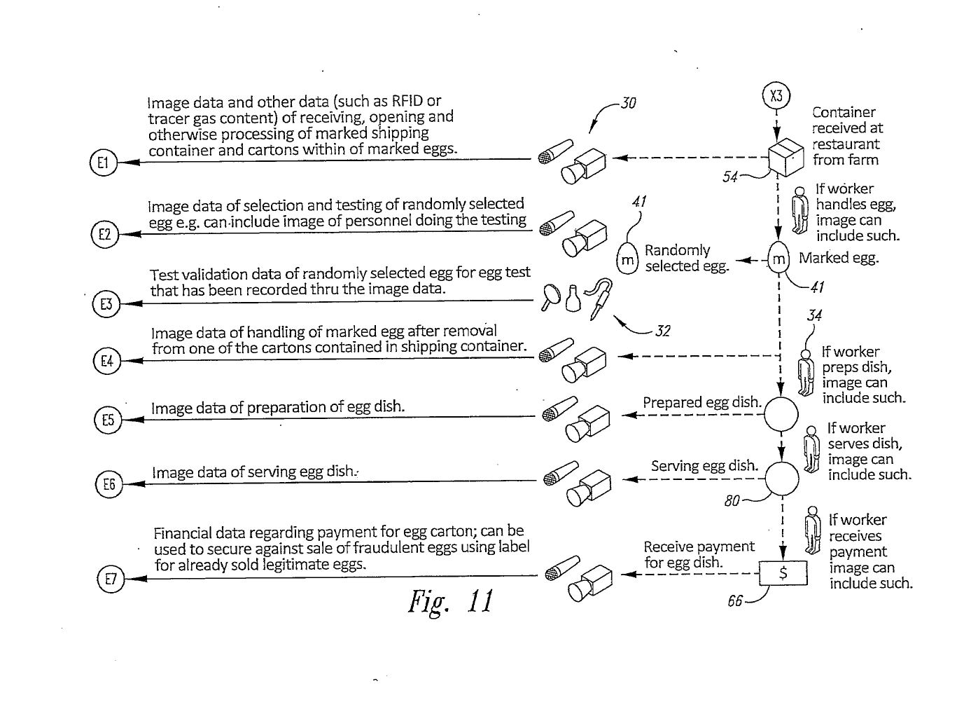

Activities conducted in a restaurant including those depicted in FIG. 11 such as receiving, handling, preparing, serving 80, and transacting payment can be included in monitoring and testing aspects to be stored on the restaurant-test and track co info hub 72 or elsewhere.

Various aspects embodied and illustrated through FIGS. 1-11 can be enumerated below and are provided to provide examples but are not intended to be limiting.

Food Supply Chain Automation

1. Feed (e.g. Grain) Farm Track Information Hub
a. receive fertilizer track and test hub information
b. receive fertilizer container tracer information or fertilizer tracer information
c. verify fertilizer container tracer information or fertilizer tracer information with fertilizer track hub information
d. receive internal fertilizer container tracker information
e. verify internal fertilizer container tracker information with fertilizer track hub information
f. receive local fertilizer container handling audio-video and sensor information
g. scan local fertilizer container handling audio-video and sensor information for error or noncompliance
h. receive accounting information of production factor use for local fertilizer container handling
i. correlate local fertilizer container handling audio-video and sensor information with accounting information of production factor use for local fertilizer container handling
j. associate local fertilizer container handling audio-video and sensor information with fertilizer tracer information
k. receive local fertilizer handling audio-video and sensor information
l. scan local fertilizer handling audio-video and sensor information for error or noncompliance
m. receive accounting information of production factor use for local fertilizer handling
n. correlate local fertilizer behavior and handling audio-video and sensor information with accounting information of production factor use for local fertilizer handling
o. associate local fertilizer handling audio-video and sensor information with animal tracer information
p. receive local feed (grain) handling audio-video and sensor information
q. associate local feed handling audio-video and sensor information with feed container tracer information or feed tracer information
r. receive local grain field handling audio-video and sensor information
s. scan local grain field handling audio-video and sensor information for error or noncompliance
t. receive accounting information of production factor use for local grain field handling
u. correlate local grain field handling audio-video and sensor information with accounting information of production factor use for local fertilizer handling
v. associate local grain field handling audio-video and sensor information with animal tracer information

2. Animal (e.g. chicken) Farm Track and Test Information Hub
a. receive feed track hub information
b. receive feed container tracer information or feed tracer information
c. verify feed container tracer information or feed tracer information with feed track hub information
d. receive internal feed container tracker information
e. verify internal feed container tracker information with feed track hub information
f. receive local feed handling audio-video and sensor information
g. associate local feed handling audio-video and sensor information with chicken tracer information
h. scan local feed handling audio-video and sensor information for error or noncompliance
i. receive accounting information of production factor use for local feed handling
j. correlate local feed handling audio-video and sensor information with accounting information of production factor use for local feed handling
k. send alert to initiate feed sample test event
l. receive feed test sample tracer information
m. verify feed test sample tracer information with egg track hub information
n. receive feed test sample handling audio-video and sensor information
o. associate feed test sample handing audio-video and sensor information with chicken tracer information
p. scan feed test sample handling audio-video and sensor information for error or noncompliance
q. receive accounting information of production factor use for feed test sample handling
r. correlate feed test sample handling audio-video and sensor information with accounting information of production factor use for feed test sample handling
s. receive test results for feed test sample
t. associate test results for feed test sample with feed test sample tracer information
u. update feed (grain) farm track information hub re butchered chicken portion test sample testing
v. receive local chicken behavior and handling audio-video and sensor information
w. associate local chicken behavior and handling audio-video and sensor information with chicken tracer information
x. scan local chicken behavior and handling audio-video and sensor information for error or noncompliance
y. receive accounting information of production factor use for local chicken behavior and handling
z. correlate local chicken behavior and handling audio-video and sensor information with accounting information of production factor use for local chicken behavior and handling
aa. send alert to initiate chicken sample test event
bb. receive chicken test sample tracer information
cc. verify chicken test sample tracer information with egg track hub information
dd. receive chicken test sample handling audio-video and sensor information
ee. associate chicken test sample handing audio-video and sensor information with chicken tracer information
ff. scan chicken test sample handling audio-video and sensor information for error or noncompliance
gg. receive accounting information of production factor use for chicken test sample handling
hh. correlate chicken test sample handling audio-video and sensor information with accounting information of production factor use for chicken test sample handling
ii. receive test results for chicken test sample
jj. associate test results for chicken test sample with chicken test sample tracer information
kk. update feed (grain) farm track information hub re chicken test sample testing
ll. scan chicken behavior and handling audio-video and sensor information to determine egg was laid
mm. instruct emitter to mark laid egg with egg tracer(s) upon determining egg was laid
nn. receive local egg marking audio-video and sensor information
oo. scan local egg marking audio-video and sensor information for error or noncompliance
pp. receive accounting information of production factor use for local egg marking
qq. correlate local egg marking audio-video and sensor information with accounting information of production factor use for local egg marking
rr. associate audio-video and sensor information of egg marking with egg tracer information
ss. associate egg tracer information with tracer information of chicken that laid egg
tt. receive local egg handling audio-video and sensor information
uu. scan local egg handling audio-video and sensor information for error or noncompliance
vv. receive accounting information of production factor use for local egg handling
ww. correlate local egg handling audio-video and sensor information with accounting information of production factor use for local egg handling
xx. associate local egg handling audio-video and sensor information with egg tracer information
yy. send alert to initiate egg sample test event
zz. receive egg test sample tracer information
aaa. verify egg test sample tracer information with egg track hub information
bbb. receive egg test sample handling audio-video and sensor information
ccc. associate egg test sample handing audio-video and sensor information with chicken tracer information
ddd. scan egg test sample handling audio-video and sensor information for error or noncompliance
eee. receive accounting information of production factor use for egg test sample handling
fff. correlate egg test sample handling audio-video and sensor information with accounting information of production factor use for egg test sample handling
ggg. receive test results for egg test sample
hhh. associate test results for egg test sample with egg test sample tracer information
iii. update feed (grain) farm track information hub re egg test sample testing
jjj. receive local egg hatching into hatched chicken audio-video and sensor information
kkk. scan local egg hatching into hatched audio-video and sensor information for error or noncompliance
lll. receive accounting information of production factor use for local egg hatching into hatched chicken
mmm. correlate local egg hatching audio-video and sensor information with accounting information of production factor use for local egg hatching into hatched chicken
nnn. associate local egg hatching into hatched chicken audio-video and sensor information with egg tracer information
ooo. send alert to initiate hatched chicken sample test event
ppp. receive hatched chicken test sample tracer information
qqq. verify hatched chicken test sample tracer information with egg track hub information
rrr. receive hatched chicken test sample handling audio-video and sensor information
sss. associate hatched chicken test sample handing audio-video and sensor information with chicken tracer information
ttt. scan hatched chicken test sample handling audio-video and sensor information for error or noncompliance
uuu. receive accounting information of production factor use for hatched chicken test sample handling
vvv. correlate hatched chicken test sample handling audio-video and sensor information with accounting information of production factor use for hatched chicken test sample handling
www. receive test results for hatched chicken test sample
xxx. associate test results for hatched chicken test sample with hatched chicken test sample tracer information
yyy. update feed (grain) farm track information hub re hatched chicken test sample testing
zzz. instruct emitter to mark local hatched chicken with hatched chicken tracer(s)
aaaa. receive local hatched chicken marking audio-video and sensor information
bbbb. scan local hatched chicken marking audio-video and sensor information for error or noncompliance
cccc. receive accounting information of production factor use for local hatched chicken marking
dddd. correlate local hatched chicken marking audio-video and sensor information with accounting information of production factor use for local hatched chicken marking
eeee. associate local hatched chicken audio-video and sensor information with local hatched chicken tracer information
ffff. receive local hatched chicken behavior audio-video and sensor information
gggg. scan local hatched chicken behavior audio-video and sensor information for error or noncompliance
hhhh. receive accounting information of production factor use for local hatched chicken behavior
iiii. correlate local hatched chicken behavior audio-video and sensor information with accounting information of production factor use for local hatched chicken behavior
jjjj. associate local hatched chicken behavior audio-video and sensor information with local hatched chicken tracer information
kkkk. send alert to initiate hatched chicken sample test event
llll. receive hatched chicken test sample tracer information
mmmm. verify hatched chicken test sample tracer information with egg track hub information
nnnn. receive hatched chicken test sample handling audio-video and sensor information
oooo. associate hatched chicken test sample handing audio-video and sensor information with chicken tracer information
pppp. scan hatched chicken test sample handling audio-video and sensor information for error or noncompliance
qqqq. receive accounting information of production factor use for hatched chicken test sample handling
rrrr. correlate hatched chicken test sample handling audio-video and sensor information with accounting information of production factor use for hatched chicken test sample handling
ssss. receive test results for hatched chicken test sample
tttt. associate test results for hatched chicken test sample with hatched chicken test sample tracer information
uuuu. update feed (grain) farm track information hub re hatched chicken test sample testing
vvvv. scan handling and behavior of local hatched chicken to determine when slaughter of local hatched chicken occurs
wwww. scan handling of slaughter of local hatched chicken for error or non-compliance
xxxx. receive accounting information of production factor use for slaughter of local hatched chicken
yyyy. correlate slaughter of local hatched chicken behavior audio-video and sensor information with accounting information of production factor use for slaughter of local hatched chicken
zzzz. associate slaughter of local hatched chicken audio-video and sensor information with local hatched chicken tracer information
aaaaa. scan handling and behavior of local hatched chicken to determine when butcher of local hatched chicken occurs
bbbbb. scan handling of butcher of local hatched chicken for error or non-compliance
ccccc. receive accounting information of production factor use for butcher of local hatched chicken
ddddd. correlate butcher of local hatched chicken audio-video and sensor information with accounting information of production factor use for butcher of local hatched chicken
eeeee. associate butcher of local hatched chicken audio-video and sensor information with local hatched chicken tracer
fffff. instruct emitter to mark each portion of butchered chicken with chicken portion tracer(s)
ggggg. receive butchered chicken portion marking audio-video and sensor information
hhhhh. scan butchered chicken portion marking audio-video and sensor information for error or noncompliance
iiiii. receive accounting information of production factor use for butchered chicken portion marking
jjjjj. correlate butchered chicken portion marking audio-video and sensor information with accounting information of production factor use for butchered chicken portion marking
kkkkk. associate butchered chicken portion marking audio-video and sensor information with butchered chicken portion tracer information
lllll. send alert to initiate butchered chicken portion sample test event
mmmmm. receive butchered chicken portion test sample tracer information
nnnnn. verify butchered chicken portion test sample tracer information with egg track hub information
ooooo. receive butchered chicken portion test sample handling audio-video and sensor information
ppppp. associate butchered chicken portion test sample handing audio-video and sensor information with chicken tracer information
qqqqq. scan butchered chicken portion test sample handling audio-video and sensor information for error or noncompliance
rrrrr. receive accounting information of production factor use for butchered chicken portion test sample handling
sssss. correlate butchered chicken portion test sample handling audio-video and sensor information with accounting information of production factor use for butchered chicken portion test sample handling
ttttt. receive test results for butchered chicken portion test sample
uuuuu. associate test results for butchered chicken portion test sample with butchered chicken portion test sample tracer information
vvvvv. update feed (grain) farm track information hub re butchered chicken portion test sample testing
wwwww. receive local packing butchered chicken portion into butchered chicken portion carton audio-video and sensor information
xxxxx. scan local packing butchered chicken portion into butchered chicken portion carton handling audio-video and sensor information for error or noncompliance
yyyyy. receive accounting information of production factor use for local packing butchered chicken portion into butchered chicken portion carton
zzzzz. correlate local packing butchered chicken portion into butchered chicken portion carton handling audio-video and sensor information with accounting information of production factor use for local packing butchered chicken portion into butchered chicken portion carton
aaaaaa. associate local packing butchered chicken portion into butchered chicken portion carton audio-video and sensor information with butchered chicken portion tracer information
bbbbbb. instruct emitter to mark butchered chicken portion carton with butchered chicken portion carton tracer(s)
cccccc. receive local butchered chicken portion carton marking audio-video and sensor information
dddddd. scan local butchered chicken portion carton marking audio-video and sensor information for error or noncompliance
eeeeee. receive accounting information of production factor use for local butchered chicken portion carton marking
ffffff. correlate local butchered chicken portion carton marking audio-video and sensor information with accounting information of production factor use for local butchered chicken portion carton marking
gggggg. associate butchered chicken portion carton marking audio-video and sensor information with butchered chicken portion carton tracer information
hhhhhh. receive local packing butchered chicken portion carton into carton container audio-video and sensor information
iiiiii. scan local packing butchered chicken portion carton into carton container audio-video and sensor information for error or noncompliance
jjjjjjj. receive accounting information of production factor use for local packing butchered chicken portion carton into carton container
kkkkkk. correlate local packing butchered chicken portion carton into carton container audio-video and sensor information with accounting information of production factor use for local packing butchered chicken portion carton into carton container
llllll. associate local packing butchered chicken portion carton into carton container audio-video and sensor information with carton container tracer information
mmmmmm. instruct emitter to mark carton container with carton container tracer(s)
nnnnnn. receive local carton container marking audio-video and sensor information
oooooo. scan local carton container marking audio-video and sensor information for error or noncompliance
pppppp. receive accounting information of production factor use for local carton container marking
qqqqqq. correlate local carton container marking audio-video and sensor information with accounting information of production factor use for local carton container marking
rrrrrr. associate local carton container marking audio-video and sensor information with carton container tracer information

3. Egg Farm Track Information Hub
a. receive feed track hub information
b. receive feed container tracer information or feed tracer information
c. verify feed container tracer information or feed tracer information with feed track hub information
d. receive internal feed container tracker information
e. verify internal feed container tracker information with feed track hub information
f. receive local feed handling audio-video and sensor information
g. associate local feed handling audio-video and sensor information with chicken tracer information
h. scan local feed handling audio-video and sensor information for error or noncompliance
i. receive accounting information of production factor use for local feed handling
j. correlate local feed handling audio-video and sensor information with accounting information of production factor use for local feed handling
k. receive chicken track hub information
l. receive chicken container tracer information or chicken tracer information
m. verify chicken container tracer information or chicken tracer information with chicken track hub information
n. receive internal chicken container tracker information
o. verify internal chicken container tracker information with chicken track hub information
p. receive local chicken behavior and handling audio-video and sensor information
q. associate local chicken behavior and handling audio-video and sensor information with chicken tracer information
r. scan local chicken behavior and handling audio-video and sensor information for error or noncompliance
s. receive accounting information of production factor use for local chicken behavior and handling
t. correlate local chicken behavior and handling audio-video and sensor information with accounting information of production factor use for local chicken behavior and handling
u. scan chicken behavior and handling audio-video and sensor information to determine egg was laid
v. instruct emitter to mark laid egg with egg tracer(s) upon determining egg was laid
w. receive local egg marking audio-video and sensor information
x. scan local egg marking audio-video and sensor information for error or noncompliance
y. receive accounting information of production factor use for local egg marking
z. correlate local egg marking audio-video and sensor information with accounting information of production factor use for local egg marking
aa. associate audio-video and sensor information of egg marking with egg tracer information
bb. associate egg tracer information with tracer information of chicken that laid egg
cc. receive local egg handling (includes marking) audio-video and sensor information
dd. scan local egg handling audio-video and sensor information for error or noncompliance
ee. receive accounting information of production factor use for local egg handling
ff. correlate local egg handling audio-video and sensor information with accounting information of production factor use for local egg handling
gg. associate local egg handling audio-video and sensor information with egg tracer information
hh. receive local packing egg into egg carton audio-video and sensor information
ii. scan local packing egg into egg carton handling audio-video and sensor information for error or noncompliance
jj. receive accounting information of production factor use for local packing egg into egg carton
kk. correlate local packing egg into egg carton handling audio-video and sensor information with accounting information of production factor use for local packing egg into egg carton
ll. associate local packing egg into egg carton audio-video and sensor information with egg tracer information
mm. instruct emitter to mark egg carton with egg carton tracer(s)
nn. receive local egg carton marking audio-video and sensor information
oo. scan local egg carton marking audio-video and sensor information for error or noncompliance
pp. receive accounting information of production factor use for local egg carton marking
qq. correlate local egg carton marking audio-video and sensor information with accounting information of production factor use for local egg carton marking
rr. associate egg carton marking audio-video and sensor information with egg carton tracer information
ss. receive local egg carton handling audio-video and sensor handling information
tt. scan local egg carton handling audio-video and sensor information for error or noncompliance
uu. receive accounting information of production factor use for local egg carton handling
vv. correlate local egg carton handling audio-video and sensor information with accounting information of production factor use for local egg carton handling
ww. associate local egg carton handling audio-video and sensor information with egg carton tracer information
xx. associate carton tracer information with egg tracer information
yy. receive local packing egg carton into carton container audio-video and sensor information
zz. scan local packing egg carton into carton container audio-video and sensor information for error or noncompliance
aaa. receive accounting information of production factor use for local packing egg carton into carton container
bbb. correlate local packing egg carton into carton container audio-video and sensor information with accounting information of production factor use for local packing egg carton into carton container
ccc. associate local packing egg carton into carton container audio-video and sensor information with carton container tracer information
ddd. instruct emitter to mark carton container with carton container tracer(s)
eee. receive local carton container marking audio-video and sensor information
fff. scan local carton container marking audio-video and sensor information for error or noncompliance
ggg. receive accounting information of production factor use for local carton container marking
hhh. correlate local carton container marking audio-video and sensor information with accounting information of production factor use for local carton container marking
iii. associate local carton container marking audio-video and sensor information with carton container tracer information
jjj. receive local carton container handling audio-video and sensor information
kkk. scan local carton container handling audio-video and sensor information for error or noncompliance
lll. receive accounting information of production factor use for local carton container handling
mmm. correlate local carton container handling audio-video and sensor information with accounting information of production factor use for local carton container handling
nnn. associate carton container handling audio-video and sensor information with carton container tracer information
ooo. associate carton container tracer information with egg carton tracer information
ppp. initiate tracker placed internally in carton container during packing thereof
qqq. receive egg test hub information

4. Egg Farm Test Information Hub
a. receive egg track hub information
b. send alert to initiate local feed sample test event
c. receive local feed test sample tracer information
d. verify local feed test sample tracer information with egg track hub information
e. receive local feed test sample handling audio-video and sensor information
f. associate local feed test sample handing audio-video and sensor information with local feed test sample tracer information
g. scan local feed test sample handling audio-video and sensor information for error or noncompliance
h. receive accounting information of production factor use for local feed test sample handling
i. correlate local feed test sample handling audio-video and sensor information with accounting information of production factor use for local feed test sample handling
j. receive test results for local feed test sample
k. associate test results for local feed test sample with local feed test sample tracer information
l. update egg farm track information hub re local feed test sample testing
m. update chicken farm track information hub re local feed test sample testing
n. update feed (grain) farm track information hub re local feed test sample testing
o. send alert to initiate local chicken sample test event
p. receive local chicken test sample tracer information
q. verify local chicken test sample tracer information with egg track hub information
r. receive local chicken test sample handling audio-video and sensor information
s. associate local chicken test sample handing audio-video and sensor information with chicken tracer information
t. scan local chicken test sample handling audio-video and sensor information for error or noncompliance
u. receive accounting information of production factor use for local chicken test sample handling
v. correlate local chicken test sample handling audio-video and sensor information with accounting information of production factor use for local chicken test sample handling
w. receive test results for local chicken test sample
x. associate test results for local chicken test sample with local chicken test sample tracer information
y. update egg farm track information hub re local chicken test sample testing
z. update chicken farm track information hub re local chicken test sample testing
aa. update feed (grain) farm track information hub re local chicken test sample testing
bb. receive local egg test sample tracer information
cc. verify local egg test sample tracer information with egg track hub information
dd. receive local egg test sample handling audio-video and sensor information
ee. associate local egg test sample handing audio-video and sensor information with egg tracer information
ff. scan local egg test sample handling audio-video and sensor information for error or noncompliance
gg. receive accounting information of production factor use for local egg test sample handling
hh. correlate local egg test sample handling audio-video and sensor information with accounting information of production factor use for local egg test sample handling
ii. receive test results for local egg test sample
jj. associate test results for local egg test sample with local egg test sample tracer information
kk. update egg farm track information hub re local egg test sample testing
ll. update chicken farm track information hub re local egg test sample testing
mm. update feed (grain) farm track information hub re local egg test sample testing

5. Restaurant Test and Track Information Hub
a. receive egg farm track hub information
b. receive egg farm test hub information
c. receive carton container tracer information
d. verify carton container tracer information with egg track hub information
e. receive internal carton container tracker information
f. verify internal carton container tracker information with egg track hub information
g. receive local carton container handling audio-video and sensor information
h. scan local carton container handling audio-video and sensor information for error or noncompliance
i. receive accounting information of production factor use for local carton container handling
j. correlate local carton container handling audio-video and sensor information with accounting information of production factor use for local carton container handling
k. associate local handling of carton container audio-video and sensor information with carton container tracer information
l. receive local egg carton handling audio-video and sensor information
m. scan local egg carton handling audio-video and sensor information for error or noncompliance
n. receive accounting information of production factor use for local egg carton handling
o. correlate local egg carton handling audio-video and sensor information with accounting information of production factor use for local egg carton handling
p. associate local egg carton handling audio-video and sensor information with egg carton tracer information
q. receive local egg handling audio-video and sensor information
r. scan local egg handling audio-video and sensor information for error or noncompliance
s. receive accounting information of production factor use for local egg handling
t. correlate local egg handling audio-video and sensor information with accounting information of production factor use for local egg handling
u. associate local egg handling audio-video and sensor information with egg tracer information
v. send alert to initiate local egg sample test event
w. receive local egg test sample tracer information
x. verify local egg test sample tracer information with egg track hub information
y. receive local egg test sample handling audio-video and sensor information
z. associate local egg test sample handing audio-video and sensor information with egg tracer information
aa. scan local egg test sample handling audio-video and sensor information for error or noncompliance
bb. receive accounting information of production factor use for local egg test sample handling
cc. correlate local egg test sample handling audio-video and sensor information with accounting information of production factor use for local egg test sample handling
dd. receive test results for local egg test sample
ee. associate test results for local egg test sample with local egg test sample tracer information
ff. update egg farm track information hub re local egg test sample testing
gg. update chicken farm track information hub re local egg test sample testing
hh. update feed (grain) farm track information hub re local egg test sample testing
ii. receive local egg dish preparation audio-video and sensor information
jj. scan local egg dish preparation audio-video and sensor information for error or noncompliance
kk. receive accounting information of production factor use for local egg dish preparation
ll. correlate local egg dish preparation audio-video and sensor information with accounting information of production factor use for local egg dish preparation
mm. associate local egg dish preparation audio-video and sensor information with egg tracer information
nn. receive local egg dish serving audio-video and sensor information
oo. scan local egg dish serving audio-video and sensor information for error or noncompliance
pp. receive accounting information of production factor use for local egg dish serving
qq. correlate local egg dish serving audio-video and sensor information with accounting information of production factor use for local egg dish serving
rr. associate local egg dish serving audio-video and sensor information with egg tracer information
ss. receive local egg dish payment audio-video and sensor information
tt. scan local egg dish payment audio-video and sensor information for error or noncompliance
uu. receive accounting information of production factor use for local egg dish payment
vv. correlate local egg dish payment audio-video and sensor information with accounting information of production factor use for local egg dish payment
ww. associate local egg dish payment audio-video and sensor information with egg tracer information

6. Grocery Test and Track Information Hub
a. receive egg farm track hub information
b. receive egg farm test hub information
c. receive carton container tracer information
d. verify carton container tracer information with egg track hub information
e. receive internal carton container tracker information
f. verify internal carton container tracker information with egg track hub information
g. receive local carton container handling audio-video and sensor information
h. scan local carton container handling audio-video and sensor information for error or noncompliance
i. receive accounting information of production factor use for local carton container handling
j. correlate local carton container handling audio-video and sensor information with accounting information of production factor use for local carton container handling
k. associate local handling of carton container audio-video and sensor information with carton container tracer information
l. receive local egg carton handling audio-video and sensor information
m. scan local egg carton handling audio-video and sensor information for error or noncompliance
n. receive accounting information of production factor use for local egg carton handling
o. correlate local egg carton handling audio-video and sensor information with accounting information of production factor use for local egg carton handling
p. associate local egg carton handling audio-video and sensor information with egg carton tracer information
q. send alert to initiate local egg sample test event
r. receive local egg test sample tracer information
s. verify local egg test sample tracer information with egg track hub information
t. receive local egg test sample handling audio-video and sensor information
u. associate local egg test sample handing audio-video and sensor information with egg tracer information
v. scan local egg test sample handling audio-video and sensor information for error or noncompliance
w. receive accounting information of production factor use for local egg test sample handling
x. correlate local egg test sample handling audio-video and sensor information with accounting information of production factor use for local egg test sample handling
y. receive test results for local egg test sample
z. associate test results for local egg test sample with local egg test sample tracer information
aa. update egg farm track information hub re local egg test sample testing
bb. update chicken farm track information hub re local egg test sample testing
cc. update feed (grain) farm track information hub re local egg test sample testing
dd. receive local egg carton payment audio-video and sensor information
ee. scan local egg carton payment audio-video and sensor information for error or noncompliance
ff. receive accounting information of production factor use for local egg carton payment
gg. correlate local egg carton payment audio-video and sensor information with accounting information of production factor use for local egg carton payment
hh. associate local egg carton payment audio-video and sensor information with egg carton tracer information

7. Home Test and Track Information Hub
a. receive grocery test and track hub information
b. receive egg carton tracer information
c. verify egg carton tracer information with egg track hub information
d. receive internal carton container tracker information
e. verify internal carton container tracker information with egg track hub information
f. receive local egg carton handling audio-video and sensor information
g. scan local egg carton handling audio-video and sensor information for error or noncompliance
h. receive accounting information of production factor use for local egg carton handling
i. correlate local egg carton handling audio-video and sensor information with accounting information of production factor use for local egg carton handling
j. associate local egg carton handling audio-video and sensor information with egg carton tracer information
k. receive local egg handling audio-video and sensor information
l. scan local egg handling audio-video and sensor information for error or noncompliance
m. receive accounting information of production factor use for local egg handling
n. correlate local egg handling audio-video and sensor information with accounting information of production factor use for local egg handling
o. associate local egg handling audio-video and sensor information with egg tracer information
p. send alert to initiate local egg sample test event
q. receive local egg test sample tracer information
r. verify local egg test sample tracer information with egg track hub information
s. receive local egg test sample handling audio-video and sensor information
t. associate local egg test sample handing audio-video and sensor information with egg tracer information
u. scan local egg test sample handling audio-video and sensor information for error or noncompliance
v. receive accounting information of production factor use for local egg test sample handling
w. correlate local egg test sample handling audio-video and sensor information with accounting information of production factor use for local egg test sample handling
x. receive test results for local egg test sample
y. associate test results for local egg test sample with local egg test sample tracer information
z. update grocery track information hub re local egg test sample testing
aa. update egg farm track information hub re local egg test sample testing
bb. update chicken farm track information hub re local egg test sample testing
cc. update feed (grain) farm track information hub re local egg test sample testing
dd. receive local egg dish preparation audio-video and sensor information
ee. scan local egg dish preparation audio-video and sensor information for error or noncompliance
ff. receive accounting information of production factor use for local egg dish preparation
gg. correlate local egg dish preparation audio-video and sensor information with accounting information of production factor use for local egg dish preparation
hh. associate local egg dish preparation audio-video and sensor information with egg tracer information
ii. receive local egg dish serving audio-video and sensor information
jj. scan local egg dish serving audio-video and sensor information for error or noncompliance
kk. receive accounting information of production factor use for local egg dish serving
ll. correlate local egg dish serving audio-video and sensor information with accounting information of production factor use for local egg dish serving
mm. associate local egg dish serving audio-video and sensor information with egg tracer information

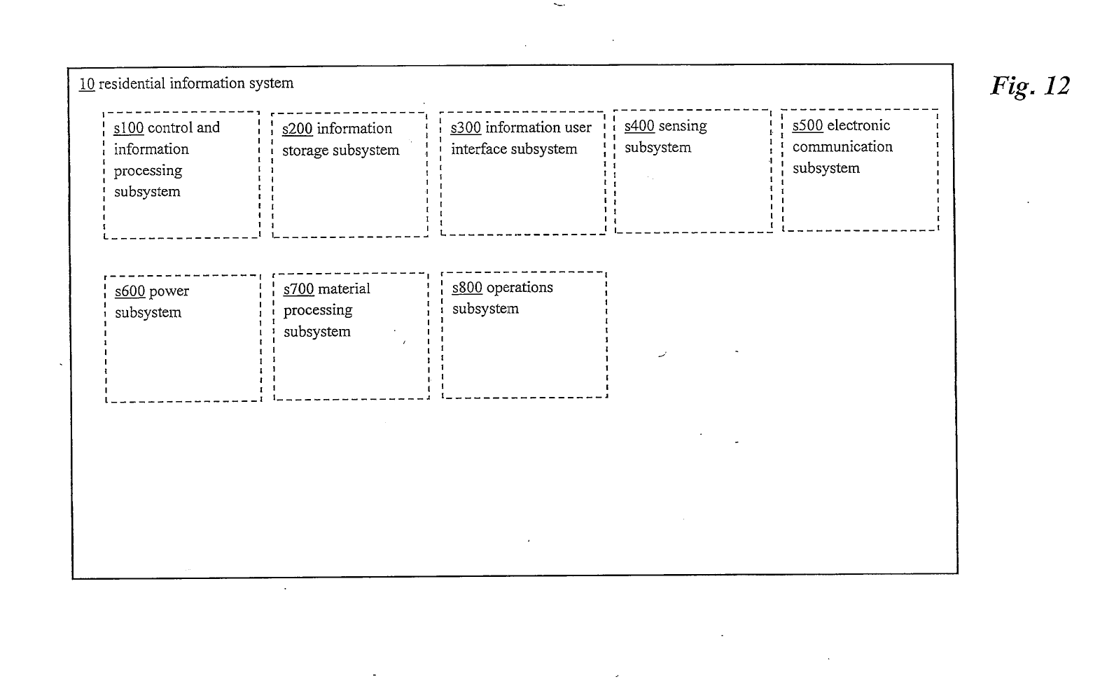

An exemplary version of the residential information system 10 is shown in FIG. 12 to optionally include various subsystems such as control and information processing subsystem s100, information storage subsystem s200, information user interface subsystem s300, sensing subsystem s400, electronic communication subsystem s500, power subsystem s600, material processing subsystem s700, and operations subsystem s800.

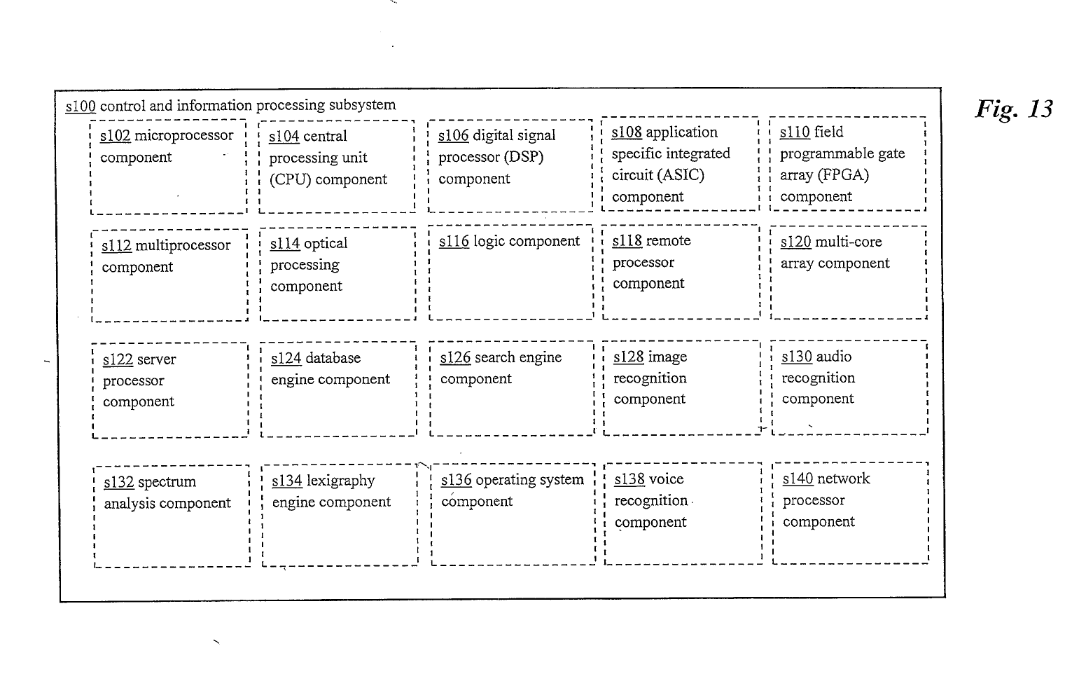

An exemplary implementation of the control and information processing subsystem s100 is shown in FIG. 13 to optionally include various components such as microprocessor component s102, central processing unit (CPU) component s104, digital signal processor (DSP) component s106, application specific integrated circuit (ASIC) component s108, field programmable gate array (FPGA) component s110, multiprocessor component s112, optical processing component s114, logic component s116, remote processor component s118, multi-core array component s120, server processor component s122, database engine component s124, search engine component s126, image recognition component s128, audio recognition component s130, spectrum analysis component s132, lexigraphy engine component s134, operating system component s136, voice recognition component s138, and network processor component s140.

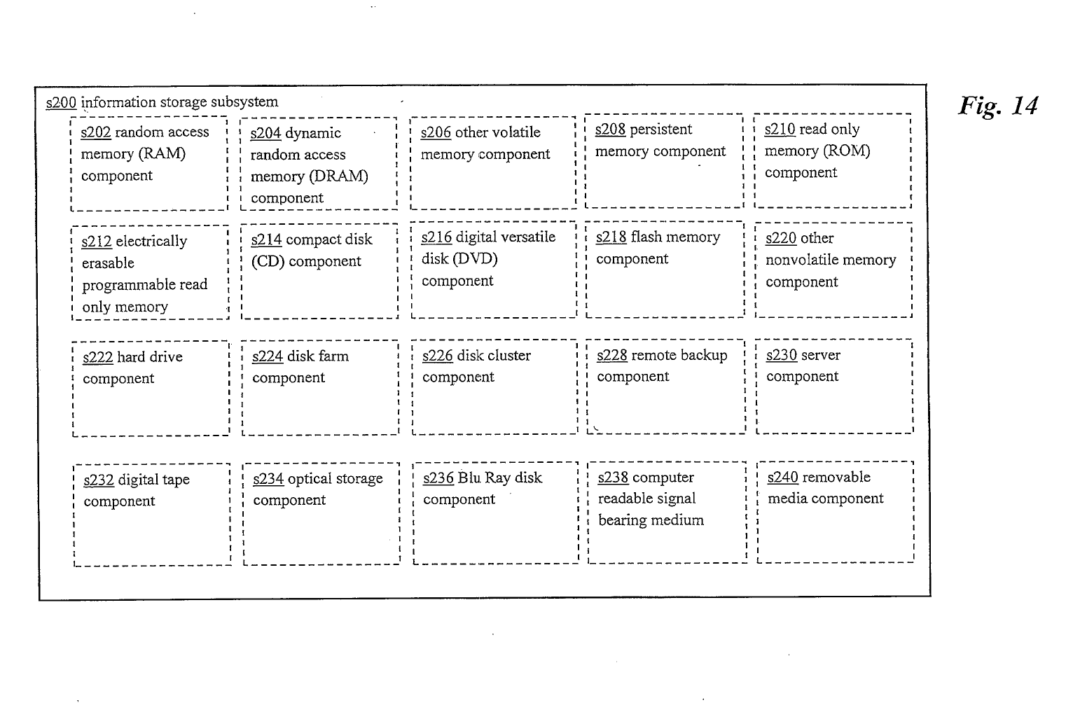

An exemplary implementation of the information storage subsystem s200 is shown in FIG. 14 to optionally include various components such as random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, Blu Ray disk component s236, computer readable signal bearing medium s238, and removable media component s240.

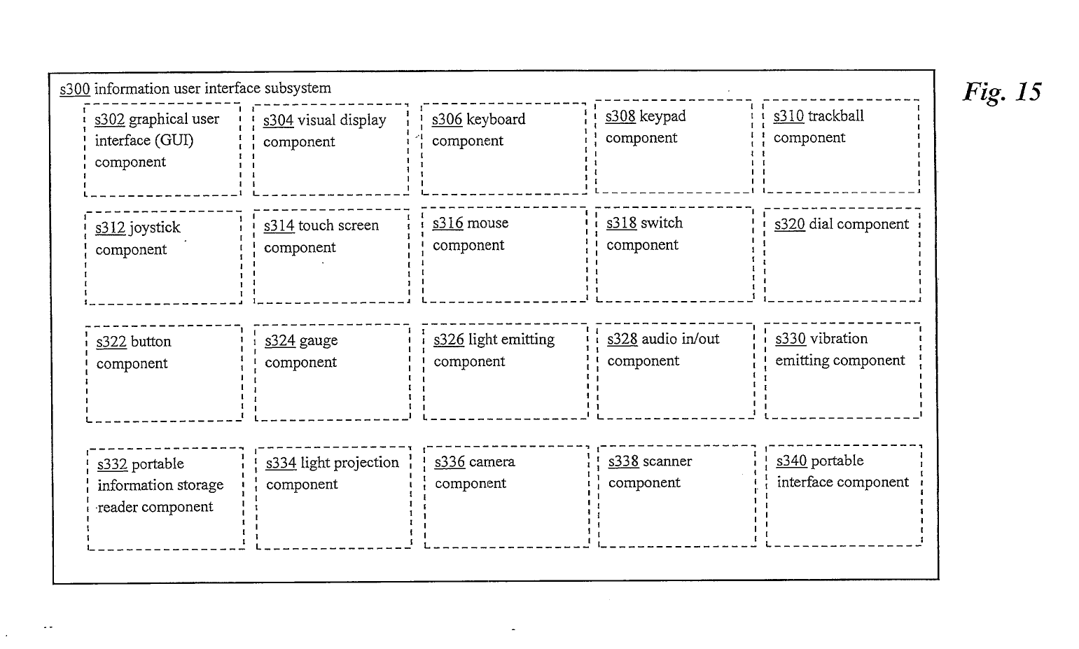

An exemplary implementation of the information user interface subsystem s300 is shown in FIG. 15 to optionally include various components such as graphical user interface (GUI) component s302, visual display component s304, keyboard component s306, keypad component s308, trackball component s310, joystick component s312, touch screen component s314, mouse component s316, switch component s318, dial component s320, button component s322, gauge component s324, light emitting component s326, audio in/out component s328, vibration emitting component s330, portable information storage reader component s332, light projection component s334, camera component s336, scanner component s338, and portable interface component s340.

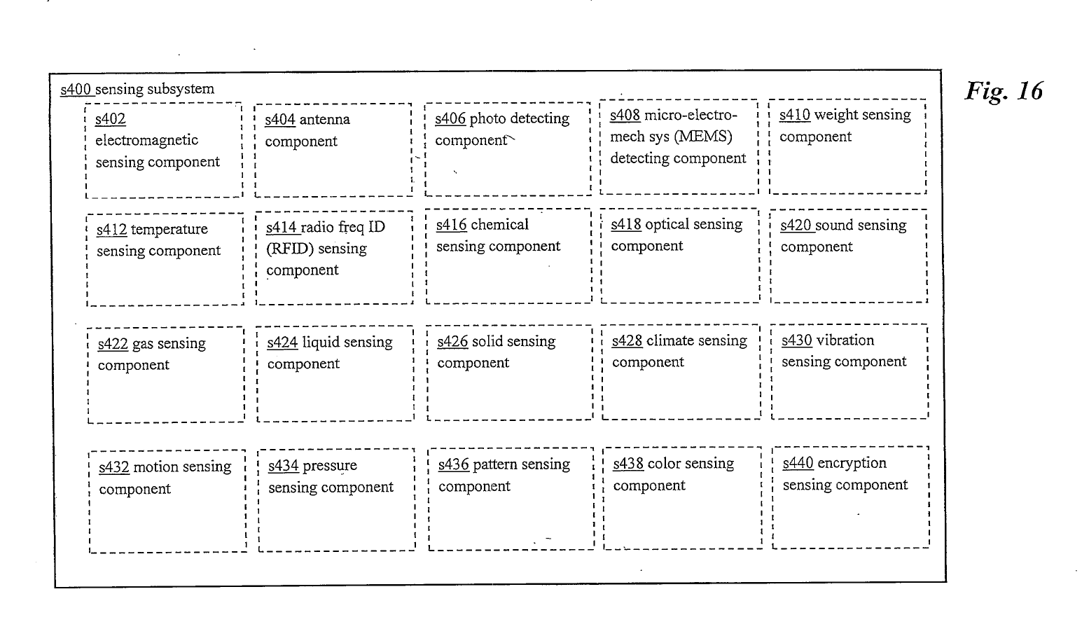

An exemplary implementation of the sensing subsystem s400 is shown in FIG. 16 to optionally include various components such as electromagnetic sensing component s402, antenna component s404, photo detecting component s406, micro-electro-mech sys (MEMS) detecting component s408, weight sensing component s410, temperature sensing component s412, radio freq ID (RFID) sensing component s414, chemical sensing component s416, optical sensing component s418, sound sensing component s420, solid sensing component s422, liquid sensing component s424, solid sensing component s426, climate sensing component s428, vibration sensing component s430, motion sensing component s432, pressure sensing component s434, pattern sensing component s436, color sensing component s438, and encryption sensing component s440.

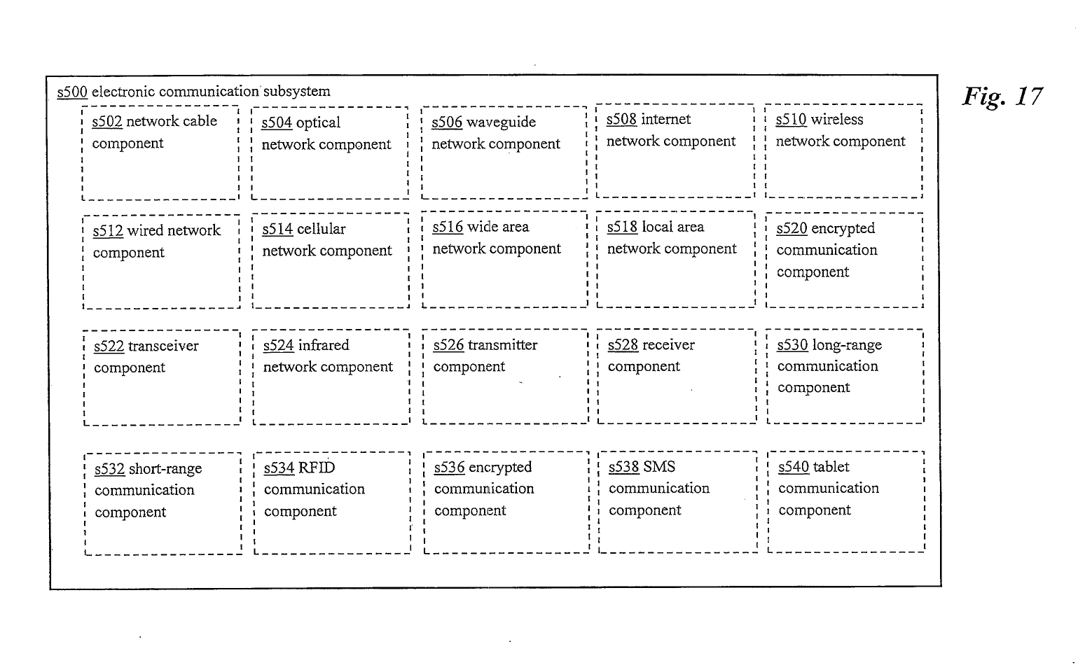

An exemplary implementation of the electronic communication subsystem s500 is shown in FIG. 17 to optionally include various components such as network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, receiver component s528, receiver component s528, long-range communication component s530, short-range communication component s532, RFID communication component s534, encrypted communication component s536, SMS communication component s538, and tablet communication component s540.

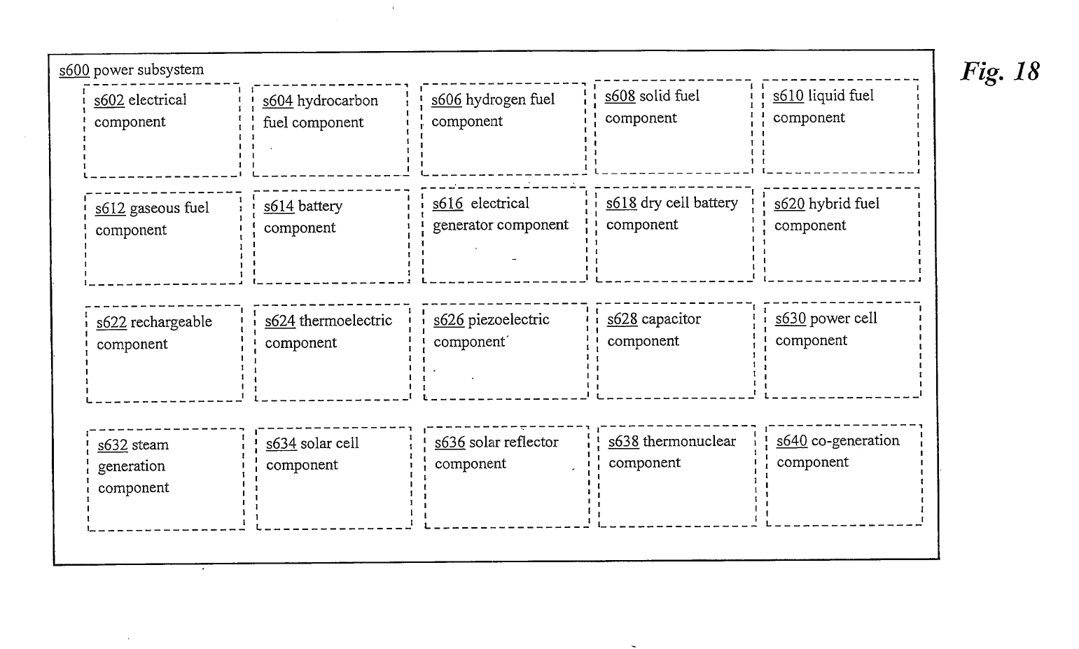

An exemplary implementation of the power subsystem s600 is shown in FIG. 18 to optionally include various components such as electrical component s602, hydrocarbon fuel component s604, hydrogen fuel component s606, solid fuel component s608, liquid fuel component s610, gaseous fuel component s612, battery component s614, battery component s622, battery component s624, battery component s626, battery component s628, power cell component s630, steam generation component s632, solar cell component s634, solar reflector component s636, thermonuclear component s638, and co-generation component s640.

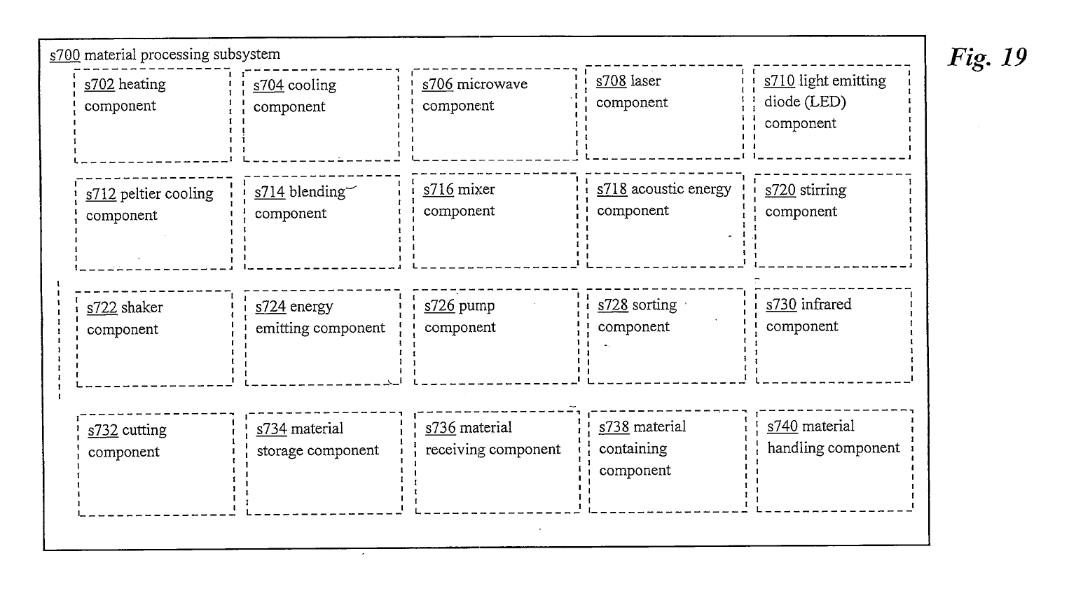

An exemplary implementation of the material processing subsystem s700 is shown in FIG. 19 to optionally include various components such as heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, material receiving component s736, material containing component s738, and material handling component s740.

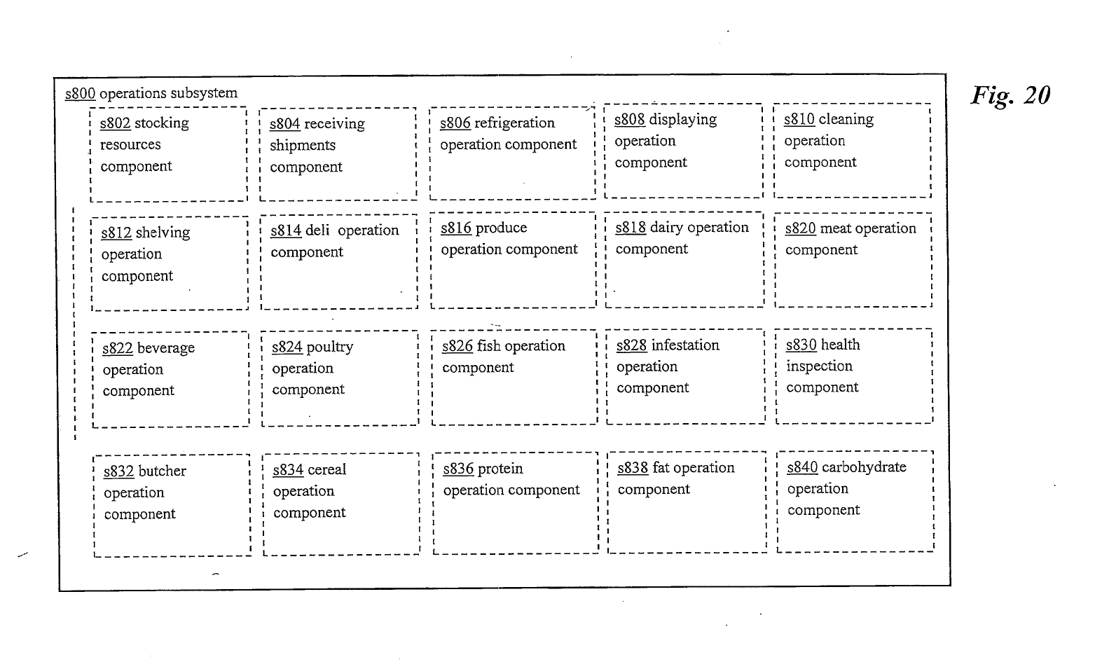

An exemplary implementation of the operations subsystem s800 is shown in FIG. 20 to optionally include various components such as stocking resources component s802, receiving shipments component s804, refrigeration operation component s806, displaying operation component s808, cleaning operation component s810, shelving operation component s812, deli operation component s814, produce operation component s816, dairy operation component s818, meat operation component s820, beverage operation component s822, poultry operation component s824, fish operation component s826, infestation operation component s828, health inspection component s830, butcher operation component s832, cereal operation component s834, protein operation component s836, fat operation component s838, and carbohydrate operation component s840.

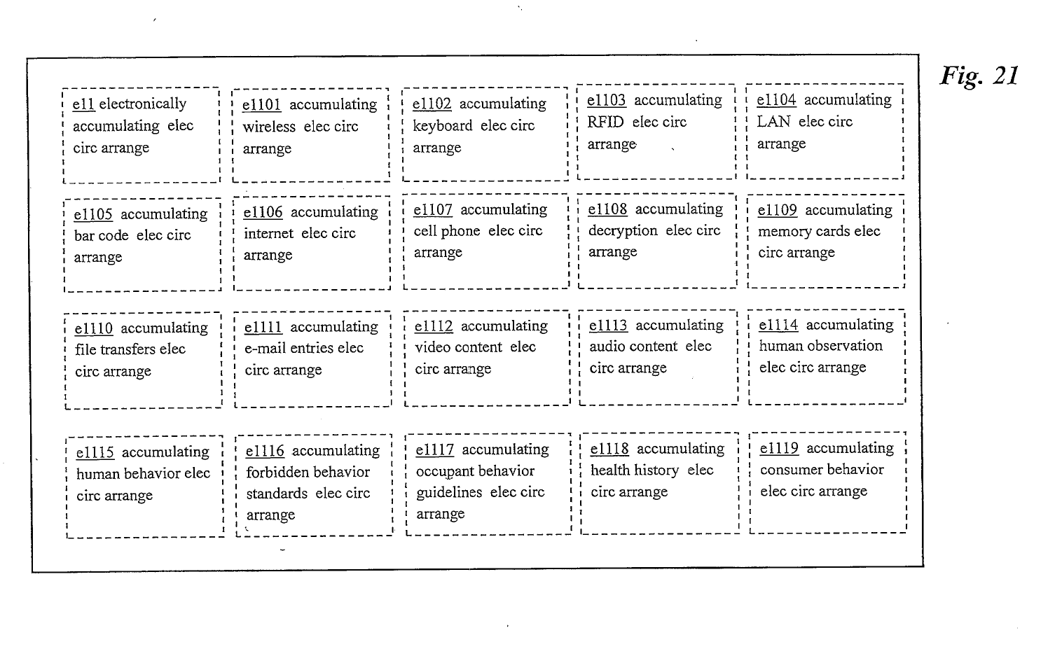

Implementations involve different combinations (otherwise known as “electrical circuitry arrangements”) of components from the subsystems of the residential information system 10. Exemplary depictions of some of these electrical circuitry arrangements are shown in FIG. 21 to include electronically accumulating electrical circuitry arrangement e11, accumulating wireless electrical circuitry arrangement e1101, accumulating keyboard electrical circuitry arrangement e1102, accumulating RFID electrical circuitry arrangement e1103, accumulating LAN electrical circuitry arrangement e1104, accumulating bar code electrical circuitry arrangement e1105, accumulating internet electrical circuitry arrangement e1106, accumulating cell phone electrical circuitry arrangement e1107, accumulating decryption electrical circuitry arrangement e1108, accumulating memory cards electrical circuitry arrangement e1109, accumulating file transfers electrical circuitry arrangement e1110, accumulating e-mail entries electrical circuitry arrangement e1111, accumulating video content electrical circuitry arrangement e1112, accumulating audio content electrical circuitry arrangement e1113, accumulating human observation electrical circuitry arrangement e1114, accumulating human behavior electrical circuitry arrangement e1115, accumulating forbidden behavior standards electrical circuitry arrangement e1116, accumulating occupant behavior guidelines electrical circuitry arrangement e1117, accumulating health history electrical circuitry arrangement e1118, and accumulating consumer behavior electrical circuitry arrangement e1119.

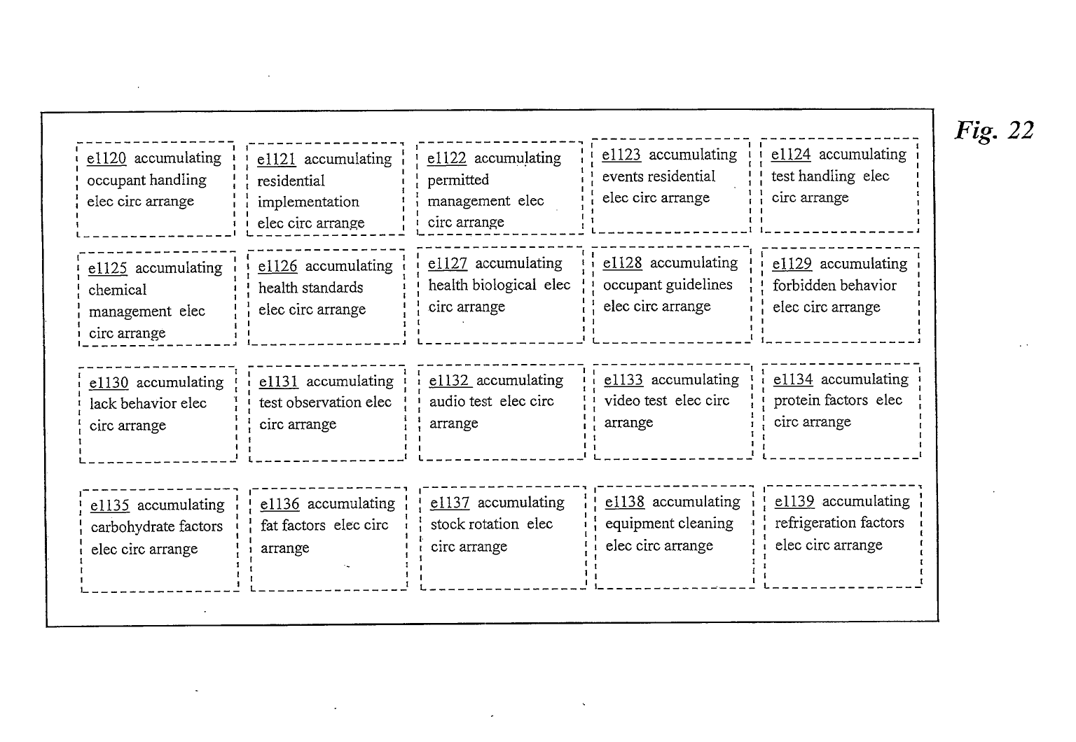

Some of these electrical circuitry arrangements are depicted in FIG. 22 to include accumulating occupant handling electrical circuitry arrangement e1120, accumulating residential implementation electrical circuitry arrangement e1121, accumulating permitted management electrical circuitry arrangement e1122, accumulating events residential electrical circuitry arrangement e1123, accumulating test handling electrical circuitry arrangement e1124, accumulating chemical management electrical circuitry arrangement e1125, accumulating health standards electrical circuitry arrangement e1126, accumulating health biological electrical circuitry arrangement e1127, accumulating occupant guidelines electrical circuitry arrangement e1128, accumulating forbidden behavior electrical circuitry arrangement e1129, accumulating lack behavior electrical circuitry arrangement e1130, accumulating test observation electrical circuitry arrangement e113, accumulating audio test electrical circuitry arrangement e1132, accumulating video test electrical circuitry arrangement e1133, accumulating protein factors electrical circuitry arrangement e1134, accumulating carbohydrate factors electrical circuitry arrangement e1135, accumulating fat factors electrical circuitry arrangement e1136, accumulating stock rotation electrical circuitry arrangement e1137, accumulating equipment cleaning electrical circuitry arrangement e1138, and accumulating refrigeration factors electrical circuitry arrangement e1139.

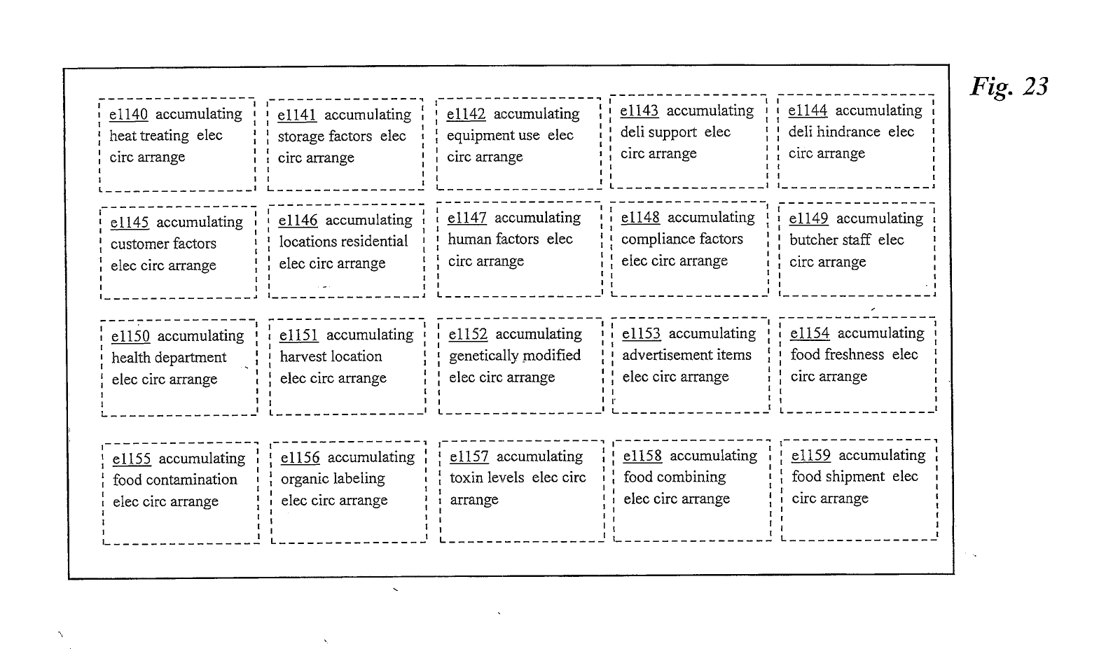

Some of these electrical circuitry arrangements are depicted in FIG. 23 to include accumulating heat treating electrical circuitry arrangement e1140, accumulating storage factors electrical circuitry arrangement e1141, accumulating equipment use electrical circuitry arrangement e1142, accumulating deli support electrical circuitry arrangement e1143, accumulating deli hindrance electrical circuitry arrangement e1144, accumulating customer factors electrical circuitry arrangement e1145, accumulating locations residential electrical circuitry arrangement e1146, accumulating human factors electrical circuitry arrangement e1147, accumulating compliance factors electrical circuitry arrangement e1148, accumulating butcher staff electrical circuitry arrangement e1149, accumulating health department electrical circuitry arrangement e1150, accumulating harvest location electrical circuitry arrangement e1151, accumulating genetically modified electrical circuitry arrangement e1152, accumulating advertisement items electrical circuitry arrangement e1153, accumulating food freshness electrical circuitry arrangement e1154, accumulating food contamination electrical circuitry arrangement e1155, accumulating organic labeling electrical circuitry arrangement e1156, accumulating toxin levels electrical circuitry arrangement e1157, accumulating food combining electrical circuitry arrangement e1158, and accumulating food shipment electrical circuitry arrangement e1159.

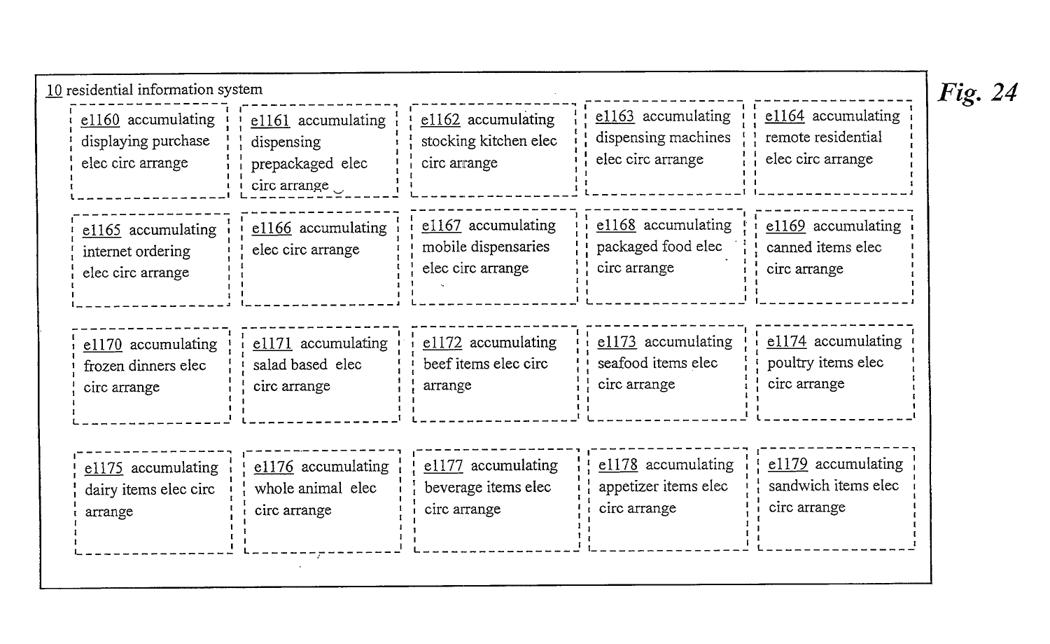

Some of these electrical circuitry arrangements are depicted in FIG. 24 to include accumulating displaying purchase electrical circuitry arrangement e1160, accumulating dispensing prepackaged electrical circuitry arrangement e1161, accumulating stocking kitchen electrical circuitry arrangement e1162, accumulating dispensing machines electrical circuitry arrangement e1163, accumulating remote residential electrical circuitry arrangement e1164, accumulating internet ordering electrical circuitry arrangement e1165, and accumulating electrical circuitry arrangement e1166, accumulating mobile dispensaries electrical circuitry arrangement e1167, accumulating packaged food electrical circuitry arrangement e1168, accumulating canned items electrical circuitry arrangement e1169, accumulating frozen dinners electrical circuitry arrangement e1170, accumulating salad based electrical circuitry arrangement e1171, accumulating beef items electrical circuitry arrangement e1172, accumulating seafood items electrical circuitry arrangement e1173, accumulating poultry items electrical circuitry arrangement e1174, accumulating dairy items electrical circuitry arrangement e1175, accumulating whole animal electrical circuitry arrangement e1176, accumulating beverage items electrical circuitry arrangement e1177, accumulating appetizer items electrical circuitry arrangement e1178, and accumulating sandwich items electrical circuitry arrangement e1179.

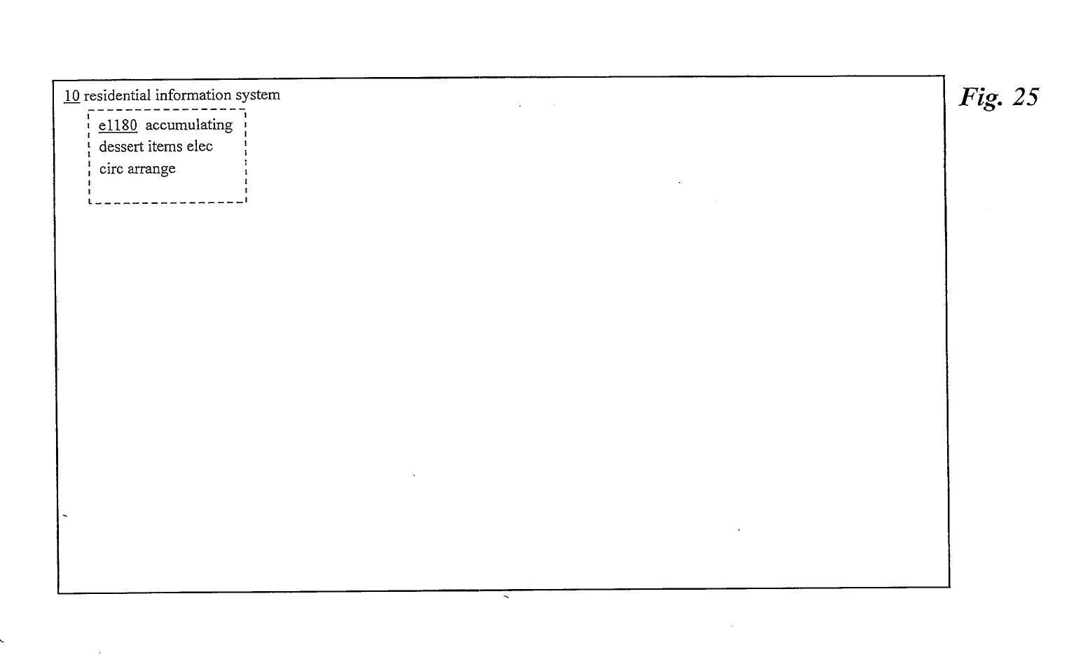

Some of these electrical circuitry arrangements are depicted in FIG. 25 to include accumulating dessert items electrical circuitry arrangement e1180.

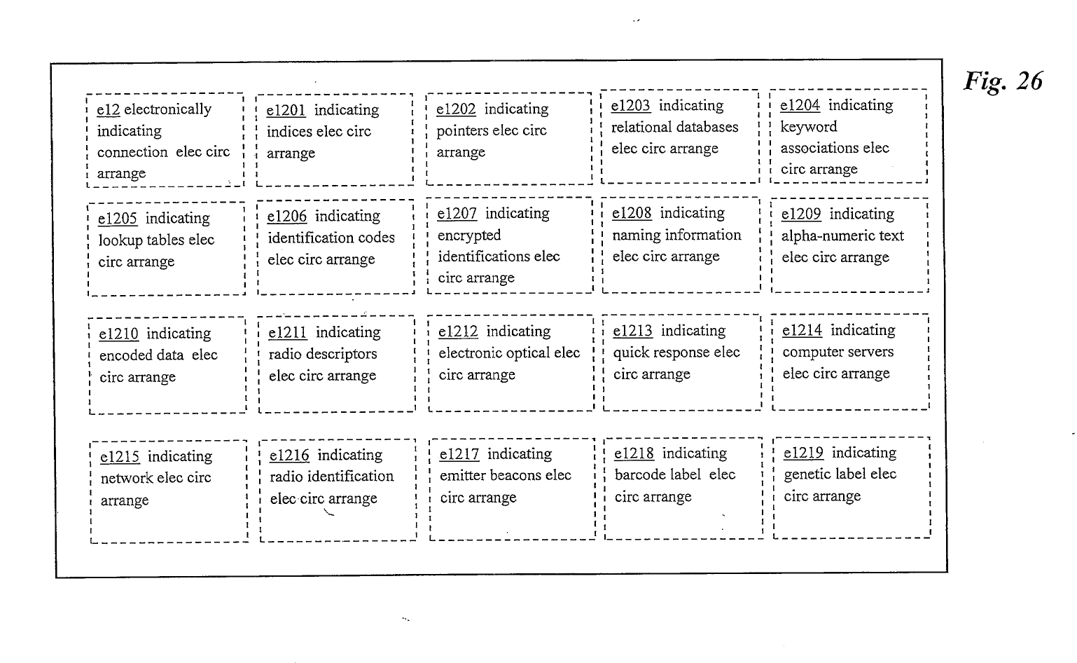

Some of these electrical circuitry arrangements are depicted in FIG. 26 to include electronically indicating connection electrical circuitry arrangement e12, indicating indices electrical circuitry arrangement e1201, indicating pointers electrical circuitry arrangement e1202, indicating relational databases electrical circuitry arrangement e1203, indicating keyword associations electrical circuitry arrangement e1204, indicating lookup tables electrical circuitry arrangement e1205, indicating identification codes electrical circuitry arrangement e1206, indicating encrypted identifications electrical circuitry arrangement e1207, indicating naming information electrical circuitry arrangement e1208, indicating alpha-numeric text electrical circuitry arrangement e1209, indicating encoded data electrical circuitry arrangement e1210, indicating radio descriptors electrical circuitry arrangement e1211, and indicating electronic optical electrical circuitry arrangement e1212, indicating quick response electrical circuitry arrangement e1213, indicating computer servers electrical circuitry arrangement e1214, indicating network electrical circuitry arrangement e1215, indicating radio identification electrical circuitry arrangement e1216, indicating emitter beacons electrical circuitry arrangement e1217, indicating barcode label electrical circuitry arrangement e1218, and indicating genetic label electrical circuitry arrangement e1219.

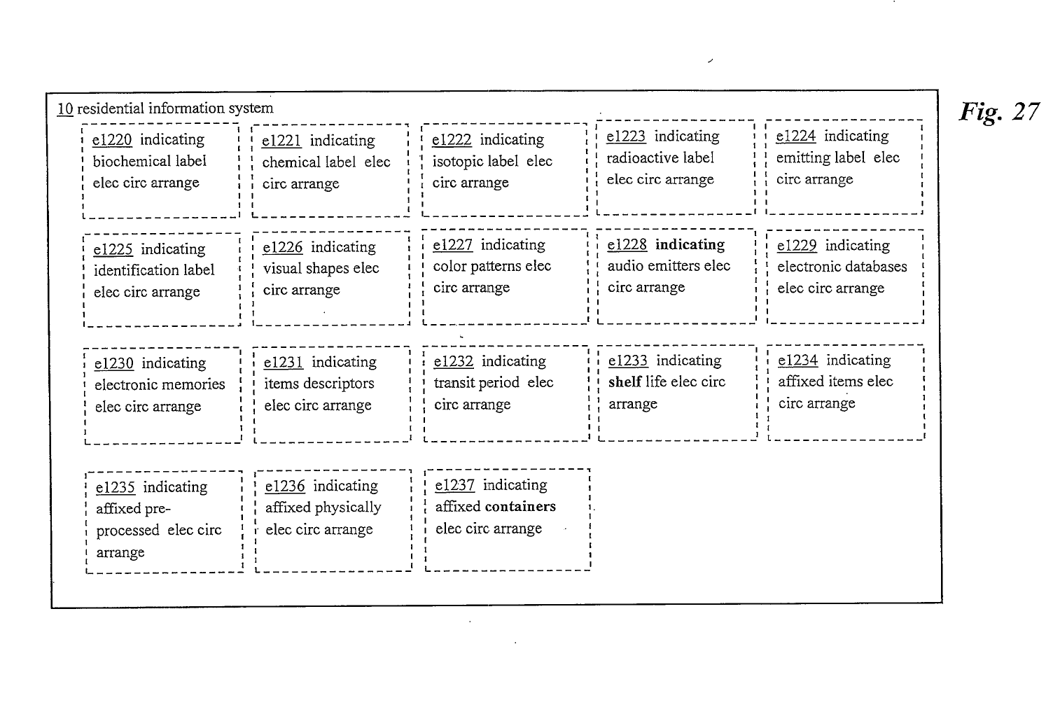

Some of these electrical circuitry arrangements are depicted in FIG. 27 to include indicating biochemical label electrical circuitry arrangement e1220, indicating chemical label electrical circuitry arrangement e1221, indicating isotopic label electrical circuitry arrangement e1222, indicating radioactive label electrical circuitry arrangement e1223, indicating emitting label electrical circuitry arrangement e1224, indicating identification label electrical circuitry arrangement e1225, indicating visual shapes electrical circuitry arrangement e1226, indicating color patterns electrical circuitry arrangement e1227, indicating audio emitters electrical circuitry arrangement e1228, indicating electronic databases electrical circuitry arrangement e1229, indicating affixed items electrical circuitry arrangement e1234, indicating items descriptors electrical circuitry arrangement e1231, indicating transit period electrical circuitry arrangement e1232, indicating shelf life electrical circuitry arrangement e1233, indicating affixed items electrical circuitry arrangement e1234, indicating affixed pre-processed electrical circuitry arrangement e1235, indicating affixed physically electrical circuitry arrangement e1236, and indicating affixed containers electrical circuitry arrangement e1237.

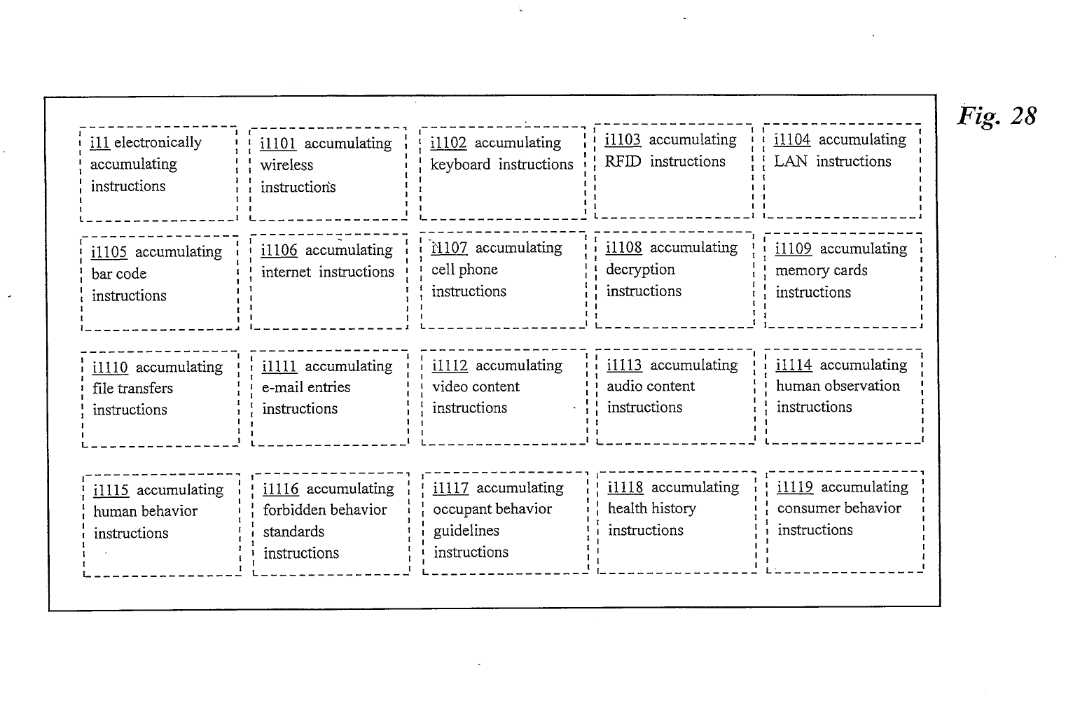

In implementations one or more instructions are stored and/or otherwise borne in various subsystems, components, and/or accessories of the residential information system 10 such as being borne in a non-transitory signal bearing medium of information storage subsystem s200. One or more exemplary instructions depicted in FIG. 28 as being borne in an exemplary version of a non-transitory signal bearing medium of information storage subsystem s200 include one or more electronically accumulating instructions ill, one or more accumulating wireless instructions i1101, one or more accumulating keyboard instructions i1102, one or more accumulating RFID instructions i1103, one or more accumulating LAN instructions i1104, one or more accumulating bar code instructions i1105, one or more accumulating internet instructions i1106, one or more accumulating cell phone instructions i1107, one or more accumulating decryption instructions i1108, one or more accumulating memory cards instructions i1109, one or more accumulating file transfers instructions i1110, one or more accumulating e-mail entries instructions i1111, one or more accumulating video content instructions i1112, one or more accumulating audio content instructions i1113, one or more accumulating human observation instructions i1114, one or more accumulating human behavior instructions i1115, one or more accumulating forbidden behavior standards instructions i1116, one or more accumulating occupant behavior guidelines instructions i1117, one or more accumulating health history instructions i1118, and one or more accumulating consumer behavior instructions i1119.

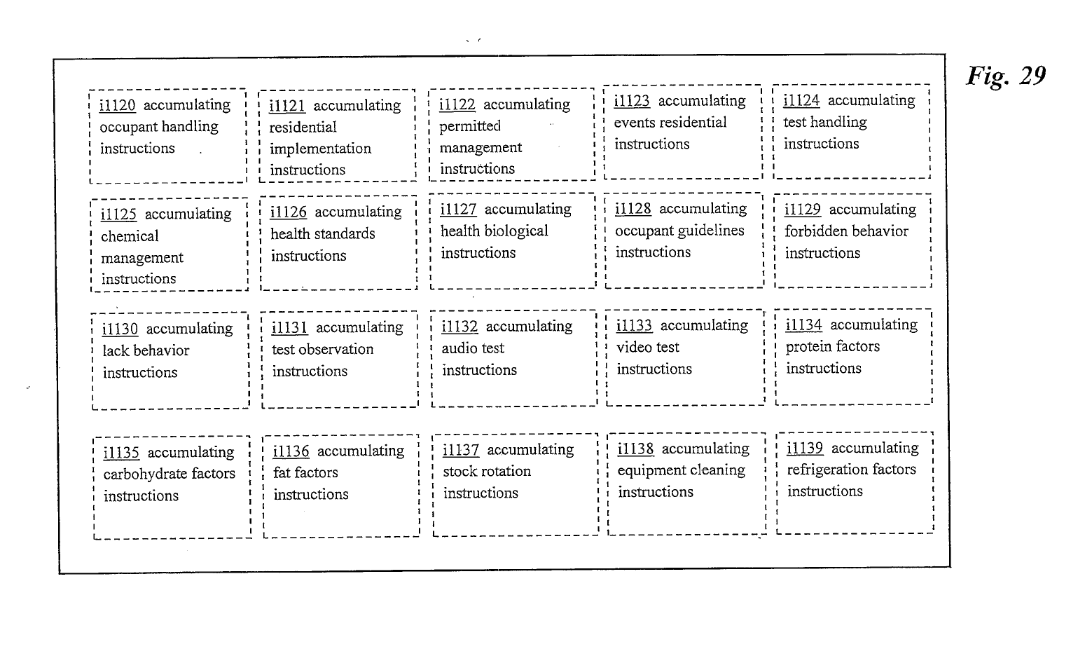

One or more exemplary instructions depicted in FIG. 29 as being borne in an exemplary version of a non-transitory signal bearing medium of information storage subsystem s200 include one or more accumulating occupant handling instructions i1120, one or more accumulating residential implementation instructions i1121, one or more accumulating permitted management instructions i1122, one or more accumulating events residential instructions i1123, one or more accumulating test handling instructions i1124, one or more accumulating chemical management instructions i1125, one or more accumulating health standards instructions i1126, one or more accumulating health biological instructions i1127, one or more accumulating occupant guidelines instructions i1128, one or more accumulating forbidden behavior instructions i1129, one or more accumulating lack behavior instructions i1130, one or more accumulating test observation instructions i1131, one or more accumulating audio test instructions i1132, one or more accumulating video test instructions i1133, one or more accumulating protein factors instructions i1134, one or more accumulating carbohydrate factors instructions i1135, one or more accumulating fat factors instructions i1136, one or more accumulating stock rotation instructions i1137, one or more accumulating equipment cleaning instructions i1138, and one or more accumulating refrigeration factors instructions i1139.

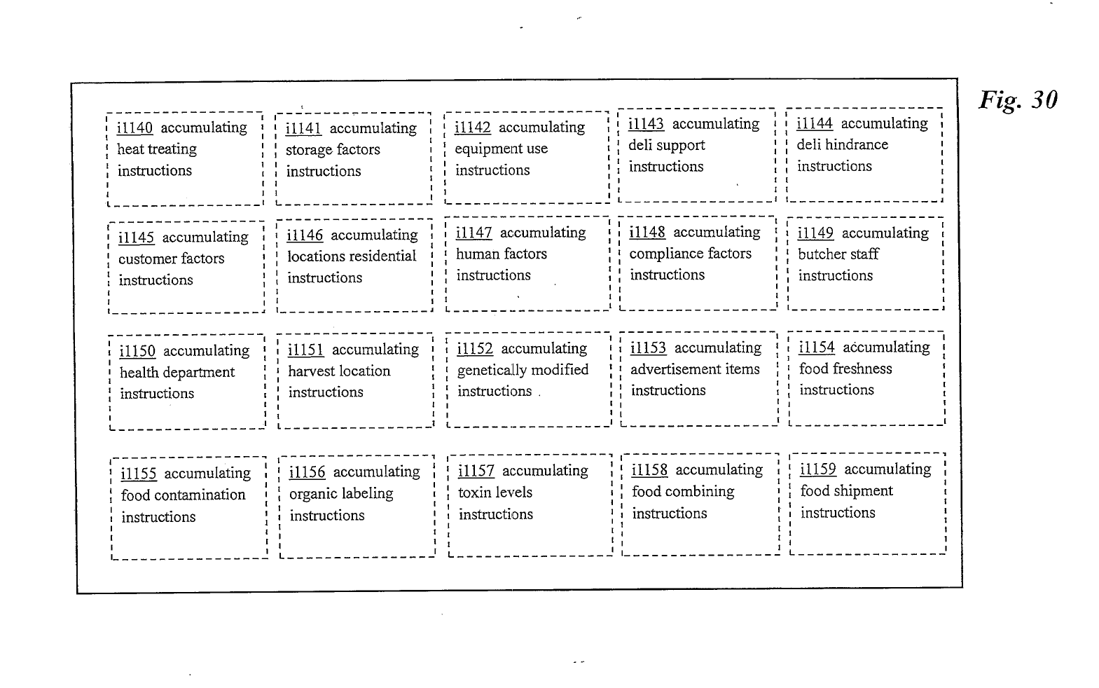

One or more exemplary instructions depicted in FIG. 30 as being borne in an exemplary version of a non-transitory signal bearing medium of information storage subsystem s200 include one or more accumulating heat treating instructions i1140, one or more accumulating storage factors instructions i1141, one or more accumulating equipment use instructions i1142, one or more accumulating deli support instructions i1143, one or more accumulating deli hindrance instructions i1144, one or more accumulating customer factors instructions i1145, one or more accumulating locations residential instructions i1146, one or more accumulating human factors instructions i1147, one or more accumulating compliance factors instructions i1148, one or more accumulating butcher staff instructions i1149, one or more accumulating health department instructions i1150, one or more accumulating harvest location instructions i1151, one or more accumulating genetically modified instructions i1152, one or more accumulating advertisement items instructions i1153, one or more accumulating food freshness instructions i1154, one or more accumulating food contamination instructions i1155, one or more accumulating organic labeling instructions i1156, one or more accumulating toxin levels instructions i1157, one or more accumulating food combining instructions i1158, and one or more accumulating food shipment instructions i1159.

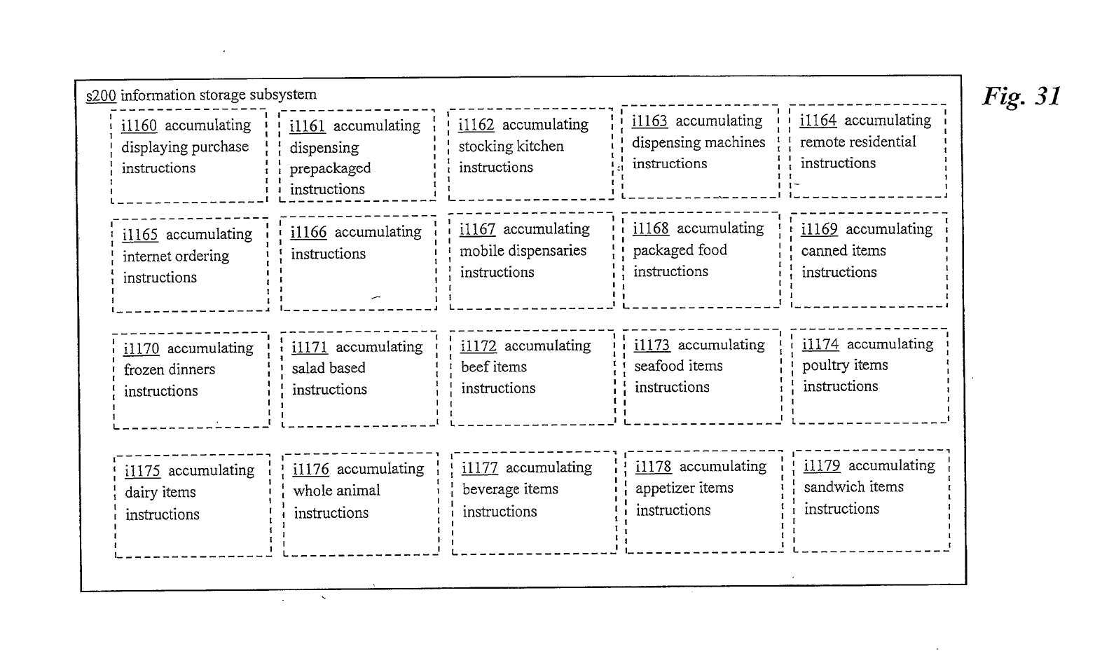

One or more exemplary instructions depicted in FIG. 31 as being borne in an exemplary version of a non-transitory signal bearing medium of information storage subsystem s200 include one or more accumulating displaying purchase instructions i1160, one or more accumulating dispensing prepackaged instructions i1161, one or more accumulating stocking kitchen instructions i1162, one or more accumulating dispensing machines instructions i1163, one or more accumulating remote residential instructions i1164, one or more accumulating internet ordering instructions i1165, and one or more accumulating instructions i1166, one or more accumulating mobile dispensaries instructions i1167, one or more accumulating packaged food instructions i1168, one or more accumulating canned items instructions i1169, one or more accumulating frozen dinners instructions i1170, one or more accumulating salad based instructions i1171, one or more accumulating beef items instructions i1172, one or more accumulating seafood items instructions i1173, one or more accumulating poultry items instructions i1174, one or more accumulating dairy items instructions i1175, one or more accumulating whole animal instructions i1176, one or more accumulating beverage items instructions i1177, one or more accumulating appetizer items instructions i1178, and one or more accumulating sandwich items instructions i1179.

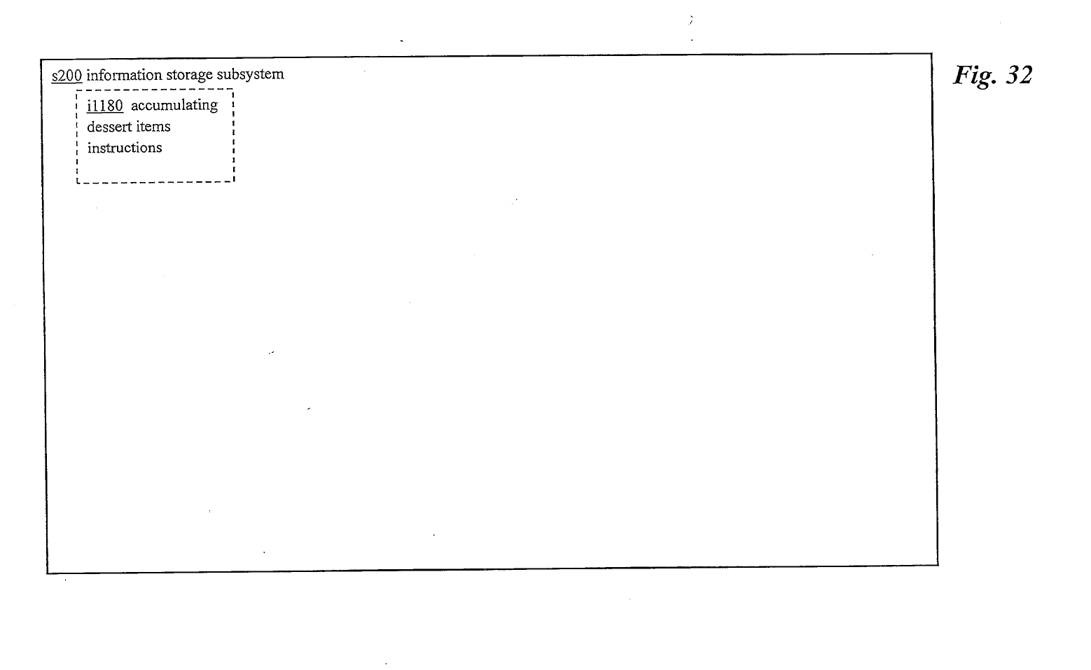

One or more exemplary instructions depicted in FIG. 32 as being borne in an exemplary version of a non-transitory signal bearing medium of information storage subsystem s200 include one or more accumulating dessert items instructions i1180.

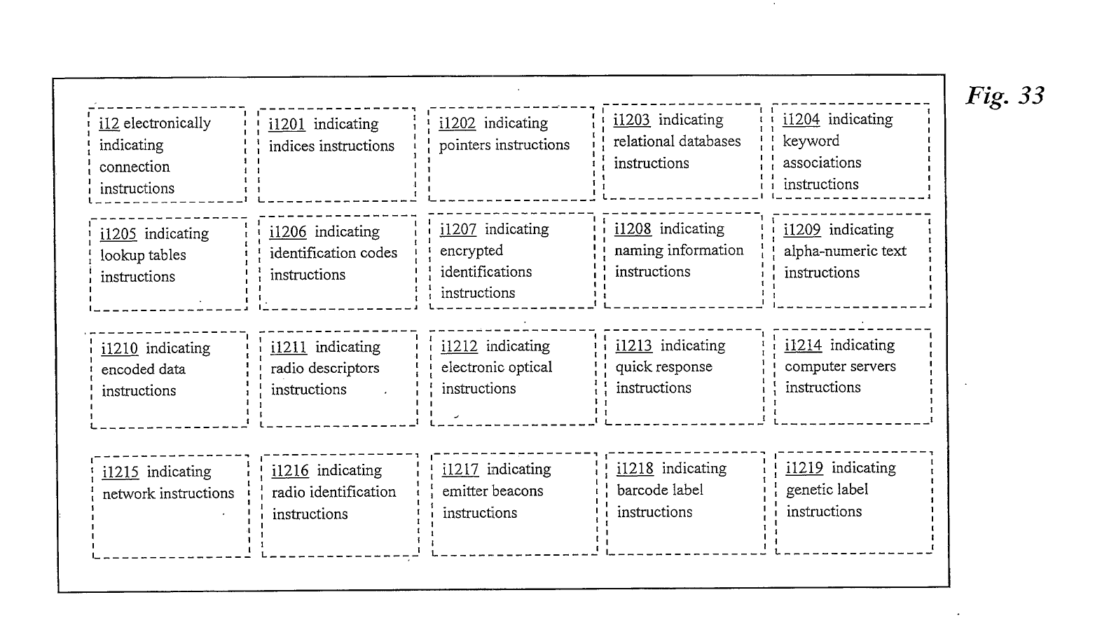

One or more exemplary instructions depicted in FIG. 33 as being borne in an exemplary version of a non-transitory signal bearing medium of information storage subsystem s200 include one or more electronically indicating connection instructions i12, one or more indicating indices instructions i1201, one or more indicating pointers instructions i1202, one or more indicating relational databases instructions i1203, one or more indicating keyword associations instructions i1204, one or more indicating lookup tables instructions i1205, one or more indicating identification codes instructions i1206, one or more indicating encrypted identifications instructions i1207, one or more indicating naming information instructions i1208, one or more indicating alpha-numeric text instructions i1209, one or more indicating encoded data instructions i1210, one or more indicating radio descriptors instructions i1211, one or more indicating electronic optical instructions i1212, one or more indicating quick response instructions i1213, one or more indicating computer servers instructions i1214, one or more indicating network instructions i1215, one or more indicating radio identification instructions i1216, one or more indicating emitter beacons instructions i1217, one or more indicating barcode label instructions i1218, and one or more indicating genetic label instructions i1219.

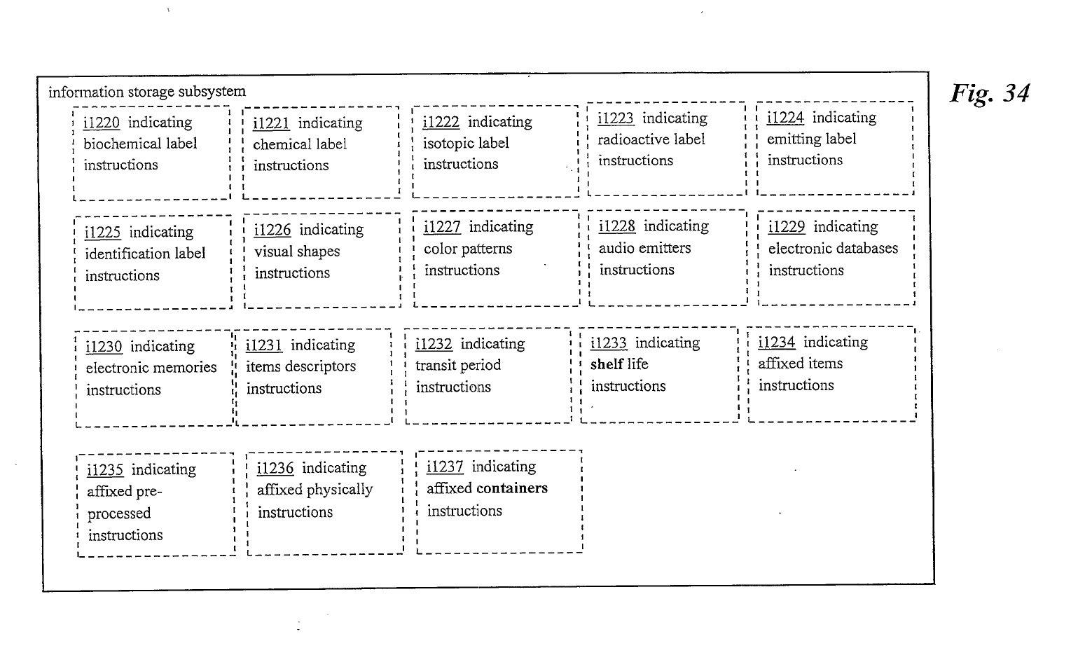

One or more exemplary instructions depicted in FIG. 34 as being borne in an exemplary version of a non-transitory signal bearing medium of information storage subsystem s200 include one or more indicating biochemical label instructions i1220, one or more indicating chemical label instructions i1221, one or more indicating isotopic label instructions i1222, one or more indicating radioactive label instructions i1223, one or more indicating emitting label instructions i1224, one or more indicating identification label instructions i1225, one or more indicating visual shapes instructions i1226, one or more indicating color patterns instructions i1227, one or more indicating audio emitters instructions i1228, one or more indicating electronic databases instructions i1229, one or more indicating affixed items instructions i1234, one or more indicating items descriptors instructions i1231, one or more indicating transit period instructions i1232, one or more indicating shelf life instructions i1233, one or more indicating affixed items instructions i1234, one or more indicating affixed pre-processed instructions i1235, one or more indicating affixed physically instructions i1236, and one or more indicating affixed containers instructions i1237.

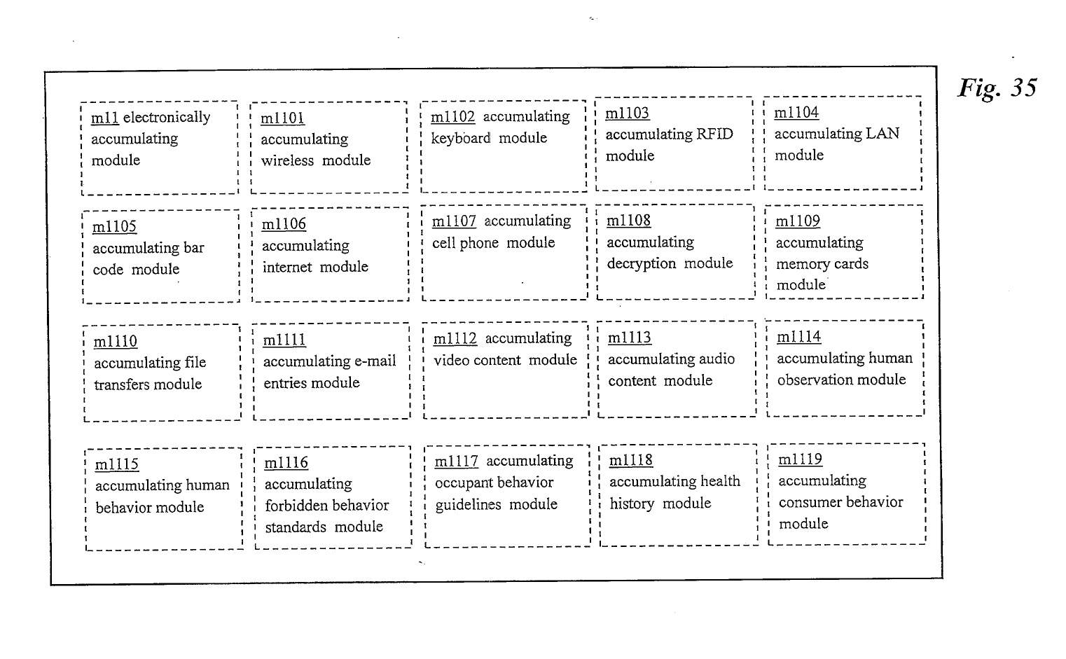

Implementations of modules involve different combinations (limited to patentable subject matter under 35 U.S.C. 101) of one or more aspects from one or more of the electrical circuitry arrangements and/or one or more aspects from one or more of the instructions of the residential information system 10. Exemplary depictions of some of these modules are shown in FIG. 35 to include electronically accumulating module m11, accumulating wireless module m1101, accumulating keyboard module m1102, accumulating RFID module m1103, accumulating LAN module m1104, accumulating bar code module m1105, accumulating internet module m1106, accumulating cell phone module m1107, accumulating decryption module m1108, accumulating memory cards module m1109, accumulating file transfers module m1110, accumulating e-mail entries module m1111, accumulating video content module m1112, accumulating audio content module m1113, accumulating human observation module m1114, accumulating human behavior module m1115, accumulating forbidden behavior standards module m1116, accumulating occupant behavior guidelines module m1117, accumulating health history module m1118, and accumulating consumer behavior module m1119.

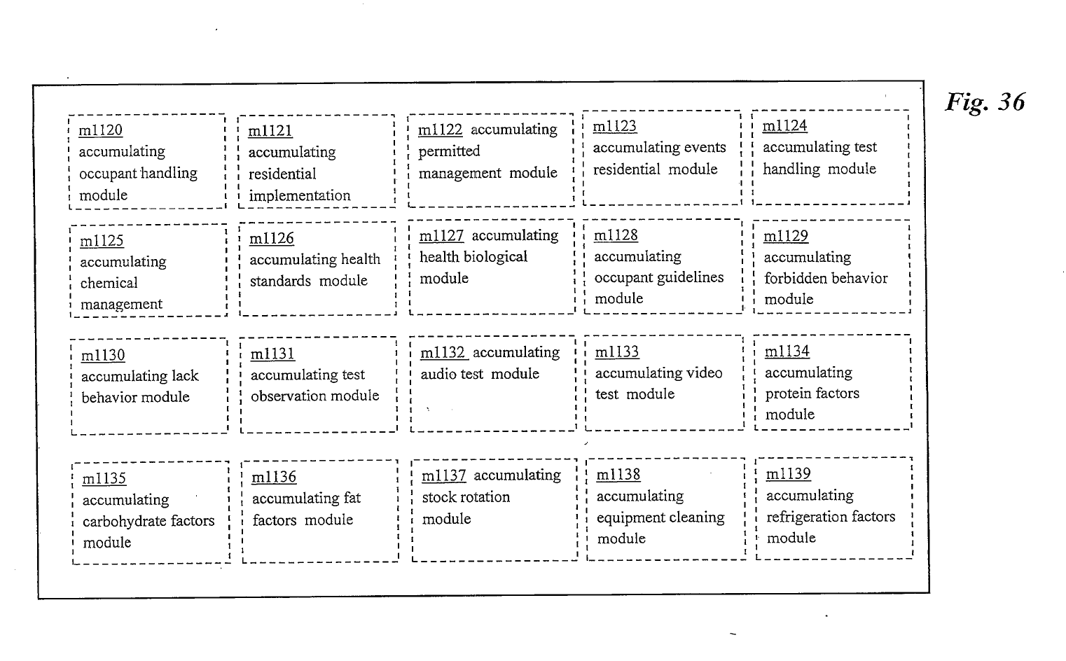

Some of these modules are depicted in FIG. 36 to include accumulating occupant handling module m1120, accumulating residential implementation module m1121, accumulating permitted management module m1122, accumulating events residential module m1123, accumulating test handling module m1124, accumulating chemical management module m1125, accumulating health standards module m1126, accumulating health biological module m1127, accumulating occupant guidelines module m1128, accumulating forbidden behavior module m1129, accumulating lack behavior module m1130, accumulating test observation module m113, accumulating audio test module m1132, accumulating video test module m1133, accumulating protein factors module m1134, accumulating carbohydrate factors module m1135, accumulating fat factors module m1136, accumulating stock rotation module m1137, accumulating equipment cleaning module m1138, and accumulating refrigeration factors module m1139.

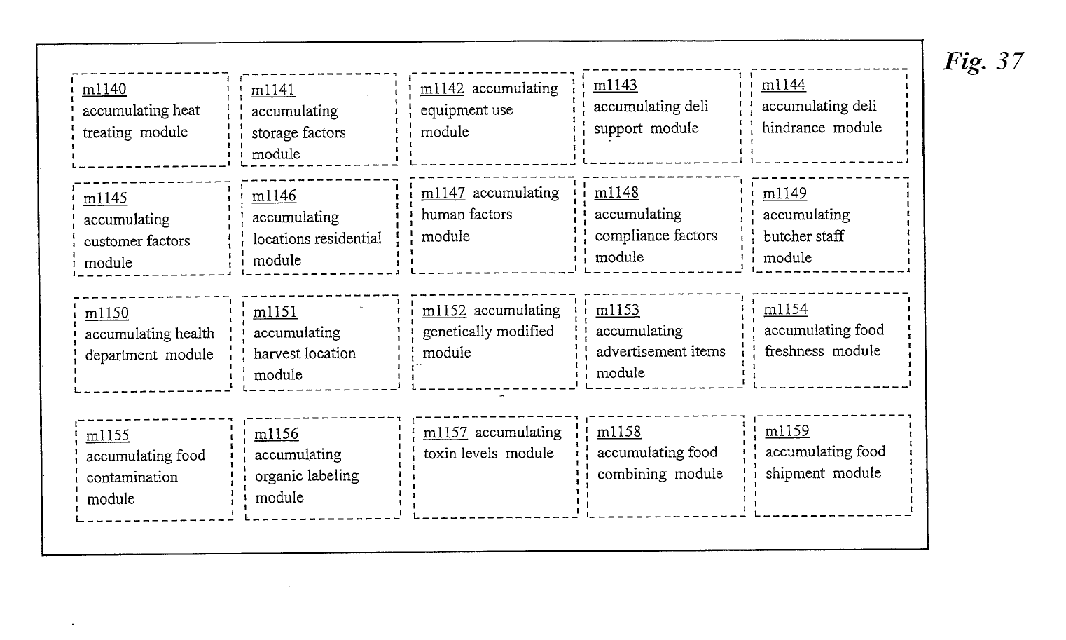

Some of these modules are depicted in FIG. 37 to include accumulating heat treating module m1140, accumulating storage factors module m1141, accumulating equipment use module m1142, accumulating deli support module m1143, accumulating deli hindrance module m1144, accumulating customer factors module m1145, accumulating locations residential module m1146, accumulating human factors module m1147, accumulating compliance factors module m1148, accumulating butcher staff module m1149, accumulating health department module m1150, accumulating harvest location module m1151, accumulating genetically modified module m1152, accumulating advertisement items module m1153, accumulating food freshness module m1154, accumulating food contamination module m1155, accumulating organic labeling module m1156, accumulating toxin levels module m1157, accumulating food combining module m1158, and accumulating food shipment module m1159.

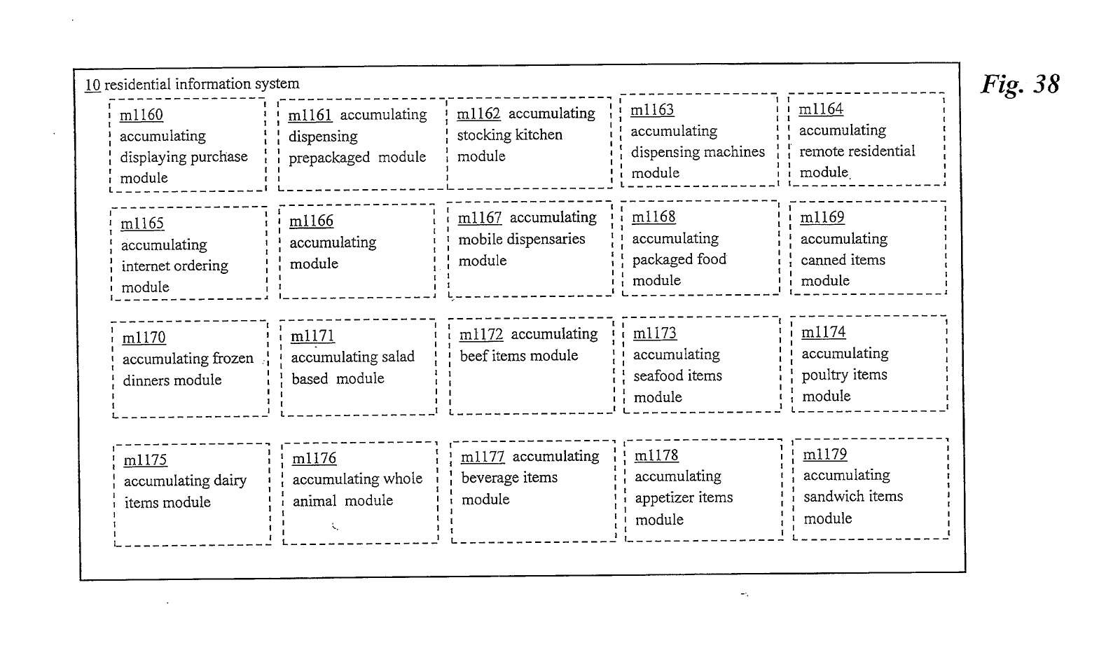

Some of these modules are depicted in FIG. 38 to include accumulating displaying purchase module m1160, accumulating dispensing prepackaged module m1161, accumulating stocking kitchen module m1162, accumulating dispensing machines module m1163, accumulating remote residential module m1164, accumulating internet ordering module m1165, and accumulating module m1166, accumulating mobile dispensaries module m1167, accumulating packaged food module m1168, accumulating canned items module m1169, accumulating frozen dinners module m1170, accumulating salad based module m1171, accumulating beef items module m1172, accumulating seafood items module m1173, accumulating poultry items module m1174, accumulating dairy items module m1175, accumulating whole animal module m1176, accumulating beverage items module m1177, accumulating appetizer items module m1178, and accumulating sandwich items module m1179.

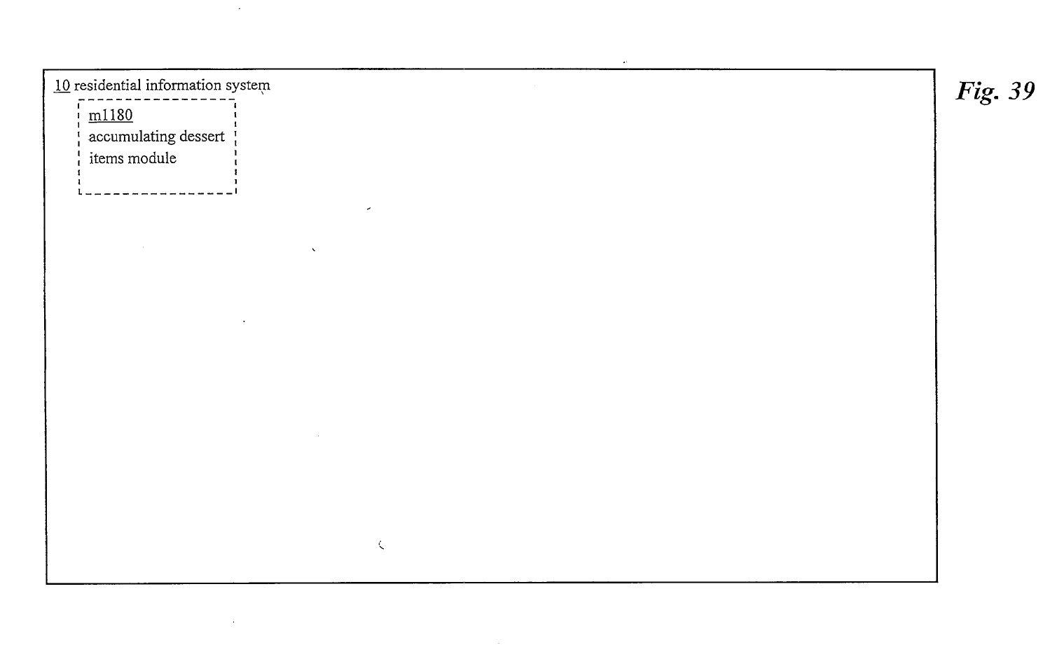

Some of these modules are depicted in FIG. 39 to include accumulating dessert items.

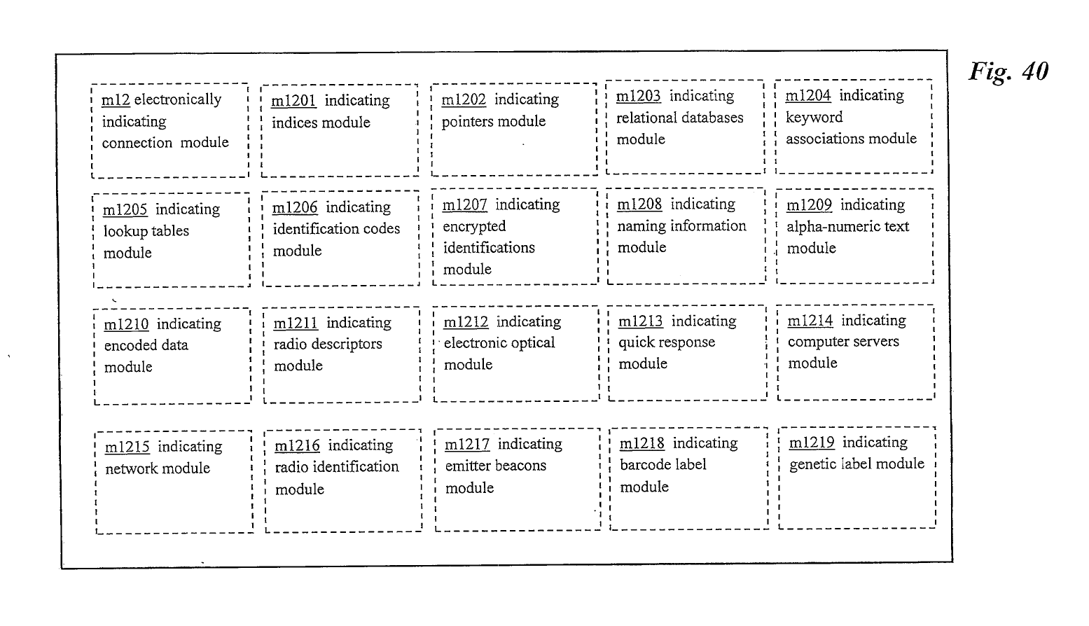

Some of these modules are depicted in FIG. 40 to include electronically indicating connection module m12, indicating indices module m1201, indicating pointers module m1202, indicating relational databases module m1203, indicating keyword associations module m1204, indicating lookup tables module m1205, indicating identification codes module m1206, indicating encrypted identifications module m1207, indicating naming information module m1208, indicating alpha-numeric text module m1209, indicating encoded data module m1210, indicating radio descriptors module m1211, and indicating electronic optical module m1212, indicating quick response module m1213, indicating computer servers module m1214, indicating network module m1215, indicating radio identification module m1216, indicating emitter beacons module m1217, indicating barcode label module m1218, and indicating genetic label module m1219.

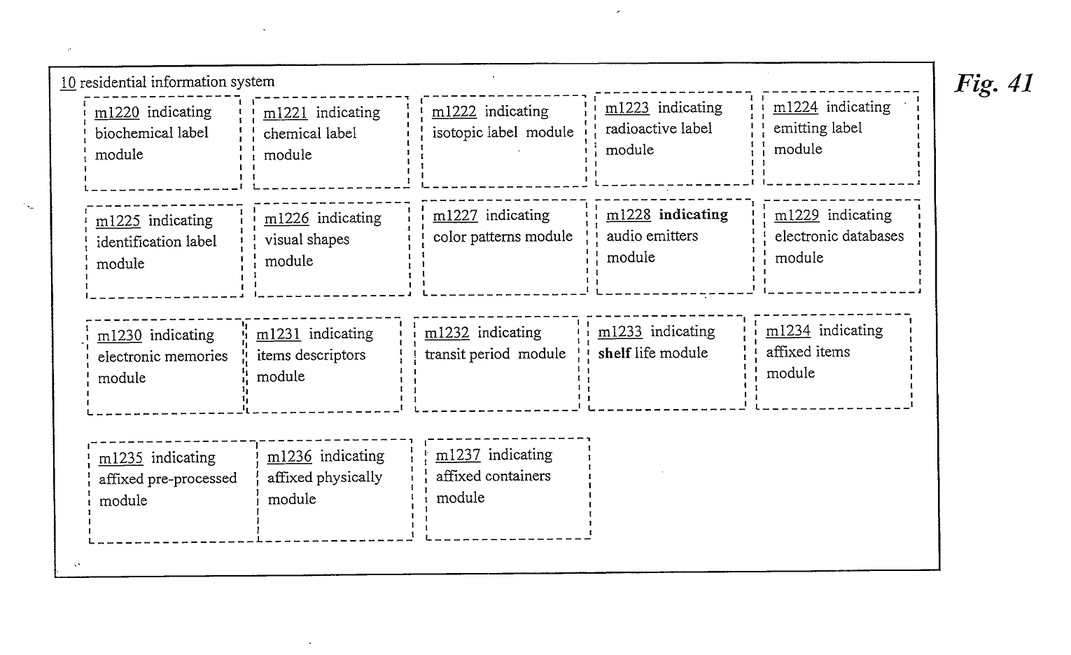

Some of these modules are depicted in FIG. 41 to include indicating biochemical label module m12, indicating chemical label module m1221, indicating isotopic label module m1222, indicating radioactive label module m1223, indicating emitting label module m1224, indicating identification label module m1225, indicating visual shapes module m1226, indicating color patterns module m1227, indicating audio emitters module m1228, indicating electronic databases module m1229, indicating affixed items module m1234, indicating items descriptors module m1231, indicating transit period module m1232, indicating shelf life module m1233, indicating affixed items module m1234, indicating affixed pre-processed module m1235, indicating affixed physically module m1236, and indicating affixed containers module m1237.

In some implementations, non-transitory signal-bearing medium of information storage subsystem s200 as articles of manufacture may store the one or more exemplary instructions. In some implementations, the non-transitory signal bearing medium may include a computer-readable medium. In some implementations, the non-transitory signal-bearing medium may include a recordable medium. In some implementations, the signal-bearing medium may include a communication medium.

The various subsystems and components of the residential information system s10 such as the control and information processing subsystem s100, the information storage subsystem s200, the information user interface subsystems 300, the sensing subsystem s400 and the electronic communication subsystem s500 and their sub-components and the other exemplary entities depicted may be embodied by hardware, software and/or firmware (limited to patentable subject matter under 35 USC 101). For example, in some implementations of the residential information system s10, aspects may be implemented with a processor (e.g., microprocessor, controller, and so forth) executing computer readable instructions (e.g., computer program product) stored in a storage medium (e.g., volatile or non-volatile memory) such as a signal-bearing medium. Alternatively, hardware such as application specific integrated circuit (ASIC) may be employed in order to implement such modules in some alternative implementations.

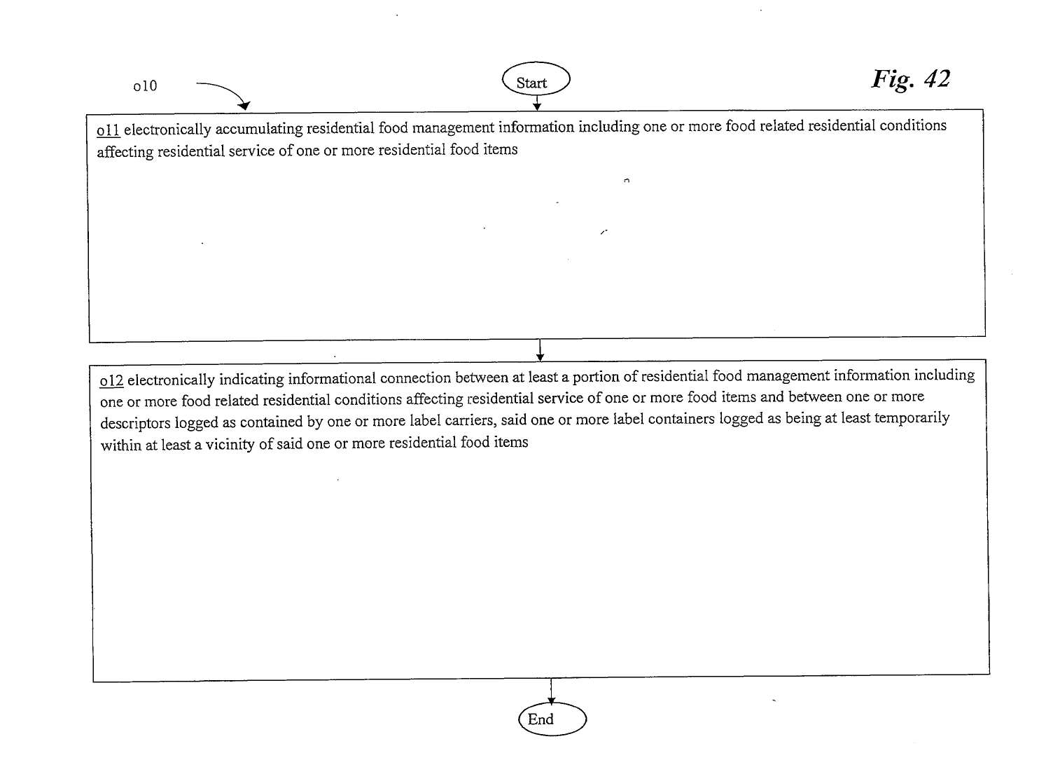

An operational flow o10 as shown in FIG. 42 represents example operations related to electronically accumulating residential food management information including one or more food related residential conditions affecting residential service of one or more residential food items and electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items.

FIG. 42 and those figures that follow may have various examples of operational flows, and explanation may be provided with respect to the above-described examples of FIGS. 1-11 and/or with respect to other examples and contexts. Nonetheless, it should be understood that the operational flows may be executed in a number of other environments and contexts, and/or in modified versions of FIGS. 1-11. Furthermore, although the various operational flows are presented in the sequence(s) illustrated, it should be understood that the various operations may be performed in other orders than those which are illustrated, or may be performed concurrently.

In FIG. 42 and those figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

As shown in FIG. 42, the operational flow o10 proceeds to operation o11 for electronically accumulating residential food management information including one or more food related residential conditions affecting residential service of one or more residential food items. An exemplary version of a non-transitory signal bearing medium of information storage subsystem s200 is depicted as bearing one or more electronically accumulating instructions ill that when executed will direct performance of the operation o11. In an implementation, the one or more electronically accumulating instructions ill when executed direct electronically accumulating (e.g. from wifi, from laptop entry, from RFID scan, etc.) residential food management information (e.g. AVI file format, MP3 file format, audio listening, etc.) including (e.g. associated, affected, affecting, etc.) one or more food related residential conditions (e.g. organic produce delivery schedule, cost of labor, record keeping methods, etc.) affecting (e.g. associated, affected, affecting, etc.) residential service of (e.g. fine dining residential food item preparation, fast food residential food item preparation, family buffet residential food item preparation, etc.) one or more residential food items (e.g. beef main course residential food item, pork main course residential food item, fish main course residential food item, etc.). Furthermore, the electronically accumulating electrical circuitry arrangement (“elec circ arrange”) e11 when activated will perform the operation o1101. Also, the accumulating wireless module m1101, when executed and/or activated, will direct performance of and/or performs the operation o11. In an implementation, the electronically accumulating electrical circuitry arrangement e11, when activated performs electronically accumulating (e.g. from wifi, from laptop entry, from RFID scan, etc.) residential food management information (e.g. AVI file format, MP3 file format, audio listening, etc.) including (e.g. associated, affected, affecting, etc.) one or more food related residential conditions (e.g. organic produce delivery schedule, cost of labor, record keeping methods, etc.) affecting (e.g. associated, affected, affecting, etc.) residential service of (e.g. fine dining residential food item preparation, fast food residential food item preparation, family buffet residential food item preparation, etc.) one or more residential food items (e.g. beef main course residential food item, pork main course residential food item, fish main course residential food item, etc.). Also, the electronically accumulating module m11, when executed and/or activated, will direct performance of and/or perform the operation o11. In an implementation, the electronically accumulating residential food management information including one or more food related residential conditions affecting residential service of one or more residential food items is carried out by electronically accumulating (e.g. from wifi, from laptop entry, from RFID scan, etc.) residential food management information (e.g. AVI file format, MP3 file format, audio listening, etc.) including (e.g. associated, affected, affecting, etc.) one or more food related residential conditions (e.g. organic produce delivery schedule, cost of labor, record keeping methods, etc.) affecting (e.g. associated, affected, affecting, etc.) residential service of (e.g. fine dining residential food item preparation, fast food residential food item preparation, family buffet residential food item preparation, etc.) one or more residential food items (e.g. beef main course residential food item, pork main course residential food item, fish main course residential food item, etc.).

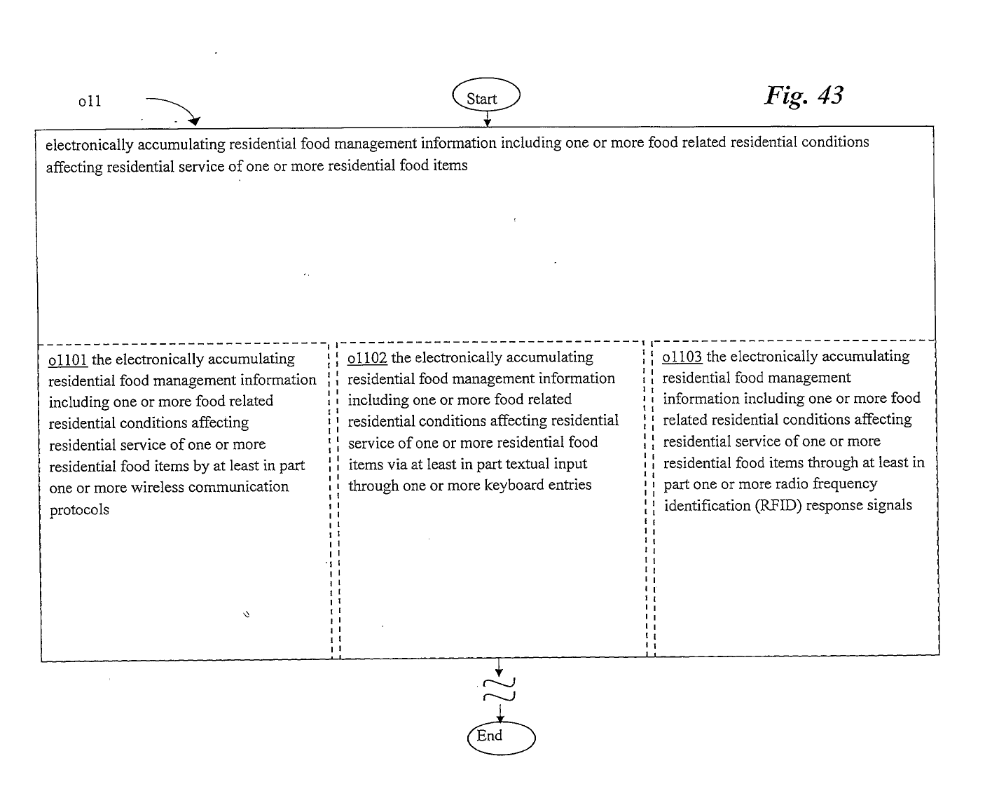

In one or more implementations, as shown in FIG. 43, operation o11 includes an operation o1101 for the electronically accumulating residential food management information including one or more food related residential conditions affecting residential service of one or more residential food items by at least in part one or more wireless communication protocols. Origination of an illustratively derived accumulating wireless component group can be accomplished through skilled in the art design choice selection of one or more of the above depicted components from one or more of the above depicted subsystems shown in FIG. 12. Components from the accumulating wireless component group can be used in implementing execution of the one or more accumulating wireless instructions i1101 of FIG. 28, can be used in performance of the accumulating wireless electrical circuitry arrangement e1101 of FIG. 21, and/or can be used in otherwise fulfillment of the operation o1101. An exemplary non-transitory signal bearing medium version of the information storage subsystem s200 is depicted in FIG. 28 as bearing the one or more accumulating wireless instructions i1101 that when executed will direct performance of the operation o1101. Furthermore, the accumulating wireless electrical circuitry arrangement (“elec circ arrange”) e1101, when activated, will perform the operation o1101. Also, the accumulating wireless module m1101, when executed and/or activated, will direct performance of and/or perform the operation o1101. For instance, in one or more exemplary implementations, the one or more accumulating wireless instructions i1101, when executed, direct performance of the operation o1101 in the illustrative depiction as follows, and/or the accumulating wireless electrical circuitry arrangement e1101, when activated, performs the operation o1101 in the illustrative depiction as follows, and/or the accumulating wireless module m1101, when executed and/or activated, directs performance of and/or performs the operation o1101 in the illustrative depiction as follows, and/or the operation o1101 is otherwise carried out in the illustrative depiction as follows: the electronically accumulating (e.g. from wifi, etc.) residential food management information (e.g. AVI file format, etc.) including (e.g. associated, etc.) one or more food related residential conditions (e.g. organic produce delivery schedule, etc.) affecting (e.g. associated, etc.) residential service of (e.g. fine dining residential food item preparation, etc.) one or more residential food items (e.g. beef main course residential food item, etc.) by at least in part one or more wireless communication protocols (e.g. wifi, etc.).

In one or more implementations, as shown in FIG. 43, operation o11 includes an operation o1102 for the electronically accumulating residential food management information including one or more food related residential conditions affecting residential service of one or more residential food items via at least in part textual input through one or more keyboard entries. Origination of an illustratively derived accumulating keyboard component group can be accomplished through skilled in the art design choice selection of one or more of the above depicted components from one or more of the above depicted subsystems shown in FIG. 12. Components from the accumulating keyboard component group can be used in implementing execution of the one or more accumulating keyboard instructions i1102 of FIG. 28, can be used in performance of the accumulating keyboard electrical circuitry arrangement e1102 of FIG. 21, and/or can be used in otherwise fulfillment of the operation o1102. An exemplary non-transitory signal bearing medium version of the information storage subsystem s200 is depicted in FIG. 28 as bearing the one or more accumulating keyboard instructions i1102 that when executed will direct performance of the operation o1102. Furthermore, the accumulating keyboard electrical circuitry arrangement (“elec circ arrange”) e1102, when activated, will perform the operation o1102. Also, the accumulating keyboard module m1102, when executed and/or activated, will direct performance of and/or perform the operation o1102. For instance, in one or more exemplary implementations, the one or more accumulating keyboard instructions i1102, when executed, direct performance of the operation o1102 in the illustrative depiction as follows, and/or the accumulating keyboard electrical circuitry arrangement e1102, when activated, performs the operation o1102 in the illustrative depiction as follows, and/or the accumulating keyboard module m1102, when executed and/or activated, directs performance of and/or performs the operation o1102 in the illustrative depiction as follows, and/or the operation o1102 is otherwise carried out in the illustrative depiction as follows: the electronically accumulating (e.g. from laptop entry, etc.) residential food management information (e.g. MP3 file format, etc.) including (e.g. affected, etc.) one or more food related residential conditions (e.g. cost of labor, etc.) affecting (e.g. affected, etc.) residential service of (e.g. fast food residential food item preparation, etc.) one or more residential food items (e.g. pork main course residential food item, etc.) via at least in part textual input through one or more keyboard entries (e.g. laptop entry, etc.).

In one or more implementations, as shown in FIG. 43, operation o11 includes an operation o1103 for the electronically accumulating residential food management information including one or more food related residential conditions affecting residential service of one or more residential food items through at least in part one or more radio frequency identification (RFID) response signals. Origination of an illustratively derived accumulating RFID component group can be accomplished through skilled in the art design choice selection of one or more of the above depicted components from one or more of the above depicted subsystems shown in FIG. 12. Components from the accumulating RFID component group can be used in implementing execution of the one or more accumulating RFID instructions i1103 of FIG. 28, can be used in performance of the accumulating RFID electrical circuitry arrangement e1103 of FIG. 21, and/or can be used in otherwise fulfillment of the operation o1103. An exemplary non-transitory signal bearing medium version of the information storage subsystem s200 is depicted in FIG. 28 as bearing the one or more accumulating RFID instructions i1103 that when executed will direct performance of the operation o1103. Furthermore, the accumulating RFID electrical circuitry arrangement (“elec circ arrange”) e1103, when activated, will perform the operation o1103. Also, the accumulating RFID module m1103, when executed and/or activated, will direct performance of and/or perform the operation o1103. For instance, in one or more exemplary implementations, the one or more accumulating RFID instructions i1103, when executed, direct performance of the operation o1103 in the illustrative depiction as follows, and/or the accumulating RFID electrical circuitry arrangement e1103, when activated, performs the operation o1103 in the illustrative depiction as follows, and/or the accumulating RFID module m1103, when executed and/or activated, directs performance of and/or performs the operation o1103 in the illustrative depiction as follows, and/or the operation o1103 is otherwise carried out in the illustrative depiction as follows: the electronically accumulating (e.g. from RFID scan, etc.) residential food management information (e.g. audio listening, etc.) including (e.g. affecting, etc.) one or more food related residential conditions (e.g. record keeping methods, etc.) affecting (e.g. affecting, etc.) residential service of (e.g. family buffet residential food item preparation, etc.) one or more residential food items (e.g. fish main course residential food item, etc.) through at least in part one or more radio frequency identification (RFID) response signals (e.g. RFID scan, etc.).

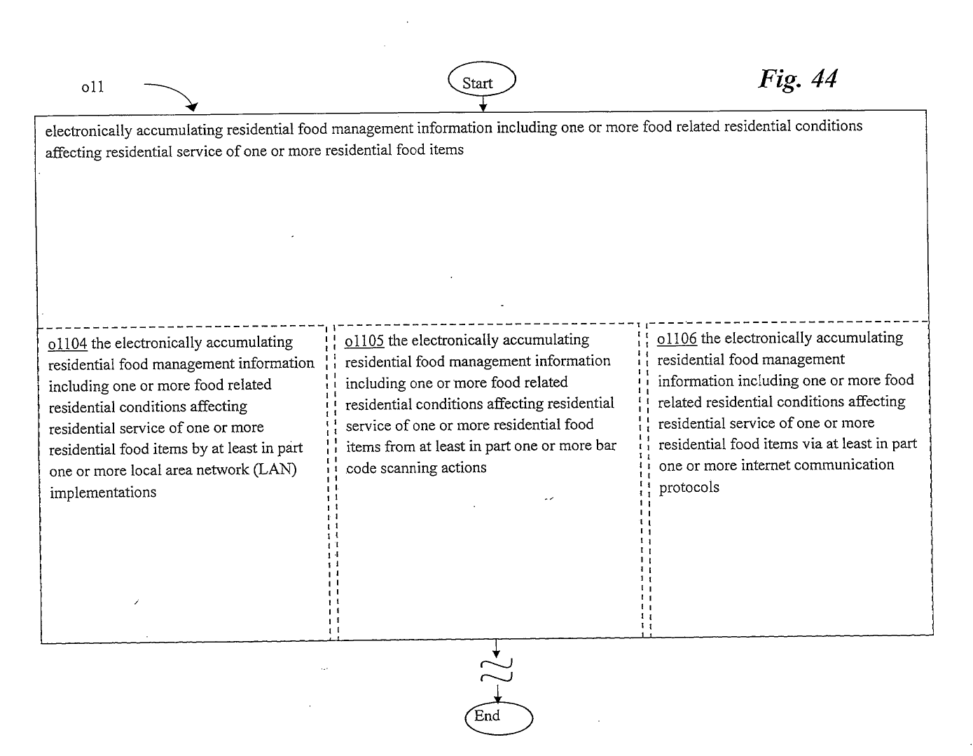

In one or more implementations, as shown in FIG. 44, operation o11 includes an operation o1104 for the electronically accumulating residential food management information including one or more food related residential conditions affecting residential service of one or more residential food items by at least in part one or more local area network (LAN) implementations. Origination of an illustratively derived accumulating LAN component group can be accomplished through skilled in the art design choice selection of one or more of the above depicted components from one or more of the above depicted subsystems shown in FIG. 12. Components from the accumulating LAN component group can be used in implementing execution of the one or more accumulating LAN instructions i1104 of FIG. 28, can be used in performance of the accumulating LAN electrical circuitry arrangement e1104 of FIG. 21, and/or can be used in otherwise fulfillment of the operation o1104. An exemplary non-transitory signal bearing medium version of the information storage subsystem s200 is depicted in FIG. 28 as bearing the one or more accumulating LAN instructions i1104 that when executed will direct performance of the operation o1104. Furthermore, the accumulating LAN electrical circuitry arrangement (“elec circ arrange”) e1104, when activated, will perform the operation o1104. Also, the accumulating LAN module m1104, when executed and/or activated, will direct performance of and/or perform the operation o1104. For instance, in one or more exemplary implementations, the one or more accumulating LAN instructions i1104, when executed, direct performance of the operation o1104 in the illustrative depiction as follows, and/or the accumulating LAN electrical circuitry arrangement e1104, when activated, performs the operation o1104 in the illustrative depiction as follows, and/or the accumulating LAN module m1104, when executed and/or activated, directs performance of and/or performs the operation o1104 in the illustrative depiction as follows, and/or the operation o1104 is otherwise carried out in the illustrative depiction as follows: the electronically accumulating (e.g. from ethernet, etc.) residential food management information (e.g. disobeying safety protocols, etc.) including (e.g. argue, etc.) one or more food related residential conditions (e.g. certification deadlines, etc.) affecting (e.g. argue, etc.) residential service of (e.g. mobile lifestyle residential food item preparation, etc.) one or more residential food items (e.g. tofu main course residential food item, etc.) by at least in part one or more local area network (LAN) implementations (e.g. ethernet, etc.).

In one or more implementations, as shown in FIG. 44, operation o11 includes an operation o1105 for the electronically accumulating residential food management information including one or more food related residential conditions affecting residential service of one or more residential food items from at least in part one or more bar code scanning actions. Origination of an illustratively derived accumulating bar code component group can be accomplished through skilled in the art design choice selection of one or more of the above depicted components from one or more of the above depicted subsystems shown in FIG. 12. Components from the accumulating bar code component group can be used in implementing execution of the one or more accumulating bar code instructions i1105 of FIG. 28, can be used in performance of the accumulating bar code electrical circuitry arrangement e1105 of FIG. 21, and/or can be used in otherwise fulfillment of the operation o1105. An exemplary non-transitory signal bearing medium version of the information storage subsystem s200 is depicted in FIG. 28 as bearing the one or more accumulating bar code instructions i1105 that when executed will direct performance of the operation o1105. Furthermore, the accumulating bar code electrical circuitry arrangement (“elec circ arrange”) e1105, when activated, will perform the operation o1105. Also, the accumulating bar code module m1105, when executed and/or activated, will direct performance of and/or perform the operation o1105. For instance, in one or more exemplary implementations, the one or more accumulating bar code instructions i1105, when executed, direct performance of the operation o1105 in the illustrative depiction as follows, and/or the accumulating bar code electrical circuitry arrangement e1105, when activated, performs the operation o1105 in the illustrative depiction as follows, and/or the accumulating bar code module m1105, when executed and/or activated, directs performance of and/or performs the operation o1105 in the illustrative depiction as follows, and/or the operation o1105 is otherwise carried out in the illustrative depiction as follows: the electronically accumulating (e.g. from UPC scan, etc.) residential food management information (e.g. preparation rates of residential food items, etc.) including (e.g. connected, etc.) one or more food related residential conditions (e.g. types of residential food items on order, etc.) affecting (e.g. connected, etc.) residential service of (e.g. institutional residential food item preparation, etc.) one or more residential food items (e.g. chicken main course residential food item, etc.) from at least in part one or more bar code scanning actions (e.g. UPC scan, etc.).

In one or more implementations, as shown in FIG. 44, operation o11 includes an operation o1106 for the electronically accumulating residential food management information including one or more food related residential conditions affecting residential service of one or more residential food items via at least in part one or more internet communication protocols. Origination of an illustratively derived accumulating internet component group can be accomplished through skilled in the art design choice selection of one or more of the above depicted components from one or more of the above depicted subsystems shown in FIG. 12. Components from the accumulating internet component group can be used in implementing execution of the one or more accumulating internet instructions i1106 of FIG. 28, can be used in performance of the accumulating internet electrical circuitry arrangement e1106 of FIG. 21, and/or can be used in otherwise fulfillment of the operation o1106. An exemplary non-transitory signal bearing medium version of the information storage subsystem s200 is depicted in FIG. 28 as bearing the one or more accumulating internet instructions i1106 that when executed will direct performance of the operation o1106. Furthermore, the accumulating internet electrical circuitry arrangement (“elec circ arrange”) e1106, when activated, will perform the operation o1106. Also, the accumulating internet module m1106, when executed and/or activated, will direct performance of and/or perform the operation o1106. For instance, in one or more exemplary implementations, the one or more accumulating internet instructions i1106, when executed, direct performance of the operation o1106 in the illustrative depiction as follows, and/or the accumulating internet electrical circuitry arrangement e1106, when activated, performs the operation o1106 in the illustrative depiction as follows, and/or the accumulating internet module m1106, when executed and/or activated, directs performance of and/or performs the operation o1106 in the illustrative depiction as follows, and/or the operation o1106 is otherwise carried out in the illustrative depiction as follows: the electronically accumulating (e.g. from HTML code, etc.) residential food management information (e.g. food poisoning reports, etc.) including (e.g. commit to, etc.) one or more food related residential conditions (e.g. banned residential handling practices, etc.) affecting (e.g. commit to, etc.) residential service of (e.g. large family cafeteria residential food item preparation, etc.) one or more residential food items (e.g. seafood main course residential food item, etc.) via at least in part one or more internet communication protocols (e.g. HTML code, etc.).

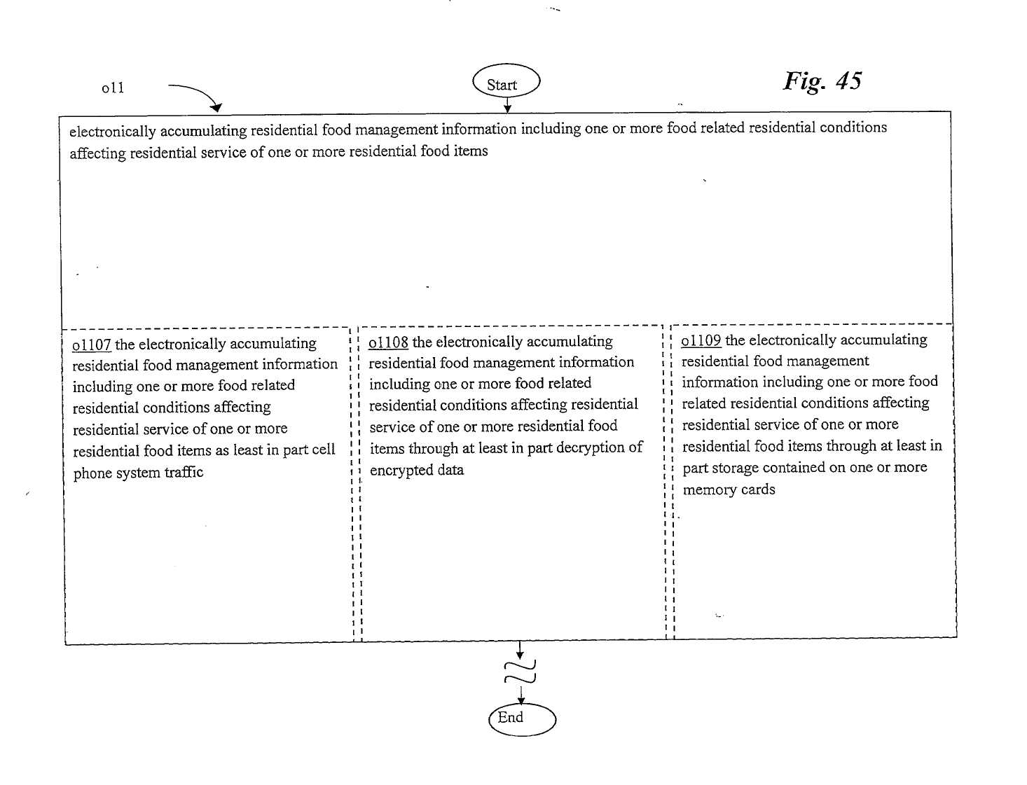

In one or more implementations, as shown in FIG. 45, operation o11 includes an operation o1107 for the electronically accumulating residential food management information including one or more food related residential conditions affecting residential service of one or more residential food items as least in part cell phone system traffic. Origination of an illustratively derived accumulating cell phone component group can be accomplished through skilled in the art design choice selection of one or more of the above depicted components from one or more of the above depicted subsystems shown in FIG. 12. Components from the accumulating cell phone component group can be used in implementing execution of the one or more accumulating cell phone instructions i1107 of FIG. 28, can be used in performance of the accumulating cell phone electrical circuitry arrangement e1107 of FIG. 21, and/or can be used in otherwise fulfillment of the operation o1107. An exemplary non-transitory signal bearing medium version of the information storage subsystem s200 is depicted in FIG. 28 as bearing the one or more accumulating cell phone instructions i1107 that when executed will direct performance of the operation o1107. Furthermore, the accumulating cell phone electrical circuitry arrangement (“elec circ arrange”) e1107, when activated, will perform the operation o1107. Also, the accumulating cell phone module m1107, when executed and/or activated, will direct performance of and/or perform the operation o1107. For instance, in one or more exemplary implementations, the one or more accumulating cell phone instructions i1107, when executed, direct performance of the operation o1107 in the illustrative depiction as follows, and/or the accumulating cell phone electrical circuitry arrangement e1107, when activated, performs the operation o1107 in the illustrative depiction as follows, and/or the accumulating cell phone module m1107, when executed and/or activated, directs performance of and/or performs the operation o1107 in the illustrative depiction as follows, and/or the operation o1107 is otherwise carried out in the illustrative depiction as follows: the electronically accumulating (e.g. from MMS, etc.) residential food management information (e.g. residential occupant illness reports, etc.) including (e.g. absorbed by, etc.) one or more food related residential conditions (e.g. amount of seasonal residential food item use, etc.) affecting (e.g. absorbed by, etc.) residential service of (e.g. in-home nursing care residential food item preparation, etc.) one or more residential food items (e.g. poultry main course residential food item, etc.) as least in part cell phone system traffic (e.g. MMS, etc.).

In one or more implementations, as shown in FIG. 45, operation o11 includes an operation o1108 for the electronically accumulating residential food management information including one or more food related residential conditions affecting residential service of one or more residential food items through at least in part decryption of encrypted data. Origination of an illustratively derived accumulating decryption component group can be accomplished through skilled in the art design choice selection of one or more of the above depicted components from one or more of the above depicted subsystems shown in FIG. 12. Components from the accumulating decryption component group can be used in implementing execution of the one or more accumulating decryption instructions i1108 of FIG. 28, can be used in performance of the accumulating decryption electrical circuitry arrangement e1108 of FIG. 21, and/or can be used in otherwise fulfillment of the operation o1108. An exemplary non-transitory signal bearing medium version of the information storage subsystem s200 is depicted in FIG. 28 as bearing the one or more accumulating decryption instructions i1108 that when executed will direct performance of the operation o1108. Furthermore, the accumulating decryption electrical circuitry arrangement (“elec circ arrange”) e1108, when activated, will perform the operation o1108. Also, the accumulating decryption module m1108, when executed and/or activated, will direct performance of and/or perform the operation o1108. For instance, in one or more exemplary implementations, the one or more accumulating decryption instructions i1108, when executed, direct performance of the operation o1108 in the illustrative depiction as follows, and/or the accumulating decryption electrical circuitry arrangement e1108, when activated, performs the operation o1108 in the illustrative depiction as follows, and/or the accumulating decryption module m1108, when executed and/or activated, directs performance of and/or performs the operation o1108 in the illustrative depiction as follows, and/or the operation o1108 is otherwise carried out in the illustrative depiction as follows: the electronically accumulating (e.g. as 256-bit AES, etc.) residential food management information (e.g. residential occupancy rates, etc.) including (e.g. embraced by, etc.) one or more food related residential conditions (e.g. predicted amounts of expenditures from particular residential food items, etc.) affecting (e.g. embraced by, etc.) residential service of (e.g. outside delivery of residential food item preparation, etc.) one or more residential food items (e.g. diary main course residential food item, etc.) through at least in part decryption of encrypted data (e.g. 256-bit AES, etc.).

In one or more implementations, as shown in FIG. 45, operation o11 includes an operation o1109 for the electronically accumulating residential food management information including one or more food related residential conditions affecting residential service of one or more residential food items through at least in part storage contained on one or more memory cards. Origination of an illustratively derived accumulating memory cards component group can be accomplished through skilled in the art design choice selection of one or more of the above depicted components from one or more of the above depicted subsystems shown in FIG. 12. Components from the accumulating memory cards component group can be used in implementing execution of the one or more accumulating memory cards instructions i1109 of FIG. 28, can be used in performance of the accumulating memory cards electrical circuitry arrangement e1109 of FIG. 21, and/or can be used in otherwise fulfillment of the operation o1109. An exemplary non-transitory signal bearing medium version of the information storage subsystem s200 is depicted in FIG. 28 as bearing the one or more accumulating memory cards instructions i1109 that when executed will direct performance of the operation o1109. Furthermore, the accumulating memory cards electrical circuitry arrangement (“elec circ arrange”) e1109, when activated, will perform the operation o1109. Also, the accumulating memory cards module m1109, when executed and/or activated, will direct performance of and/or perform the operation o1109. For instance, in one or more exemplary implementations, the one or more accumulating memory cards instructions i1109, when executed, direct performance of the operation o1109 in the illustrative depiction as follows, and/or the accumulating memory cards electrical circuitry arrangement e1109, when activated, performs the operation o1109 in the illustrative depiction as follows, and/or the accumulating memory cards module m1109, when executed and/or activated, directs performance of and/or performs the operation o1109 in the illustrative depiction as follows, and/or the operation o1109 is otherwise carried out in the illustrative depiction as follows: the electronically accumulating (e.g. onto compact flash, etc.) residential food management information (e.g. total resident food item expenditures, etc.) including (e.g. containing, etc.) one or more food related residential conditions (e.g. fluctuations in occupancy levels at residential, etc.) affecting (e.g. containing, etc.) residential service of (e.g. mobile kitchen residential food item preparation, etc.) one or more residential food items (e.g. vegetarian main course residential food item, etc.) through at least in part storage contained on one or more memory cards (e.g. compact flash, etc.).

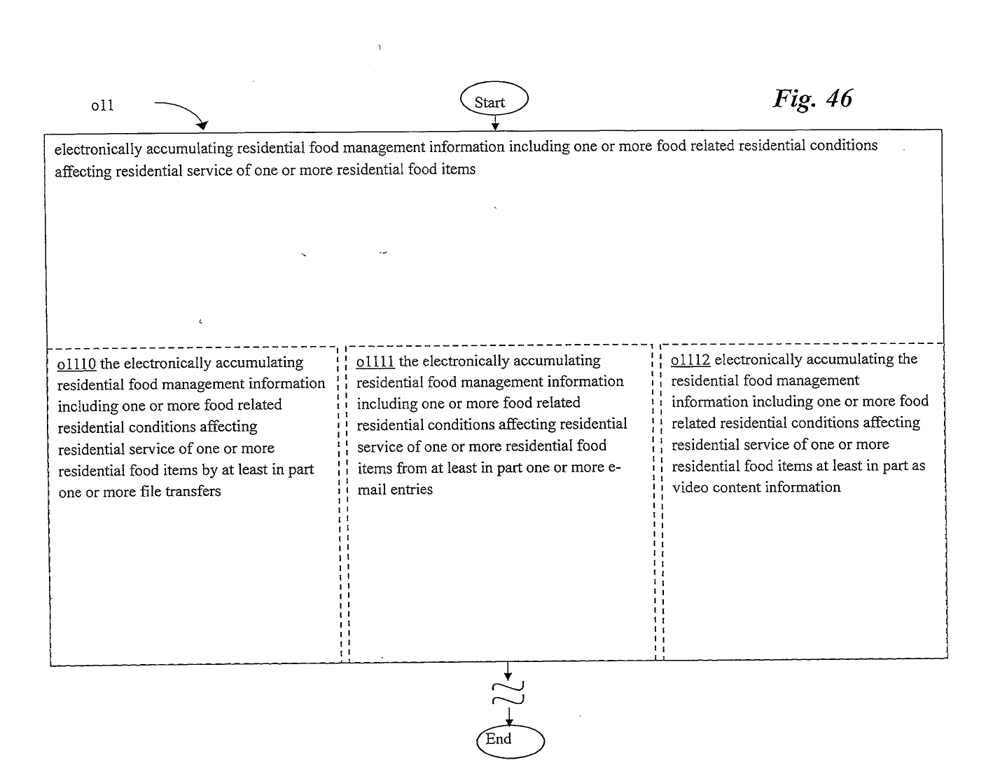

In one or more implementations, as shown in FIG. 46, operation o11 includes an operation o1110 for the electronically accumulating residential food management information including one or more food related residential conditions affecting residential service of one or more residential food items by at least in part one or more file transfers. Origination of an illustratively derived accumulating file transfers component group can be accomplished through skilled in the art design choice selection of one or more of the above depicted components from one or more of the above depicted subsystems shown in FIG. 12. Components from the accumulating file transfers component group can be used in implementing execution of the one or more accumulating file transfers instructions i1110 of FIG. 28, can be used in performance of the accumulating file transfers electrical circuitry arrangement e1110 of FIG. 21, and/or can be used in otherwise fulfillment of the operation o1110. An exemplary non-transitory signal bearing medium version of the information storage subsystem s200 is depicted in FIG. 28 as bearing the one or more accumulating file transfers instructions i1110 that when executed will direct performance of the operation o1110. Furthermore, the accumulating file transfers electrical circuitry arrangement (“elec circ arrange”) e1110, when activated, will perform the operation o1110. Also, the accumulating file transfers module m1110, when executed and/or activated, will direct performance of and/or perform the operation o1110. For instance, in one or more exemplary implementations, the one or more accumulating file transfers instructions i1110, when executed, direct performance of the operation o1110 in the illustrative depiction as follows, and/or the accumulating file transfers electrical circuitry arrangement e1110, when activated, performs the operation o1110 in the illustrative depiction as follows, and/or the accumulating file transfers module m1110, when executed and/or activated, directs performance of and/or performs the operation o1110 in the illustrative depiction as follows, and/or the operation o1110 is otherwise carried out in the illustrative depiction as follows: the electronically accumulating (e.g. via push-based, etc.) residential food management information (e.g. average shelf life of produce used, etc.) including (e.g. engaging, etc.) one or more food related residential conditions (e.g. cost factors for residential hired labor, etc.) affecting (e.g. engaging, etc.) residential service of (e.g. in-home hospital residential food item preparation, etc.) one or more residential food items (e.g. salad main course residential food item, etc.) by at least in part one or more file transfers (e.g. push-based, etc.).

In one or more implementations, as shown in FIG. 46, operation o11 includes an operation o1111 for the electronically accumulating residential food management information including one or more food related residential conditions affecting residential service of one or more residential food items from at least in part one or more e-mail entries. Origination of an illustratively derived accumulating e-mail entries component group can be accomplished through skilled in the art design choice selection of one or more of the above depicted components from one or more of the above depicted subsystems shown in FIG. 12. Components from the accumulating e-mail entries component group can be used in implementing execution of the one or more accumulating e-mail entries instructions i1111 of FIG. 28, can be used in performance of the accumulating e-mail entries electrical circuitry arrangement e1111 of FIG. 21, and/or can be used in otherwise fulfillment of the operation o1111. An exemplary non-transitory signal bearing medium version of the information storage subsystem s200 is depicted in FIG. 28 as bearing the one or more accumulating e-mail entries instructions i1111 that when executed will direct performance of the operation o1111. Furthermore, the accumulating e-mail entries electrical circuitry arrangement (“elec circ arrange”) e1111, when activated, will perform the operation o1111. Also, the accumulating e-mail entries module m1111, when executed and/or activated, will direct performance of and/or perform the operation o1111. For instance, in one or more exemplary implementations, the one or more accumulating e-mail entries instructions i1111, when executed, direct performance of the operation o1111 in the illustrative depiction as follows, and/or the accumulating e-mail entries electrical circuitry arrangement e1111, when activated, performs the operation o1111 in the illustrative depiction as follows, and/or the accumulating e-mail entries module m1111, when executed and/or activated, directs performance of and/or performs the operation o1111 in the illustrative depiction as follows, and/or the operation o1111 is otherwise carried out in the illustrative depiction as follows: the electronically accumulating (e.g. onto SMTP server, etc.) residential food management information (e.g. residential occupant accident reports, etc.) including (e.g. engaged by, etc.) one or more food related residential conditions (e.g. shipping costs incurred, etc.) affecting (e.g. engaged by, etc.) residential service of (e.g. deli style residential food item preparation, etc.) one or more residential food items (e.g. grain main course residential food item, etc.) from at least in part one or more e-mail entries (e.g. SMTP server, etc.).

In one or more implementations, as shown in FIG. 46, operation o11 includes an operation o1112 for electronically accumulating the residential food management information including one or more food related residential conditions affecting residential service of one or more residential food items at least in part as video content information. Origination of an illustratively derived accumulating video content component group can be accomplished through skilled in the art design choice selection of one or more of the above depicted components from one or more of the above depicted subsystems shown in FIG. 12. Components from the accumulating video content component group can be used in implementing execution of the one or more accumulating video content instructions i1112 of FIG. 28, can be used in performance of the accumulating video content electrical circuitry arrangement e1112 of FIG. 21, and/or can be used in otherwise fulfillment of the operation o1112. An exemplary non-transitory signal bearing medium version of the information storage subsystem s200 is depicted in FIG. 28 as bearing the one or more accumulating video content instructions i1112 that when executed will direct performance of the operation o1112. Furthermore, the accumulating video content electrical circuitry arrangement (“elec circ arrange”) e1112, when activated, will perform the operation o1112. Also, the accumulating video content module m1112, when executed and/or activated, will direct performance of and/or perform the operation o1112. For instance, in one or more exemplary implementations, the one or more accumulating video content instructions i1112, when executed, direct performance of the operation o1112 in the illustrative depiction as follows, and/or the accumulating video content electrical circuitry arrangement e1112, when activated, performs the operation o1112 in the illustrative depiction as follows, and/or the accumulating video content module m1112, when executed and/or activated, directs performance of and/or performs the operation o1112 in the illustrative depiction as follows, and/or the operation o1112 is otherwise carried out in the illustrative depiction as follows: electronically accumulating (e.g. from radio wave, etc.) the residential food management information (e.g. duration of time required to store received stock in residential refrigeration, etc.) including (e.g. incorporating, etc.) one or more food related residential conditions (e.g. shipping schedules involved with residential food items received by various wholesalers or farms, etc.) affecting (e.g. incorporating, etc.) residential service of (e.g. fine dining residential food item purchasing, etc.) one or more residential food items (e.g. bean main course residential food item, etc.) at least in part as video content information (e.g. video content of residential occupants receiving shipments, etc.).

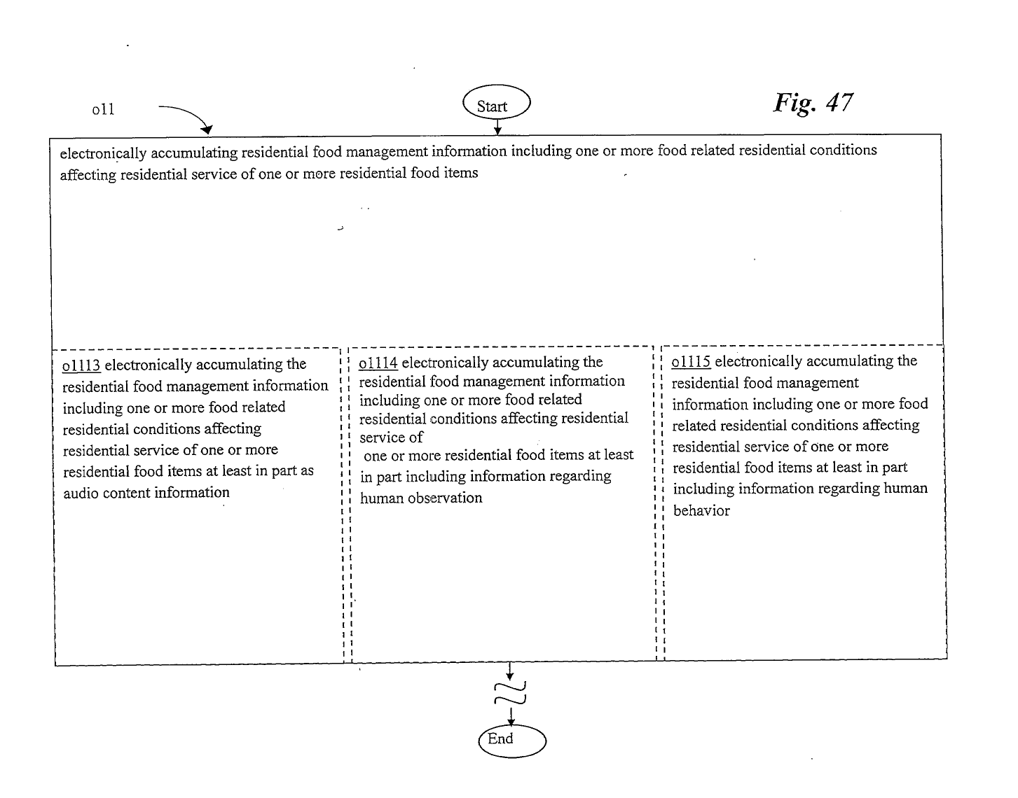

In one or more implementations, as shown in FIG. 47, operation o11 includes an operation o1113 for electronically accumulating the residential food management information including one or more food related residential conditions affecting residential service of one or more residential food items at least in part as audio content information. Origination of an illustratively derived accumulating audio content component group can be accomplished through skilled in the art design choice selection of one or more of the above depicted components from one or more of the above depicted subsystems shown in FIG. 12. Components from the accumulating audio content component group can be used in implementing execution of the one or more accumulating audio content instructions i1113 of FIG. 28, can be used in performance of the accumulating audio content electrical circuitry arrangement e1113 of FIG. 21, and/or can be used in otherwise fulfillment of the operation o1113. An exemplary non-transitory signal bearing medium version of the information storage subsystem s200 is depicted in FIG. 28 as bearing the one or more accumulating audio content instructions i1113 that when executed will direct performance of the operation o1113. Furthermore, the accumulating audio content electrical circuitry arrangement (“elec circ arrange”) e1113, when activated, will perform the operation o1113. Also, the accumulating audio content module m1113, when executed and/or activated, will direct performance of and/or perform the operation o1113. For instance, in one or more exemplary implementations, the one or more accumulating audio content instructions i1113, when executed, direct performance of the operation o1113 in the illustrative depiction as follows, and/or the accumulating audio content electrical circuitry arrangement e1113, when activated, performs the operation o1113 in the illustrative depiction as follows, and/or the accumulating audio content module m1113, when executed and/or activated, directs performance of and/or performs the operation o1113 in the illustrative depiction as follows, and/or the operation o1113 is otherwise carried out in the illustrative depiction as follows: electronically accumulating (e.g. from infra-red, etc.) the residential food management information (e.g. WAV file format, etc.) including (e.g. engrossing, etc.) one or more food related residential conditions (e.g. known pandemic status, etc.) affecting (e.g. engrossing, etc.) residential service of (e.g. fast residential food item purchasing, etc.) one or more residential food items (e.g. cooked main course residential food item, etc.) at least in part as audio content information (e.g. WAV file format, etc.).

In one or more implementations, as shown in FIG. 47, operation o11 includes an operation o1114 for electronically accumulating the residential food management information including one or more food related residential conditions affecting residential service of one or more residential food items at least in part including information regarding human observation. Origination of an illustratively derived accumulating human observation component group can be accomplished through skilled in the art design choice selection of one or more of the above depicted components from one or more of the above depicted subsystems shown in FIG. 12. Components from the accumulating human observation component group can be used in implementing execution of the one or more accumulating human observation instructions i1114 of FIG. 28, can be used in performance of the accumulating human observation electrical circuitry arrangement e1114 of FIG. 21, and/or can be used in otherwise fulfillment of the operation o1114. An exemplary non-transitory signal bearing medium version of the information storage subsystem s200 is depicted in FIG. 28 as bearing the one or more accumulating human observation instructions i1114 that when executed will direct performance of the operation o1114. Furthermore, the accumulating human observation electrical circuitry arrangement (“elec circ arrange”) e1114, when activated, will perform the operation o1114. Also, the accumulating human observation module m1114, when executed and/or activated, will direct performance of and/or perform the operation o1114. For instance, in one or more exemplary implementations, the one or more accumulating human observation instructions i1114, when executed, direct performance of the operation o1114 in the illustrative depiction as follows, and/or the accumulating human observation electrical circuitry arrangement e1114, when activated, performs the operation o1114 in the illustrative depiction as follows, and/or the accumulating human observation module m1114, when executed and/or activated, directs performance of and/or performs the operation o1114 in the illustrative depiction as follows, and/or the operation o1114 is otherwise carried out in the illustrative depiction as follows: electronically accumulating (e.g. from bluetooth, etc.) the residential food management information (e.g. visual observation, etc.) including (e.g. implicate, etc.) one or more food related residential conditions (e.g. market demands, etc.) affecting (e.g. implicate, etc.) residential service of (e.g. family buffet residential food item purchasing, etc.) one or more residential food items (e.g. raw main course residential food item, etc.) at least in part including information regarding human observation (e.g. visual observation of residential food quality, etc.).

In one or more implementations, as shown in FIG. 47, operation o11 includes an operation o1115 for electronically accumulating the residential food management information including one or more food related residential conditions affecting residential service of one or more residential food items at least in part including information regarding human behavior. Origination of an illustratively derived accumulating human behavior component group can be accomplished through skilled in the art design choice selection of one or more of the above depicted components from one or more of the above depicted subsystems shown in FIG. 12. Components from the accumulating human behavior component group can be used in implementing execution of the one or more accumulating human behavior instructions i1115 of FIG. 28, can be used in performance of the accumulating human behavior electrical circuitry arrangement e1115 of FIG. 21, and/or can be used in otherwise fulfillment of the operation o1115. An exemplary non-transitory signal bearing medium version of the information storage subsystem s200 is depicted in FIG. 28 as bearing the one or more accumulating human behavior instructions i1115 that when executed will direct performance of the operation o1115. Furthermore, the accumulating human behavior electrical circuitry arrangement (“elec circ arrange”) e1115, when activated, will perform the operation o1115. Also, the accumulating human behavior module m1115, when executed and/or activated, will direct performance of and/or perform the operation o1115. For instance, in one or more exemplary implementations, the one or more accumulating human behavior instructions i1115, when executed, direct performance of the operation o1115 in the illustrative depiction as follows, and/or the accumulating human behavior electrical circuitry arrangement e1115, when activated, performs the operation o1115 in the illustrative depiction as follows, and/or the accumulating human behavior module m1115, when executed and/or activated, directs performance of and/or performs the operation o1115 in the illustrative depiction as follows, and/or the operation o1115 is otherwise carried out in the illustrative depiction as follows: electronically accumulating (e.g. from webpage, etc.) the residential food management information (e.g. following safety protocols, etc.) including (e.g. necessitate, etc.) one or more food related residential conditions (e.g. crop disease status, etc.) affecting (e.g. necessitate, etc.) residential service of (e.g. mobile lifestyle residential food item purchasing, etc.) one or more residential food items (e.g. buffet main course residential food item, etc.) at least in part including information regarding human behavior (e.g. following health safety protocols, etc.).

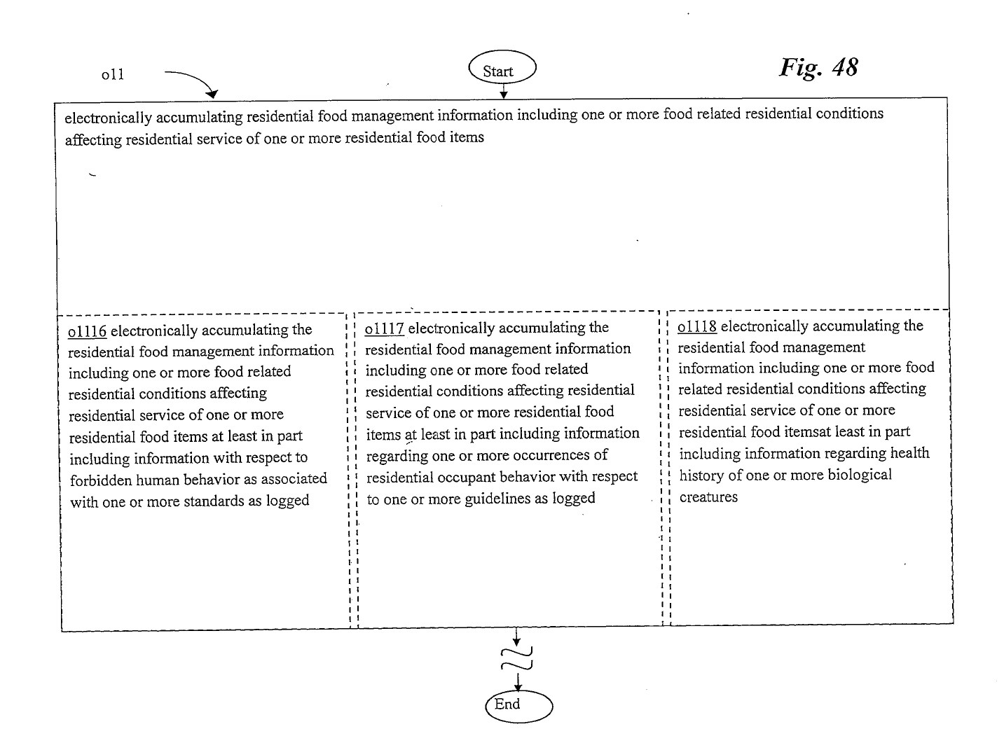

In one or more implementations, as shown in FIG. 48, operation o11 includes an operation o1116 for electronically accumulating the residential food management information including one or more food related residential conditions affecting residential service of one or more residential food items at least in part including information with respect to forbidden human behavior as associated with one or more standards as logged. Origination of an illustratively derived accumulating forbidden behavior standards component group can be accomplished through skilled in the art design choice selection of one or more of the above depicted components from one or more of the above depicted subsystems shown in FIG. 12. Components from the accumulating forbidden behavior standards component group can be used in implementing execution of the one or more accumulating forbidden behavior standards instructions i1116 of FIG. 28, can be used in performance of the accumulating forbidden behavior standards electrical circuitry arrangement e1116 of FIG. 21, and/or can be used in otherwise fulfillment of the operation o1116. An exemplary non-transitory signal bearing medium version of the information storage subsystem s200 is depicted in FIG. 28 as bearing the one or more accumulating forbidden behavior standards instructions i1116 that when executed will direct performance of the operation o1116. Furthermore, the accumulating forbidden behavior standards electrical circuitry arrangement (“elec circ arrange”) e1116, when activated, will perform the operation o1116. Also, the accumulating forbidden behavior standards module m1116, when executed and/or activated, will direct performance of and/or perform the operation o1116. For instance, in one or more exemplary implementations, the one or more accumulating forbidden behavior standards instructions i1116, when executed, direct performance of the operation o1116 in the illustrative depiction as follows, and/or the accumulating forbidden behavior standards electrical circuitry arrangement e1116, when activated, performs the operation o1116 in the illustrative depiction as follows, and/or the accumulating forbidden behavior standards module m1116, when executed and/or activated, directs performance of and/or performs the operation o1116 in the illustrative depiction as follows, and/or the operation o1116 is otherwise carried out in the illustrative depiction as follows: electronically accumulating (e.g. from website, etc.) the residential food management information (e.g. certification forgery, etc.) including (e.g. presuppose, etc.) one or more food related residential conditions (e.g. climate conditions near the residential facilities, etc.) affecting (e.g. presuppose, etc.) residential service of (e.g. institutional residential food item purchasing, etc.) one or more residential food items (e.g. soup main course residential food item, etc.) at least in part including information with respect to forbidden human behavior as associated with one or more standards as logged (e.g. certification document forgery, etc.).

In one or more implementations, as shown in FIG. 48, operation o11 includes an operation o1117 for electronically accumulating the residential food management information including one or more food related residential conditions affecting residential service of one or more residential food items at least in part including information regarding one or more occurrences of residential occupant behavior with respect to one or more guidelines as logged. Origination of an illustratively derived accumulating occupant behavior guidelines component group can be accomplished through skilled in the art design choice selection of one or more of the above depicted components from one or more of the above depicted subsystems shown in FIG. 12. Components from the accumulating occupant behavior guidelines component group can be used in implementing execution of the one or more accumulating occupant behavior guidelines instructions i1117 of FIG. 28, can be used in performance of the accumulating occupant behavior guidelines electrical circuitry arrangement e1117 of FIG. 21, and/or can be used in otherwise fulfillment of the operation o1117. An exemplary non-transitory signal bearing medium version of the information storage subsystem s200 is depicted in FIG. 28 as bearing the one or more accumulating occupant behavior guidelines instructions i1117 that when executed will direct performance of the operation o1117. Furthermore, the accumulating occupant behavior guidelines electrical circuitry arrangement (“elec circ arrange”) e1117, when activated, will perform the operation o1117. Also, the accumulating occupant behavior guidelines module m1117, when executed and/or activated, will direct performance of and/or perform the operation o1117. For instance, in one or more exemplary implementations, the one or more accumulating occupant behavior guidelines instructions i1117, when executed, direct performance of the operation o1117 in the illustrative depiction as follows, and/or the accumulating occupant behavior guidelines electrical circuitry arrangement e1117, when activated, performs the operation o1117 in the illustrative depiction as follows, and/or the accumulating occupant behavior guidelines module m1117, when executed and/or activated, directs performance of and/or performs the operation o1117 in the illustrative depiction as follows, and/or the operation o1117 is otherwise carried out in the illustrative depiction as follows: electronically accumulating (e.g. from cellphone entry, etc.) the residential food management information (e.g. resident demographics, etc.) including (e.g. related to, etc.) one or more food related residential conditions (e.g. hygiene practices of the residential occupants, etc.) affecting (e.g. related to, etc.) residential service of (e.g. large family cafeteria residential food item purchasing, etc.) one or more residential food items (e.g. stew main course residential food item, etc.) at least in part including information regarding one or more occurrences of residential occupant behavior with respect to one or more guidelines as logged (e.g. manufacture recalls regarding equipment used to process residential food shipments, etc.).

In one or more implementations, as shown in FIG. 48, operation o11 includes an operation o1118 for electronically accumulating the residential food management information including one or more food related residential conditions affecting residential service of one or more residential food items at least in part including information regarding health history of one or more biological creatures. Origination of an illustratively derived accumulating health history component group can be accomplished through skilled in the art design choice selection of one or more of the above depicted components from one or more of the above depicted subsystems shown in FIG. 12. Components from the accumulating health history component group can be used in implementing execution of the one or more accumulating health history instructions i1118 of FIG. 28, can be used in performance of the accumulating health history electrical circuitry arrangement e1118 of FIG. 21, and/or can be used in otherwise fulfillment of the operation o1118. An exemplary non-transitory signal bearing medium version of the information storage subsystem s200 is depicted in FIG. 28 as bearing the one or more accumulating health history instructions i1118 that when executed will direct performance of the operation o1118. Furthermore, the accumulating health history electrical circuitry arrangement (“elec circ arrange”) e1118, when activated, will perform the operation o1118. Also, the accumulating health history module m1118, when executed and/or activated, will direct performance of and/or perform the operation o1118. For instance, in one or more exemplary implementations, the one or more accumulating health history instructions i1118, when executed, direct performance of the operation o1118 in the illustrative depiction as follows, and/or the accumulating health history electrical circuitry arrangement e1118, when activated, performs the operation o1118 in the illustrative depiction as follows, and/or the accumulating health history module m1118, when executed and/or activated, directs performance of and/or performs the operation o1118 in the illustrative depiction as follows, and/or the operation o1118 is otherwise carried out in the illustrative depiction as follows: electronically accumulating (e.g. from satellite transmission, etc.) the residential food management information (e.g. residential facility temperature, etc.) including (e.g. relationship, etc.) one or more food related residential conditions (e.g. turnover rate of produce supply, etc.) affecting (e.g. relationship, etc.) residential service of (e.g. in-house nursing home residential food item purchasing, etc.) one or more residential food items (e.g. hot dish main course residential food item, etc.) at least in part including information regarding health history of one or more biological creatures (e.g. identification and description of farm animals used at least in part to produce one or more residential food items, etc.).

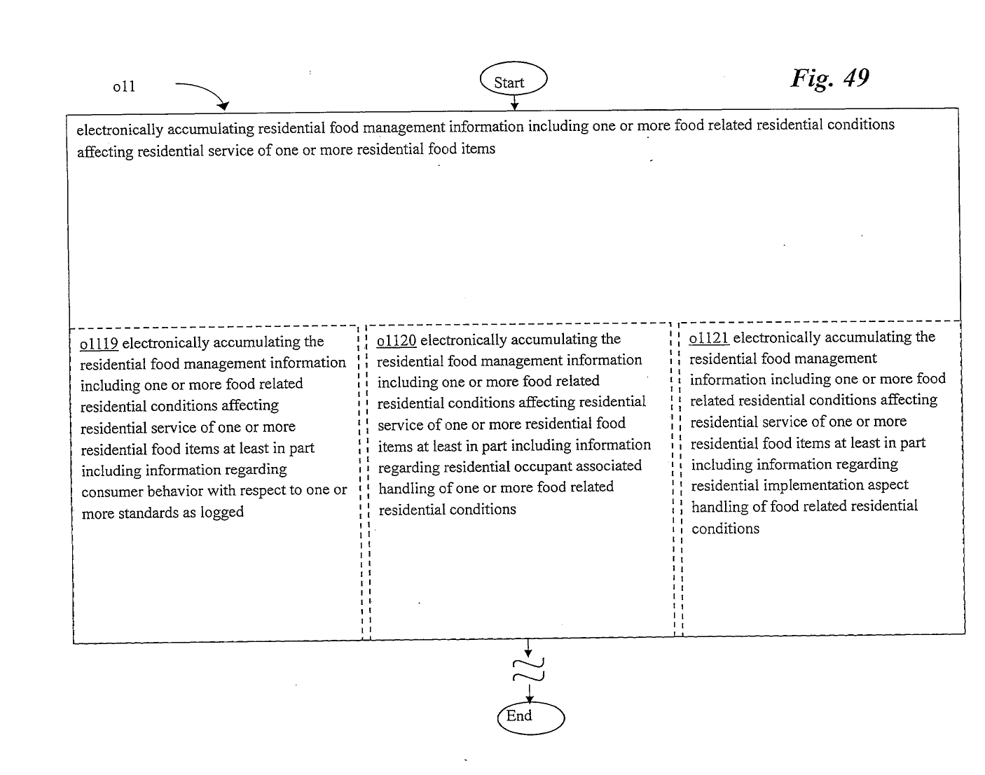

In one or more implementations, as shown in FIG. 49, operation o11 includes an operation o1119 for electronically accumulating the residential food management information including one or more food related residential conditions affecting residential service of one or more residential food items at least in part including information regarding consumer behavior with respect to one or more standards as logged. Origination of an illustratively derived accumulating consumer behavior component group can be accomplished through skilled in the art design choice selection of one or more of the above depicted components from one or more of the above depicted subsystems shown in FIG. 12. Components from the accumulating consumer behavior component group can be used in implementing execution of the one or more accumulating consumer behavior instructions i1119 of FIG. 28, can be used in performance of the accumulating consumer behavior electrical circuitry arrangement e1119 of FIG. 21, and/or can be used in otherwise fulfillment of the operation o1119. An exemplary non-transitory signal bearing medium version of the information storage subsystem s200 is depicted in FIG. 28 as bearing the one or more accumulating consumer behavior instructions i1119 that when executed will direct performance of the operation o1119. Furthermore, the accumulating consumer behavior electrical circuitry arrangement (“elec circ arrange”) e1119, when activated, will perform the operation o1119. Also, the accumulating consumer behavior module m1119, when executed and/or activated, will direct performance of and/or perform the operation o1119. For instance, in one or more exemplary implementations, the one or more accumulating consumer behavior instructions i1119, when executed, direct performance of the operation o1119 in the illustrative depiction as follows, and/or the accumulating consumer behavior electrical circuitry arrangement e1119, when activated, performs the operation o1119 in the illustrative depiction as follows, and/or the accumulating consumer behavior module m1119, when executed and/or activated, directs performance of and/or performs the operation o1119 in the illustrative depiction as follows, and/or the operation o1119 is otherwise carried out in the illustrative depiction as follows: electronically accumulating (e.g. via pull-based, etc.) the residential food management information (e.g. cold packing, etc.) including (e.g. suggest, etc.) one or more food related residential conditions (e.g. shipment time required from farm through wholesaler to residential facility, etc.) affecting (e.g. suggest, etc.) residential service of (e.g. outside delivery of residential food item purchasing, etc.) one or more residential food items (e.g. cold dish main course residential food item, etc.) at least in part including information regarding consumer behavior with respect to one or more standards as logged (e.g. which residential food items are most popular as correlated with what farms and wholesalers were used to supply ingestible materials to constitute at least in part the residential food items, etc.).

In one or more implementations, as shown in FIG. 49, operation o11 includes an operation o1120 for electronically accumulating the residential food management information including one or more food related residential conditions affecting residential service of one or more residential food items at least in part including information regarding residential occupant associated handling of one or more food related residential conditions. Origination of an illustratively derived accumulating occupant handling component group can be accomplished through skilled in the art design choice selection of one or more of the above depicted components from one or more of the above depicted subsystems shown in FIG. 12. Components from the accumulating occupant handling component group can be used in implementing execution of the one or more accumulating occupant handling instructions i1120 of FIG. 29, can be used in performance of the accumulating occupant handling electrical circuitry arrangement e1120 of FIG. 22, and/or can be used in otherwise fulfillment of the operation o1120. An exemplary non-transitory signal bearing medium version of the information storage subsystem s200 is depicted in FIG. 29 as bearing the one or more accumulating occupant handling instructions i1120 that when executed will direct performance of the operation o1120. Furthermore, the accumulating occupant handling electrical circuitry arrangement (“elec circ arrange”) e1120, when activated, will perform the operation o1120. Also, the accumulating occupant handling module m1120, when executed and/or activated, will direct performance of and/or perform the operation o1120. For instance, in one or more exemplary implementations, the one or more accumulating occupant handling instructions i1120, when executed, direct performance of the operation o1120 in the illustrative depiction as follows, and/or the accumulating occupant handling electrical circuitry arrangement e1120, when activated, performs the operation o1120 in the illustrative depiction as follows, and/or the accumulating occupant handling module m1120, when executed and/or activated, directs performance of and/or performs the operation o1120 in the illustrative depiction as follows, and/or the operation o1120 is otherwise carried out in the illustrative depiction as follows: electronically accumulating (e.g. onto POP3 server, etc.) the residential food management information (e.g. oven operation, etc.) including (e.g. tangle, etc.) one or more food related residential conditions (e.g. maintenance procedure on residential equipment, etc.) affecting (e.g. tangle, etc.) residential service of (e.g. mobile kitchen residential food item purchasing, etc.) one or more residential food items (e.g. weight loss, etc.) at least in part including information regarding residential occupant associated handling of one or more food related residential conditions (e.g. compliance with maintenance and cleaning procedures for the residential food item preparation equipment, etc.).

In one or more implementations, as shown in FIG. 49, operation o11 includes an operation o1121 for electronically accumulating the residential food management information including one or more food related residential conditions affecting residential service of one or more residential food items at least in part including information regarding residential implementation aspect handling of food related residential conditions. Origination of an illustratively derived accumulating residential implementation component group can be accomplished through skilled in the art design choice selection of one or more of the above depicted components from one or more of the above depicted subsystems shown in FIG. 12. Components from the accumulating residential implementation component group can be used in implementing execution of the one or more accumulating residential implementation instructions i1121 of FIG. 29, can be used in performance of the accumulating residential implementation electrical circuitry arrangement e1121 of FIG. 22, and/or can be used in otherwise fulfillment of the operation o1121. An exemplary non-transitory signal bearing medium version of the information storage subsystem s200 is depicted in FIG. 29 as bearing the one or more accumulating residential implementation instructions i1121 that when executed will direct performance of the operation o1121. Furthermore, the accumulating residential implementation electrical circuitry arrangement (“elec circ arrange”) e1121, when activated, will perform the operation o1121. Also, the accumulating residential implementation module m1121, when executed and/or activated, will direct performance of and/or perform the operation o1121. For instance, in one or more exemplary implementations, the one or more accumulating residential implementation instructions i1121, when executed, direct performance of the operation o1121 in the illustrative depiction as follows, and/or the accumulating residential implementation electrical circuitry arrangement e1121, when activated, performs the operation o1121 in the illustrative depiction as follows, and/or the accumulating residential implementation module m1121, when executed and/or activated, directs performance of and/or performs the operation o1121 in the illustrative depiction as follows, and/or the operation o1121 is otherwise carried out in the illustrative depiction as follows: electronically accumulating (e.g. as hardware based encryption, etc.) the residential food management information (e.g. electricity usage, etc.) including (e.g. exclude, etc.) one or more food related residential conditions (e.g. cost of extra residential equipment rental, etc.) affecting (e.g. exclude, etc.) residential service of (e.g. in-home hospital residential food item purchasing, etc.) one or more residential food items (e.g. sports nutrition main course residential food item, etc.) at least in part including information regarding residential implementation aspect handling of food related residential conditions (e.g. handling of machines to prepare produce to be used in canning of such for residential food items, etc.).

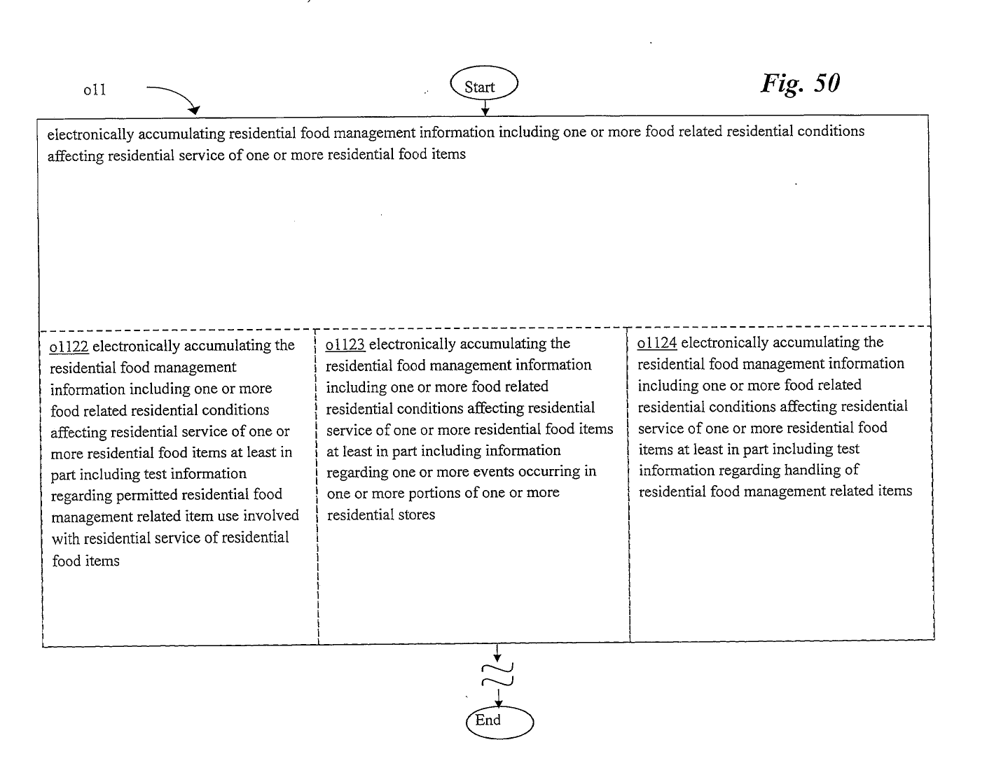

In one or more implementations, as shown in FIG. 50, operation o11 includes an operation o1122 for electronically accumulating the residential food management information including one or more food related residential conditions affecting residential service of one or more residential food items at least in part including test information regarding permitted residential food management related item use involved with residential service of residential food items. Origination of an illustratively derived accumulating permitted management component group can be accomplished through skilled in the art design choice selection of one or more of the above depicted components from one or more of the above depicted subsystems shown in FIG. 12. Components from the accumulating permitted management component group can be used in implementing execution of the one or more accumulating permitted management instructions i1122 of FIG. 29, can be used in performance of the accumulating permitted management electrical circuitry arrangement e1122 of FIG. 22, and/or can be used in otherwise fulfillment of the operation o1122. An exemplary non-transitory signal bearing medium version of the information storage subsystem s200 is depicted in FIG. 29 as bearing the one or more accumulating permitted management instructions i1122 that when executed will direct performance of the operation o1122. Furthermore, the accumulating permitted management electrical circuitry arrangement (“elec circ arrange”) e1122, when activated, will perform the operation o1122. Also, the accumulating permitted management module m1122, when executed and/or activated, will direct performance of and/or perform the operation o1122. For instance, in one or more exemplary implementations, the one or more accumulating permitted management instructions i1122, when executed, direct performance of the operation o1122 in the illustrative depiction as follows, and/or the accumulating permitted management electrical circuitry arrangement e1122, when activated, performs the operation o1122 in the illustrative depiction as follows, and/or the accumulating permitted management module m1122, when executed and/or activated, directs performance of and/or performs the operation o1122 in the illustrative depiction as follows, and/or the operation o1122 is otherwise carried out in the illustrative depiction as follows: electronically accumulating (e.g. as software based encryption, etc.) the residential food management information (e.g. refrigeration temperatures, etc.) including (e.g. bound, etc.) one or more food related residential conditions (e.g. residential equipment maintenance schedule, etc.) affecting (e.g. bound, etc.) residential service of (e.g. deli style residential food item purchasing, etc.) one or more residential food items (e.g. baked main course residential food item, etc.) at least in part including test information regarding permitted residential food management related item use involved with residential service of residential food items (e.g. testing for toxin levels with organic produce to confirm quality claims for the produce, etc.).

In one or more implementations, as shown in FIG. 50, operation o11 includes an operation o1123 for electronically accumulating the residential food management information including one or more food related residential conditions affecting residential service of one or more residential food items at least in part including information regarding one or more events occurring in one or more portions of one or more residential stores. Origination of an illustratively derived accumulating events residential component group can be accomplished through skilled in the art design choice selection of one or more of the above depicted components from one or more of the above depicted subsystems shown in FIG. 12. Components from the accumulating events residential component group can be used in implementing execution of the one or more accumulating events residential instructions i1123 of FIG. 29, can be used in performance of the accumulating events residential electrical circuitry arrangement e1123 of FIG. 22, and/or can be used in otherwise fulfillment of the operation o1123. An exemplary non-transitory signal bearing medium version of the information storage subsystem s200 is depicted in FIG. 29 as bearing the one or more accumulating events residential instructions i1123 that when executed will direct performance of the operation o1123. Furthermore, the accumulating events residential electrical circuitry arrangement (“elec circ arrange”) e1123, when activated, will perform the operation o1123. Also, the accumulating events residential module m1123, when executed and/or activated, will direct performance of and/or perform the operation o1123. For instance, in one or more exemplary implementations, the one or more accumulating events residential instructions i1123, when executed, direct performance of the operation o1123 in the illustrative depiction as follows, and/or the accumulating events residential electrical circuitry arrangement e1123, when activated, performs the operation o1123 in the illustrative depiction as follows, and/or the accumulating events residential module m1123, when executed and/or activated, directs performance of and/or performs the operation o1123 in the illustrative depiction as follows, and/or the operation o1123 is otherwise carried out in the illustrative depiction as follows: electronically accumulating (e.g. onto SD card, etc.) the residential food management information (e.g. sanitization protocol observance, etc.) including (e.g. requiring, etc.) one or more food related residential conditions (e.g. tool requirements for repair of residential equipment, etc.) affecting (e.g. requiring, etc.) residential service of (e.g. fine dining residential food item serving, etc.) one or more residential food items (e.g. fried main course residential food item, etc.) at least in part including information regarding one or more events occurring in one or more portions of one or more residential stores (e.g. health inspection of a warehouse and residential receiving areas, etc.).

In one or more implementations, as shown in FIG. 50, operation o11 includes an operation o1124 for electronically accumulating the residential food management information including one or more food related residential conditions affecting residential service of one or more residential food items at least in part including test information regarding handling of residential food management related items. Origination of an illustratively derived accumulating test handling component group can be accomplished through skilled in the art design choice selection of one or more of the above depicted components from one or more of the above depicted subsystems shown in FIG. 12. Components from the accumulating test handling component group can be used in implementing execution of the one or more accumulating test handling instructions i1124 of FIG. 29, can be used in performance of the accumulating test handling electrical circuitry arrangement e1124 of FIG. 22, and/or can be used in otherwise fulfillment of the operation o1124. An exemplary non-transitory signal bearing medium version of the information storage subsystem s200 is depicted in FIG. 29 as bearing the one or more accumulating test handling instructions i1124 that when executed will direct performance of the operation o1124. Furthermore, the accumulating test handling electrical circuitry arrangement (“elec circ arrange”) e1124, when activated, will perform the operation o1124. Also, the accumulating test handling module m1124, when executed and/or activated, will direct performance of and/or perform the operation o1124. For instance, in one or more exemplary implementations, the one or more accumulating test handling instructions i1124, when executed, direct performance of the operation o1124 in the illustrative depiction as follows, and/or the accumulating test handling electrical circuitry arrangement e1124, when activated, performs the operation o1124 in the illustrative depiction as follows, and/or the accumulating test handling module m1124, when executed and/or activated, directs performance of and/or performs the operation o1124 in the illustrative depiction as follows, and/or the operation o1124 is otherwise carried out in the illustrative depiction as follows: electronically accumulating (e.g. onto SIM card, etc.) the residential food management information (e.g. presence of insecticides in food, etc.) including (e.g. enveloped, etc.) one or more food related residential conditions (e.g. local regulations, etc.) affecting (e.g. enveloped, etc.) residential service of (e.g. fast residential food item serving, etc.) one or more residential food items (e.g. grilled main course residential food item, etc.) at least in part including test information regarding handling of residential food management related items (e.g. bacteria testing of surfaces used in preparing residential food items, etc.).

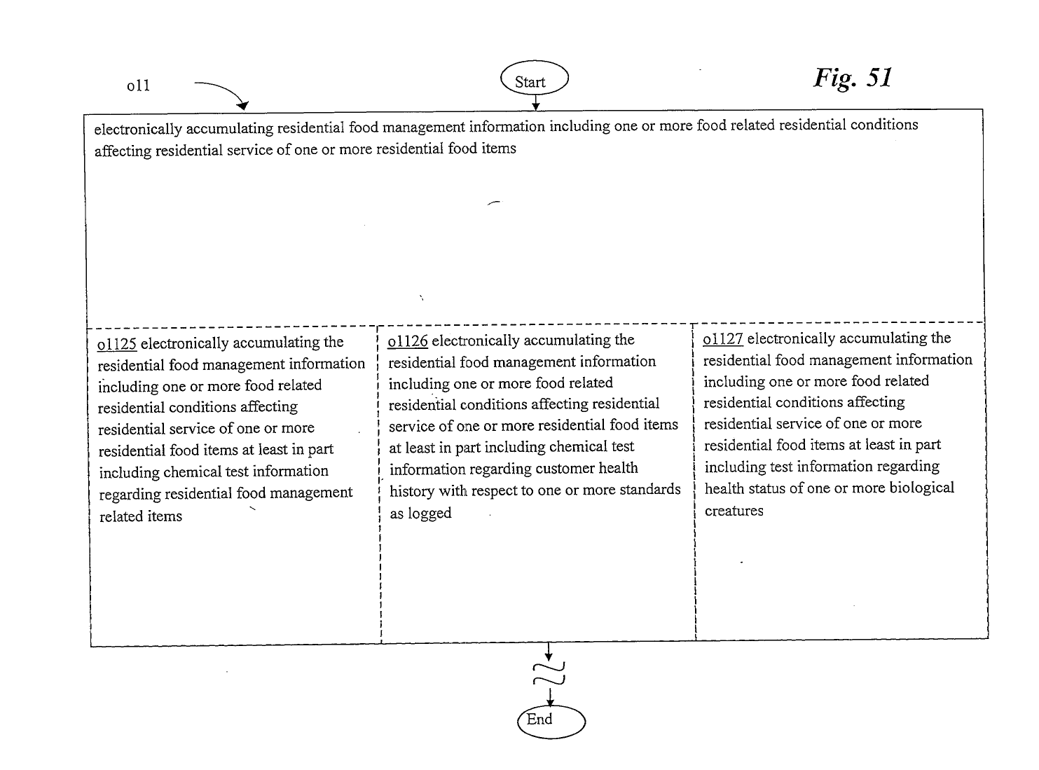

In one or more implementations, as shown in FIG. 51, operation o11 includes an operation o1125 for electronically accumulating the residential food management information including one or more food related residential conditions affecting residential service of one or more residential food items at least in part including chemical test information regarding residential food management related items. Origination of an illustratively derived accumulating chemical management component group can be accomplished through skilled in the art design choice selection of one or more of the above depicted components from one or more of the above depicted subsystems shown in FIG. 12. Components from the accumulating chemical management component group can be used in implementing execution of the one or more accumulating chemical management instructions i1125 of FIG. 29, can be used in performance of the accumulating chemical management electrical circuitry arrangement e1125 of FIG. 22, and/or can be used in otherwise fulfillment of the operation o1125. An exemplary non-transitory signal bearing medium version of the information storage subsystem s200 is depicted in FIG. 29 as bearing the one or more accumulating chemical management instructions i1125 that when executed will direct performance of the operation o1125. Furthermore, the accumulating chemical management electrical circuitry arrangement (“elec circ arrange”) e1125, when activated, will perform the operation o1125. Also, the accumulating chemical management module m1125, when executed and/or activated, will direct performance of and/or perform the operation o1125. For instance, in one or more exemplary implementations, the one or more accumulating chemical management instructions i1125, when executed, direct performance of the operation o1125 in the illustrative depiction as follows, and/or the accumulating chemical management electrical circuitry arrangement e1125, when activated, performs the operation o1125 in the illustrative depiction as follows, and/or the accumulating chemical management module m1125, when executed and/or activated, directs performance of and/or performs the operation o1125 in the illustrative depiction as follows, and/or the operation o1125 is otherwise carried out in the illustrative depiction as follows: electronically accumulating (e.g. from email, etc.) the residential food management information (e.g. preparation speed of residential occupants, etc.) including (e.g. envelope, etc.) one or more food related residential conditions (e.g. type of residential food items used by residential facility, etc.) affecting (e.g. envelope, etc.) residential service of (e.g. family buffet residential food item serving, etc.) one or more residential food items (e.g. steamed main course residential food item, etc.) at least in part including chemical test information regarding residential food management related items (e.g. residue testing to determine levels of toxins on surfaces used to prepare residential food items, etc.).

In one or more implementations, as shown in FIG. 51, operation o11 includes an operation o1126 for electronically accumulating the residential food management information including one or more food related residential conditions affecting residential service of one or more residential food items at least in part including chemical test information regarding customer health history with respect to one or more standards as logged. Origination of an illustratively derived accumulating health standards component group can be accomplished through skilled in the art design choice selection of one or more of the above depicted components from one or more of the above depicted subsystems shown in FIG. 12. Components from the accumulating health standards component group can be used in implementing execution of the one or more accumulating health standards instructions i1126 of FIG. 29, can be used in performance of the accumulating health standards electrical circuitry arrangement e1126 of FIG. 22, and/or can be used in otherwise fulfillment of the operation o1126. An exemplary non-transitory signal bearing medium version of the information storage subsystem s200 is depicted in FIG. 29 as bearing the one or more accumulating health standards instructions i1126 that when executed will direct performance of the operation o1126. Furthermore, the accumulating health standards electrical circuitry arrangement (“elec circ arrange”) e1126, when activated, will perform the operation o1126. Also, the accumulating health standards module m1126, when executed and/or activated, will direct performance of and/or perform the operation o1126. For instance, in one or more exemplary implementations, the one or more accumulating health standards instructions i1126, when executed, direct performance of the operation o1126 in the illustrative depiction as follows, and/or the accumulating health standards electrical circuitry arrangement e1126, when activated, performs the operation o1126 in the illustrative depiction as follows, and/or the accumulating health standards module m1126, when executed and/or activated, directs performance of and/or performs the operation o1126 in the illustrative depiction as follows, and/or the operation o1126 is otherwise carried out in the illustrative depiction as follows: electronically accumulating (e.g. via peer to peer, etc.) the residential food management information (e.g. residential labor force scheduling, etc.) including (e.g. associate with, etc.) one or more food related residential conditions (e.g. demographic location of residential facility, etc.) affecting (e.g. associate with, etc.) residential service of (e.g. mobile lifestyle residential food item serving, etc.) one or more residential food items (e.g. chilled main course residential food item, etc.) at least in part including chemical test information regarding customer health history with respect to one or more standards as logged (e.g. public testing results for outbreaks of illness generally found in the public, etc.).

In one or more implementations, as shown in FIG. 51, operation o11 includes an operation o1127 for electronically accumulating the residential food management information including one or more food related residential conditions affecting residential service of one or more residential food items at least in part including test information regarding health status of one or more biological creatures. Origination of an illustratively derived accumulating health biological component group can be accomplished through skilled in the art design choice selection of one or more of the above depicted components from one or more of the above depicted subsystems shown in FIG. 12. Components from the accumulating health biological component group can be used in implementing execution of the one or more accumulating health biological instructions i1127 of FIG. 29, can be used in performance of the accumulating health biological electrical circuitry arrangement e1127 of FIG. 22, and/or can be used in otherwise fulfillment of the operation o1127. An exemplary non-transitory signal bearing medium version of the information storage subsystem s200 is depicted in FIG. 29 as bearing the one or more accumulating health biological instructions i1127 that when executed will direct performance of the operation o1127. Furthermore, the accumulating health biological electrical circuitry arrangement (“elec circ arrange”) e1127, when activated, will perform the operation o1127. Also, the accumulating health biological module m1127, when executed and/or activated, will direct performance of and/or perform the operation o1127. For instance, in one or more exemplary implementations, the one or more accumulating health biological instructions i1127, when executed, direct performance of the operation o1127 in the illustrative depiction as follows, and/or the accumulating health biological electrical circuitry arrangement e1127, when activated, performs the operation o1127 in the illustrative depiction as follows, and/or the accumulating health biological module m1127, when executed and/or activated, directs performance of and/or performs the operation o1127 in the illustrative depiction as follows, and/or the operation o1127 is otherwise carried out in the illustrative depiction as follows: electronically accumulating (e.g. from 10-key, etc.) the residential food management information (e.g. future market demands, etc.) including (e.g. embroil, etc.) one or more food related residential conditions (e.g. age of equipment used in the residential facility, etc.) affecting (e.g. embroil, etc.) residential service of (e.g. institutional residential food item serving, etc.) one or more residential food items (e.g. microwaved main course residential food item, etc.) at least in part including test information regarding health status of one or more biological creatures (e.g. infectious disease testing of farm animals used in residential food items, etc.).

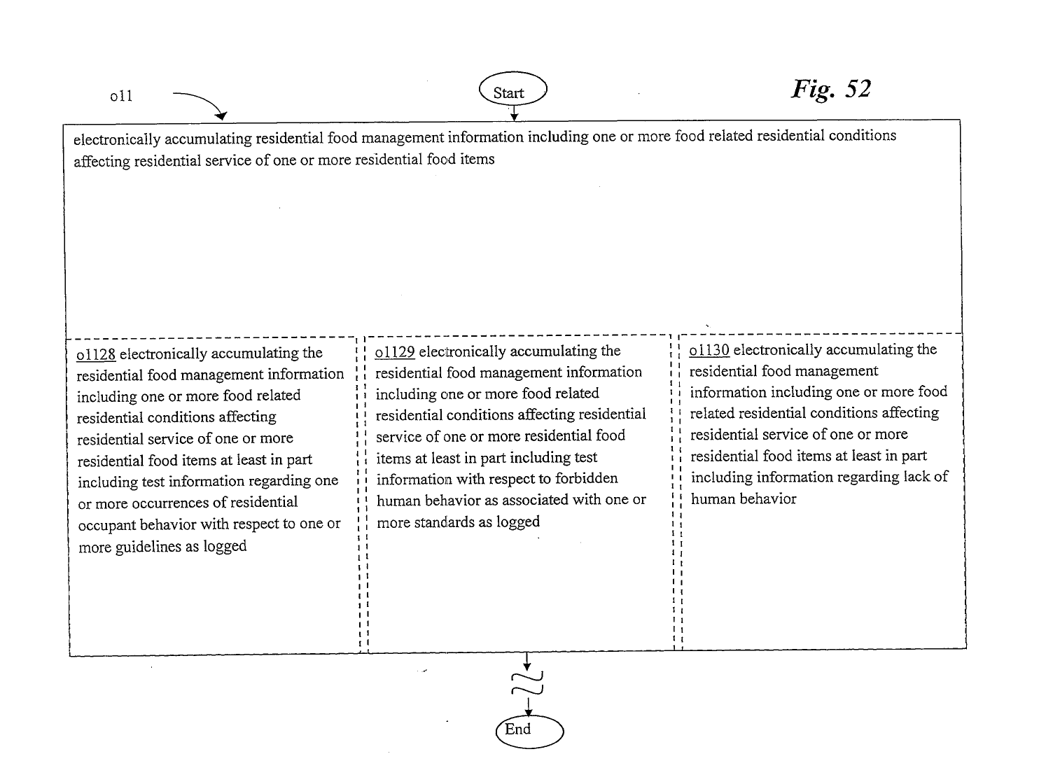

In one or more implementations, as shown in FIG. 52, operation o11 includes an operation o1128 for electronically accumulating the residential food management information including one or more food related residential conditions affecting residential service of one or more residential food items at least in part including test information regarding one or more occurrences of residential occupant behavior with respect to one or more guidelines as logged. Origination of an illustratively derived accumulating occupant guidelines component group can be accomplished through skilled in the art design choice selection of one or more of the above depicted components from one or more of the above depicted subsystems shown in FIG. 12. Components from the accumulating occupant guidelines component group can be used in implementing execution of the one or more accumulating occupant guidelines instructions i1128 of FIG. 29, can be used in performance of the accumulating occupant guidelines electrical circuitry arrangement e1128 of FIG. 22, and/or can be used in otherwise fulfillment of the operation o1128. An exemplary non-transitory signal bearing medium version of the information storage subsystem s200 is depicted in FIG. 29 as bearing the one or more accumulating occupant guidelines instructions i1128 that when executed will direct performance of the operation o1128. Furthermore, the accumulating occupant guidelines electrical circuitry arrangement (“elec circ arrange”) e1128, when activated, will perform the operation o1128. Also, the accumulating occupant guidelines module m1128, when executed and/or activated, will direct performance of and/or perform the operation o1128. For instance, in one or more exemplary implementations, the one or more accumulating occupant guidelines instructions i1128, when executed, direct performance of the operation o1128 in the illustrative depiction as follows, and/or the accumulating occupant guidelines electrical circuitry arrangement e1128, when activated, performs the operation o1128 in the illustrative depiction as follows, and/or the accumulating occupant guidelines module m1128, when executed and/or activated, directs performance of and/or performs the operation o1128 in the illustrative depiction as follows, and/or the operation o1128 is otherwise carried out in the illustrative depiction as follows: electronically accumulating (e.g. from USB port, etc.) the residential food management information (e.g. improper data calculation, etc.) including (e.g. take in, etc.) one or more food related residential conditions (e.g. distribution of various type of residential food items used, etc.) affecting (e.g. take in, etc.) residential service of (e.g. large family cafeteria residential food item serving, etc.) one or more residential food items (e.g. convection oven prepared main course residential food item, etc.) at least in part including test information regarding one or more occurrences of residential occupant behavior with respect to one or more guidelines as logged (e.g. residential occupant hygiene habits, etc.).

In one or more implementations, as shown in FIG. 52, operation o11 includes an operation o1129 for electronically accumulating the residential food management information including one or more food related residential conditions affecting residential service of one or more residential food items at least in part including test information with respect to forbidden human behavior as associated with one or more standards as logged. Origination of an illustratively derived accumulating forbidden behavior component group can be accomplished through skilled in the art design choice selection of one or more of the above depicted components from one or more of the above depicted subsystems shown in FIG. 12. Components from the accumulating forbidden behavior component group can be used in implementing execution of the one or more accumulating forbidden behavior instructions i1129 of FIG. 29, can be used in performance of the accumulating forbidden behavior electrical circuitry arrangement e1129 of FIG. 22, and/or can be used in otherwise fulfillment of the operation o1129. An exemplary non-transitory signal bearing medium version of the information storage subsystem s200 is depicted in FIG. 29 as bearing the one or more accumulating forbidden behavior instructions i1129 that when executed will direct performance of the operation o1129. Furthermore, the accumulating forbidden behavior electrical circuitry arrangement (“elec circ arrange”) e1129, when activated, will perform the operation o1129. Also, the accumulating forbidden behavior module m1129, when executed and/or activated, will direct performance of and/or perform the operation o1129. For instance, in one or more exemplary implementations, the one or more accumulating forbidden behavior instructions i1129, when executed, direct performance of the operation o1129 in the illustrative depiction as follows, and/or the accumulating forbidden behavior electrical circuitry arrangement e1129, when activated, performs the operation o1129 in the illustrative depiction as follows, and/or the accumulating forbidden behavior module m1129, when executed and/or activated, directs performance of and/or performs the operation o1129 in the illustrative depiction as follows, and/or the operation o1129 is otherwise carried out in the illustrative depiction as follows: electronically accumulating (e.g. as FTP, etc.) the residential food management information (e.g. infestation of residence, etc.) including (e.g. comprised of, etc.) one or more food related residential conditions (e.g. labor laws for hired workers in residential facility, etc.) affecting (e.g. comprised of, etc.) residential service of (e.g. in-home nursing home residential food item serving, etc.) one or more residential food items (e.g. smoked main course residential food item, etc.) at least in part including test information with respect to forbidden human behavior as associated with one or more standards as logged (e.g. lack of sanitary measures performed by residential occupants, etc.).

In one or more implementations, as shown in FIG. 52, operation o11 includes an operation o1130 for electronically accumulating the residential food management information including one or more food related residential conditions affecting residential service of one or more residential food items at least in part including information regarding lack of human behavior. Origination of an illustratively derived accumulating lack behavior component group can be accomplished through skilled in the art design choice selection of one or more of the above depicted components from one or more of the above depicted subsystems shown in FIG. 12. Components from the accumulating lack behavior component group can be used in implementing execution of the one or more accumulating lack behavior instructions i1130 of FIG. 29, can be used in performance of the accumulating lack behavior electrical circuitry arrangement e1130 of FIG. 22, and/or can be used in otherwise fulfillment of the operation o1130. An exemplary non-transitory signal bearing medium version of the information storage subsystem s200 is depicted in FIG. 29 as bearing the one or more accumulating lack behavior instructions i1130 that when executed will direct performance of the operation o1130. Furthermore, the accumulating lack behavior electrical circuitry arrangement (“elec circ arrange”) e1130, when activated, will perform the operation o1130. Also, the accumulating lack behavior module m1130, when executed and/or activated, will direct performance of and/or perform the operation o1130. For instance, in one or more exemplary implementations, the one or more accumulating lack behavior instructions i1130, when executed, direct performance of the operation o1130 in the illustrative depiction as follows, and/or the accumulating lack behavior electrical circuitry arrangement e1130, when activated, performs the operation o1130 in the illustrative depiction as follows, and/or the accumulating lack behavior module m1130, when executed and/or activated, directs performance of and/or performs the operation o1130 in the illustrative depiction as follows, and/or the operation o1130 is otherwise carried out in the illustrative depiction as follows: electronically accumulating (e.g. as HTTP, etc.) the residential food management information (e.g. sanitizer usage, etc.) including (e.g. comprehend, etc.) one or more food related residential conditions (e.g. safety regulations, etc.) affecting (e.g. comprehend, etc.) residential service of (e.g. outside delivery of residential food item serving, etc.) one or more residential food items (e.g. boiled main course residential food item, etc.) at least in part including information regarding lack of human behavior (e.g. degree of absence of human supervisors during testing procedures, etc.).

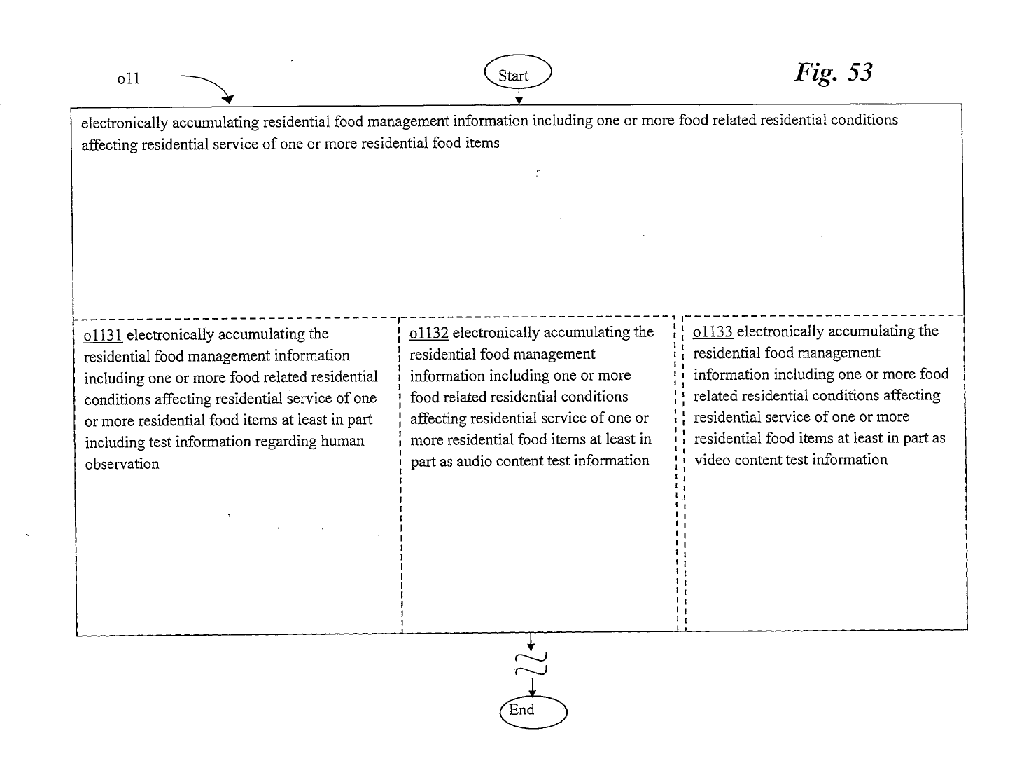

In one or more implementations, as shown in FIG. 53, operation o11 includes an operation o1131 for electronically accumulating the residential food management information including one or more food related residential conditions affecting residential service of one or more residential food items at least in part including test information regarding human observation. Origination of an illustratively derived accumulating test observation component group can be accomplished through skilled in the art design choice selection of one or more of the above depicted components from one or more of the above depicted subsystems shown in FIG. 12. Components from the accumulating test observation component group can be used in implementing execution of the one or more accumulating test observation instructions i1131 of FIG. 29, can be used in performance of the accumulating test observation electrical circuitry arrangement e1131 of FIG. 22, and/or can be used in otherwise fulfillment of the operation o1131. An exemplary non-transitory signal bearing medium version of the information storage subsystem s200 is depicted in FIG. 29 as bearing the one or more accumulating test observation instructions i1131 that when executed will direct performance of the operation o1131. Furthermore, the accumulating test observation electrical circuitry arrangement (“elec circ arrange”) e1131, when activated, will perform the operation o1131. Also, the accumulating test observation module m1131, when executed and/or activated, will direct performance of and/or perform the operation o1131. For instance, in one or more exemplary implementations, the one or more accumulating test observation instructions i1131, when executed, direct performance of the operation o1131 in the illustrative depiction as follows, and/or the accumulating test observation electrical circuitry arrangement e1131, when activated, performs the operation o1131 in the illustrative depiction as follows, and/or the accumulating test observation module m1131, when executed and/or activated, directs performance of and/or performs the operation o1131 in the illustrative depiction as follows, and/or the operation o1131 is otherwise carried out in the illustrative depiction as follows: electronically accumulating (e.g. from bittorent, etc.) the residential food management information (e.g. cleaning protocols implemented, etc.) including (e.g. associated, etc.) one or more food related residential conditions (e.g. neighboring residential facilities, etc.) affecting (e.g. associated, etc.) residential service of (e.g. mobile kitchen residential food item serving, etc.) one or more residential food items (e.g. sandwich main course residential food item, etc.) at least in part including test information regarding human observation (e.g. human perception of residential food stuffs regarding their level of quality, etc.).

In one or more implementations, as shown in FIG. 53, operation o11 includes an operation o1132 for electronically accumulating the residential food management information including one or more food related residential conditions affecting residential service of one or more residential food items at least in part as audio content test information. Origination of an illustratively derived accumulating audio test component group can be accomplished through skilled in the art design choice selection of one or more of the above depicted components from one or more of the above depicted subsystems shown in FIG. 12. Components from the accumulating audio test component group can be used in implementing execution of the one or more accumulating audio test instructions i1132 of FIG. 29, can be used in performance of the accumulating audio test electrical circuitry arrangement e1132 of FIG. 22, and/or can be used in otherwise fulfillment of the operation o1132. An exemplary non-transitory signal bearing medium version of the information storage subsystem s200 is depicted in FIG. 29 as bearing the one or more accumulating audio test instructions i1132 that when executed will direct performance of the operation o1132. Furthermore, the accumulating audio test electrical circuitry arrangement (“elec circ arrange”) e1132, when activated, will perform the operation o1132. Also, the accumulating audio test module m1132, when executed and/or activated, will direct performance of and/or perform the operation o1132. For instance, in one or more exemplary implementations, the one or more accumulating audio test instructions i1132, when executed, direct performance of the operation o1132 in the illustrative depiction as follows, and/or the accumulating audio test electrical circuitry arrangement e1132, when activated, performs the operation o1132 in the illustrative depiction as follows, and/or the accumulating audio test module m1132, when executed and/or activated, directs performance of and/or performs the operation o1132 in the illustrative depiction as follows, and/or the operation o1132 is otherwise carried out in the illustrative depiction as follows: electronically accumulating (e.g. from gnutella, etc.) the residential food management information (e.g. humidity of storage units, etc.) including (e.g. affected, etc.) one or more food related residential conditions (e.g. any quarantines imposed in surrounding area, etc.) affecting (e.g. affected, etc.) residential service of (e.g. in-home hospital residential food item serving, etc.) one or more residential food items (e.g. rotisserie main course residential food item, etc.) at least in part as audio content test information (e.g. residential tester verbal comments regarding residential food item quality, etc.).

In one or more implementations, as shown in FIG. 53, operation o11 includes an operation o1133 for electronically accumulating the residential food management information including one or more food related residential conditions affecting residential service of one or more residential food items at least in part as video content test information. Origination of an illustratively derived accumulating video test component group can be accomplished through skilled in the art design choice selection of one or more of the above depicted components from one or more of the above depicted subsystems shown in FIG. 12. Components from the accumulating video test component group can be used in implementing execution of the one or more accumulating video test instructions i1133 of FIG. 29, can be used in performance of the accumulating video test electrical circuitry arrangement e1133 of FIG. 22, and/or can be used in otherwise fulfillment of the operation o1133. An exemplary non-transitory signal bearing medium version of the information storage subsystem s200 is depicted in FIG. 29 as bearing the one or more accumulating video test instructions i1133 that when executed will direct performance of the operation o1133. Furthermore, the accumulating video test electrical circuitry arrangement (“elec circ arrange”) e1133, when activated, will perform the operation o1133. Also, the accumulating video test module m1133, when executed and/or activated, will direct performance of and/or perform the operation o1133. For instance, in one or more exemplary implementations, the one or more accumulating video test instructions i1133, when executed, direct performance of the operation o1133 in the illustrative depiction as follows, and/or the accumulating video test electrical circuitry arrangement e1133, when activated, performs the operation o1133 in the illustrative depiction as follows, and/or the accumulating video test module m1133, when executed and/or activated, directs performance of and/or performs the operation o1133 in the illustrative depiction as follows, and/or the operation o1133 is otherwise carried out in the illustrative depiction as follows: electronically accumulating (e.g. via TCP/IP, etc.) the residential food management information (e.g. oxygen sensor of storage equipment, etc.) including (e.g. affecting, etc.) one or more food related residential conditions (e.g. pesticide levels of food materials for residential food items, etc.) affecting (e.g. affecting, etc.) residential service of (e.g. deli style residential food item serving, etc.) one or more residential food items (e.g. braised main course residential food item, etc.) at least in part as video content test information (e.g. video recording of residential food item testing procedures, etc.).

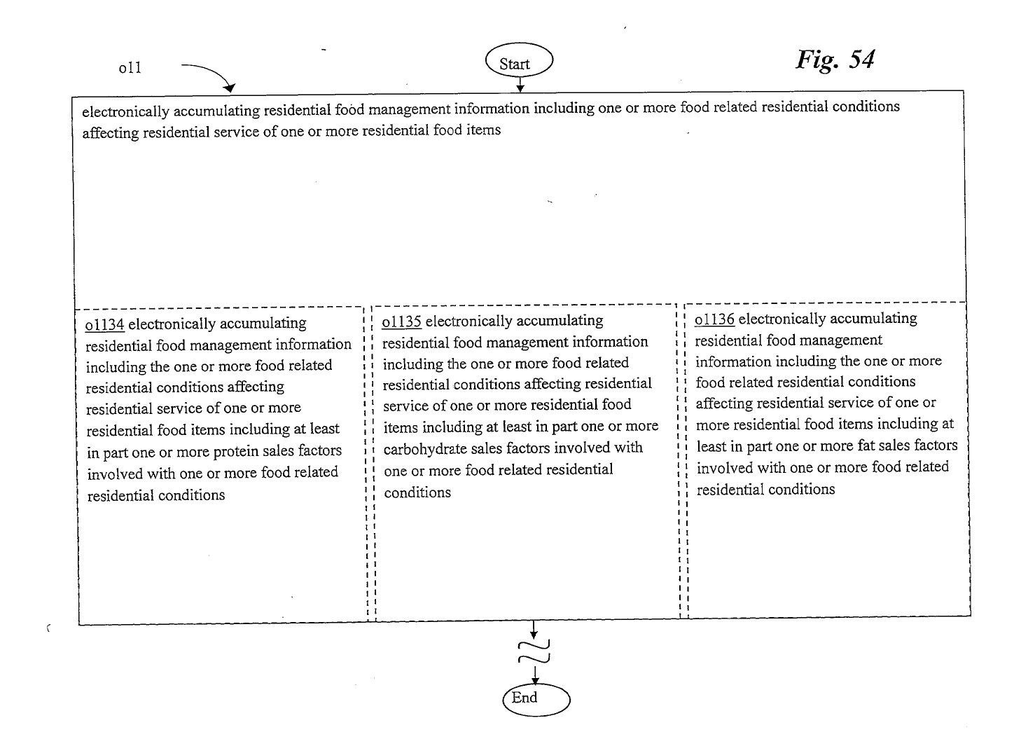

In one or more implementations, as shown in FIG. 54, operation o11 includes an operation o1134 for electronically accumulating residential food management information including the one or more food related residential conditions affecting residential service of one or more residential food items including at least in part one or more protein sales factors involved with one or more food related residential conditions. Origination of an illustratively derived accumulating protein factors component group can be accomplished through skilled in the art design choice selection of one or more of the above depicted components from one or more of the above depicted subsystems shown in FIG. 12. Components from the accumulating protein factors component group can be used in implementing execution of the one or more accumulating protein factors instructions i1134 of FIG. 29, can be used in performance of the accumulating protein factors electrical circuitry arrangement e1134 of FIG. 22, and/or can be used in otherwise fulfillment of the operation o1134. An exemplary non-transitory signal bearing medium version of the information storage subsystem s200 is depicted in FIG. 29 as bearing the one or more accumulating protein factors instructions i1134 that when executed will direct performance of the operation o1134. Furthermore, the accumulating protein factors electrical circuitry arrangement (“elec circ arrange”) e1134, when activated, will perform the operation o1134. Also, the accumulating protein factors module m1134, when executed and/or activated, will direct performance of and/or perform the operation o1134. For instance, in one or more exemplary implementations, the one or more accumulating protein factors instructions i1134, when executed, direct performance of the operation o1134 in the illustrative depiction as follows, and/or the accumulating protein factors electrical circuitry arrangement e1134, when activated, performs the operation o1134 in the illustrative depiction as follows, and/or the accumulating protein factors module m1134, when executed and/or activated, directs performance of and/or performs the operation o1134 in the illustrative depiction as follows, and/or the operation o1134 is otherwise carried out in the illustrative depiction as follows: electronically accumulating (e.g. from RS-232, etc.) residential food management information (e.g. carton psi, etc.) including (e.g. argue, etc.) the one or more food related residential conditions (e.g. type of sanitizers used, etc.) affecting (e.g. argue, etc.) residential service of (e.g. fine dining residential food item receiving, etc.) one or more residential food items (e.g. sous-vide main course residential food item, etc.) including at least in part one or more protein sales factors involved with one or more food related residential conditions (e.g. highest demand sources of beef used in residential food items, etc.).

In one or more implementations, as shown in FIG. 54, operation o11 includes an operation o1135 for electronically accumulating residential food management information including the one or more food related residential conditions affecting residential service of one or more residential food items including at least in part one or more carbohydrate sales factors involved with one or more food related residential conditions. Origination of an illustratively derived accumulating carbohydrate factors component group can be accomplished through skilled in the art design choice selection of one or more of the above depicted components from one or more of the above depicted subsystems shown in FIG. 12. Components from the accumulating carbohydrate factors component group can be used in implementing execution of the one or more accumulating carbohydrate factors instructions i1135 of FIG. 29, can be used in performance of the accumulating carbohydrate factors electrical circuitry arrangement e1135 of FIG. 22, and/or can be used in otherwise fulfillment of the operation o1135. An exemplary non-transitory signal bearing medium version of the information storage subsystem s200 is depicted in FIG. 29 as bearing the one or more accumulating carbohydrate factors instructions i1135 that when executed will direct performance of the operation o1135. Furthermore, the accumulating carbohydrate factors electrical circuitry arrangement (“elec circ arrange”) e1135, when activated, will perform the operation o1135. Also, the accumulating carbohydrate factors module m1135, when executed and/or activated, will direct performance of and/or perform the operation o1135. For instance, in one or more exemplary implementations, the one or more accumulating carbohydrate factors instructions i1135, when executed, direct performance of the operation o1135 in the illustrative depiction as follows, and/or the accumulating carbohydrate factors electrical circuitry arrangement e1135, when activated, performs the operation o1135 in the illustrative depiction as follows, and/or the accumulating carbohydrate factors module m1135, when executed and/or activated, directs performance of and/or performs the operation o1135 in the illustrative depiction as follows, and/or the operation o1135 is otherwise carried out in the illustrative depiction as follows: electronically accumulating (e.g. from tablet entry, etc.) residential food management information (e.g. carton in Hg, etc.) including (e.g. connected, etc.) the one or more food related residential conditions (e.g. whether any GMO foods are used, etc.) affecting (e.g. connected, etc.) residential service of (e.g. fast residential food item receiving, etc.) one or more residential food items (e.g. blended main course residential food item, etc.) including at least in part one or more carbohydrate sales factors involved with one or more food related residential conditions (e.g. sales records of GMO carbohydrate based residential food items, etc.).

In one or more implementations, as shown in FIG. 54, operation o11 includes an operation o1136 for electronically accumulating residential food management information including the one or more food related residential conditions affecting residential service of one or more residential food items including at least in part one or more fat sales factors involved with one or more food related residential conditions. Origination of an illustratively derived accumulating fat factors component group can be accomplished through skilled in the art design choice selection of one or more of the above depicted components from one or more of the above depicted subsystems shown in FIG. 12. Components from the accumulating fat factors component group can be used in implementing execution of the one or more accumulating fat factors instructions i1136 of FIG. 29, can be used in performance of the accumulating fat factors electrical circuitry arrangement e1136 of FIG. 22, and/or can be used in otherwise fulfillment of the operation o1136. An exemplary non-transitory signal bearing medium version of the information storage subsystem s200 is depicted in FIG. 29 as bearing the one or more accumulating fat factors instructions i1136 that when executed will direct performance of the operation o1136. Furthermore, the accumulating fat factors electrical circuitry arrangement (“elec circ arrange”) e1136, when activated, will perform the operation o1136. Also, the accumulating fat factors module m1136, when executed and/or activated, will direct performance of and/or perform the operation o1136. For instance, in one or more exemplary implementations, the one or more accumulating fat factors instructions i1136, when executed, direct performance of the operation o1136 in the illustrative depiction as follows, and/or the accumulating fat factors electrical circuitry arrangement e1136, when activated, performs the operation o1136 in the illustrative depiction as follows, and/or the accumulating fat factors module m1136, when executed and/or activated, directs performance of and/or performs the operation o1136 in the illustrative depiction as follows, and/or the operation o1136 is otherwise carried out in the illustrative depiction as follows: electronically accumulating (e.g. from PDA entry, etc.) residential food management information (e.g. equipment maintenance, etc.) including (e.g. commit to, etc.) the one or more food related residential conditions (e.g. instances of health violations in residential facilities, etc.) affecting (e.g. commit to, etc.) residential service of (e.g. family buffet residential food item receiving, etc.) one or more residential food items (e.g. beverage main course residential food item, etc.) including at least in part one or more fat sales factors involved with one or more food related residential conditions (e.g. instances of health violations in handling of oils to be used as residential food items, etc.).

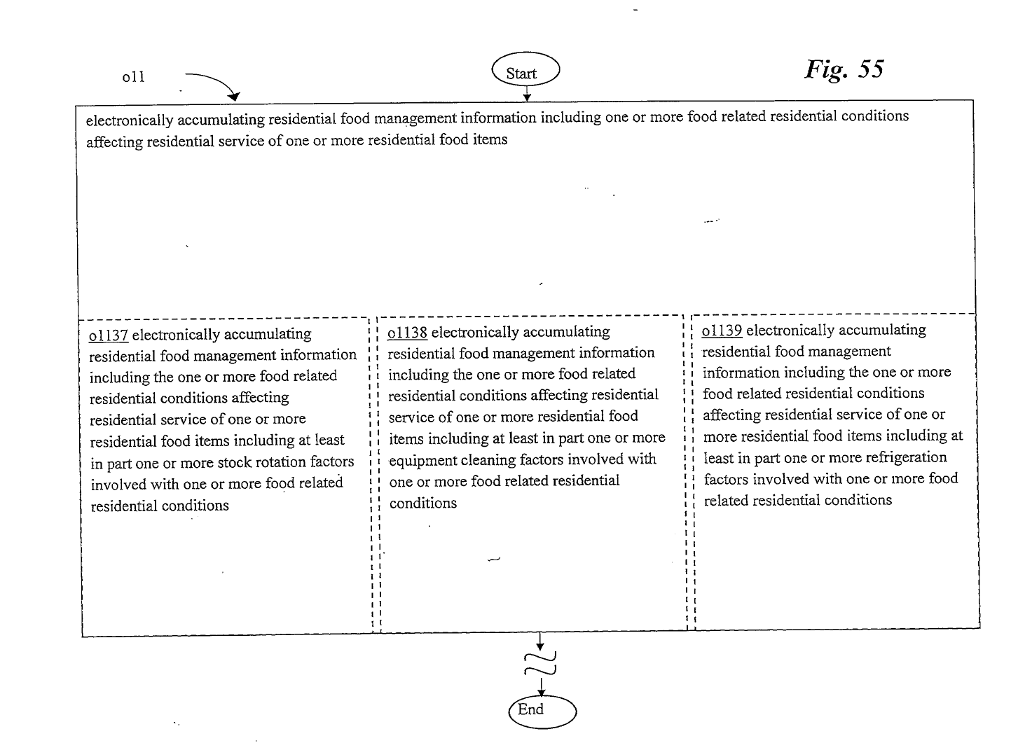

In one or more implementations, as shown in FIG. 55, operation o11 includes an operation o1137 for electronically accumulating residential food management information including the one or more food related residential conditions affecting residential service of one or more residential food items including at least in part one or more stock rotation factors involved with one or more food related residential conditions. Origination of an illustratively derived accumulating stock rotation component group can be accomplished through skilled in the art design choice selection of one or more of the above depicted components from one or more of the above depicted subsystems shown in FIG. 12. Components from the accumulating stock rotation component group can be used in implementing execution of the one or more accumulating stock rotation instructions i1137 of FIG. 29, can be used in performance of the accumulating stock rotation electrical circuitry arrangement e1137 of FIG. 22, and/or can be used in otherwise fulfillment of the operation o1137. An exemplary non-transitory signal bearing medium version of the information storage subsystem s200 is depicted in FIG. 29 as bearing the one or more accumulating stock rotation instructions i1137 that when executed will direct performance of the operation o1137. Furthermore, the accumulating stock rotation electrical circuitry arrangement (“elec circ arrange”) e1137, when activated, will perform the operation o1137. Also, the accumulating stock rotation module m1137, when executed and/or activated, will direct performance of and/or perform the operation o1137. For instance, in one or more exemplary implementations, the one or more accumulating stock rotation instructions i1137, when executed, direct performance of the operation o1137 in the illustrative depiction as follows, and/or the accumulating stock rotation electrical circuitry arrangement e1137, when activated, performs the operation o1137 in the illustrative depiction as follows, and/or the accumulating stock rotation module m1137, when executed and/or activated, directs performance of and/or performs the operation o1137 in the illustrative depiction as follows, and/or the operation o1137 is otherwise carried out in the illustrative depiction as follows: electronically accumulating (e.g. from desktop entry, etc.) residential food management information (e.g. nitrogen gas levels of storage units, etc.) including (e.g. absorbed by, etc.) the one or more food related residential conditions (e.g. purchasing patterns from wholesalers, etc.) affecting (e.g. absorbed by, etc.) residential service of (e.g. mobile lifestyle residential food item receiving, etc.) one or more residential food items (e.g. protein main course residential food item, etc.) including at least in part one or more stock rotation factors involved with one or more food related residential conditions (e.g. availability patterns from wholesalers as it impacts stock rotations, etc.).

In one or more implementations, as shown in FIG. 55, operation o11 includes an operation o1138 for electronically accumulating residential food management information including the one or more food related residential conditions affecting residential service of one or more residential food items including at least in part one or more equipment cleaning factors involved with one or more food related residential conditions. Origination of an illustratively derived accumulating equipment cleaning component group can be accomplished through skilled in the art design choice selection of one or more of the above depicted components from one or more of the above depicted subsystems shown in FIG. 12. Components from the accumulating equipment cleaning component group can be used in implementing execution of the one or more accumulating equipment cleaning instructions i1138 of FIG. 29, can be used in performance of the accumulating equipment cleaning electrical circuitry arrangement e1138 of FIG. 22, and/or can be used in otherwise fulfillment of the operation o1138. An exemplary non-transitory signal bearing medium version of the information storage subsystem s200 is depicted in FIG. 29 as bearing the one or more accumulating equipment cleaning instructions i1138 that when executed will direct performance of the operation o1138. Furthermore, the accumulating equipment cleaning electrical circuitry arrangement (“elec circ arrange”) e1138, when activated, will perform the operation o1138. Also, the accumulating equipment cleaning module m1138, when executed and/or activated, will direct performance of and/or perform the operation o1138. For instance, in one or more exemplary implementations, the one or more accumulating equipment cleaning instructions i1138, when executed, direct performance of the operation o1138 in the illustrative depiction as follows, and/or the accumulating equipment cleaning electrical circuitry arrangement e1138, when activated, performs the operation o1138 in the illustrative depiction as follows, and/or the accumulating equipment cleaning module m1138, when executed and/or activated, directs performance of and/or performs the operation o1138 in the illustrative depiction as follows, and/or the operation o1138 is otherwise carried out in the illustrative depiction as follows: electronically accumulating (e.g. as acoustic energy, etc.) residential food management information (e.g. amount of waste to disposed of, etc.) including (e.g. embraced by, etc.) the one or more food related residential conditions (e.g. rodent infestation history, etc.) affecting (e.g. embraced by, etc.) residential service of (e.g. institutional residential food item receiving, etc.) one or more residential food items (e.g. carbohydrate main course residential food item, etc.) including at least in part one or more equipment cleaning factors involved with one or more food related residential conditions (e.g. rodent infestation history, etc.).

In one or more implementations, as shown in FIG. 55, operation o11 includes an operation o1139 for electronically accumulating residential food management information including the one or more food related residential conditions affecting residential service of one or more residential food items including at least in part one or more refrigeration factors involved with one or more food related residential conditions. Origination of an illustratively derived accumulating refrigeration factors component group can be accomplished through skilled in the art design choice selection of one or more of the above depicted components from one or more of the above depicted subsystems shown in FIG. 12. Components from the accumulating refrigeration factors component group can be used in implementing execution of the one or more accumulating refrigeration factors instructions i1139 of FIG. 29, can be used in performance of the accumulating refrigeration factors electrical circuitry arrangement e1139 of FIG. 22, and/or can be used in otherwise fulfillment of the operation o1139. An exemplary non-transitory signal bearing medium version of the information storage subsystem s200 is depicted in FIG. 29 as bearing the one or more accumulating refrigeration factors instructions i1139 that when executed will direct performance of the operation o1139. Furthermore, the accumulating refrigeration factors electrical circuitry arrangement (“elec circ arrange”) e1139, when activated, will perform the operation o1139. Also, the accumulating refrigeration factors module m1139, when executed and/or activated, will direct performance of and/or perform the operation o1139. For instance, in one or more exemplary implementations, the one or more accumulating refrigeration factors instructions i1139, when executed, direct performance of the operation o1139 in the illustrative depiction as follows, and/or the accumulating refrigeration factors electrical circuitry arrangement e1139, when activated, performs the operation o1139 in the illustrative depiction as follows, and/or the accumulating refrigeration factors module m1139, when executed and/or activated, directs performance of and/or performs the operation o1139 in the illustrative depiction as follows, and/or the operation o1139 is otherwise carried out in the illustrative depiction as follows: electronically accumulating (e.g. from VHF, etc.) residential food management information (e.g. carrier information for residential shipments, etc.) including (e.g. containing, etc.) the one or more food related residential conditions (e.g. recycling practices implemented, etc.) affecting (e.g. containing, etc.) residential service of (e.g. large family cafeteria residential food item receiving, etc.) one or more residential food items (e.g. fat dominant main course residential food item, etc.) including at least in part one or more refrigeration factors involved with one or more food related residential conditions (e.g. operational temperature profiles for refrigeration systems, etc.).

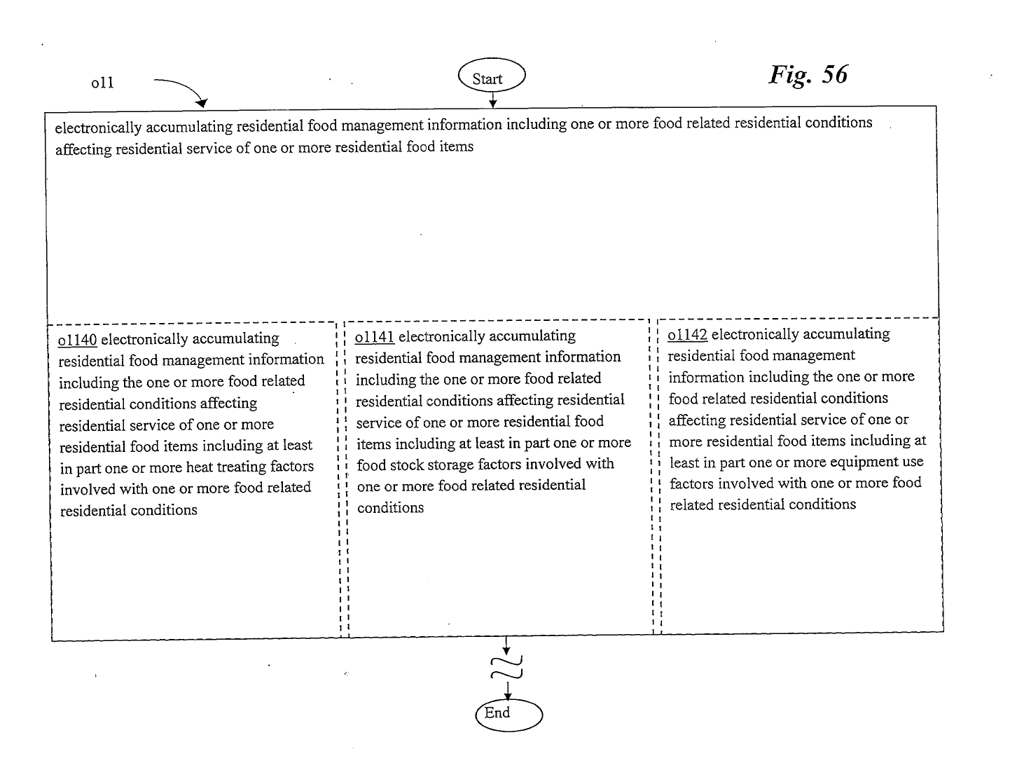

In one or more implementations, as shown in FIG. 56, operation o11 includes an operation o1140 for electronically accumulating residential food management information including the one or more food related residential conditions affecting residential service of one or more residential food items including at least in part one or more heat treating factors involved with one or more food related residential conditions. Origination of an illustratively derived accumulating heat treating component group can be accomplished through skilled in the art design choice selection of one or more of the above depicted components from one or more of the above depicted subsystems shown in FIG. 12. Components from the accumulating heat treating component group can be used in implementing execution of the one or more accumulating heat treating instructions i1140 of FIG. 30, can be used in performance of the accumulating heat treating electrical circuitry arrangement e1140 of FIG. 23, and/or can be used in otherwise fulfillment of the operation o1140. An exemplary non-transitory signal bearing medium version of the information storage subsystem s200 is depicted in FIG. 30 as bearing the one or more accumulating heat treating instructions i1140 that when executed will direct performance of the operation o1140. Furthermore, the accumulating heat treating electrical circuitry arrangement (“elec circ arrange”) e1140, when activated, will perform the operation o1140. Also, the accumulating heat treating module m1140, when executed and/or activated, will direct performance of and/or perform the operation o1140. For instance, in one or more exemplary implementations, the one or more accumulating heat treating instructions i1140, when executed, direct performance of the operation o1140 in the illustrative depiction as follows, and/or the accumulating heat treating electrical circuitry arrangement e1140, when activated, performs the operation o1140 in the illustrative depiction as follows, and/or the accumulating heat treating module m1140, when executed and/or activated, directs performance of and/or performs the operation o1140 in the illustrative depiction as follows, and/or the operation o1140 is otherwise carried out in the illustrative depiction as follows: electronically accumulating (e.g. from UFH, etc.) residential food management information (e.g. water usage, etc.) including (e.g. engaging, etc.) the one or more food related residential conditions (e.g. demographics of residential customers, etc.) affecting (e.g. engaging, etc.) residential service of (e.g. in-home nursing home residential food item receiving, etc.) one or more residential food items (e.g. pasta main course residential food item, etc.) including at least in part one or more heat treating factors involved with one or more food related residential conditions (e.g. temperature settings of ovens used to prepare residential food items, etc.).

In one or more implementations, as shown in FIG. 56, operation o11 includes an operation o1141 for electronically accumulating residential food management information including the one or more food related residential conditions affecting residential service of one or more residential food items including at least in part one or more food stock storage factors involved with one or more food related residential conditions. Origination of an illustratively derived accumulating storage factors component group can be accomplished through skilled in the art design choice selection of one or more of the above depicted components from one or more of the above depicted subsystems shown in FIG. 12. Components from the accumulating storage factors component group can be used in implementing execution of the one or more accumulating storage factors instructions i1141 of FIG. 30, can be used in performance of the accumulating storage factors electrical circuitry arrangement e1141 of FIG. 23, and/or can be used in otherwise fulfillment of the operation o1141. An exemplary non-transitory signal bearing medium version of the information storage subsystem s200 is depicted in FIG. 30 as bearing the one or more accumulating storage factors instructions i1141 that when executed will direct performance of the operation o1141. Furthermore, the accumulating storage factors electrical circuitry arrangement (“elec circ arrange”) e1141, when activated, will perform the operation o1141. Also, the accumulating storage factors module m1141, when executed and/or activated, will direct performance of and/or perform the operation o1141. For instance, in one or more exemplary implementations, the one or more accumulating storage factors instructions i1141, when executed, direct performance of the operation o1141 in the illustrative depiction as follows, and/or the accumulating storage factors electrical circuitry arrangement e1141, when activated, performs the operation o1141 in the illustrative depiction as follows, and/or the accumulating storage factors module m1141, when executed and/or activated, directs performance of and/or performs the operation o1141 in the illustrative depiction as follows, and/or the operation o1141 is otherwise carried out in the illustrative depiction as follows: electronically accumulating (e.g. from FRS, etc.) residential food management information (e.g. produce quality observed as received from various warehouses, etc.) including (e.g. engaged by, etc.) the one or more food related residential conditions (e.g. stocking rates for various residential food items, etc.) affecting (e.g. engaged by, etc.) residential service of (e.g. outside delivery of residential food item receiving, etc.) one or more residential food items (e.g. beef side dish residential food item, etc.) including at least in part one or more food stock storage factors involved with one or more food related residential conditions (e.g. statistical distribution of stock rotation periods, etc.).

In one or more implementations, as shown in FIG. 56, operation o11 includes an operation o1142 for electronically accumulating residential food management information including the one or more food related residential conditions affecting residential service of one or more residential food items including at least in part one or more equipment use factors involved with one or more food related residential conditions. Origination of an illustratively derived accumulating equipment use component group can be accomplished through skilled in the art design choice selection of one or more of the above depicted components from one or more of the above depicted subsystems shown in FIG. 12. Components from the accumulating equipment use component group can be used in implementing execution of the one or more accumulating equipment use instructions i1142 of FIG. 30, can be used in performance of the accumulating equipment use electrical circuitry arrangement e1142 of FIG. 23, and/or can be used in otherwise fulfillment of the operation o1142. An exemplary non-transitory signal bearing medium version of the information storage subsystem s200 is depicted in FIG. 30 as bearing the one or more accumulating equipment use instructions i1142 that when executed will direct performance of the operation o1142. Furthermore, the accumulating equipment use electrical circuitry arrangement (“elec circ arrange”) e1142, when activated, will perform the operation o1142. Also, the accumulating equipment use module m1142, when executed and/or activated, will direct performance of and/or perform the operation o1142. For instance, in one or more exemplary implementations, the one or more accumulating equipment use instructions i1142, when executed, direct performance of the operation o1142 in the illustrative depiction as follows, and/or the accumulating equipment use electrical circuitry arrangement e1142, when activated, performs the operation o1142 in the illustrative depiction as follows, and/or the accumulating equipment use module m1142, when executed and/or activated, directs performance of and/or performs the operation o1142 in the illustrative depiction as follows, and/or the operation o1142 is otherwise carried out in the illustrative depiction as follows: electronically accumulating (e.g. from GMRS, etc.) residential food management information (e.g. meat quality observed as received from various slaughter houses, etc.) including (e.g. incorporating, etc.) the one or more food related residential conditions (e.g. profit margin on various residential food items, etc.) affecting (e.g. incorporating, etc.) residential service of (e.g. mobile lifestyle residential food item receiving, etc.) one or more residential food items (e.g. pork side dish residential food item, etc.) including at least in part one or more equipment use factors involved with one or more food related residential conditions (e.g. equipment repair and maintenance histories, etc.).

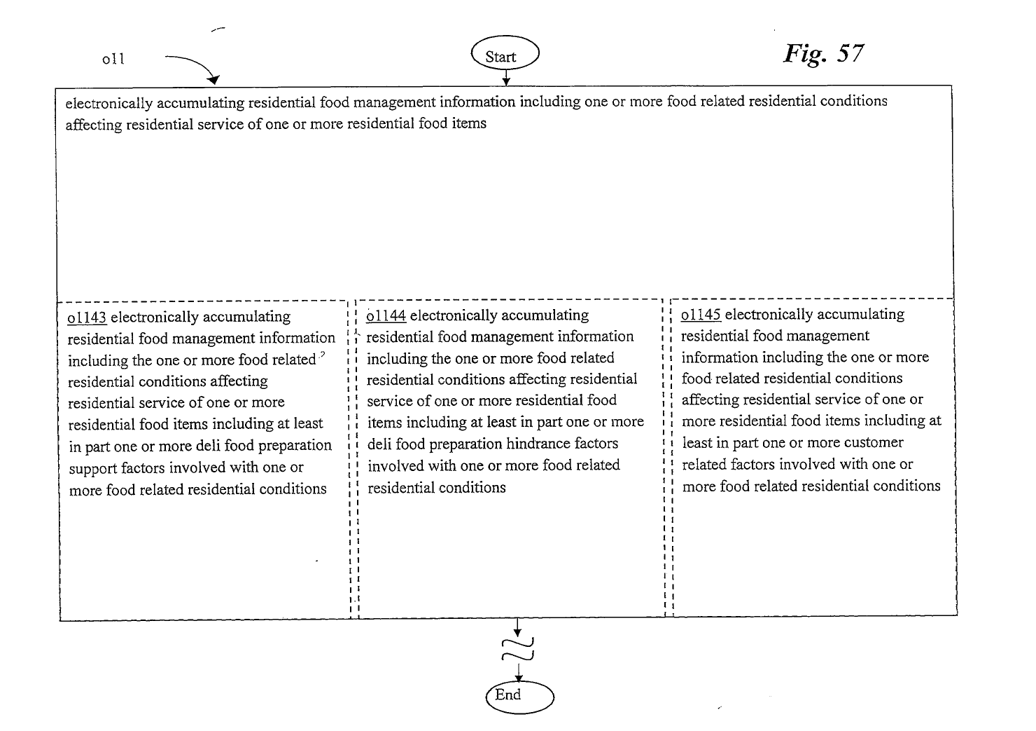

In one or more implementations, as shown in FIG. 57, operation o11 includes an operation o1143 for electronically accumulating residential food management information including the one or more food related residential conditions affecting residential service of one or more residential food items including at least in part one or more deli food preparation support factors involved with one or more food related residential conditions. Origination of an illustratively derived accumulating deli support component group can be accomplished through skilled in the art design choice selection of one or more of the above depicted components from one or more of the above depicted subsystems shown in FIG. 12. Components from the accumulating deli support component group can be used in implementing execution of the one or more accumulating deli support instructions i1143 of FIG. 30, can be used in performance of the accumulating deli support electrical circuitry arrangement e1143 of FIG. 23, and/or can be used in otherwise fulfillment of the operation o1143. An exemplary non-transitory signal bearing medium version of the information storage subsystem s200 is depicted in FIG. 30 as bearing the one or more accumulating deli support instructions i1143 that when executed will direct performance of the operation o1143. Furthermore, the accumulating deli support electrical circuitry arrangement (“elec circ arrange”) e1143, when activated, will perform the operation o1143. Also, the accumulating deli support module m1143, when executed and/or activated, will direct performance of and/or perform the operation o1143. For instance, in one or more exemplary implementations, the one or more accumulating deli support instructions i1143, when executed, direct performance of the operation o1143 in the illustrative depiction as follows, and/or the accumulating deli support electrical circuitry arrangement e1143, when activated, performs the operation o1143 in the illustrative depiction as follows, and/or the accumulating deli support module m1143, when executed and/or activated, directs performance of and/or performs the operation o1143 in the illustrative depiction as follows, and/or the operation o1143 is otherwise carried out in the illustrative depiction as follows: electronically accumulating (e.g. via IEEE 802.11, etc.) residential food management information (e.g. poultry quality observed as received from various farms, etc.) including (e.g. engrossing, etc.) the one or more food related residential conditions (e.g. customer occupation statistics, etc.) affecting (e.g. engrossing, etc.) residential service of (e.g. in-home hospital residential food item receiving, etc.) one or more residential food items (e.g. fish side dish residential food item, etc.) including at least in part one or more deli food preparation support factors involved with one or more food related residential conditions (e.g. residential occupant illness histories, etc.).

In one or more implementations, as shown in FIG. 57, operation o11 includes an operation o1144 for electronically accumulating residential food management information including the one or more food related residential conditions affecting residential service of one or more residential food items including at least in part one or more deli food preparation hindrance factors involved with one or more food related residential conditions. Origination of an illustratively derived accumulating deli hindrance component group can be accomplished through skilled in the art design choice selection of one or more of the above depicted components from one or more of the above depicted subsystems shown in FIG. 12. Components from the accumulating deli hindrance component group can be used in implementing execution of the one or more accumulating deli hindrance instructions i1144 of FIG. 30, can be used in performance of the accumulating deli hindrance electrical circuitry arrangement e1144 of FIG. 23, and/or can be used in otherwise fulfillment of the operation o1144. An exemplary non-transitory signal bearing medium version of the information storage subsystem s200 is depicted in FIG. 30 as bearing the one or more accumulating deli hindrance instructions i1144 that when executed will direct performance of the operation o1144. Furthermore, the accumulating deli hindrance electrical circuitry arrangement (“elec circ arrange”) e1144, when activated, will perform the operation o1144. Also, the accumulating deli hindrance module m1144, when executed and/or activated, will direct performance of and/or perform the operation o1144. For instance, in one or more exemplary implementations, the one or more accumulating deli hindrance instructions i1144, when executed, direct performance of the operation o1144 in the illustrative depiction as follows, and/or the accumulating deli hindrance electrical circuitry arrangement e1144, when activated, performs the operation o1144 in the illustrative depiction as follows, and/or the accumulating deli hindrance module m1144, when executed and/or activated, directs performance of and/or performs the operation o1144 in the illustrative depiction as follows, and/or the operation o1144 is otherwise carried out in the illustrative depiction as follows: electronically accumulating (e.g. via CDMA, etc.) residential food management information (e.g. shipping container information, etc.) including (e.g. implicate, etc.) the one or more food related residential conditions (e.g. garbage disposal practices, etc.) affecting (e.g. implicate, etc.) residential service of (e.g. deli style residential food item receiving, etc.) one or more residential food items (e.g. tofu side dish residential food item, etc.) including at least in part one or more deli food preparation hindrance factors involved with one or more food related residential conditions (e.g. residential garbage disposal practices, etc.).

In one or more implementations, as shown in FIG. 57, operation o11 includes an operation o1145 for electronically accumulating residential food management information including the one or more food related residential conditions affecting residential service of one or more residential food items including at least in part one or more customer related factors involved with one or more food related residential conditions. Origination of an illustratively derived accumulating customer factors component group can be accomplished through skilled in the art design choice selection of one or more of the above depicted components from one or more of the above depicted subsystems shown in FIG. 12. Components from the accumulating customer factors component group can be used in implementing execution of the one or more accumulating customer factors instructions i1145 of FIG. 30, can be used in performance of the accumulating customer factors electrical circuitry arrangement e1145 of FIG. 23, and/or can be used in otherwise fulfillment of the operation o1145. An exemplary non-transitory signal bearing medium version of the information storage subsystem s200 is depicted in FIG. 30 as bearing the one or more accumulating customer factors instructions i1145 that when executed will direct performance of the operation o1145. Furthermore, the accumulating customer factors electrical circuitry arrangement (“elec circ arrange”) e1145, when activated, will perform the operation o1145. Also, the accumulating customer factors module m1145, when executed and/or activated, will direct performance of and/or perform the operation o1145. For instance, in one or more exemplary implementations, the one or more accumulating customer factors instructions i1145, when executed, direct performance of the operation o1145 in the illustrative depiction as follows, and/or the accumulating customer factors electrical circuitry arrangement e1145, when activated, performs the operation o1145 in the illustrative depiction as follows, and/or the accumulating customer factors module m1145, when executed and/or activated, directs performance of and/or performs the operation o1145 in the illustrative depiction as follows, and/or the operation o1145 is otherwise carried out in the illustrative depiction as follows: electronically accumulating (e.g. from GPRS, etc.) residential food management information (e.g. dairy quality observed from various farms, etc.) including (e.g. necessitate, etc.) the one or more food related residential conditions (e.g. standards used to classify condition of residential food items received, etc.) affecting (e.g. necessitate, etc.) residential service of (e.g. fine dining residential food item storing, etc.) one or more residential food items (e.g. chicken side dish residential food item, etc.) including at least in part one or more customer related factors involved with one or more food related residential conditions (e.g. occupancy statistics for residential occupants with respect to holidays, etc.).

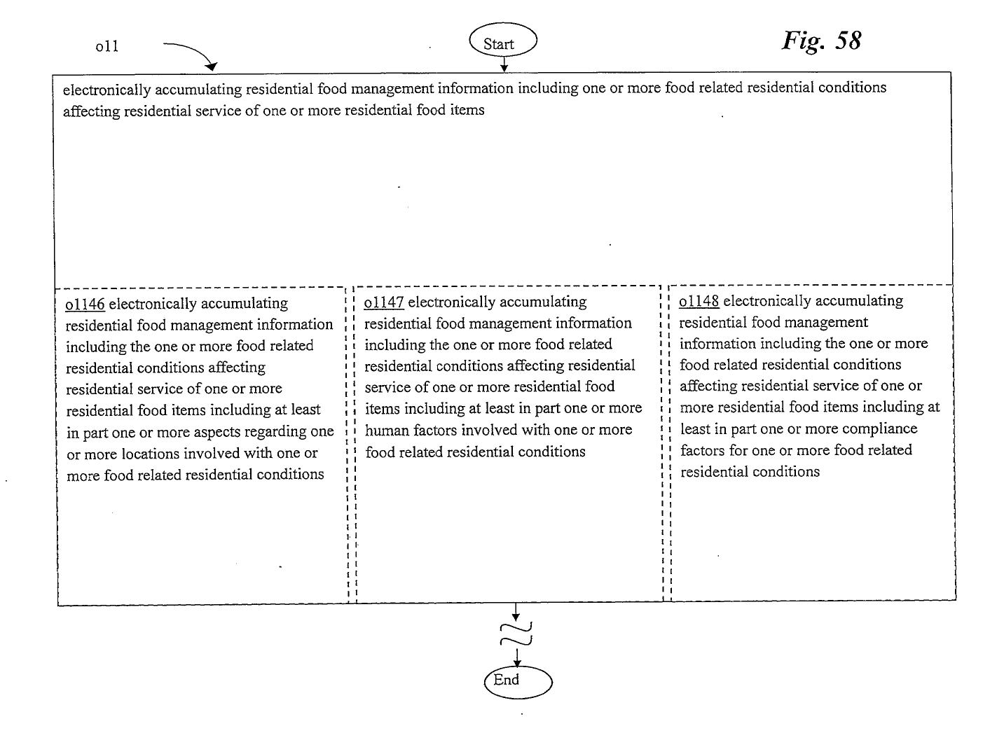

In one or more implementations, as shown in FIG. 58, operation o11 includes an operation o1146 for electronically accumulating residential food management information including the one or more food related residential conditions affecting residential service of one or more residential food items including at least in part one or more aspects regarding one or more locations involved with one or more food related residential conditions. Origination of an illustratively derived accumulating locations residential component group can be accomplished through skilled in the art design choice selection of one or more of the above depicted components from one or more of the above depicted subsystems shown in FIG. 12. Components from the accumulating locations residential component group can be used in implementing execution of the one or more accumulating locations residential instructions i1146 of FIG. 30, can be used in performance of the accumulating locations residential electrical circuitry arrangement e1146 of FIG. 23, and/or can be used in otherwise fulfillment of the operation o1146. An exemplary non-transitory signal bearing medium version of the information storage subsystem s200 is depicted in FIG. 30 as bearing the one or more accumulating locations residential instructions i1146 that when executed will direct performance of the operation o1146. Furthermore, the accumulating locations residential electrical circuitry arrangement (“elec circ arrange”) e1146, when activated, will perform the operation o1146. Also, the accumulating locations residential module m1146, when executed and/or activated, will direct performance of and/or perform the operation o1146. For instance, in one or more exemplary implementations, the one or more accumulating locations residential instructions i1146, when executed, direct performance of the operation o1146 in the illustrative depiction as follows, and/or the accumulating locations residential electrical circuitry arrangement e1146, when activated, performs the operation o1146 in the illustrative depiction as follows, and/or the accumulating locations residential module m1146, when executed and/or activated, directs performance of and/or performs the operation o1146 in the illustrative depiction as follows, and/or the operation o1146 is otherwise carried out in the illustrative depiction as follows: electronically accumulating (e.g. via G3, etc.) residential food management information (e.g. AVI file format, etc.) including (e.g. presuppose, etc.) the one or more food related residential conditions (e.g. standards used to classify condition of food stored, etc.) affecting (e.g. presuppose, etc.) residential service of (e.g. fast residential food item storing, etc.) one or more residential food items (e.g. seafood side dish residential food item, etc.) including at least in part one or more aspects regarding one or more locations involved with one or more food related residential conditions (e.g. condition of water supply and air quality of residential living quarters, etc.).

In one or more implementations, as shown in FIG. 58, operation o11 includes an operation o1147 for electronically accumulating residential food management information including the one or more food related residential conditions affecting residential service of one or more residential food items including at least in part one or more human factors involved with one or more food related residential conditions. Origination of an illustratively derived accumulating human factors component group can be accomplished through skilled in the art design choice selection of one or more of the above depicted components from one or more of the above depicted subsystems shown in FIG. 12. Components from the accumulating human factors component group can be used in implementing execution of the one or more accumulating human factors instructions i1147 of FIG. 30, can be used in performance of the accumulating human factors electrical circuitry arrangement e1147 of FIG. 23, and/or can be used in otherwise fulfillment of the operation o1147. An exemplary non-transitory signal bearing medium version of the information storage subsystem s200 is depicted in FIG. 30 as bearing the one or more accumulating human factors instructions i1147 that when executed will direct performance of the operation o1147. Furthermore, the accumulating human factors electrical circuitry arrangement (“elec circ arrange”) e1147, when activated, will perform the operation o1147. Also, the accumulating human factors module m1147, when executed and/or activated, will direct performance of and/or perform the operation o1147. For instance, in one or more exemplary implementations, the one or more accumulating human factors instructions i1147, when executed, direct performance of the operation o1147 in the illustrative depiction as follows, and/or the accumulating human factors electrical circuitry arrangement e1147, when activated, performs the operation o1147 in the illustrative depiction as follows, and/or the accumulating human factors module m1147, when executed and/or activated, directs performance of and/or performs the operation o1147 in the illustrative depiction as follows, and/or the operation o1147 is otherwise carried out in the illustrative depiction as follows: electronically accumulating (e.g. via G4, etc.) residential food management information (e.g. MP3 file format, etc.) including (e.g. related to, etc.) the one or more food related residential conditions (e.g. residential occupant exemplary behavior, etc.) affecting (e.g. related to, etc.) residential service of (e.g. family buffet residential food item storing, etc.) one or more residential food items (e.g. poultry side dish residential food item, etc.) including at least in part one or more human factors involved with one or more food related residential conditions (e.g. residential occupant residency statistics, etc.).

In one or more implementations, as shown in FIG. 58, operation o11 includes an operation o1148 for electronically accumulating residential food management information including the one or more food related residential conditions affecting residential service of one or more residential food items including at least in part one or more compliance factors for one or more food related residential conditions. Origination of an illustratively derived accumulating compliance factors component group can be accomplished through skilled in the art design choice selection of one or more of the above depicted components from one or more of the above depicted subsystems shown in FIG. 12. Components from the accumulating compliance factors component group can be used in implementing execution of the one or more accumulating compliance factors instructions i1148 of FIG. 30, can be used in performance of the accumulating compliance factors electrical circuitry arrangement e1148 of FIG. 23, and/or can be used in otherwise fulfillment of the operation o1148. An exemplary non-transitory signal bearing medium version of the information storage subsystem s200 is depicted in FIG. 30 as bearing the one or more accumulating compliance factors instructions i1148 that when executed will direct performance of the operation o1148. Furthermore, the accumulating compliance factors electrical circuitry arrangement (“elec circ arrange”) e1148, when activated, will perform the operation o1148. Also, the accumulating compliance factors module m1148, when executed and/or activated, will direct performance of and/or perform the operation o1148. For instance, in one or more exemplary implementations, the one or more accumulating compliance factors instructions i1148, when executed, direct performance of the operation o1148 in the illustrative depiction as follows, and/or the accumulating compliance factors electrical circuitry arrangement e1148, when activated, performs the operation o1148 in the illustrative depiction as follows, and/or the accumulating compliance factors module m1148, when executed and/or activated, directs performance of and/or performs the operation o1148 in the illustrative depiction as follows, and/or the operation o1148 is otherwise carried out in the illustrative depiction as follows: electronically accumulating (e.g. onto CD-ROM, etc.) residential food management information (e.g. audio descriptions, etc.) including (e.g. relationship, etc.) the one or more food related residential conditions (e.g. residential occupant poor behavior, etc.) affecting (e.g. relationship, etc.) residential service of (e.g. mobile lifestyle residential food item storing, etc.) one or more residential food items (e.g. diary side dish residential food item, etc.) including at least in part one or more compliance factors for one or more food related residential conditions (e.g. health inspection violations of residential facilities such as a house or an apartment unit, etc.).

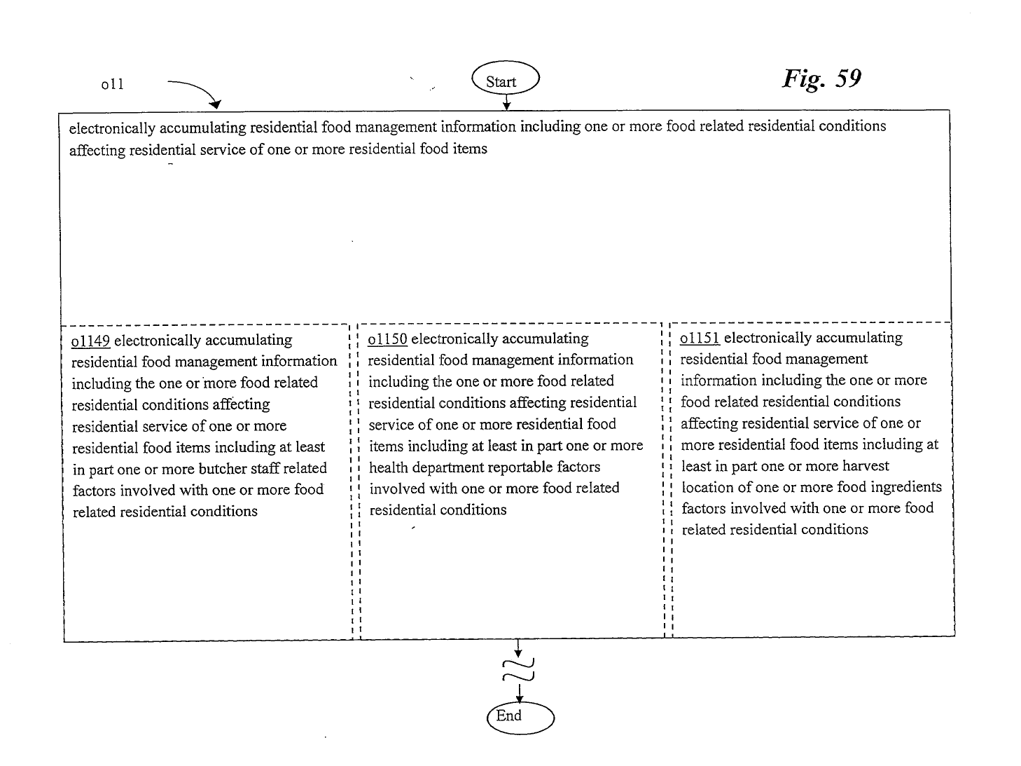

In one or more implementations, as shown in FIG. 59, operation o11 includes an operation o1149 for electronically accumulating residential food management information including the one or more food related residential conditions affecting residential service of one or more residential food items including at least in part one or more butcher staff related factors involved with one or more food related residential conditions. Origination of an illustratively derived accumulating butcher staff component group can be accomplished through skilled in the art design choice selection of one or more of the above depicted components from one or more of the above depicted subsystems shown in FIG. 12. Components from the accumulating butcher staff component group can be used in implementing execution of the one or more accumulating butcher staff instructions i1149 of FIG. 30, can be used in performance of the accumulating butcher staff electrical circuitry arrangement e1149 of FIG. 23, and/or can be used in otherwise fulfillment of the operation o1149. An exemplary non-transitory signal bearing medium version of the information storage subsystem s200 is depicted in FIG. 30 as bearing the one or more accumulating butcher staff instructions i1149 that when executed will direct performance of the operation o1149. Furthermore, the accumulating butcher staff electrical circuitry arrangement (“elec circ arrange”) e1149, when activated, will perform the operation o1149. Also, the accumulating butcher staff module m1149, when executed and/or activated, will direct performance of and/or perform the operation o1149. For instance, in one or more exemplary implementations, the one or more accumulating butcher staff instructions i1149, when executed, direct performance of the operation o1149 in the illustrative depiction as follows, and/or the accumulating butcher staff electrical circuitry arrangement e1149, when activated, performs the operation o1149 in the illustrative depiction as follows, and/or the accumulating butcher staff module m1149, when executed and/or activated, directs performance of and/or performs the operation o1149 in the illustrative depiction as follows, and/or the operation o1149 is otherwise carried out in the illustrative depiction as follows: electronically accumulating (e.g. onto DVD, etc.) residential food management information (e.g. noncompliance with safety protocols, etc.) including (e.g. suggest, etc.) the one or more food related residential conditions (e.g. identified issues regarding food quality from one or more wholesalers, etc.) affecting (e.g. suggest, etc.) residential service of (e.g. institutional residential food item storing, etc.) one or more residential food items (e.g. vegetarian side dish residential food item, etc.) including at least in part one or more butcher staff related factors involved with one or more food related residential conditions (e.g. illness histories of butcher staff involved with residential food items, etc.).

In one or more implementations, as shown in FIG. 59, operation o11 includes an operation o1150 for electronically accumulating residential food management information including the one or more food related residential conditions affecting residential service of one or more residential food items including at least in part one or more health department reportable factors involved with one or more food related residential conditions. Origination of an illustratively derived accumulating health department component group can be accomplished through skilled in the art design choice selection of one or more of the above depicted components from one or more of the above depicted subsystems shown in FIG. 12. Components from the accumulating health department component group can be used in implementing execution of the one or more accumulating health department instructions i1150 of FIG. 30, can be used in performance of the accumulating health department electrical circuitry arrangement e1150 of FIG. 23, and/or can be used in otherwise fulfillment of the operation o1150. An exemplary non-transitory signal bearing medium version of the information storage subsystem s200 is depicted in FIG. 30 as bearing the one or more accumulating health department instructions i1150 that when executed will direct performance of the operation o1150. Furthermore, the accumulating health department electrical circuitry arrangement (“elec circ arrange”) e1150, when activated, will perform the operation o1150. Also, the accumulating health department module m1150, when executed and/or activated, will direct performance of and/or perform the operation o1150. For instance, in one or more exemplary implementations, the one or more accumulating health department instructions i1150, when executed, direct performance of the operation o1150 in the illustrative depiction as follows, and/or the accumulating health department electrical circuitry arrangement e1150, when activated, performs the operation o1150 in the illustrative depiction as follows, and/or the accumulating health department module m1150, when executed and/or activated, directs performance of and/or performs the operation o1150 in the illustrative depiction as follows, and/or the operation o1150 is otherwise carried out in the illustrative depiction as follows: electronically accumulating (e.g. onto hard drive, etc.) residential food management information (e.g. residential occupation statistics, etc.) including (e.g. tangle, etc.) the one or more food related residential conditions (e.g. identified issues regarding food quality from one or more farms, etc.) affecting (e.g. tangle, etc.) residential service of (e.g. large family cafeteria residential food item storing, etc.) one or more residential food items (e.g. salad side dish residential food item, etc.) including at least in part one or more health department reportable factors involved with one or more food related residential conditions (e.g. sanitation procedures mandated by health department, etc.).

In one or more implementations, as shown in FIG. 59, operation o11 includes an operation o1151 for electronically accumulating residential food management information including the one or more food related residential conditions affecting residential service of one or more residential food items including at least in part one or more harvest location of one or more food ingredients factors involved with one or more food related residential conditions. Origination of an illustratively derived accumulating harvest location component group can be accomplished through skilled in the art design choice selection of one or more of the above depicted components from one or more of the above depicted subsystems shown in FIG. 12. Components from the accumulating harvest location component group can be used in implementing execution of the one or more accumulating harvest location instructions i1151 of FIG. 30, can be used in performance of the accumulating harvest location electrical circuitry arrangement e1151 of FIG. 23, and/or can be used in otherwise fulfillment of the operation o1151. An exemplary non-transitory signal bearing medium version of the information storage subsystem s200 is depicted in FIG. 30 as bearing the one or more accumulating harvest location instructions i1151 that when executed will direct performance of the operation o1151. Furthermore, the accumulating harvest location electrical circuitry arrangement (“elec circ arrange”) e1151, when activated, will perform the operation o1151. Also, the accumulating harvest location module m1151, when executed and/or activated, will direct performance of and/or perform the operation o1151. For instance, in one or more exemplary implementations, the one or more accumulating harvest location instructions i1151, when executed, direct performance of the operation o1151 in the illustrative depiction as follows, and/or the accumulating harvest location electrical circuitry arrangement e1151, when activated, performs the operation o1151 in the illustrative depiction as follows, and/or the accumulating harvest location module m1151, when executed and/or activated, directs performance of and/or performs the operation o1151 in the illustrative depiction as follows, and/or the operation o1151 is otherwise carried out in the illustrative depiction as follows: electronically accumulating (e.g. from wifi, etc.) residential food management information (e.g. operational data regarding residential machine preparation of residential food items, etc.) including (e.g. exclude, etc.) the one or more food related residential conditions (e.g. identified issues regarding one or more residential occupants, etc.) affecting (e.g. exclude, etc.) residential service of (e.g. in-home nursing home residential food item storing, etc.) one or more residential food items (e.g. grain side dish residential food item, etc.) including at least in part one or more harvest location of one or more food ingredients factors involved with one or more food related residential conditions (e.g. country, state and county of origin for produce used in residential food items, etc.).

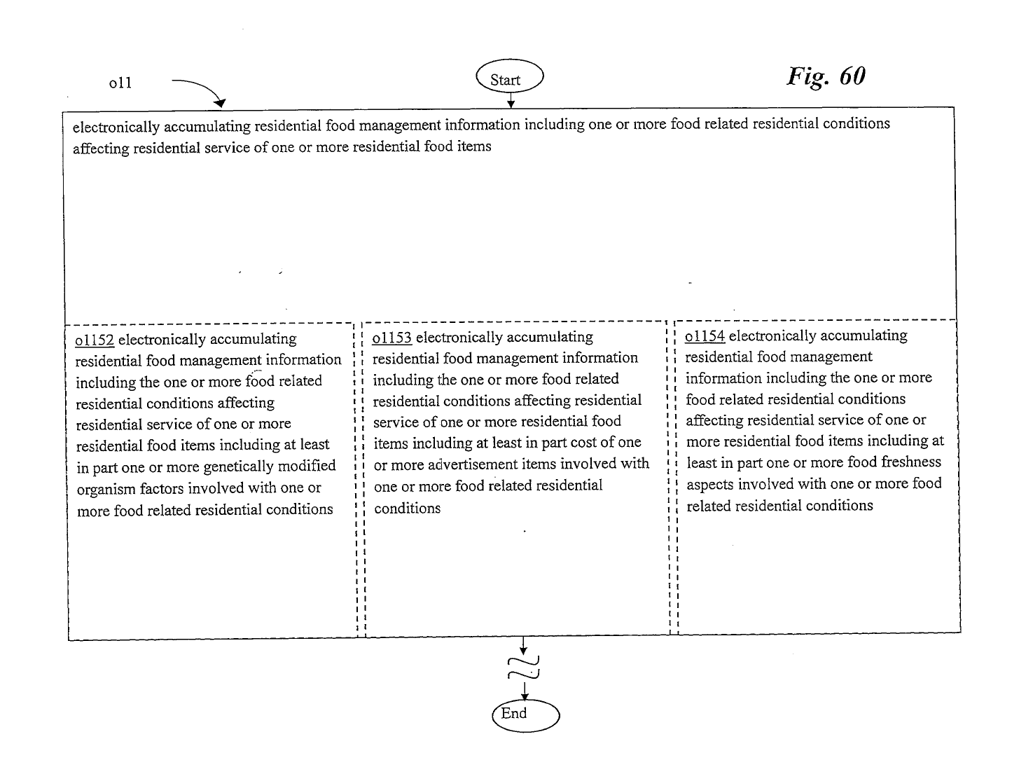

In one or more implementations, as shown in FIG. 60, operation o11 includes an operation o1152 for electronically accumulating residential food management information including the one or more food related residential conditions affecting residential service of one or more residential food items including at least in part one or more genetically modified organism factors involved with one or more food related residential conditions. Origination of an illustratively derived accumulating genetically modified component group can be accomplished through skilled in the art design choice selection of one or more of the above depicted components from one or more of the above depicted subsystems shown in FIG. 12. Components from the accumulating genetically modified component group can be used in implementing execution of the one or more accumulating genetically modified instructions i1152 of FIG. 30, can be used in performance of the accumulating genetically modified electrical circuitry arrangement e1152 of FIG. 23, and/or can be used in otherwise fulfillment of the operation o1152. An exemplary non-transitory signal bearing medium version of the information storage subsystem s200 is depicted in FIG. 30 as bearing the one or more accumulating genetically modified instructions i1152 that when executed will direct performance of the operation o1152. Furthermore, the accumulating genetically modified electrical circuitry arrangement (“elec circ arrange”) e1152, when activated, will perform the operation o1152. Also, the accumulating genetically modified module m1152, when executed and/or activated, will direct performance of and/or perform the operation o1152. For instance, in one or more exemplary implementations, the one or more accumulating genetically modified instructions i1152, when executed, direct performance of the operation o1152 in the illustrative depiction as follows, and/or the accumulating genetically modified electrical circuitry arrangement e1152, when activated, performs the operation o1152 in the illustrative depiction as follows, and/or the accumulating genetically modified module m1152, when executed and/or activated, directs performance of and/or performs the operation o1152 in the illustrative depiction as follows, and/or the operation o1152 is otherwise carried out in the illustrative depiction as follows: electronically accumulating (e.g. from laptop entry, etc.) residential food management information (e.g. UV index of current climate, etc.) including (e.g. bound, etc.) the one or more food related residential conditions (e.g. identified issues regarding one or more residential equipment, etc.) affecting (e.g. bound, etc.) residential service of (e.g. outside delivery of residential food item storing, etc.) one or more residential food items (e.g. bean side dish residential food item, etc.) including at least in part one or more genetically modified organism factors involved with one or more food related residential conditions (e.g. existence of certification on non-GMO produce used in residential food items, etc.).

In one or more implementations, as shown in FIG. 60, operation o11 includes an operation o1153 for electronically accumulating residential food management information including the one or more food related residential conditions affecting residential service of one or more residential food items including at least in part cost of one or more advertisement items involved with one or more food related residential conditions. Origination of an illustratively derived accumulating advertisement items component group can be accomplished through skilled in the art design choice selection of one or more of the above depicted components from one or more of the above depicted subsystems shown in FIG. 12. Components from the accumulating advertisement items component group can be used in implementing execution of the one or more accumulating advertisement items instructions i1153 of FIG. 30, can be used in performance of the accumulating advertisement items electrical circuitry arrangement e1153 of FIG. 23, and/or can be used in otherwise fulfillment of the operation o1153. An exemplary non-transitory signal bearing medium version of the information storage subsystem s200 is depicted in FIG. 30 as bearing the one or more accumulating advertisement items instructions i1153 that when executed will direct performance of the operation o1153. Furthermore, the accumulating advertisement items electrical circuitry arrangement (“elec circ arrange”) e1153, when activated, will perform the operation o1153. Also, the accumulating advertisement items module m1153, when executed and/or activated, will direct performance of and/or perform the operation o1153. For instance, in one or more exemplary implementations, the one or more accumulating advertisement items instructions i1153, when executed, direct performance of the operation o1153 in the illustrative depiction as follows, and/or the accumulating advertisement items electrical circuitry arrangement e1153, when activated, performs the operation o1153 in the illustrative depiction as follows, and/or the accumulating advertisement items module m1153, when executed and/or activated, directs performance of and/or performs the operation o1153 in the illustrative depiction as follows, and/or the operation o1153 is otherwise carried out in the illustrative depiction as follows: electronically accumulating (e.g. from RFID scan, etc.) residential food management information (e.g. carbon dioxide levels in residential facilities, etc.) including (e.g. requiring, etc.) the one or more food related residential conditions (e.g. identified issues regarding one or more types of food materials used to prepare one or more residential food items to be use, etc.) affecting (e.g. requiring, etc.) residential service of (e.g. mobile lifestyle residential food item storing, etc.) one or more residential food items (e.g. cooked side dish residential food item, etc.) including at least in part cost of one or more advertisement items involved with one or more food related residential conditions (e.g. seasonal fluctuations of residential food item pricing, etc.).

In one or more implementations, as shown in FIG. 60, operation o11 includes an operation o1154 for electronically accumulating residential food management information including the one or more food related residential conditions affecting residential service of one or more residential food items including at least in part one or more food freshness aspects involved with one or more food related residential conditions. Origination of an illustratively derived accumulating food freshness component group can be accomplished through skilled in the art design choice selection of one or more of the above depicted components from one or more of the above depicted subsystems shown in FIG. 12. Components from the accumulating food freshness component group can be used in implementing execution of the one or more accumulating food freshness instructions i1154 of FIG. 30, can be used in performance of the accumulating food freshness electrical circuitry arrangement e1154 of FIG. 23, and/or can be used in otherwise fulfillment of the operation o1154. An exemplary non-transitory signal bearing medium version of the information storage subsystem s200 is depicted in FIG. 30 as bearing the one or more accumulating food freshness instructions i1154 that when executed will direct performance of the operation o1154. Furthermore, the accumulating food freshness electrical circuitry arrangement (“elec circ arrange”) e1154, when activated, will perform the operation o1154. Also, the accumulating food freshness module m1154, when executed and/or activated, will direct performance of and/or perform the operation o1154. For instance, in one or more exemplary implementations, the one or more accumulating food freshness instructions i1154, when executed, direct performance of the operation o1154 in the illustrative depiction as follows, and/or the accumulating food freshness electrical circuitry arrangement e1154, when activated, performs the operation o1154 in the illustrative depiction as follows, and/or the accumulating food freshness module m1154, when executed and/or activated, directs performance of and/or performs the operation o1154 in the illustrative depiction as follows, and/or the operation o1154 is otherwise carried out in the illustrative depiction as follows: electronically accumulating (e.g. via ethernet, etc.) residential food management information (e.g. water usage, etc.) including (e.g. enveloped, etc.) the one or more food related residential conditions (e.g. identified issues regarding one or more types of residential food items used by residential facility, etc.) affecting (e.g. enveloped, etc.) residential service of (e.g. in-home hospital residential food item storing, etc.) one or more residential food items (e.g. raw side dish residential food item, etc.) including at least in part one or more food freshness aspects involved with one or more food related residential conditions (e.g. transit time between farm, wholesaler and residential facilities such as a home or nursing home, etc.).

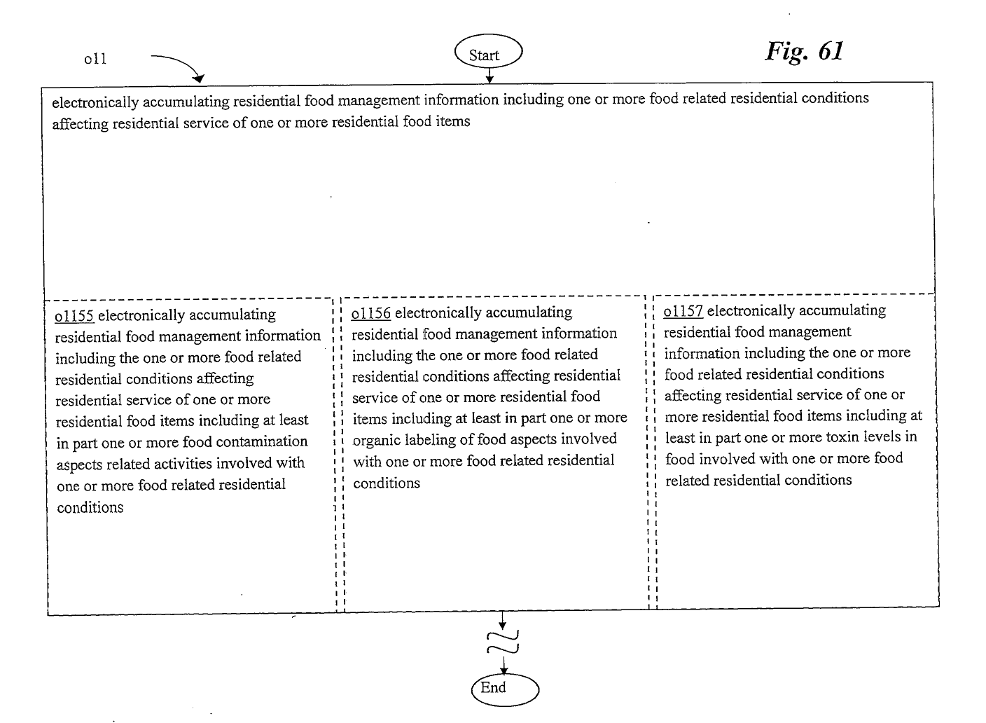

In one or more implementations, as shown in FIG. 61, operation o11 includes an operation o1155 for electronically accumulating residential food management information including the one or more food related residential conditions affecting residential service of one or more residential food items including at least in part one or more food contamination aspects related activities involved with one or more food related residential conditions. Origination of an illustratively derived accumulating food contamination component group can be accomplished through skilled in the art design choice selection of one or more of the above depicted components from one or more of the above depicted subsystems shown in FIG. 12. Components from the accumulating food contamination component group can be used in implementing execution of the one or more accumulating food contamination instructions i1155 of FIG. 30, can be used in performance of the accumulating food contamination electrical circuitry arrangement e1155 of FIG. 23, and/or can be used in otherwise fulfillment of the operation o1155. An exemplary non-transitory signal bearing medium version of the information storage subsystem s200 is depicted in FIG. 30 as bearing the one or more accumulating food contamination instructions i1155 that when executed will direct performance of the operation o1155. Furthermore, the accumulating food contamination electrical circuitry arrangement (“elec circ arrange”) e1155, when activated, will perform the operation o1155. Also, the accumulating food contamination module m1155, when executed and/or activated, will direct performance of and/or perform the operation o1155. For instance, in one or more exemplary implementations, the one or more accumulating food contamination instructions i1155, when executed, direct performance of the operation o1155 in the illustrative depiction as follows, and/or the accumulating food contamination electrical circuitry arrangement e1155, when activated, performs the operation o1155 in the illustrative depiction as follows, and/or the accumulating food contamination module m1155, when executed and/or activated, directs performance of and/or performs the operation o1155 in the illustrative depiction as follows, and/or the operation o1155 is otherwise carried out in the illustrative depiction as follows: electronically accumulating (e.g. via UPC scan, etc.) residential food management information (e.g. natural gas usage, etc.) including (e.g. envelope, etc.) the one or more food related residential conditions (e.g. identified issues regarding one or more types of non-food items used by residential facility, etc.) affecting (e.g. envelope, etc.) residential service of (e.g. deli style residential food item storing, etc.) one or more residential food items (e.g. buffet side dish residential food item, etc.) including at least in part one or more food contamination aspects related activities involved with one or more food related residential conditions (e.g. recall notices for food-based ingredients used in residential food items, etc.).

In one or more implementations, as shown in FIG. 61, operation o11 includes an operation o1156 for electronically accumulating residential food management information including the one or more food related residential conditions affecting residential service of one or more residential food items including at least in part one or more organic labeling of food aspects involved with one or more food related residential conditions. Origination of an illustratively derived accumulating organic labeling component group can be accomplished through skilled in the art design choice selection of one or more of the above depicted components from one or more of the above depicted subsystems shown in FIG. 12. Components from the accumulating organic labeling component group can be used in implementing execution of the one or more accumulating organic labeling instructions i1156 of FIG. 30, can be used in performance of the accumulating organic labeling electrical circuitry arrangement e1156 of FIG. 23, and/or can be used in otherwise fulfillment of the operation o1156. An exemplary non-transitory signal bearing medium version of the information storage subsystem s200 is depicted in FIG. 30 as bearing the one or more accumulating organic labeling instructions i1156 that when executed will direct performance of the operation o1156. Furthermore, the accumulating organic labeling electrical circuitry arrangement (“elec circ arrange”) e1156, when activated, will perform the operation o1156. Also, the accumulating organic labeling module m1156, when executed and/or activated, will direct performance of and/or perform the operation o1156. For instance, in one or more exemplary implementations, the one or more accumulating organic labeling instructions i1156, when executed, direct performance of the operation o1156 in the illustrative depiction as follows, and/or the accumulating organic labeling electrical circuitry arrangement e1156, when activated, performs the operation o1156 in the illustrative depiction as follows, and/or the accumulating organic labeling module m1156, when executed and/or activated, directs performance of and/or performs the operation o1156 in the illustrative depiction as follows, and/or the operation o1156 is otherwise carried out in the illustrative depiction as follows: electronically accumulating (e.g. via HTML code, etc.) residential food management information (e.g. methane gas usage, etc.) including (e.g. associate with, etc.) the one or more food related residential conditions (e.g. identified issues regarding one or more procedures used to prepare one or more food items used by residential facility, etc.) affecting (e.g. associate with, etc.) residential service of (e.g. fine dining residential food item packaging, etc.) one or more residential food items (e.g. soup side dish residential food item, etc.) including at least in part one or more organic labeling of food aspects involved with one or more food related residential conditions (e.g. verification of organic labeling of ingredients used for the residential food items, etc.).

In one or more implementations, as shown in FIG. 61, operation o11 includes an operation o1157 for electronically accumulating residential food management information including the one or more food related residential conditions affecting residential service of one or more residential food items including at least in part one or more toxin levels in food involved with one or more food related residential conditions. Origination of an illustratively derived accumulating toxin levels component group can be accomplished through skilled in the art design choice selection of one or more of the above depicted components from one or more of the above depicted subsystems shown in FIG. 12. Components from the accumulating toxin levels component group can be used in implementing execution of the one or more accumulating toxin levels instructions i1157 of FIG. 30, can be used in performance of the accumulating toxin levels electrical circuitry arrangement e1157 of FIG. 23, and/or can be used in otherwise fulfillment of the operation o1157. An exemplary non-transitory signal bearing medium version of the information storage subsystem s200 is depicted in FIG. 30 as bearing the one or more accumulating toxin levels instructions i1157 that when executed will direct performance of the operation o1157. Furthermore, the accumulating toxin levels electrical circuitry arrangement (“elec circ arrange”) e1157, when activated, will perform the operation o1157. Also, the accumulating toxin levels module m1157, when executed and/or activated, will direct performance of and/or perform the operation o1157. For instance, in one or more exemplary implementations, the one or more accumulating toxin levels instructions i1157, when executed, direct performance of the operation o1157 in the illustrative depiction as follows, and/or the accumulating toxin levels electrical circuitry arrangement e1157, when activated, performs the operation o1157 in the illustrative depiction as follows, and/or the accumulating toxin levels module m1157, when executed and/or activated, directs performance of and/or performs the operation o1157 in the illustrative depiction as follows, and/or the operation o1157 is otherwise carried out in the illustrative depiction as follows: electronically accumulating (e.g. via MMS, etc.) residential food management information (e.g. MPEG file format, etc.) including (e.g. embroil, etc.) the one or more food related residential conditions (e.g. age profile of residential equipment used, etc.) affecting (e.g. embroil, etc.) residential service of (e.g. fast residential food item packaging, etc.) one or more residential food items (e.g. stew side dish residential food item, etc.) including at least in part one or more toxin levels in food involved with one or more food related residential conditions (e.g. toxin level histories for produce from various residential facilities such as a condominium unit, house, or apartment unit, etc.).

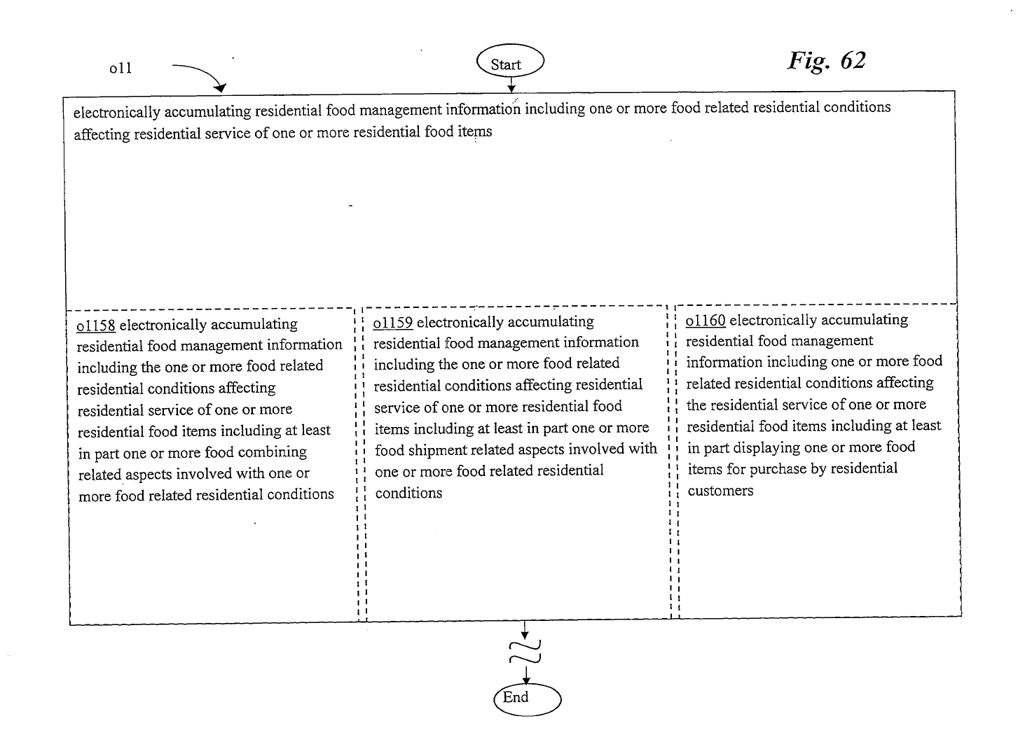

In one or more implementations, as shown in FIG. 62, operation o11 includes an operation o1158 for electronically accumulating residential food management information including the one or more food related residential conditions affecting residential service of one or more residential food items including at least in part one or more food combining related aspects involved with one or more food related residential conditions. Origination of an illustratively derived accumulating food combining component group can be accomplished through skilled in the art design choice selection of one or more of the above depicted components from one or more of the above depicted subsystems shown in FIG. 12. Components from the accumulating food combining component group can be used in implementing execution of the one or more accumulating food combining instructions i1158 of FIG. 30, can be used in performance of the accumulating food combining electrical circuitry arrangement e1158 of FIG. 23, and/or can be used in otherwise fulfillment of the operation o1158. An exemplary non-transitory signal bearing medium version of the information storage subsystem s200 is depicted in FIG. 30 as bearing the one or more accumulating food combining instructions i1158 that when executed will direct performance of the operation o1158. Furthermore, the accumulating food combining electrical circuitry arrangement (“elec circ arrange”) e1158, when activated, will perform the operation o1158. Also, the accumulating food combining module m1158, when executed and/or activated, will direct performance of and/or perform the operation o1158. For instance, in one or more exemplary implementations, the one or more accumulating food combining instructions i1158, when executed, direct performance of the operation o1158 in the illustrative depiction as follows, and/or the accumulating food combining electrical circuitry arrangement e1158, when activated, performs the operation o1158 in the illustrative depiction as follows, and/or the accumulating food combining module m1158, when executed and/or activated, directs performance of and/or performs the operation o1158 in the illustrative depiction as follows, and/or the operation o1158 is otherwise carried out in the illustrative depiction as follows: electronically accumulating (e.g. as 256-bit AES, etc.) residential food management information (e.g. WAV file format, etc.) including (e.g. take in, etc.) the one or more food related residential conditions (e.g. lease duration of residential equipment, etc.) affecting (e.g. take in, etc.) residential service of (e.g. family buffet residential food item packaging, etc.) one or more residential food items (e.g. hot side dish residential food item, etc.) including at least in part one or more food combining related aspects involved with one or more food related residential conditions (e.g. instances of fast digesting sugars with slow digesting proteins and fats in various residential food items, etc.).

In one or more implementations, as shown in FIG. 62, operation o11 includes an operation o1159 for electronically accumulating residential food management information including the one or more food related residential conditions affecting residential service of one or more residential food items including at least in part one or more food shipment related aspects involved with one or more food related residential conditions. Origination of an illustratively derived accumulating food shipment component group can be accomplished through skilled in the art design choice selection of one or more of the above depicted components from one or more of the above depicted subsystems shown in FIG. 12. Components from the accumulating food shipment component group can be used in implementing execution of the one or more accumulating food shipment instructions i1159 of FIG. 30, can be used in performance of the accumulating food shipment electrical circuitry arrangement e1159 of FIG. 23, and/or can be used in otherwise fulfillment of the operation o1159. An exemplary non-transitory signal bearing medium version of the information storage subsystem s200 is depicted in FIG. 30 as bearing the one or more accumulating food shipment instructions i1159 that when executed will direct performance of the operation o1159. Furthermore, the accumulating food shipment electrical circuitry arrangement (“elec circ arrange”) e1159, when activated, will perform the operation o1159. Also, the accumulating food shipment module m1159, when executed and/or activated, will direct performance of and/or perform the operation o1159. For instance, in one or more exemplary implementations, the one or more accumulating food shipment instructions i1159, when executed, direct performance of the operation o1159 in the illustrative depiction as follows, and/or the accumulating food shipment electrical circuitry arrangement e1159, when activated, performs the operation o1159 in the illustrative depiction as follows, and/or the accumulating food shipment module m1159, when executed and/or activated, directs performance of and/or performs the operation o1159 in the illustrative depiction as follows, and/or the operation o1159 is otherwise carried out in the illustrative depiction as follows: electronically accumulating (e.g. onto compact flash, etc.) residential food management information (e.g. visual observation, etc.) including (e.g. comprised of, etc.) the one or more food related residential conditions (e.g. efficiency of residential equipment used, etc.) affecting (e.g. comprised of, etc.) residential service of (e.g. mobile lifestyle residential food item packaging, etc.) one or more residential food items (e.g. cold side dish residential food item, etc.) including at least in part one or more food shipment related aspects involved with one or more food related residential conditions (e.g. temperature profiles of receiving docks, etc.).

In one or more implementations, as shown in FIG. 62, operation o11 includes an operation o1160 for electronically accumulating residential food management information including one or more food related residential conditions affecting the residential service of one or more residential food items including at least in part displaying one or more food items for purchase by residential customers. Origination of an illustratively derived accumulating displaying purchase component group can be accomplished through skilled in the art design choice selection of one or more of the above depicted components from one or more of the above depicted subsystems shown in FIG. 12. Components from the accumulating displaying purchase component group can be used in implementing execution of the one or more accumulating displaying purchase instructions i1160 of FIG. 31, can be used in performance of the accumulating displaying purchase electrical circuitry arrangement e1160 of FIG. 24, and/or can be used in otherwise fulfillment of the operation o1160. An exemplary non-transitory signal bearing medium version of the information storage subsystem s200 is depicted in FIG. 31 as bearing the one or more accumulating displaying purchase instructions i1160 that when executed will direct performance of the operation o1160. Furthermore, the accumulating displaying purchase electrical circuitry arrangement (“elec circ arrange”) e1160, when activated, will perform the operation o1160. Also, the accumulating displaying purchase module m1160, when executed and/or activated, will direct performance of and/or perform the operation o1160. For instance, in one or more exemplary implementations, the one or more accumulating displaying purchase instructions i1160, when executed, direct performance of the operation o1160 in the illustrative depiction as follows, and/or the accumulating displaying purchase electrical circuitry arrangement e1160, when activated, performs the operation o1160 in the illustrative depiction as follows, and/or the accumulating displaying purchase module m1160, when executed and/or activated, directs performance of and/or performs the operation o1160 in the illustrative depiction as follows, and/or the operation o1160 is otherwise carried out in the illustrative depiction as follows: electronically accumulating (e.g. as push-based, etc.) residential food management information (e.g. compliance with safety protocols, etc.) including (e.g. comprehend, etc.) one or more food related residential conditions (e.g. location of residential facility, etc.) affecting (e.g. comprehend, etc.) the residential service of (e.g. institutional residential food item packaging, etc.) one or more residential food items (e.g. weight loss side dish residential food item, etc.) including at least in part displaying one or more food items for purchase by residential customers (e.g. preparation of sample pasta dishes for special residential event, etc.).

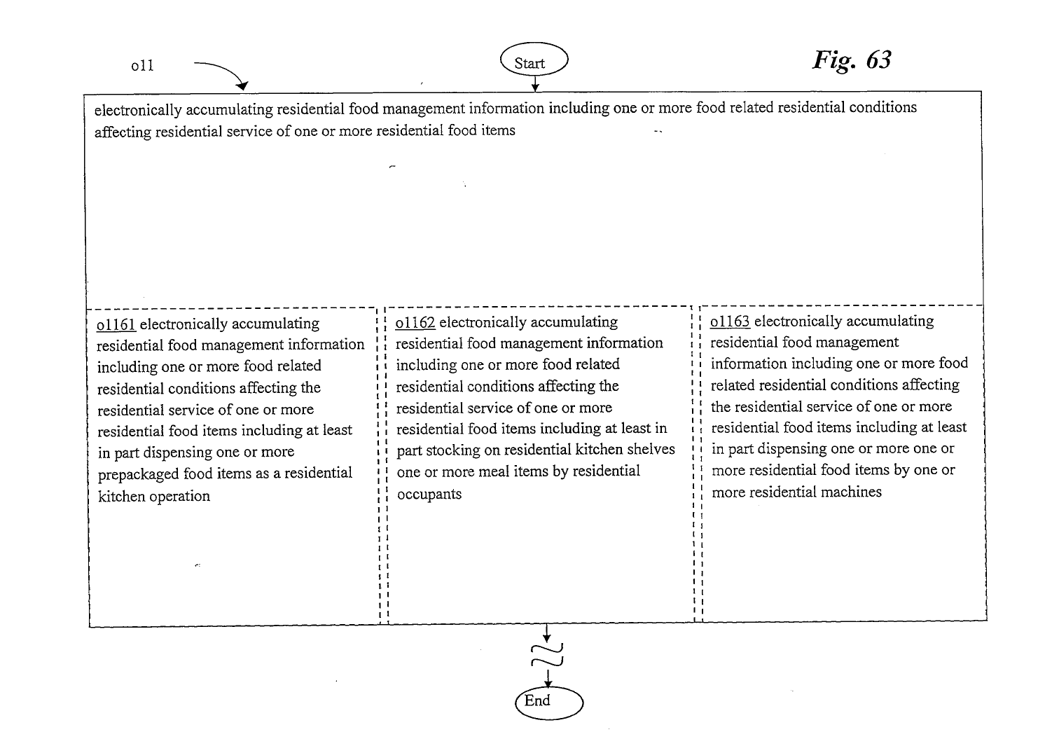

In one or more implementations, as shown in FIG. 63, operation o11 includes an operation o1161 for electronically accumulating residential food management information including one or more food related residential conditions affecting the residential service of one or more residential food items including at least in part dispensing one or more prepackaged food items as a residential kitchen operation. Origination of an illustratively derived accumulating dispensing prepackaged component group can be accomplished through skilled in the art design choice selection of one or more of the above depicted components from one or more of the above depicted subsystems shown in FIG. 12. Components from the accumulating dispensing prepackaged component group can be used in implementing execution of the one or more accumulating dispensing prepackaged instructions i1161 of FIG. 31, can be used in performance of the accumulating dispensing prepackaged electrical circuitry arrangement e1161 of FIG. 24, and/or can be used in otherwise fulfillment of the operation o1161. An exemplary non-transitory signal bearing medium version of the information storage subsystem s200 is depicted in FIG. 31 as bearing the one or more accumulating dispensing prepackaged instructions i1161 that when executed will direct performance of the operation o1161. Furthermore, the accumulating dispensing prepackaged electrical circuitry arrangement (“elec circ arrange”) e1161, when activated, will perform the operation o1161. Also, the accumulating dispensing prepackaged module m1161, when executed and/or activated, will direct performance of and/or perform the operation o1161. For instance, in one or more exemplary implementations, the one or more accumulating dispensing prepackaged instructions i1161, when executed, direct performance of the operation o1161 in the illustrative depiction as follows, and/or the accumulating dispensing prepackaged electrical circuitry arrangement e1161, when activated, performs the operation o1161 in the illustrative depiction as follows, and/or the accumulating dispensing prepackaged module m1161, when executed and/or activated, directs performance of and/or performs the operation o1161 in the illustrative depiction as follows, and/or the operation o1161 is otherwise carried out in the illustrative depiction as follows: electronically accumulating (e.g. onto SMTP server, etc.) residential food management information (e.g. document authenticity, etc.) including (e.g. calculate, etc.) one or more food related residential conditions (e.g. type of residential facility, etc.) affecting (e.g. calculate, etc.) the residential service of (e.g. large family residential food item packaging, etc.) one or more residential food items (e.g. sports nutrition side dish residential food item, etc.) including at least in part dispensing one or more prepackaged food items as a residential kitchen operation (e.g. quality of food item packaging by deli department to be received as a residential food item, etc.).

In one or more implementations, as shown in FIG. 63, operation o11 includes an operation o1162 for electronically accumulating residential food management information including one or more food related residential conditions affecting the residential service of one or more residential food items including at least in part stocking on residential kitchen shelves one or more meal items by residential occupants. Origination of an illustratively derived accumulating stocking kitchen component group can be accomplished through skilled in the art design choice selection of one or more of the above depicted components from one or more of the above depicted subsystems shown in FIG. 12. Components from the accumulating stocking kitchen component group can be used in implementing execution of the one or more accumulating stocking kitchen instructions i1162 of FIG. 31, can be used in performance of the accumulating stocking kitchen electrical circuitry arrangement e1162 of FIG. 24, and/or can be used in otherwise fulfillment of the operation o1162. An exemplary non-transitory signal bearing medium version of the information storage subsystem s200 is depicted in FIG. 31 as bearing the one or more accumulating stocking kitchen instructions i1162 that when executed will direct performance of the operation o1162. Furthermore, the accumulating stocking kitchen electrical circuitry arrangement (“elec circ arrange”) e1162, when activated, will perform the operation o1162. Also, the accumulating stocking kitchen module m1162, when executed and/or activated, will direct performance of and/or perform the operation o1162. For instance, in one or more exemplary implementations, the one or more accumulating stocking kitchen instructions i1162, when executed, direct performance of the operation o1162 in the illustrative depiction as follows, and/or the accumulating stocking kitchen electrical circuitry arrangement e1162, when activated, performs the operation o1162 in the illustrative depiction as follows, and/or the accumulating stocking kitchen module m1162, when executed and/or activated, directs performance of and/or performs the operation o1162 in the illustrative depiction as follows, and/or the operation o1162 is otherwise carried out in the illustrative depiction as follows: electronically accumulating (e.g. from radio wave, etc.) residential food management information (e.g. scheduled residential food stock turnover, etc.) including (e.g. affected, etc.) one or more food related residential conditions (e.g. whether residential facility is part of an overseeing organization, etc.) affecting (e.g. affected, etc.) the residential service of (e.g. in-home nursing home residential food item packaging, etc.) one or more residential food items (e.g. baked side dish residential food item, etc.) including at least in part stocking on residential kitchen shelves one or more meal items by residential occupants (e.g. handling of produce by produce manager when restocking produce department, etc.).

In one or more implementations, as shown in FIG. 63, operation o11 includes an operation o1163 for electronically accumulating residential food management information including one or more food related residential conditions affecting the residential service of one or more residential food items including at least in part dispensing one or more one or more residential food items by one or more residential machines. Origination of an illustratively derived accumulating dispensing machines component group can be accomplished through skilled in the art design choice selection of one or more of the above depicted components from one or more of the above depicted subsystems shown in FIG. 12. Components from the accumulating dispensing machines component group can be used in implementing execution of the one or more accumulating dispensing machines instructions i1163 of FIG. 31, can be used in performance of the accumulating dispensing machines electrical circuitry arrangement e1163 of FIG. 24, and/or can be used in otherwise fulfillment of the operation o1163. An exemplary non-transitory signal bearing medium version of the information storage subsystem s200 is depicted in FIG. 31 as bearing the one or more accumulating dispensing machines instructions i1163 that when executed will direct performance of the operation o1163. Furthermore, the accumulating dispensing machines electrical circuitry arrangement (“elec circ arrange”) e1163, when activated, will perform the operation o1163. Also, the accumulating dispensing machines module m1163, when executed and/or activated, will direct performance of and/or perform the operation o1163. For instance, in one or more exemplary implementations, the one or more accumulating dispensing machines instructions i1163, when executed, direct performance of the operation o1163 in the illustrative depiction as follows, and/or the accumulating dispensing machines electrical circuitry arrangement e1163, when activated, performs the operation o1163 in the illustrative depiction as follows, and/or the accumulating dispensing machines module m1163, when executed and/or activated, directs performance of and/or performs the operation o1163 in the illustrative depiction as follows, and/or the operation o1163 is otherwise carried out in the illustrative depiction as follows: electronically accumulating (e.g. from infra-red, etc.) residential food management information (e.g. residential storage room temperature. profiles, etc.) including (e.g. affecting, etc.) one or more food related residential conditions (e.g. relative amounts of saturated to unsaturated fat used, etc.) affecting (e.g. affecting, etc.) the residential service of (e.g. outside delivery of residential food item packaging, etc.) one or more residential food items (e.g. fried side dish residential food item, etc.) including at least in part dispensing one or more one or more residential food items by one or more residential machines (e.g. dispensing meal replacement shakes from residential food item machine, etc.).

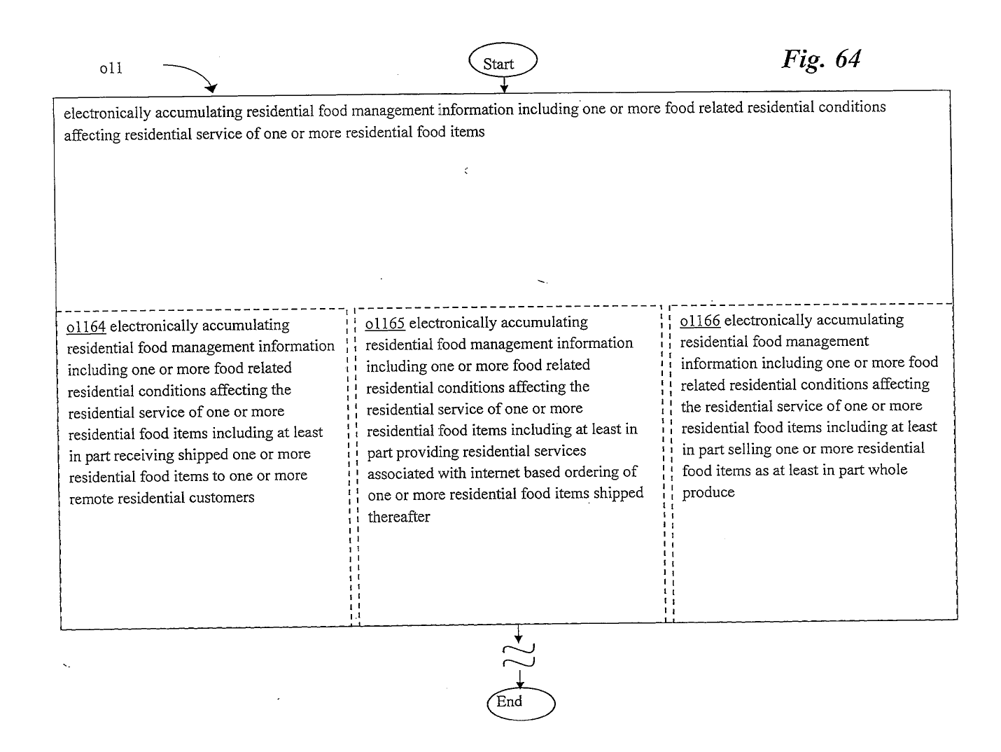

In one or more implementations, as shown in FIG. 64, operation o11 includes an operation o1164 for electronically accumulating residential food management information including one or more food related residential conditions affecting the residential service of one or more residential food items including at least in part receiving shipped one or more residential food items to one or more remote residential customers. Origination of an illustratively derived accumulating remote residential component group can be accomplished through skilled in the art design choice selection of one or more of the above depicted components from one or more of the above depicted subsystems shown in FIG. 12. Components from the accumulating remote residential component group can be used in implementing execution of the one or more accumulating remote residential instructions i1164 of FIG. 31, can be used in performance of the accumulating remote residential electrical circuitry arrangement e1164 of FIG. 24, and/or can be used in otherwise fulfillment of the operation o1164. An exemplary non-transitory signal bearing medium version of the information storage subsystem s200 is depicted in FIG. 31 as bearing the one or more accumulating remote residential instructions i1164 that when executed will direct performance of the operation o1164. Furthermore, the accumulating remote residential electrical circuitry arrangement (“elec circ arrange”) e1164, when activated, will perform the operation o1164. Also, the accumulating remote residential module m1164, when executed and/or activated, will direct performance of and/or perform the operation o1164. For instance, in one or more exemplary implementations, the one or more accumulating remote residential instructions i1164, when executed, direct performance of the operation o1164 in the illustrative depiction as follows, and/or the accumulating remote residential electrical circuitry arrangement e1164, when activated, performs the operation o1164 in the illustrative depiction as follows, and/or the accumulating remote residential module m1164, when executed and/or activated, directs performance of and/or performs the operation o1164 in the illustrative depiction as follows, and/or the operation o1164 is otherwise carried out in the illustrative depiction as follows: electronically accumulating (e.g. from bluetooth, etc.) residential food management information (e.g. residential cold storage data for stored residential food materials, etc.) including (e.g. argue, etc.) one or more food related residential conditions (e.g. labor laws, etc.) affecting (e.g. argue, etc.) the residential service of (e.g. mobile lifestyle residential food item packaging, etc.) one or more residential food items (e.g. grilled side dish residential food item, etc.) including at least in part receiving shipped one or more residential food items to one or more remote residential customers (e.g. receiving shipment of residential food items through private carrier such as FedEx, etc.).

In one or more implementations, as shown in FIG. 64, operation o11 includes an operation o1165 for electronically accumulating residential food management information including one or more food related residential conditions affecting the residential service of one or more residential food items including at least in part providing residential services associated with internet based ordering of one or more residential food items shipped thereafter. Origination of an illustratively derived accumulating internet ordering component group can be accomplished through skilled in the art design choice selection of one or more of the above depicted components from one or more of the above depicted subsystems shown in FIG. 12. Components from the accumulating internet ordering component group can be used in implementing execution of the one or more accumulating internet ordering instructions i1165 of FIG. 31, can be used in performance of the accumulating internet ordering electrical circuitry arrangement e1165 of FIG. 24, and/or can be used in otherwise fulfillment of the operation o1165. An exemplary non-transitory signal bearing medium version of the information storage subsystem s200 is depicted in FIG. 31 as bearing the one or more accumulating internet ordering instructions i1165 that when executed will direct performance of the operation o1165. Furthermore, the accumulating internet ordering electrical circuitry arrangement (“elec circ arrange”) e1165, when activated, will perform the operation o1165. Also, the accumulating internet ordering module m1165, when executed and/or activated, will direct performance of and/or perform the operation o1165. For instance, in one or more exemplary implementations, the one or more accumulating internet ordering instructions i1165, when executed, direct performance of the operation o1165 in the illustrative depiction as follows, and/or the accumulating internet ordering electrical circuitry arrangement e1165, when activated, performs the operation o1165 in the illustrative depiction as follows, and/or the accumulating internet ordering module m1165, when executed and/or activated, directs performance of and/or performs the operation o1165 in the illustrative depiction as follows, and/or the operation o1165 is otherwise carried out in the illustrative depiction as follows: electronically accumulating (e.g. from webpage, etc.) residential food management information (e.g. stove maintenance operation, etc.) including (e.g. connected, etc.) one or more food related residential conditions (e.g. safety regulations, etc.) affecting (e.g. connected, etc.) the residential service of (e.g. in-home hospital residential food item packaging, etc.) one or more residential food items (e.g. steamed side dish residential food item, etc.) including at least in part providing residential services associated with internet based ordering of one or more residential food items shipped thereafter (e.g. receiving transporting of residential food items locally in response to internet ordering, etc.).

In one or more implementations, as shown in FIG. 64, operation o11 includes an operation o1166 for electronically accumulating residential food management information including one or more food related residential conditions affecting the residential service of one or more residential food items including at least in part selling one or more residential food items as at least in part whole produce. Origination of an illustratively derived accumulating component group can be accomplished through skilled in the art design choice selection of one or more of the above depicted components from one or more of the above depicted subsystems shown in FIG. 12. Components from the accumulating component group can be used in implementing execution of the one or more accumulating instructions i1166 of FIG. 31, can be used in performance of the accumulating electrical circuitry arrangement e1166 of FIG. 24, and/or can be used in otherwise fulfillment of the operation o1166. An exemplary non-transitory signal bearing medium version of the information storage subsystem s200 is depicted in FIG. 31 as bearing the one or more accumulating instructions i1166 that when executed will direct performance of the operation o1166. Furthermore, the accumulating electrical circuitry arrangement (“elec circ arrange”) e1166, when activated, will perform the operation o1166. Also, the accumulating module m1166, when executed and/or activated, will direct performance of and/or perform the operation o1166. For instance, in one or more exemplary implementations, the one or more accumulating instructions i1166, when executed, direct performance of the operation o1166 in the illustrative depiction as follows, and/or the accumulating electrical circuitry arrangement e1166, when activated, performs the operation o1166 in the illustrative depiction as follows, and/or the accumulating module m1166, when executed and/or activated, directs performance of and/or performs the operation o1166 in the illustrative depiction as follows, and/or the operation o1166 is otherwise carried out in the illustrative depiction as follows: electronically accumulating (e.g. from website, etc.) residential food management information (e.g. electricity usage, etc.) including (e.g. commit to, etc.) one or more food related residential conditions (e.g. relative amounts of sugars to slowly digesting starches used, etc.) affecting (e.g. commit to, etc.) the residential service of (e.g. deli style residential food item packaging, etc.) one or more residential food items (e.g. chilled side dish residential food item, etc.) including at least in part selling one or more residential food items as at least in part whole produce (e.g. preparation of whole apples, potatoes, and squashes, etc.).

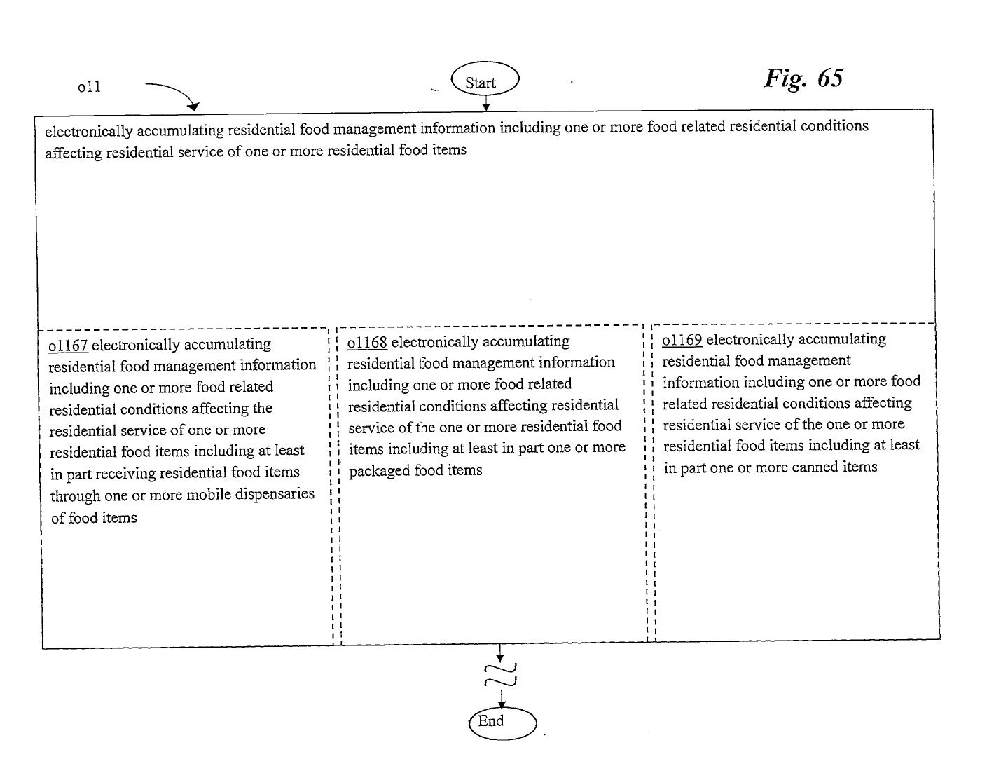

In one or more implementations, as shown in FIG. 65, operation o11 includes an operation o1167 for electronically accumulating residential food management information including one or more food related residential conditions affecting the residential service of one or more residential food items including at least in part receiving residential food items through one or more mobile dispensaries of food items. Origination of an illustratively derived accumulating mobile dispensaries component group can be accomplished through skilled in the art design choice selection of one or more of the above depicted components from one or more of the above depicted subsystems shown in FIG. 12. Components from the accumulating mobile dispensaries component group can be used in implementing execution of the one or more accumulating mobile dispensaries instructions i1167 of FIG. 31, can be used in performance of the accumulating mobile dispensaries electrical circuitry arrangement e1167 of FIG. 24, and/or can be used in otherwise fulfillment of the operation o1167. An exemplary non-transitory signal bearing medium version of the information storage subsystem s200 is depicted in FIG. 31 as bearing the one or more accumulating mobile dispensaries instructions i1167 that when executed will direct performance of the operation o1167. Furthermore, the accumulating mobile dispensaries electrical circuitry arrangement (“elec circ arrange”) e1167, when activated, will perform the operation o1167. Also, the accumulating mobile dispensaries module m1167, when executed and/or activated, will direct performance of and/or perform the operation o1167. For instance, in one or more exemplary implementations, the one or more accumulating mobile dispensaries instructions i1167, when executed, direct performance of the operation o1167 in the illustrative depiction as follows, and/or the accumulating mobile dispensaries electrical circuitry arrangement e1167, when activated, performs the operation o1167 in the illustrative depiction as follows, and/or the accumulating mobile dispensaries module m1167, when executed and/or activated, directs performance of and/or performs the operation o1167 in the illustrative depiction as follows, and/or the operation o1167 is otherwise carried out in the illustrative depiction as follows: electronically accumulating (e.g. as cellphone entry, etc.) residential food management information (e.g. residence water usage, etc.) including (e.g. absorbed by, etc.) one or more food related residential conditions (e.g. relative amounts of denatured to nondenatured protein used, etc.) affecting (e.g. absorbed by, etc.) the residential service of (e.g. fine dining residential food item transporting, etc.) one or more residential food items (e.g. microwaved side dish residential food item, etc.) including at least in part receiving residential food items through one or more mobile dispensaries of food items (e.g. truck based farmer market purchases by residential occupants that visit local community parks, etc.).

In one or more implementations, as shown in FIG. 65, operation o11 includes an operation o1168 for electronically accumulating residential food management information including one or more food related residential conditions affecting residential service of the one or more residential food items including at least in part one or more packaged food items. Origination of an illustratively derived accumulating packaged food component group can be accomplished through skilled in the art design choice selection of one or more of the above depicted components from one or more of the above depicted subsystems shown in FIG. 12. Components from the accumulating packaged food component group can be used in implementing execution of the one or more accumulating packaged food instructions i1168 of FIG. 31, can be used in performance of the accumulating packaged food electrical circuitry arrangement e1168 of FIG. 24, and/or can be used in otherwise fulfillment of the operation o1168. An exemplary non-transitory signal bearing medium version of the information storage subsystem s200 is depicted in FIG. 31 as bearing the one or more accumulating packaged food instructions i1168 that when executed will direct performance of the operation o1168. Furthermore, the accumulating packaged food electrical circuitry arrangement (“elec circ arrange”) e1168, when activated, will perform the operation o1168. Also, the accumulating packaged food module m1168, when executed and/or activated, will direct performance of and/or perform the operation o1168. For instance, in one or more exemplary implementations, the one or more accumulating packaged food instructions i1168, when executed, direct performance of the operation o1168 in the illustrative depiction as follows, and/or the accumulating packaged food electrical circuitry arrangement e1168, when activated, performs the operation o1168 in the illustrative depiction as follows, and/or the accumulating packaged food module m1168, when executed and/or activated, directs performance of and/or performs the operation o1168 in the illustrative depiction as follows, and/or the operation o1168 is otherwise carried out in the illustrative depiction as follows: electronically accumulating (e.g. as satellite transmission, etc.) residential food management information (e.g. distribution of residential food item costs, etc.) including (e.g. embraced, etc.) one or more food related residential conditions (e.g. relative amounts of animal protein to plant protein used, etc.) affecting (e.g. embraced, etc.) residential service of (e.g. fast residential food item transporting, etc.) the one or more residential food items (e.g. convection oven prepared side dish residential food item, etc.) including at least in part one or more packaged food items (e.g. pre-packaged roasted chicken, etc.).

In one or more implementations, as shown in FIG. 65, operation o11 includes an operation o1169 for electronically accumulating residential food management information including one or more food related residential conditions affecting residential service of the one or more residential food items including at least in part one or more canned items. Origination of an illustratively derived accumulating canned items component group can be accomplished through skilled in the art design choice selection of one or more of the above depicted components from one or more of the above depicted subsystems shown in FIG. 12. Components from the accumulating canned items component group can be used in implementing execution of the one or more accumulating canned items instructions i1169 of FIG. 31, can be used in performance of the accumulating canned items electrical circuitry arrangement e1169 of FIG. 24, and/or can be used in otherwise fulfillment of the operation o1169. An exemplary non-transitory signal bearing medium version of the information storage subsystem s200 is depicted in FIG. 31 as bearing the one or more accumulating canned items instructions i1169 that when executed will direct performance of the operation o1169. Furthermore, the accumulating canned items electrical circuitry arrangement (“elec circ arrange”) e1169, when activated, will perform the operation o1169. Also, the accumulating canned items module m1169, when executed and/or activated, will direct performance of and/or perform the operation o1169. For instance, in one or more exemplary implementations, the one or more accumulating canned items instructions i1169, when executed, direct performance of the operation o1169 in the illustrative depiction as follows, and/or the accumulating canned items electrical circuitry arrangement e1169, when activated, performs the operation o1169 in the illustrative depiction as follows, and/or the accumulating canned items module m1169, when executed and/or activated, directs performance of and/or performs the operation o1169 in the illustrative depiction as follows, and/or the operation o1169 is otherwise carried out in the illustrative depiction as follows: electronically accumulating (e.g. as pull-based, etc.) residential food management information (e.g. toxin levels in residential food sources, etc.) including (e.g. contain, etc.) one or more food related residential conditions (e.g. levels of one or more vitamins present in one or more residential food items used, etc.) affecting (e.g. contain, etc.) residential service of (e.g. family buffet residential food item transporting, etc.) the one or more residential food items (e.g. smoked side dish residential food item, etc.) including at least in part one or more canned items (e.g. canned tomato products, etc.).

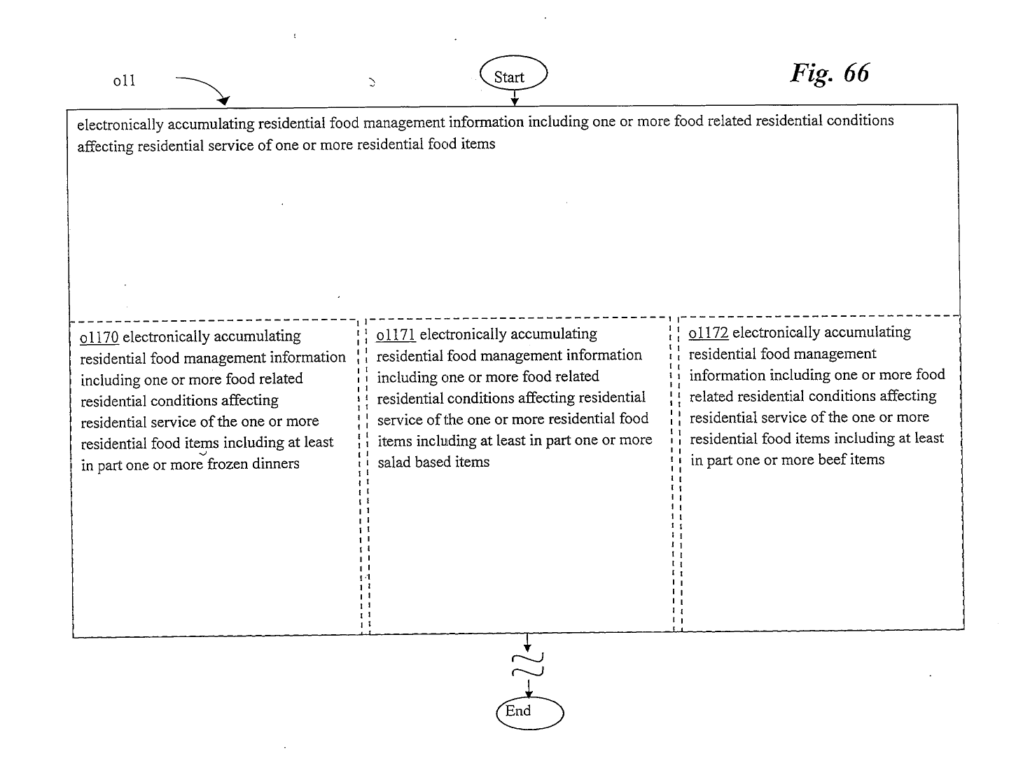

In one or more implementations, as shown in FIG. 66, operation o11 includes an operation o1170 for electronically accumulating residential food management information including one or more food related residential conditions affecting residential service of the one or more residential food items including at least in part one or more frozen dinners. Origination of an illustratively derived accumulating frozen dinners component group can be accomplished through skilled in the art design choice selection of one or more of the above depicted components from one or more of the above depicted subsystems shown in FIG. 12. Components from the accumulating frozen dinners component group can be used in implementing execution of the one or more accumulating frozen dinners instructions i1170 of FIG. 31, can be used in performance of the accumulating frozen dinners electrical circuitry arrangement e1170 of FIG. 24, and/or can be used in otherwise fulfillment of the operation o1170. An exemplary non-transitory signal bearing medium version of the information storage subsystem s200 is depicted in FIG. 31 as bearing the one or more accumulating frozen dinners instructions i1170 that when executed will direct performance of the operation o1170. Furthermore, the accumulating frozen dinners electrical circuitry arrangement (“elec circ arrange”) e1170, when activated, will perform the operation o1170. Also, the accumulating frozen dinners module m1170, when executed and/or activated, will direct performance of and/or perform the operation o1170. For instance, in one or more exemplary implementations, the one or more accumulating frozen dinners instructions i1170, when executed, direct performance of the operation o1170 in the illustrative depiction as follows, and/or the accumulating frozen dinners electrical circuitry arrangement e1170, when activated, performs the operation o1170 in the illustrative depiction as follows, and/or the accumulating frozen dinners module m1170, when executed and/or activated, directs performance of and/or performs the operation o1170 in the illustrative depiction as follows, and/or the operation o1170 is otherwise carried out in the illustrative depiction as follows: electronically accumulating (e.g. onto POP3 server, etc.) residential food management information (e.g. residential beverage consumption rates, etc.) including (e.g. engage, etc.) one or more food related residential conditions (e.g. levels of one or more minerals present in one or more residential food items used, etc.) affecting (e.g. engage, etc.) residential service of (e.g. mobile lifestyle residential food item transporting, etc.) the one or more residential food items (e.g. boiled side dish residential food item, etc.) including at least in part one or more frozen dinners (e.g. frozen steak dinner, etc.).

In one or more implementations, as shown in FIG. 66, operation o11 includes an operation o1171 for electronically accumulating residential food management information including one or more food related residential conditions affecting residential service of the one or more residential food items including at least in part one or more salad based items. Origination of an illustratively derived accumulating salad based component group can be accomplished through skilled in the art design choice selection of one or more of the above depicted components from one or more of the above depicted subsystems shown in FIG. 12. Components from the accumulating salad based component group can be used in implementing execution of the one or more accumulating salad based instructions i1171 of FIG. 31, can be used in performance of the accumulating salad based electrical circuitry arrangement e1171 of FIG. 24, and/or can be used in otherwise fulfillment of the operation o1171. An exemplary non-transitory signal bearing medium version of the information storage subsystem s200 is depicted in FIG. 31 as bearing the one or more accumulating salad based instructions i1171 that when executed will direct performance of the operation o1171. Furthermore, the accumulating salad based electrical circuitry arrangement (“elec circ arrange”) e1171, when activated, will perform the operation o1171. Also, the accumulating salad based module m1171, when executed and/or activated, will direct performance of and/or perform the operation o1171. For instance, in one or more exemplary implementations, the one or more accumulating salad based instructions i1171, when executed, direct performance of the operation o1171 in the illustrative depiction as follows, and/or the accumulating salad based electrical circuitry arrangement e1171, when activated, performs the operation o1171 in the illustrative depiction as follows, and/or the accumulating salad based module m1171, when executed and/or activated, directs performance of and/or performs the operation o1171 in the illustrative depiction as follows, and/or the operation o1171 is otherwise carried out in the illustrative depiction as follows: electronically accumulating (e.g. as hardware based encryption, etc.) residential food management information (e.g. residential occupants labor force scheduling, etc.) including (e.g. engaged by, etc.) one or more food related residential conditions (e.g. level of one or more antioxidants present in one or more residential food items used, etc.) affecting (e.g. engaged by, etc.) residential service of (e.g. institutional residential food item transporting, etc.) the one or more residential food items (e.g. sandwich side dish residential food item, etc.) including at least in part one or more salad based items (e.g. pre-packaged chef salad, etc.).

In one or more implementations, as shown in FIG. 66, operation o11 includes an operation o1172 for electronically accumulating residential food management information including one or more food related residential conditions affecting residential service of the one or more residential food items including at least in part one or more beef items. Origination of an illustratively derived accumulating beef items component group can be accomplished through skilled in the art design choice selection of one or more of the above depicted components from one or more of the above depicted subsystems shown in FIG. 12. Components from the accumulating beef items component group can be used in implementing execution of the one or more accumulating beef items instructions i1172 of FIG. 31, can be used in performance of the accumulating beef items electrical circuitry arrangement e1172 of FIG. 24, and/or can be used in otherwise fulfillment of the operation o1172. An exemplary non-transitory signal bearing medium version of the information storage subsystem s200 is depicted in FIG. 31 as bearing the one or more accumulating beef items instructions i1172 that when executed will direct performance of the operation o1172. Furthermore, the accumulating beef items electrical circuitry arrangement (“elec circ arrange”) e1172, when activated, will perform the operation o1172. Also, the accumulating beef items module m1172, when executed and/or activated, will direct performance of and/or perform the operation o1172. For instance, in one or more exemplary implementations, the one or more accumulating beef items instructions i1172, when executed, direct performance of the operation o1172 in the illustrative depiction as follows, and/or the accumulating beef items electrical circuitry arrangement e1172, when activated, performs the operation o1172 in the illustrative depiction as follows, and/or the accumulating beef items module m1172, when executed and/or activated, directs performance of and/or performs the operation o1172 in the illustrative depiction as follows, and/or the operation o1172 is otherwise carried out in the illustrative depiction as follows: electronically accumulating (e.g. as software based encryption, etc.) residential food management information (e.g. future market demands, etc.) including (e.g. incorporate, etc.) one or more food related residential conditions (e.g. characterization of the residence in terms of type of residential trade dress if any is used, etc.) affecting (e.g. incorporate, etc.) residential service of (e.g. large family cafeteria residential food item transporting, etc.) the one or more residential food items (e.g. rotisserie side dish residential food item, etc.) including at least in part one or more beef items (e.g. pre-packaged bowl of beef stew, etc.).

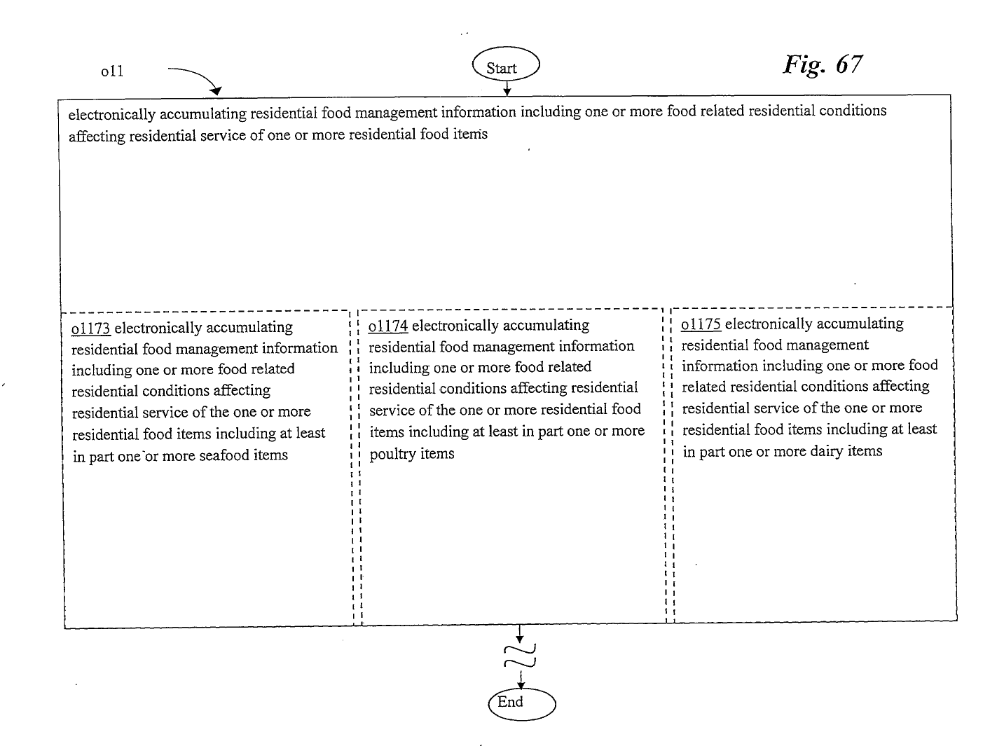

In one or more implementations, as shown in FIG. 67, operation o11 includes an operation o1173 for electronically accumulating residential food management information including one or more food related residential conditions affecting residential service of the one or more residential food items including at least in part one or more seafood items. Origination of an illustratively derived accumulating seafood items component group can be accomplished through skilled in the art design choice selection of one or more of the above depicted components from one or more of the above depicted subsystems shown in FIG. 12. Components from the accumulating seafood items component group can be used in implementing execution of the one or more accumulating seafood items instructions i1173 of FIG. 31, can be used in performance of the accumulating seafood items electrical circuitry arrangement e1173 of FIG. 24, and/or can be used in otherwise fulfillment of the operation o1173. An exemplary non-transitory signal bearing medium version of the information storage subsystem s200 is depicted in FIG. 31 as bearing the one or more accumulating seafood items instructions i1173 that when executed will direct performance of the operation o1173. Furthermore, the accumulating seafood items electrical circuitry arrangement (“elec circ arrange”) e1173, when activated, will perform the operation o1173. Also, the accumulating seafood items module m1173, when executed and/or activated, will direct performance of and/or perform the operation o1173. For instance, in one or more exemplary implementations, the one or more accumulating seafood items instructions i1173, when executed, direct performance of the operation o1173 in the illustrative depiction as follows, and/or the accumulating seafood items electrical circuitry arrangement e1173, when activated, performs the operation o1173 in the illustrative depiction as follows, and/or the accumulating seafood items module m1173, when executed and/or activated, directs performance of and/or performs the operation o1173 in the illustrative depiction as follows, and/or the operation o1173 is otherwise carried out in the illustrative depiction as follows: electronically accumulating (e.g. onto SD card, etc.) residential food management information (e.g. improper data calculation, etc.) including (e.g. engross, etc.) one or more food related residential conditions (e.g. distance between one or more farms and one or more wholesalers supplying residential food items to residence, etc.) affecting (e.g. engross, etc.) residential service of (e.g. in-home nursing home residential food item transporting, etc.) the one or more residential food items (e.g. braised side dish residential food item, etc.) including at least in part one or more seafood items (e.g. pre-packaged baked flounder, etc.).

In one or more implementations, as shown in FIG. 67, operation o11 includes an operation o1174 for electronically accumulating residential food management information including one or more food related residential conditions affecting residential service of the one or more residential food items including at least in part one or more poultry items. Origination of an illustratively derived accumulating poultry items component group can be accomplished through skilled in the art design choice selection of one or more of the above depicted components from one or more of the above depicted subsystems shown in FIG. 12. Components from the accumulating poultry items component group can be used in implementing execution of the one or more accumulating poultry items instructions i1174 of FIG. 31, can be used in performance of the accumulating poultry items electrical circuitry arrangement e1174 of FIG. 24, and/or can be used in otherwise fulfillment of the operation o1174. An exemplary non-transitory signal bearing medium version of the information storage subsystem s200 is depicted in FIG. 31 as bearing the one or more accumulating poultry items instructions i1174 that when executed will direct performance of the operation o1174. Furthermore, the accumulating poultry items electrical circuitry arrangement (“elec circ arrange”) e1174, when activated, will perform the operation o1174. Also, the accumulating poultry items module m1174, when executed and/or activated, will direct performance of and/or perform the operation o1174. For instance, in one or more exemplary implementations, the one or more accumulating poultry items instructions i1174, when executed, direct performance of the operation o1174 in the illustrative depiction as follows, and/or the accumulating poultry items electrical circuitry arrangement e1174, when activated, performs the operation o1174 in the illustrative depiction as follows, and/or the accumulating poultry items module m1174, when executed and/or activated, directs performance of and/or performs the operation o1174 in the illustrative depiction as follows, and/or the operation o1174 is otherwise carried out in the illustrative depiction as follows: electronically accumulating (e.g. onto SIM card, etc.) residential food management information (e.g. rodent infestation of residential facilities, etc.) including (e.g. implicated, etc.) one or more food related residential conditions (e.g. distance between residence and one or more wholesalers providing material to residence, etc.) affecting (e.g. implicated, etc.) residential service of (e.g. outside delivery of residential food item transporting, etc.) the one or more residential food items (e.g. sous-vide side dish residential food item, etc.) including at least in part one or more poultry items (e.g. chicken pot pie, etc.).

In one or more implementations, as shown in FIG. 67, operation o11 includes an operation o1175 for electronically accumulating residential food management information including one or more food related residential conditions affecting residential service of the one or more residential food items including at least in part one or more dairy items. Origination of an illustratively derived accumulating dairy items component group can be accomplished through skilled in the art design choice selection of one or more of the above depicted components from one or more of the above depicted subsystems shown in FIG. 12. Components from the accumulating dairy items component group can be used in implementing execution of the one or more accumulating dairy items instructions i1175 of FIG. 31, can be used in performance of the accumulating dairy items electrical circuitry arrangement e1175 of FIG. 24, and/or can be used in otherwise fulfillment of the operation o1175. An exemplary non-transitory signal bearing medium version of the information storage subsystem s200 is depicted in FIG. 31 as bearing the one or more accumulating dairy items instructions i1175 that when executed will direct performance of the operation o1175. Furthermore, the accumulating dairy items electrical circuitry arrangement (“elec circ arrange”) e1175, when activated, will perform the operation o1175. Also, the accumulating dairy items module m1175, when executed and/or activated, will direct performance of and/or perform the operation o1175. For instance, in one or more exemplary implementations, the one or more accumulating dairy items instructions i1175, when executed, direct performance of the operation o1175 in the illustrative depiction as follows, and/or the accumulating dairy items electrical circuitry arrangement e1175, when activated, performs the operation o1175 in the illustrative depiction as follows, and/or the accumulating dairy items module m1175, when executed and/or activated, directs performance of and/or performs the operation o1175 in the illustrative depiction as follows, and/or the operation o1175 is otherwise carried out in the illustrative depiction as follows: electronically accumulating (e.g. from email, etc.) residential food management information (e.g. sanitizer usage, etc.) including (e.g. necessitate, etc.) one or more food related residential conditions (e.g. one or more activity aspects of residence as an upscale home, etc.) affecting (e.g. necessitate, etc.) residential service of (e.g. mobile kitchen residential food item transporting, etc.) the one or more residential food items (e.g. blended side dish residential food item, etc.) including at least in part one or more dairy items (e.g. packaged cheese cake, etc.).

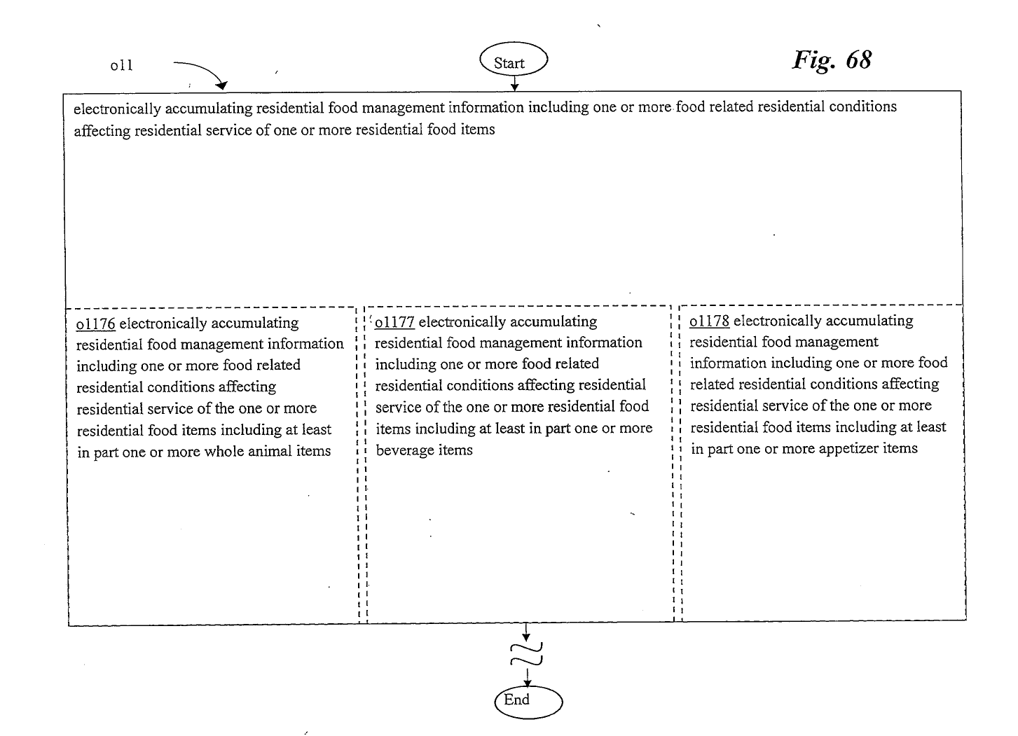

In one or more implementations, as shown in FIG. 68, operation o11 includes an operation o1176 for electronically accumulating residential food management information including one or more food related residential conditions affecting residential service of the one or more residential food items including at least in part one or more whole animal items. Origination of an illustratively derived accumulating whole animal component group can be accomplished through skilled in the art design choice selection of one or more of the above depicted components from one or more of the above depicted subsystems shown in FIG. 12. Components from the accumulating whole animal component group can be used in implementing execution of the one or more accumulating whole animal instructions i1176 of FIG. 31, can be used in performance of the accumulating whole animal electrical circuitry arrangement e1176 of FIG. 24, and/or can be used in otherwise fulfillment of the operation o1176. An exemplary non-transitory signal bearing medium version of the information storage subsystem s200 is depicted in FIG. 31 as bearing the one or more accumulating whole animal instructions i1176 that when executed will direct performance of the operation o1176. Furthermore, the accumulating whole animal electrical circuitry arrangement (“elec circ arrange”) e1176, when activated, will perform the operation o1176. Also, the accumulating whole animal module m1176, when executed and/or activated, will direct performance of and/or perform the operation o1176. For instance, in one or more exemplary implementations, the one or more accumulating whole animal instructions i1176, when executed, direct performance of the operation o1176 in the illustrative depiction as follows, and/or the accumulating whole animal electrical circuitry arrangement e1176, when activated, performs the operation o1176 in the illustrative depiction as follows, and/or the accumulating whole animal module m1176, when executed and/or activated, directs performance of and/or performs the operation o1176 in the illustrative depiction as follows, and/or the operation o1176 is otherwise carried out in the illustrative depiction as follows: electronically accumulating (e.g. as peer to peer, etc.) residential food management information (e.g. distribution of tips by residential occupants, etc.) including (e.g. presuppose, etc.) one or more food related residential conditions (e.g. one or more activity aspects of residential service as an institutional home, etc.) affecting (e.g. presuppose, etc.) residential service of (e.g. in-home hospital residential food item transporting, etc.) the one or more residential food items (e.g. beverage side dish residential food item, etc.) including at least in part one or more whole animal items (e.g. whole eggs, etc.).

In one or more implementations, as shown in FIG. 68, operation o11 includes an operation o1177 for electronically accumulating residential food management information including one or more food related residential conditions affecting residential service of the one or more residential food items including at least in part one or more beverage items. Origination of an illustratively derived accumulating beverage items component group can be accomplished through skilled in the art design choice selection of one or more of the above depicted components from one or more of the above depicted subsystems shown in FIG. 12. Components from the accumulating beverage items component group can be used in implementing execution of the one or more accumulating beverage items instructions i1177 of FIG. 31, can be used in performance of the accumulating beverage items electrical circuitry arrangement e1177 of FIG. 24, and/or can be used in otherwise fulfillment of the operation o1177. An exemplary non-transitory signal bearing medium version of the information storage subsystem s200 is depicted in FIG. 31 as bearing the one or more accumulating beverage items instructions i1177 that when executed will direct performance of the operation o1177. Furthermore, the accumulating beverage items electrical circuitry arrangement (“elec circ arrange”) e1177, when activated, will perform the operation o1177. Also, the accumulating beverage items module m1177, when executed and/or activated, will direct performance of and/or perform the operation o1177. For instance, in one or more exemplary implementations, the one or more accumulating beverage items instructions i1177, when executed, direct performance of the operation o1177 in the illustrative depiction as follows, and/or the accumulating beverage items electrical circuitry arrangement e1177, when activated, performs the operation o1177 in the illustrative depiction as follows, and/or the accumulating beverage items module m1177, when executed and/or activated, directs performance of and/or performs the operation o1177 in the illustrative depiction as follows, and/or the operation o1177 is otherwise carried out in the illustrative depiction as follows: electronically accumulating (e.g. from 10-key, etc.) residential food management information (e.g. humidity profiles of residential storage rooms, etc.) including (e.g. related to, etc.) one or more food related residential conditions (e.g. one or more activity aspects of residence as an single family dwelling, etc.) affecting (e.g. related to, etc.) residential service of (e.g. deli style residential food item transporting, etc.) the one or more residential food items (e.g. protein dominant side dish residential food item, etc.) including at least in part one or more beverage items (e.g. weight-loss shake, etc.).

In one or more implementations, as shown in FIG. 68, operation o11 includes an operation o1178 for electronically accumulating residential food management information including one or more food related residential conditions affecting residential service of the one or more residential food items including at least in part one or more appetizer items. Origination of an illustratively derived accumulating appetizer items component group can be accomplished through skilled in the art design choice selection of one or more of the above depicted components from one or more of the above depicted subsystems shown in FIG. 12. Components from the accumulating appetizer items component group can be used in implementing execution of the one or more accumulating appetizer items instructions i1178 of FIG. 31, can be used in performance of the accumulating appetizer items electrical circuitry arrangement e1178 of FIG. 24, and/or can be used in otherwise fulfillment of the operation o1178. An exemplary non-transitory signal bearing medium version of the information storage subsystem s200 is depicted in FIG. 31 as bearing the one or more accumulating appetizer items instructions i1178 that when executed will direct performance of the operation o1178. Furthermore, the accumulating appetizer items electrical circuitry arrangement (“elec circ arrange”) e1178, when activated, will perform the operation o1178. Also, the accumulating appetizer items module m1178, when executed and/or activated, will direct performance of and/or perform the operation o1178. For instance, in one or more exemplary implementations, the one or more accumulating appetizer items instructions i1178, when executed, direct performance of the operation o1178 in the illustrative depiction as follows, and/or the accumulating appetizer items electrical circuitry arrangement e1178, when activated, performs the operation o1178 in the illustrative depiction as follows, and/or the accumulating appetizer items module m1178, when executed and/or activated, directs performance of and/or performs the operation o1178 in the illustrative depiction as follows, and/or the operation o1178 is otherwise carried out in the illustrative depiction as follows: electronically accumulating (e.g. via USB port, etc.) residential food management information (e.g. profile of oxygen levels in residential produce handling facilities, etc.) including (e.g. relationship, etc.) one or more food related residential conditions (e.g. one or more activity aspects of residence as a factory food item user, etc.) affecting (e.g. relationship, etc.) residential service of (e.g. fine dining residential food item planning, etc.) the one or more residential food items (e.g. carbohydrate dominant side dish residential food item, etc.) including at least in part one or more appetizer items (e.g. packaged crackers and cheese snacks, etc.).

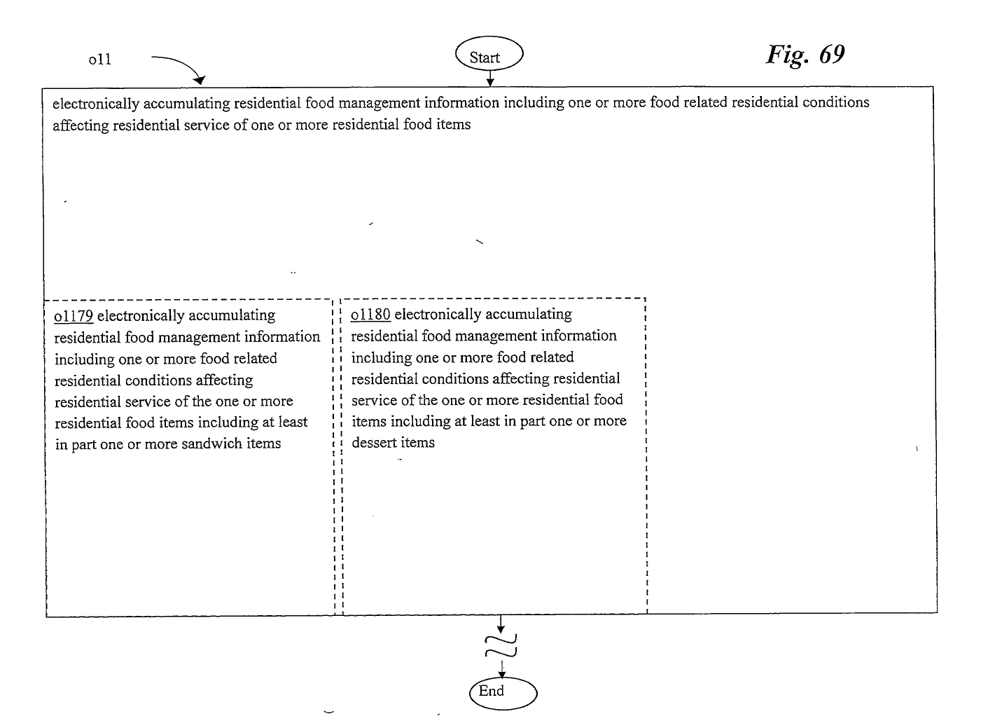

In one or more implementations, as shown in FIG. 69, operation o11 includes an operation o1179 for electronically accumulating residential food management information including one or more food related residential conditions affecting residential service of the one or more residential food items including at least in part one or more sandwich items. Origination of an illustratively derived accumulating sandwich items component group can be accomplished through skilled in the art design choice selection of one or more of the above depicted components from one or more of the above depicted subsystems shown in FIG. 12. Components from the accumulating sandwich items component group can be used in implementing execution of the one or more accumulating sandwich items instructions i1179 of FIG. 31, can be used in performance of the accumulating sandwich items electrical circuitry arrangement e1179 of FIG. 24, and/or can be used in otherwise fulfillment of the operation o1179. An exemplary non-transitory signal bearing medium version of the information storage subsystem s200 is depicted in FIG. 31 as bearing the one or more accumulating sandwich items instructions i1179 that when executed will direct performance of the operation o1179. Furthermore, the accumulating sandwich items electrical circuitry arrangement (“elec circ arrange”) e1179, when activated, will perform the operation o1179. Also, the accumulating sandwich items module m1179, when executed and/or activated, will direct performance of and/or perform the operation o1179. For instance, in one or more exemplary implementations, the one or more accumulating sandwich items instructions i1179, when executed, direct performance of the operation o1179 in the illustrative depiction as follows, and/or the accumulating sandwich items electrical circuitry arrangement e1179, when activated, performs the operation o1179 in the illustrative depiction as follows, and/or the accumulating sandwich items module m1179, when executed and/or activated, directs performance of and/or performs the operation o1179 in the illustrative depiction as follows, and/or the operation o1179 is otherwise carried out in the illustrative depiction as follows: electronically accumulating (e.g. as FTP, etc.) residential food management information (e.g. profile of carbon dioxide levels in residential facilities, etc.) including (e.g. suggest, etc.) one or more food related residential conditions (e.g. one or more activity aspects of residence as mobile based dwelling unit, etc.) affecting (e.g. suggest, etc.) residential service of (e.g. fast residential food item planning, etc.) the one or more residential food items (e.g. fat dominant side dish residential food item, etc.) including at least in part one or more sandwich items (e.g. packaged ham and cheese sandwich, etc.).

In one or more implementations, as shown in FIG. 69, operation o11 includes an operation o1180 for electronically accumulating residential food management information including one or more food related residential conditions affecting residential service of the one or more residential food items including at least in part one or more dessert items. Origination of an illustratively derived accumulating dessert items component group can be accomplished through skilled in the art design choice selection of one or more of the above depicted components from one or more of the above depicted subsystems shown in FIG. 12. Components from the accumulating dessert items component group can be used in implementing execution of the one or more accumulating dessert items instructions i1180 of FIG. 32, can be used in performance of the accumulating dessert items electrical circuitry arrangement e1180 of FIG. 25, and/or can be used in otherwise fulfillment of the operation o1180. An exemplary non-transitory signal bearing medium version of the information storage subsystem s200 is depicted in FIG. 32 as bearing the one or more accumulating dessert items instructions i1180 that when executed will direct performance of the operation o1180. Furthermore, the accumulating dessert items electrical circuitry arrangement (“elec circ arrange”) e1180, when activated, will perform the operation o1180. Also, the accumulating dessert items module m1180, when executed and/or activated, will direct performance of and/or perform the operation o1180. For instance, in one or more exemplary implementations, the one or more accumulating dessert items instructions i1180, when executed, direct performance of the operation o1180 in the illustrative depiction as follows, and/or the accumulating dessert items electrical circuitry arrangement e1180, when activated, performs the operation o1180 in the illustrative depiction as follows, and/or the accumulating dessert items module m1180, when executed and/or activated, directs performance of and/or performs the operation o1180 in the illustrative depiction as follows, and/or the operation o1180 is otherwise carried out in the illustrative depiction as follows: electronically accumulating (e.g. as HTTP, etc.) residential food management information (e.g. residential activity profiles, etc.) including (e.g. entangle, etc.) one or more food related residential conditions (e.g. one or more activity aspects of residence as internet based ordering, etc.) affecting (e.g. entangle, etc.) residential service of (e.g. family buffet residential food item planning, etc.) the one or more residential food items (e.g. pasta side dish residential food item, etc.) including at least in part one or more dessert items (e.g. chocolate cake, etc.).

As shown in FIG. 42, the operational flow o10 proceeds to operation o12 for electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items. An exemplary version of a non-transitory signal bearing medium of information storage subsystem s200 is depicted as bearing one or more electronically indicating connection instructions i12 that when executed will direct performance of the operation o12. In an implementation, the one or more electronically indicating connection instructions i12 when executed direct electronically indicating informational connection between (e.g. through database index, through database pointers, common attributes found in data set, etc.) at least a portion of residential food management information (e.g. residential cleaning protocols implemented, humidity of storage units, oxygen sensor of residential food item preparation equipment, etc.) including (e.g. associated, affected, affecting, etc.) one or more food related residential conditions (e.g. operating costs for residential facilities and equipment, equipment maintenance schedule, tool requirements for repair of residential equipment, etc.) affecting (e.g. associated, affected, affecting, etc.) residential service of (e.g. in-home nursing residential food item receiving, large family cafeteria residential food item receiving, institutional residential food item receiving, etc.) one or more food items (e.g. weight loss residential food item side dish, cold residential food item side dish, hot residential food item side dish, etc.) and between one or more descriptors (e.g. document discriminator, hologram, color code, etc.) logged as contained by (e.g. through electromagnetic reception, through search terms, through storage retrieval, etc.) one or more label carriers, (e.g. high frequency RFID, UHF emitter, ISM band emitter, etc.) said one or more label containers logged as (e.g. via server information, via index information, via body information, etc.) being at least temporarily (e.g. time since introduction of oxygen absorber, shipping time on truck from distribution center to residential, portion of shipping time returning from laboratory, etc.) within at least a vicinity of (e.g. adhered to container, tied to material, stapled to container, etc.) said one or more residential food items (e.g. filleted salmon, carrot, wheat product, etc.). Furthermore, the electronically indicating connection electrical circuitry arrangement e12 when activated will perform the operation o12. Also, the electronically indicating connection module m12, when executed and/or activated, will direct performance of and/or perform the operation o12. In an implementation, the electronically indicating connection electrical circuitry arrangement e12, when activated performs the operation o12 in the illustrative depiction as follows, and/or the electronically indicating connection module m12, when executed and/or activated, directs performance of and/or performs electronically indicating informational connection between (e.g. through database index, through database pointers, common attributes found in data set, etc.) at least a portion of residential food management information (e.g. residential cleaning protocols implemented, humidity of storage units, oxygen sensor of residential food item preparation equipment, etc.) including (e.g. associated, affected, affecting, etc.) one or more food related residential conditions (e.g. operating costs for residential facilities and equipment, equipment maintenance schedule, tool requirements for repair of residential equipment, etc.) affecting (e.g. associated, affected, affecting, etc.) residential service of (e.g. in-home nursing residential food item receiving, large family cafeteria residential food item receiving, institutional residential food item receiving, etc.) one or more food items (e.g. weight loss residential food item side dish, cold residential food item side dish, hot residential food item side dish, etc.) and between one or more descriptors (e.g. document discriminator, hologram, color code, etc.) logged as contained by (e.g. through electromagnetic reception, through search terms, through storage retrieval, etc.) one or more label carriers, (e.g. high frequency RFID, UHF emitter, ISM band emitter, etc.) said one or more label containers logged as (e.g. via server information, via index information, via body information, etc.) being at least temporarily (e.g. time since introduction of oxygen absorber, shipping time on truck from distribution center to residential, portion of shipping time returning from laboratory, etc.) within at least a vicinity of (e.g. adhered to container, tied to material, stapled to container, etc.) said one or more residential food items (e.g. filleted salmon, carrot, wheat product, etc.). In an implementation, the electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items is carried out by electronically indicating informational connection between (e.g. through database index, through database pointers, common attributes found in data set, etc.) at least a portion of residential food management information (e.g. residential cleaning protocols implemented, humidity of storage units, oxygen sensor of residential food item preparation equipment, etc.) including (e.g. associated, affected, affecting, etc.) one or more food related residential conditions (e.g. operating costs for residential facilities and equipment, equipment maintenance schedule, tool requirements for repair of residential equipment, etc.) affecting (e.g. associated, affected, affecting, etc.) residential service of (e.g. in-home nursing residential food item receiving, large family cafeteria residential food item receiving, institutional residential food item receiving, etc.) one or more food items (e.g. weight loss residential food item side dish, cold residential food item side dish, hot residential food item side dish, etc.) and between one or more descriptors (e.g. document discriminator, hologram, color code, etc.) logged as contained by (e.g. through electromagnetic reception, through search terms, through storage retrieval, etc.) one or more label carriers, (e.g. high frequency RFID, UHF emitter, ISM band emitter, etc.) said one or more label containers logged as (e.g. via server information, via index information, via body information, etc.) being at least temporarily (e.g. time since introduction of oxygen absorber, shipping time on truck from distribution center to residential, portion of shipping time returning from laboratory, etc.) within at least a vicinity of (e.g. adhered to container, tied to material, stapled to container, etc.) said one or more residential food items (e.g. filleted salmon, carrot, wheat product, etc.).

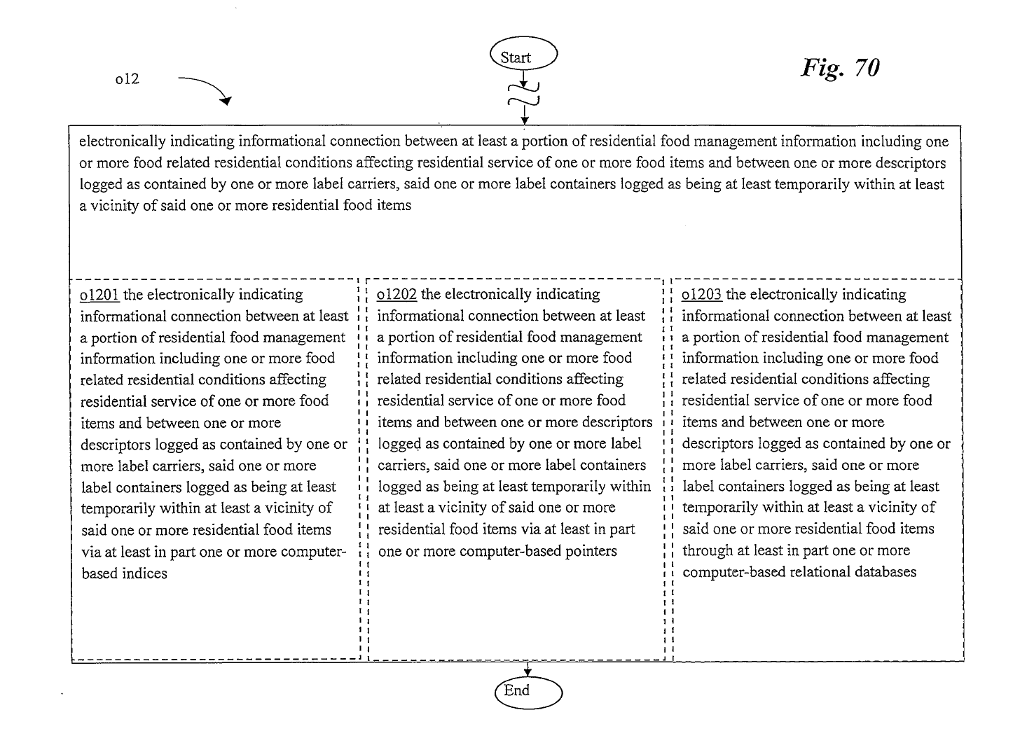

In one or more implementations, as shown in FIG. 70, operation o12 includes an operation o1201 for the electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items via at least in part one or more computer-based indices. Origination of an illustratively derived indicating indices component group can be accomplished through skilled in the art design choice selection of one or more of the above depicted components from one or more of the above depicted subsystems shown in FIG. 12. Components from the indicating indices component group can be used in implementing execution of the one or more indicating indices instructions i1201 of FIG. 33, can be used in performance of the indicating indices electrical circuitry arrangement e1201 of FIG. 26, and/or can be used in otherwise fulfillment of the operation o1201. An exemplary non-transitory signal bearing medium version of the information storage subsystem s200 is depicted in FIG. 33 as bearing the one or more indicating indices instructions i1201 that when executed will direct performance of the operation o1201. Furthermore, the indicating indices electrical circuitry arrangement (“elec circ arrange”) e1201, when activated, will perform the operation o1201. Also, the indicating indices module m1201, when executed and/or activated, will direct performance of and/or perform the operation o1201. For instance, in one or more exemplary implementations, the one or more indicating indices instructions i1201, when executed, direct performance of the operation o1201 in the illustrative depiction as follows, and/or the indicating indices electrical circuitry arrangement e1201, when activated, performs the operation o1201 in the illustrative depiction as follows, and/or the indicating indices module m1201, when executed and/or activated, directs performance of and/or performs the operation o1201 in the illustrative depiction as follows, and/or the operation o1201 is otherwise carried out in the illustrative depiction as follows: the electronically indicating informational connection between (e.g. through database index, etc.) at least a portion of residential food management information (e.g. residential cleaning protocols implemented, etc.) including (e.g. associated, etc.) one or more food related residential conditions (e.g. operating costs for residential facilities and equipment, etc.) affecting (e.g. associated, etc.) residential service of (e.g. in-home nursing residential food item receiving, etc.) one or more food items (e.g. weight loss residential food item side dish, etc.) and between one or more descriptors (e.g. document discriminator, etc.) logged as contained by (e.g. through electromagnetic reception, etc.) one or more label carriers, (e.g. high frequency RFID, etc.) said one or more label containers logged as (e.g. via server information, etc.) being at least temporarily (e.g. time since introduction of oxygen absorber, etc.) within at least a vicinity of (e.g. adhered to container, etc.) said one or more residential food items (e.g. filleted salmon, etc.) via at least in part one or more computer-based indices (e.g. through database index, etc.).

In one or more implementations, as shown in FIG. 70, operation o12 includes an operation o1202 for the electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items via at least in part one or more computer-based pointers. Origination of an illustratively derived indicating pointers component group can be accomplished through skilled in the art design choice selection of one or more of the above depicted components from one or more of the above depicted subsystems shown in FIG. 12. Components from the indicating pointers component group can be used in implementing execution of the one or more indicating pointers instructions i1202 of FIG. 33, can be used in performance of the indicating pointers electrical circuitry arrangement e1202 of FIG. 26, and/or can be used in otherwise fulfillment of the operation o1202. An exemplary non-transitory signal bearing medium version of the information storage subsystem s200 is depicted in FIG. 33 as bearing the one or more indicating pointers instructions i1202 that when executed will direct performance of the operation o1202. Furthermore, the indicating pointers electrical circuitry arrangement (“elec circ arrange”) e1202, when activated, will perform the operation o1202. Also, the indicating pointers module m1202, when executed and/or activated, will direct performance of and/or perform the operation o1202. For instance, in one or more exemplary implementations, the one or more indicating pointers instructions i1202, when executed, direct performance of the operation o1202 in the illustrative depiction as follows, and/or the indicating pointers electrical circuitry arrangement e1202, when activated, performs the operation o1202 in the illustrative depiction as follows, and/or the indicating pointers module m1202, when executed and/or activated, directs performance of and/or performs the operation o1202 in the illustrative depiction as follows, and/or the operation o1202 is otherwise carried out in the illustrative depiction as follows: the electronically indicating informational connection between (e.g. through database pointers, etc.) at least a portion of residential food management information (e.g. humidity of storage units, etc.) including (e.g. affected, etc.) one or more food related residential conditions (e.g. equipment maintenance schedule, etc.) affecting (e.g. affected, etc.) residential service of (e.g. large family cafeteria residential food item receiving, etc.) one or more food items (e.g. cold residential food item side dish, etc.) and between one or more descriptors (e.g. hologram, etc.) logged as contained by (e.g. through search terms, etc.) one or more label carriers, (e.g. UHF emitter, etc.) said one or more label containers logged as (e.g. via index information, etc.) being at least temporarily (e.g. shipping time on truck from distribution center to residential, etc.) within at least a vicinity of (e.g. tied to material, etc.) said one or more residential food items (e.g. carrot, etc.) via at least in part one or more computer-based pointers (e.g. through database pointers, etc.).

In one or more implementations, as shown in FIG. 70, operation o12 includes an operation o1203 for the electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items through at least in part one or more computer-based relational databases. Origination of an illustratively derived indicating relational databases component group can be accomplished through skilled in the art design choice selection of one or more of the above depicted components from one or more of the above depicted subsystems shown in FIG. 12. Components from the indicating relational databases component group can be used in implementing execution of the one or more indicating relational databases instructions i1203 of FIG. 33, can be used in performance of the indicating relational databases electrical circuitry arrangement e1203 of FIG. 26, and/or can be used in otherwise fulfillment of the operation o1203. An exemplary non-transitory signal bearing medium version of the information storage subsystem s200 is depicted in FIG. 33 as bearing the one or more indicating relational databases instructions i1203 that when executed will direct performance of the operation o1203. Furthermore, the indicating relational databases electrical circuitry arrangement (“elec circ arrange”) e1203, when activated, will perform the operation o1203. Also, the indicating relational databases module m1203, when executed and/or activated, will direct performance of and/or perform the operation o1203. For instance, in one or more exemplary implementations, the one or more indicating relational databases instructions i1203, when executed, direct performance of the operation o1203 in the illustrative depiction as follows, and/or the indicating relational databases electrical circuitry arrangement e1203, when activated, performs the operation o1203 in the illustrative depiction as follows, and/or the indicating relational databases module m1203, when executed and/or activated, directs performance of and/or performs the operation o1203 in the illustrative depiction as follows, and/or the operation o1203 is otherwise carried out in the illustrative depiction as follows: the electronically indicating informational connection between (e.g. common attributes found in data set, etc.) at least a portion of residential food management information (e.g. oxygen sensor of residential food item preparation equipment, etc.) including (e.g. affecting, etc.) one or more food related residential conditions (e.g. tool requirements for repair of residential equipment, etc.) affecting (e.g. affecting, etc.) residential service of (e.g. institutional residential food item receiving, etc.) one or more food items (e.g. hot residential food item side dish, etc.) and between one or more descriptors (e.g. color code, etc.) logged as contained by (e.g. through storage retrieval, etc.) one or more label carriers, (e.g. ISM band emitter, etc.) said one or more label containers logged as (e.g. via body information, etc.) being at least temporarily (e.g. portion of shipping time returning from laboratory, etc.) within at least a vicinity of (e.g. stapled to container, etc.) said one or more residential food items (e.g. wheat product, etc.) through at least in part one or more computer-based relational databases (e.g. common attributes found in data set, etc.).

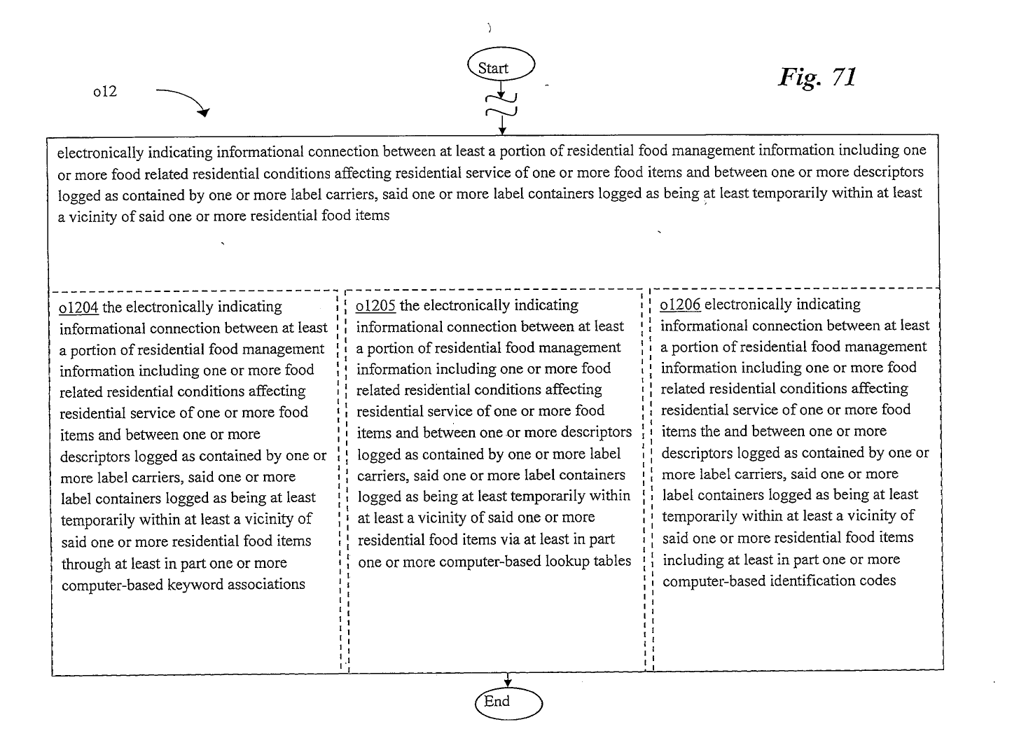

In one or more implementations, as shown in FIG. 71, operation o12 includes an operation o1204 for the electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items through at least in part one or more computer-based keyword associations. Origination of an illustratively derived indicating keyword associations component group can be accomplished through skilled in the art design choice selection of one or more of the above depicted components from one or more of the above depicted subsystems shown in FIG. 12. Components from the indicating keyword associations component group can be used in implementing execution of the one or more indicating keyword associations instructions i1204 of FIG. 33, can be used in performance of the indicating keyword associations electrical circuitry arrangement e1204 of FIG. 26, and/or can be used in otherwise fulfillment of the operation o1204. An exemplary non-transitory signal bearing medium version of the information storage subsystem s200 is depicted in FIG. 33 as bearing the one or more indicating keyword associations instructions i1204 that when executed will direct performance of the operation o1204. Furthermore, the indicating keyword associations electrical circuitry arrangement (“elec circ arrange”) e1204, when activated, will perform the operation o1204. Also, the indicating keyword associations module m1204, when executed and/or activated, will direct performance of and/or perform the operation o1204. For instance, in one or more exemplary implementations, the one or more indicating keyword associations instructions i1204, when executed, direct performance of the operation o1204 in the illustrative depiction as follows, and/or the indicating keyword associations electrical circuitry arrangement e1204, when activated, performs the operation o1204 in the illustrative depiction as follows, and/or the indicating keyword associations module m1204, when executed and/or activated, directs performance of and/or performs the operation o1204 in the illustrative depiction as follows, and/or the operation o1204 is otherwise carried out in the illustrative depiction as follows: the electronically indicating informational connection between (e.g. through search terms, etc.) at least a portion of residential food management information (e.g. bacteria count in residential produce items, etc.) including (e.g. argue, etc.) one or more food related residential conditions (e.g. local regulations, etc.) affecting (e.g. argue, etc.) residential service of (e.g. mobile lifestyle residential food item receiving, etc.) one or more food items (e.g. stew residential food item side dish, etc.) and between one or more descriptors (e.g. visual pattern, etc.) logged as contained by (e.g. through barcode scanning, etc.) one or more label carriers, (e.g. microwave emitter, etc.) said one or more label containers logged as (e.g. via food composition database, etc.) being at least temporarily (e.g. time spent on conveyor belt, etc.) within at least a vicinity of (e.g. laser etched onto container, etc.) said one or more residential food items (e.g. ground chicken ingredient, etc.) through at least in part one or more computer-based keyword associations (e.g. through search terms, etc.).

In one or more implementations, as shown in FIG. 71, operation o12 includes an operation o1205 for the electronically indicating informational connection between at least a portion of residential food management information including one or more food related residential conditions affecting residential service of one or more food items and between one or more descriptors logged as contained by one or more label carriers, said one or more label containers logged as being at least temporarily within at least a vicinity of said one or more residential food items via at least in part one or more computer-based lookup tables. Origination of an illustratively derived indicating lookup tables component group can be accomplished through skilled in the art design choice selection of one or more of the above depicted components from one or more of the above depicted subsystems shown in FIG. 12. Components from the indicating lookup tables component group can be used in implementing execution of the one or more indicating lookup tables instructions i1205 of FIG. 33, can be used in performance of the indicating lookup tables electrical circuitry arrangement e1205 of FIG. 26, and/or can be used in otherwise fulfillment of the operation o1205. An exemplary non-transitory signal bearing medium version of the information storage subsystem s200 is depicted in FIG. 33 as bearing the one or more indicating lookup tables instructions i1205 that when executed will direct performance of the operation o1205. Furthermore, the indicating lookup tables electrical circuitry arrangement (“elec circ arrange”) e1205, when activated, will perform the operation o1205. Also, the indicating lookup tables module m1205, when executed and/or activated, will direct performance of and/or perform the operation o1205. For instance, in one or more exemplary implementations, the one or more indicating lookup tables instructions i1205, when executed, direct performance of the operation o1205 in the illustrative depiction as follows, and/or the indicating lookup tables electrical circuitry arrangement e1205, when activated, performs the operation o1205 in the illustrative depiction as follows, and/or the indicating lookup tables module m1205, when executed and/or activated, directs performance of and/or performs the operation o1205 in the illustrative depiction as follows, and/or the operation o1205 is otherwise carried out in the illustrative depiction as follows: the electronically indicating informational connection between (e.g. through a query table, etc.) at least a portion of residential food management information (e.g. bacteria count on shelf surfaces, etc.) including (e.g. connected, etc.) one or more food related residential conditions (e.g. type of cuisine of residential food items used by the residential facility, etc.) affecting (e.g. connected, etc.) residential service of (e.g. family buffet residential food item receiving, etc.) one or more food items (e.g. soup residential food item side dish, etc.) and between one or more descriptors (e.g. Morse code, etc.) logged as contained by (e.g. through radiation detection, etc.) one or more label carriers, (e.g. laser ranging tracker, etc.) said one or more label containers logged as (e.g. via DVD-ROM storage, etc.) being at least temporarily (e.g. portion of time since sealed in carton, etc.) within at least a vicinity of (e.g. subdermally injected into material, etc.) said one or more residential food items (e.g. substance for produce department product, etc.) via at least in part one or more computer-based lookup tables (e.g. the database table, etc.).

In one or more implementations, as shown in FIG. 71, operation o12 includes an operation o1206 for electronically indicating informational connection between at least a portion of residential food management information including one or more food related residential conditions affecting residential service of one or more food items the and between one or more descriptors logged as contained by one or more label carriers, said one or more label containers logged as being at least temporarily within at least a vicinity of said one or more residential food items including at least in part one or more computer-based identification codes. Origination of an illustratively derived indicating identification codes component group can be accomplished through skilled in the art design choice selection of one or more of the above depicted components from one or more of the above depicted subsystems shown in FIG. 12. Components from the indicating identification codes component group can be used in implementing execution of the one or more indicating identification codes instructions i1206 of FIG. 33, can be used in performance of the indicating identification codes electrical circuitry arrangement e1206 of FIG. 26, and/or can be used in otherwise fulfillment of the operation o1206. An exemplary non-transitory signal bearing medium version of the information storage subsystem s200 is depicted in FIG. 33 as bearing the one or more indicating identification codes instructions i1206 that when executed will direct performance of the operation o1206. Furthermore, the indicating identification codes electrical circuitry arrangement (“elec circ arrange”) e1206, when activated, will perform the operation o1206. Also, the indicating identification codes module m1206, when executed and/or activated, will direct performance of and/or perform the operation o1206. For instance, in one or more exemplary implementations, the one or more indicating identification codes instructions i1206, when executed, direct performance of the operation o1206 in the illustrative depiction as follows, and/or the indicating identification codes electrical circuitry arrangement e1206, when activated, performs the operation o1206 in the illustrative depiction as follows, and/or the indicating identification codes module m1206, when executed and/or activated, directs performance of and/or performs the operation o1206 in the illustrative depiction as follows, and/or the operation o1206 is otherwise carried out in the illustrative depiction as follows: electronically indicating informational connection between (e.g. through data structure, etc.) at least a portion of residential food management information (e.g. residential equipment maintenance, etc.) including (e.g. commit to, etc.) one or more food related residential conditions (e.g. demographic location of the residential facility, etc.) affecting (e.g. commit to, etc.) residential service of (e.g. fast residential food item receiving, etc.) one or more food items (e.g. buffet residential food item side dish, etc.) the and between one or more descriptors (e.g. tertiary code, etc.) logged as contained by (e.g. through isotope identification, etc.) one or more label carriers, (e.g. ultrasonic emitter, etc.) said one or more label containers logged as (e.g. via relational database, etc.) being at least temporarily (e.g. portion of time spent packaged with similar material, etc.) within at least a vicinity of (e.g. adhered to material, etc.) said one or more residential food items (e.g. substance for dairy department product, etc.) including at least in part one or more computer-based identification codes (e.g. HTML code, etc.).

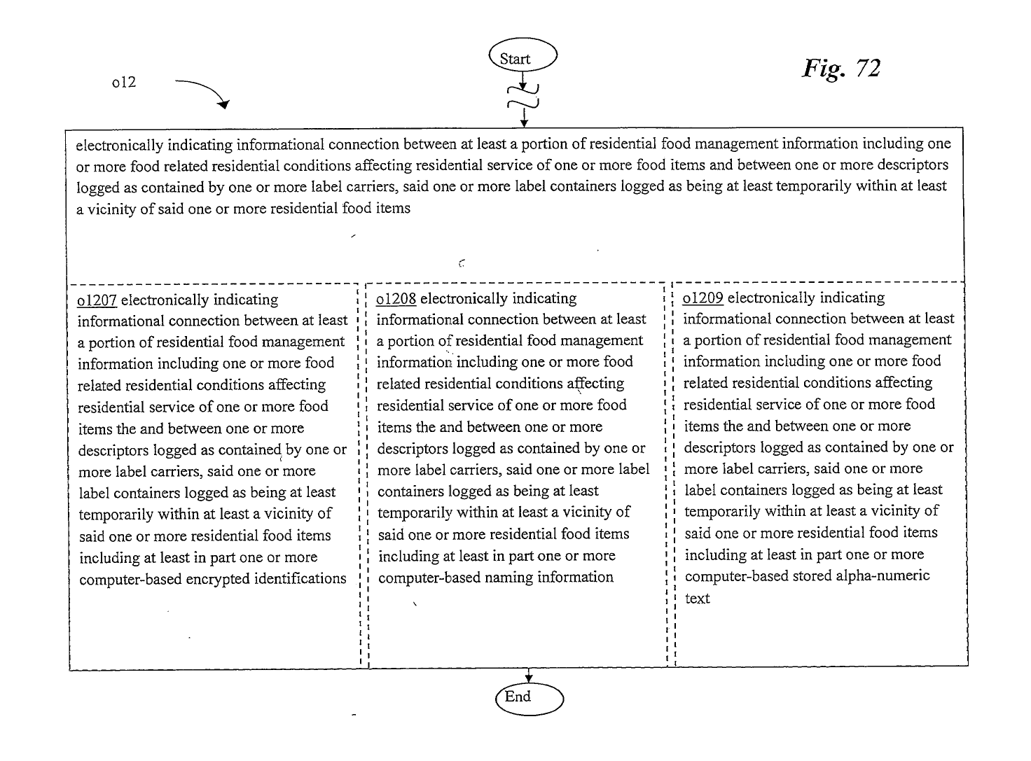

In one or more implementations, as shown in FIG. 72, operation o12 includes an operation o1207 for electronically indicating informational connection between at least a portion of residential food management information including one or more food related residential conditions affecting residential service of one or more food items the and between one or more descriptors logged as contained by one or more label carriers, said one or more label containers logged as being at least temporarily within at least a vicinity of said one or more residential food items including at least in part one or more computer-based encrypted identifications. Origination of an illustratively derived indicating encrypted identifications component group can be accomplished through skilled in the art design choice selection of one or more of the above depicted components from one or more of the above depicted subsystems shown in FIG. 12. Components from the indicating encrypted identifications component group can be used in implementing execution of the one or more indicating encrypted identifications instructions i1207 of FIG. 33, can be used in performance of the indicating encrypted identifications electrical circuitry arrangement e1207 of FIG. 26, and/or can be used in otherwise fulfillment of the operation o1207. An exemplary non-transitory signal bearing medium version of the information storage subsystem s200 is depicted in FIG. 33 as bearing the one or more indicating encrypted identifications instructions i1207 that when executed will direct performance of the operation o1207. Furthermore, the indicating encrypted identifications electrical circuitry arrangement (“elec circ arrange”) e1207, when activated, will perform the operation o1207. Also, the indicating encrypted identifications module m1207, when executed and/or activated, will direct performance of and/or perform the operation o1207. For instance, in one or more exemplary implementations, the one or more indicating encrypted identifications instructions i1207, when executed, direct performance of the operation o1207 in the illustrative depiction as follows, and/or the indicating encrypted identifications electrical circuitry arrangement e1207, when activated, performs the operation o1207 in the illustrative depiction as follows, and/or the indicating encrypted identifications module m1207, when executed and/or activated, directs performance of and/or performs the operation o1207 in the illustrative depiction as follows, and/or the operation o1207 is otherwise carried out in the illustrative depiction as follows: electronically indicating informational connection between (e.g. through database table, etc.) at least a portion of residential food management information (e.g. nitrogen gas levels of storage units, etc.) including (e.g. absorbed by, etc.) one or more food related residential conditions (e.g. age of equipment used in the residential facility, etc.) affecting (e.g. absorbed by, etc.) residential service of (e.g. fine dining residential food item receiving, etc.) one or more food items (e.g. raw residential food item side dish, etc.) the and between one or more descriptors (e.g. model number, etc.) logged as contained by (e.g. through beacon signal reception, etc.) one or more label carriers, (e.g. gyroscope, etc.) said one or more label containers logged as (e.g. via database management layer, etc.) being at least temporarily (e.g. portion of time spent on shipping vessel, etc.) within at least a vicinity of (e.g. ink stamped directly onto material, etc.) said one or more residential food items (e.g. canned soup, etc.) including at least in part one or more computer-based encrypted identifications (e.g. through 256 bit encryption, etc.).

In one or more implementations, as shown in FIG. 72, operation o12 includes an operation o1208 for electronically indicating informational connection between at least a portion of residential food management information including one or more food related residential conditions affecting residential service of one or more food items the and between one or more descriptors logged as contained by one or more label carriers, said one or more label containers logged as being at least temporarily within at least a vicinity of said one or more residential food items including at least in part one or more computer-based naming information. Origination of an illustratively derived indicating naming information component group can be accomplished through skilled in the art design choice selection of one or more of the above depicted components from one or more of the above depicted subsystems shown in FIG. 12. Components from the indicating naming information component group can be used in implementing execution of the one or more indicating naming information instructions i1208 of FIG. 33, can be used in performance of the indicating naming information electrical circuitry arrangement e1208 of FIG. 26, and/or can be used in otherwise fulfillment of the operation o1208. An exemplary non-transitory signal bearing medium version of the information storage subsystem s200 is depicted in FIG. 33 as bearing the one or more indicating naming information instructions i1208 that when executed will direct performance of the operation o1208. Furthermore, the indicating naming information electrical circuitry arrangement (“elec circ arrange”) e1208, when activated, will perform the operation o1208. Also, the indicating naming information module m1208, when executed and/or activated, will direct performance of and/or perform the operation o1208. For instance, in one or more exemplary implementations, the one or more indicating naming information instructions i1208, when executed, direct performance of the operation o1208 in the illustrative depiction as follows, and/or the indicating naming information electrical circuitry arrangement e1208, when activated, performs the operation o1208 in the illustrative depiction as follows, and/or the indicating naming information module m1208, when executed and/or activated, directs performance of and/or performs the operation o1208 in the illustrative depiction as follows, and/or the operation o1208 is otherwise carried out in the illustrative depiction as follows: electronically indicating informational connection between (e.g. through access of ordered records, etc.) at least a portion of residential food management information (e.g. amount of waste to disposed of, etc.) including (e.g. embraced by, etc.) one or more food related residential conditions (e.g. distribution of various types of residential food items used, etc.) affecting (e.g. embraced by, etc.) residential service of (e.g. deli style residential food item serving, etc.) one or more food items (e.g. cooked residential food item side dish, etc.) the and between one or more descriptors (e.g. phonetic alphabet, etc.) logged as contained by (e.g. through image scanning, etc.) one or more label carriers, (e.g. inertial sensor, etc.) said one or more label containers logged as (e.g. via footer information, etc.) being at least temporarily (e.g. time spent in cold storage, etc.) within at least a vicinity of (e.g. placed inside material, etc.) said one or more residential food items (e.g. substance for meat department product, etc.) including at least in part one or more computer-based naming information (e.g. through hierarchical nomenclature, etc.).

In one or more implementations, as shown in FIG. 72, operation o12 includes an operation o1209 for electronically indicating informational connection between at least a portion of residential food management information including one or more food related residential conditions affecting residential service of one or more food items the and between one or more descriptors logged as contained by one or more label carriers, said one or more label containers logged as being at least temporarily within at least a vicinity of said one or more residential food items including at least in part one or more computer-based stored alpha-numeric text. Origination of an illustratively derived indicating alpha-numeric text component group can be accomplished through skilled in the art design choice selection of one or more of the above depicted components from one or more of the above depicted subsystems shown in FIG. 12. Components from the indicating alpha-numeric text component group can be used in implementing execution of the one or more indicating alpha-numeric text instructions i1209 of FIG. 33, can be used in performance of the indicating alpha-numeric text electrical circuitry arrangement e1209 of FIG. 26, and/or can be used in otherwise fulfillment of the operation o1209. An exemplary non-transitory signal bearing medium version of the information storage subsystem s200 is depicted in FIG. 33 as bearing the one or more indicating alpha-numeric text instructions i1209 that when executed will direct performance of the operation o1209. Furthermore, the indicating alpha-numeric text electrical circuitry arrangement (“elec circ arrange”) e1209, when activated, will perform the operation o1209. Also, the indicating alpha-numeric text module m1209, when executed and/or activated, will direct performance of and/or perform the operation o1209. For instance, in one or more exemplary implementations, the one or more indicating alpha-numeric text instructions i1209, when executed, direct performance of the operation o1209 in the illustrative depiction as follows, and/or the indicating alpha-numeric text electrical circuitry arrangement e1209, when activated, performs the operation o1209 in the illustrative depiction as follows, and/or the indicating alpha-numeric text module m1209, when executed and/or activated, directs performance of and/or performs the operation o1209 in the illustrative depiction as follows, and/or the operation o1209 is otherwise carried out in the illustrative depiction as follows: electronically indicating informational connection between (e.g. via functions, etc.) at least a portion of residential food management information (e.g. carrier information for residential food item shipments, etc.) including (e.g. containing, etc.) one or more food related residential conditions (e.g. labor laws, etc.) affecting (e.g. containing, etc.) residential service of (e.g. in-home hospital residential food item serving, etc.) one or more food items (e.g. bean residential food item side dish, etc.) the and between one or more descriptors (e.g. Arabic alphabet, etc.) logged as contained by (e.g. through audio reception, etc.) one or more label carriers, (e.g. accelerometer, etc.) said one or more label containers logged as (e.g. via header information, etc.) being at least temporarily (e.g. portion of time spent on shipping vessel, etc.) within at least a vicinity of (e.g. placed inside container, etc.) said one or more residential food items (e.g. substance for fish department product, etc.) including at least in part one or more computer-based stored alpha-numeric text (e.g. via textual descriptors, etc.).

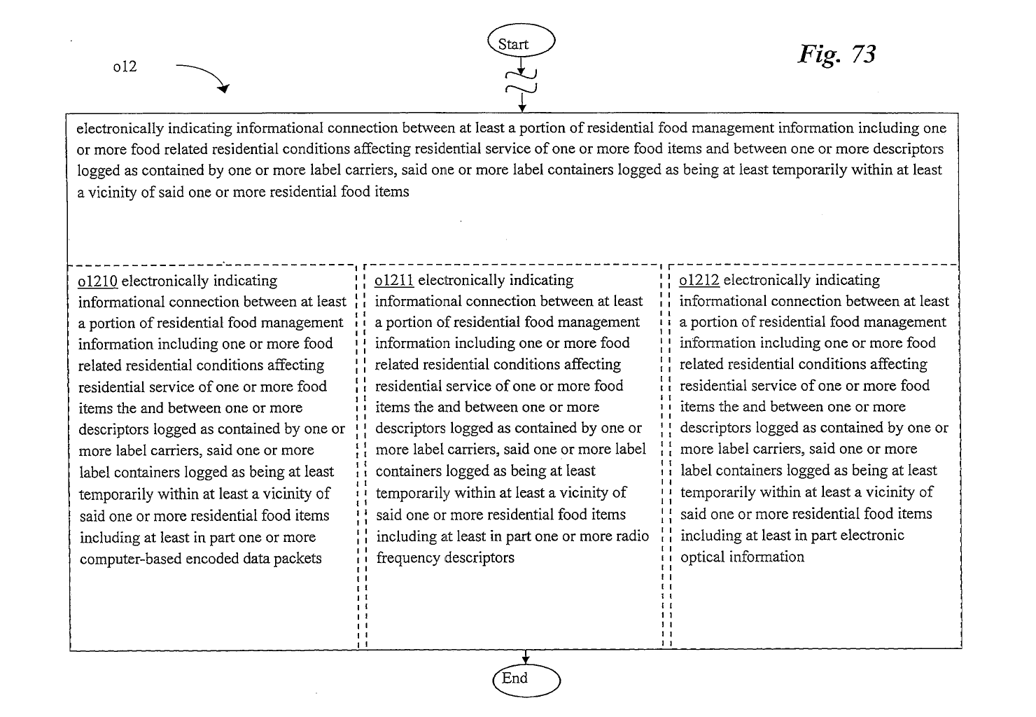

In one or more implementations, as shown in FIG. 73, operation o12 includes an operation o1210 for electronically indicating informational connection between at least a portion of residential food management information including one or more food related residential conditions affecting residential service of one or more food items the and between one or more descriptors logged as contained by one or more label carriers, said one or more label containers logged as being at least temporarily within at least a vicinity of said one or more residential food items including at least in part one or more computer-based encoded data packets. Origination of an illustratively derived indicating encoded data component group can be accomplished through skilled in the art design choice selection of one or more of the above depicted components from one or more of the above depicted subsystems shown in FIG. 12. Components from the indicating encoded data component group can be used in implementing execution of the one or more indicating encoded data instructions i1210 of FIG. 33, can be used in performance of the indicating encoded data electrical circuitry arrangement e1210 of FIG. 26, and/or can be used in otherwise fulfillment of the operation o1210. An exemplary non-transitory signal bearing medium version of the information storage subsystem s200 is depicted in FIG. 33 as bearing the one or more indicating encoded data instructions i1210 that when executed will direct performance of the operation o1210. Furthermore, the indicating encoded data electrical circuitry arrangement (“elec circ arrange”) e1210, when activated, will perform the operation o1210. Also, the indicating encoded data module m1210, when executed and/or activated, will direct performance of and/or perform the operation o1210. For instance, in one or more exemplary implementations, the one or more indicating encoded data instructions i1210, when executed, direct performance of the operation o1210 in the illustrative depiction as follows, and/or the indicating encoded data electrical circuitry arrangement e1210, when activated, performs the operation o1210 in the illustrative depiction as follows, and/or the indicating encoded data module m1210, when executed and/or activated, directs performance of and/or performs the operation o1210 in the illustrative depiction as follows, and/or the operation o1210 is otherwise carried out in the illustrative depiction as follows: electronically indicating informational connection between (e.g. via expressions, etc.) at least a portion of residential food management information (e.g. water usage, etc.) including (e.g. engaging, etc.) one or more food related residential conditions (e.g. safety regulations, etc.) affecting (e.g. engaging, etc.) residential service of (e.g. mobile kitchen residential food item serving, etc.) one or more food items (e.g. grain residential food item side dish, etc.) the and between one or more descriptors (e.g. security data, etc.) logged as contained by (e.g. through visual identification, etc.) one or more label carriers, (e.g. phase difference sensor, etc.) said one or more label containers logged as (e.g. via portion of packet information, etc.) being at least temporarily (e.g. time spent exposed to air before packaging, etc.) within at least a vicinity of (e.g. riveted to container, etc.) said one or more residential food items (e.g. ground beef, etc.) including at least in part one or more computer-based encoded data packets (e.g. tcp-ip packet, etc.).

In one or more implementations, as shown in FIG. 73, operation o12 includes an operation o1211 for electronically indicating informational connection between at least a portion of residential food management information including one or more food related residential conditions affecting residential service of one or more food items the and between one or more descriptors logged as contained by one or more label carriers, said one or more label containers logged as being at least temporarily within at least a vicinity of said one or more residential food items including at least in part one or more radio frequency descriptors. Origination of an illustratively derived indicating radio descriptors component group can be accomplished through skilled in the art design choice selection of one or more of the above depicted components from one or more of the above depicted subsystems shown in FIG. 12. Components from the indicating radio descriptors component group can be used in implementing execution of the one or more indicating radio descriptors instructions i1211 of FIG. 33, can be used in performance of the indicating radio descriptors electrical circuitry arrangement e1211 of FIG. 26, and/or can be used in otherwise fulfillment of the operation o1211. An exemplary non-transitory signal bearing medium version of the information storage subsystem s200 is depicted in FIG. 33 as bearing the one or more indicating radio descriptors instructions i1211 that when executed will direct performance of the operation o1211. Furthermore, the indicating radio descriptors electrical circuitry arrangement (“elec circ arrange”) e1211, when activated, will perform the operation o1211. Also, the indicating radio descriptors module m1211, when executed and/or activated, will direct performance of and/or perform the operation o1211. For instance, in one or more exemplary implementations, the one or more indicating radio descriptors instructions i1211, when executed, direct performance of the operation o1211 in the illustrative depiction as follows, and/or the indicating radio descriptors electrical circuitry arrangement e1211, when activated, performs the operation o1211 in the illustrative depiction as follows, and/or the indicating radio descriptors module m1211, when executed and/or activated, directs performance of and/or performs the operation o1211 in the illustrative depiction as follows, and/or the operation o1211 is otherwise carried out in the illustrative depiction as follows: electronically indicating informational connection between (e.g. via sub-linear time lookup, etc.) at least a portion of residential food management information (e.g. produce quality observed as received from various grocers or warehouses or farms, etc.) including (e.g. engaged by, etc.) one or more food related residential conditions (e.g. neighboring residential facilities, etc.) affecting (e.g. engaged by, etc.) residential service of (e.g. outside delivery residential food item serving, etc.) one or more food items (e.g. salad residential food item side dish, etc.) the and between one or more descriptors (e.g. binary sequence, etc.) logged as contained by (e.g. through light reception, etc.) one or more label carriers, (e.g. magnetic field sensor, etc.) said one or more label containers logged as (e.g. via solid state memory, etc.) being at least temporarily (e.g. portion of time spent in ice bath, etc.) within at least a vicinity of (e.g. enveloping container, etc.) said one or more residential food items (e.g. cod fish, etc.) including at least in part one or more radio frequency descriptors (e.g. RFID tag, etc.).

In one or more implementations, as shown in FIG. 73, operation o12 includes an operation o1212 for electronically indicating informational connection between at least a portion of residential food management information including one or more food related residential conditions affecting residential service of one or more food items the and between one or more descriptors logged as contained by one or more label carriers, said one or more label containers logged as being at least temporarily within at least a vicinity of said one or more residential food items including at least in part electronic optical information. Origination of an illustratively derived indicating electronic optical component group can be accomplished through skilled in the art design choice selection of one or more of the above depicted components from one or more of the above depicted subsystems shown in FIG. 12. Components from the indicating electronic optical component group can be used in implementing execution of the one or more indicating electronic optical instructions i1212 of FIG. 33, can be used in performance of the indicating electronic optical electrical circuitry arrangement e1212 of FIG. 26, and/or can be used in otherwise fulfillment of the operation o1212. An exemplary non-transitory signal bearing medium version of the information storage subsystem s200 is depicted in FIG. 33 as bearing the one or more indicating electronic optical instructions i1212 that when executed will direct performance of the operation o1212. Furthermore, the indicating electronic optical electrical circuitry arrangement (“elec circ arrange”) e1212, when activated, will perform the operation o1212. Also, the indicating electronic optical module m1212, when executed and/or activated, will direct performance of and/or perform the operation o1212. For instance, in one or more exemplary implementations, the one or more indicating electronic optical instructions i1212, when executed, direct performance of the operation o1212 in the illustrative depiction as follows, and/or the indicating electronic optical electrical circuitry arrangement e1212, when activated, performs the operation o1212 in the illustrative depiction as follows, and/or the indicating electronic optical module m1212, when executed and/or activated, directs performance of and/or performs the operation o1212 in the illustrative depiction as follows, and/or the operation o1212 is otherwise carried out in the illustrative depiction as follows: electronically indicating informational connection between (e.g. through linear search, etc.) at least a portion of residential food management information (e.g. meat quality observed as received from various grocers or warehouses or farms, etc.) including (e.g. incorporating, etc.) one or more food related residential conditions (e.g. any quarantines imposed in surrounding area, etc.) affecting (e.g. incorporating, etc.) residential service of (e.g. in-home nursing residential food item serving, etc.) one or more food items (e.g. vegetarian residential food item side dish, etc.) the and between one or more descriptors (e.g. ASCII string, etc.) logged as contained by (e.g. through color spectrum identification, etc.) one or more label carriers, (e.g. compass, etc.) said one or more label containers logged as (e.g. via food composition database, etc.) being at least temporarily (e.g. shipping time from warehouse to residence, etc.) within at least a vicinity of (e.g. debossed on material, etc.) said one or more residential food items (e.g. substance for bakery department product, etc.) including at least in part electronic optical information (e.g. holographic coded label carriers, etc.).

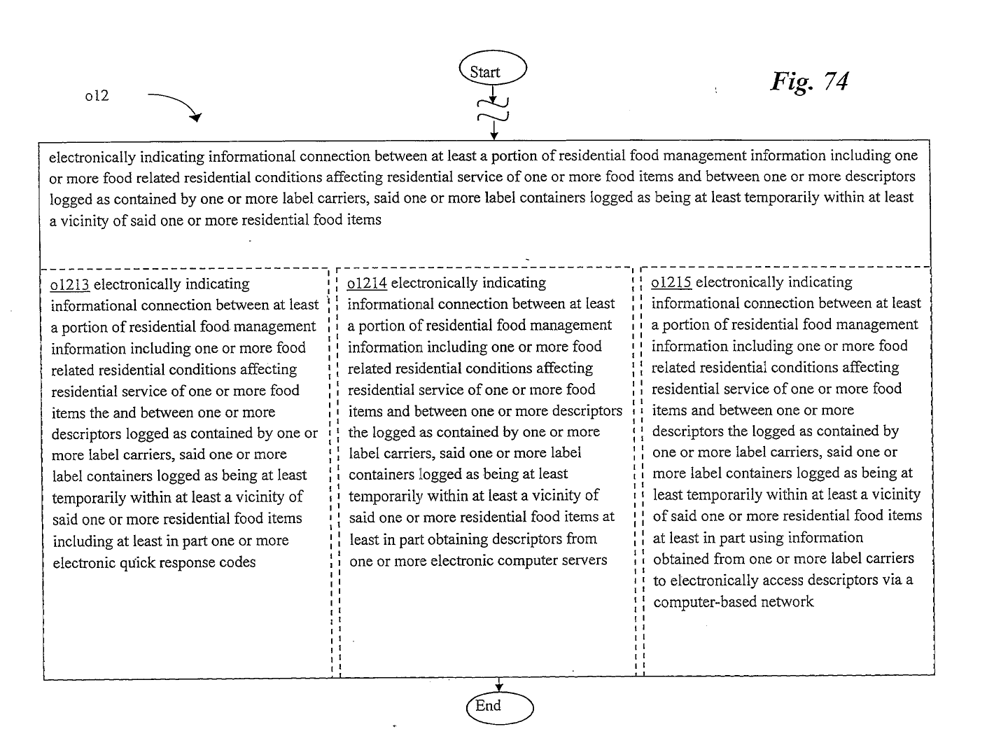

In one or more implementations, as shown in FIG. 74, operation o12 includes an operation o1213 for electronically indicating informational connection between at least a portion of residential food management information including one or more food related residential conditions affecting residential service of one or more food items the and between one or more descriptors logged as contained by one or more label carriers, said one or more label containers logged as being at least temporarily within at least a vicinity of said one or more residential food items including at least in part one or more electronic quick response codes. Origination of an illustratively derived indicating quick response component group can be accomplished through skilled in the art design choice selection of one or more of the above depicted components from one or more of the above depicted subsystems shown in FIG. 12. Components from the indicating quick response component group can be used in implementing execution of the one or more indicating quick response instructions i1213 of FIG. 33, can be used in performance of the indicating quick response electrical circuitry arrangement e1213 of FIG. 26, and/or can be used in otherwise fulfillment of the operation o1213. An exemplary non-transitory signal bearing medium version of the information storage subsystem s200 is depicted in FIG. 33 as bearing the one or more indicating quick response instructions i1213 that when executed will direct performance of the operation o1213. Furthermore, the indicating quick response electrical circuitry arrangement (“elec circ arrange”) e1213, when activated, will perform the operation o1213. Also, the indicating quick response module m1213, when executed and/or activated, will direct performance of and/or perform the operation o1213. For instance, in one or more exemplary implementations, the one or more indicating quick response instructions i1213, when executed, direct performance of the operation o1213 in the illustrative depiction as follows, and/or the indicating quick response electrical circuitry arrangement e1213, when activated, performs the operation o1213 in the illustrative depiction as follows, and/or the indicating quick response module m1213, when executed and/or activated, directs performance of and/or performs the operation o1213 in the illustrative depiction as follows, and/or the operation o1213 is otherwise carried out in the illustrative depiction as follows: electronically indicating informational connection between (e.g. through database constraints, etc.) at least a portion of residential food management information (e.g. poultry quality observed as received from various grocers or warehouses or farms, etc.) including (e.g. engrossing, etc.) one or more food related residential conditions (e.g. pesticide levels of food materials used to prepare residential food items used, etc.) affecting (e.g. engrossing, etc.) residential service of (e.g. large family cafeteria residential food item serving, etc.) one or more food items (e.g. diary residential food item side dish, etc.) the and between one or more descriptors (e.g. alpha-numeric, etc.) logged as contained by (e.g. through RF reception, etc.) one or more label carriers, (e.g. inclinometer, etc.) said one or more label containers logged as (e.g. via database table information, etc.) being at least temporarily (e.g. time spent in laboratory for testing, etc.) within at least a vicinity of (e.g. embossed on material, etc.) said one or more residential food items (e.g. substance for cereal product, etc.) including at least in part one or more electronic quick response codes (e.g. quick response code packaging labels, etc.).

In one or more implementations, as shown in FIG. 74, operation o12 includes an operation o1214 for electronically indicating informational connection between at least a portion of residential food management information including one or more food related residential conditions affecting residential service of one or more food items and between one or more descriptors the logged as contained by one or more label carriers, said one or more label containers logged as being at least temporarily within at least a vicinity of said one or more residential food items at least in part obtaining descriptors from one or more electronic computer servers. Origination of an illustratively derived indicating computer servers component group can be accomplished through skilled in the art design choice selection of one or more of the above depicted components from one or more of the above depicted subsystems shown in FIG. 12. Components from the indicating computer servers component group can be used in implementing execution of the one or more indicating computer servers instructions i1214 of FIG. 33, can be used in performance of the indicating computer servers electrical circuitry arrangement e1214 of FIG. 26, and/or can be used in otherwise fulfillment of the operation o1214. An exemplary non-transitory signal bearing medium version of the information storage subsystem s200 is depicted in FIG. 33 as bearing the one or more indicating computer servers instructions i1214 that when executed will direct performance of the operation o1214. Furthermore, the indicating computer servers electrical circuitry arrangement (“elec circ arrange”) e1214, when activated, will perform the operation o1214. Also, the indicating computer servers module m1214, when executed and/or activated, will direct performance of and/or perform the operation o1214. For instance, in one or more exemplary implementations, the one or more indicating computer servers instructions i1214, when executed, direct performance of the operation o1214 in the illustrative depiction as follows, and/or the indicating computer servers electrical circuitry arrangement e1214, when activated, performs the operation o1214 in the illustrative depiction as follows, and/or the indicating computer servers module m1214, when executed and/or activated, directs performance of and/or performs the operation o1214 in the illustrative depiction as follows, and/or the operation o1214 is otherwise carried out in the illustrative depiction as follows: electronically indicating informational connection between (e.g. through unique exclusions of data, etc.) at least a portion of residential food management information (e.g. shipping container information, etc.) including (e.g. implicate, etc.) one or more food related residential conditions (e.g. type of sanitizers used, etc.) affecting (e.g. implicate, etc.) residential service of (e.g. institutional residential food item serving, etc.) one or more food items (e.g. poultry residential food item side dish, etc.) and between one or more descriptors (e.g. ISO basic Latin alphabet, etc.) the logged as contained by (e.g. through scanning, etc.) one or more label carriers, (e.g. hybrid positioning system, etc.) said one or more label containers logged as (e.g. via database object information, etc.) being at least temporarily (e.g. partial time spent on retail display, etc.) within at least a vicinity of (e.g. welded onto container, etc.) said one or more residential food items (e.g. corn on cob, etc.) at least in part obtaining descriptors from one or more electronic computer servers (e.g. challenge-response server system, etc.).

In one or more implementations, as shown in FIG. 74, operation o12 includes an operation o1215 for electronically indicating informational connection between at least a portion of residential food management information including one or more food related residential conditions affecting residential service of one or more food items and between one or more descriptors the logged as contained by one or more label carriers, said one or more label containers logged as being at least temporarily within at least a vicinity of said one or more residential food items at least in part using information obtained from one or more label carriers to electronically access descriptors via a computer-based network. Origination of an illustratively derived indicating network component group can be accomplished through skilled in the art design choice selection of one or more of the above depicted components from one or more of the above depicted subsystems shown in FIG. 12. Components from the indicating network component group can be used in implementing execution of the one or more indicating network instructions i1215 of FIG. 33, can be used in performance of the indicating network electrical circuitry arrangement e1215 of FIG. 26, and/or can be used in otherwise fulfillment of the operation o1215. An exemplary non-transitory signal bearing medium version of the information storage subsystem s200 is depicted in FIG. 33 as bearing the one or more indicating network instructions i1215 that when executed will direct performance of the operation o1215. Furthermore, the indicating network electrical circuitry arrangement (“elec circ arrange”) e1215, when activated, will perform the operation o1215. Also, the indicating network module m1215, when executed and/or activated, will direct performance of and/or perform the operation o1215. For instance, in one or more exemplary implementations, the one or more indicating network instructions i1215, when executed, direct performance of the operation o1215 in the illustrative depiction as follows, and/or the indicating network electrical circuitry arrangement e1215, when activated, performs the operation o1215 in the illustrative depiction as follows, and/or the indicating network module m1215, when executed and/or activated, directs performance of and/or performs the operation o1215 in the illustrative depiction as follows, and/or the operation o1215 is otherwise carried out in the illustrative depiction as follows: electronically indicating informational connection between (e.g. through primary key, etc.) at least a portion of residential food management information (e.g. dairy quality observed from various grocers or warehouses or farms, etc.) including (e.g. necessitate, etc.) one or more food related residential conditions (e.g. whether any GMO foods are used, etc.) affecting (e.g. necessitate, etc.) residential service of (e.g. mobile lifestyle residential food item serving, etc.) one or more food items (e.g. seafood residential food item side dish, etc.) and between one or more descriptors (e.g. symmetrically encrypted data packet, etc.) the logged as contained by (e.g. through database query, etc.) one or more label carriers, (e.g. high frequency RFID, etc.) said one or more label containers logged as (e.g. via flat database, etc.) being at least temporarily (e.g. time on train between two terminals, etc.) within at least a vicinity of (e.g. bolted to container, etc.) said one or more residential food items (e.g. wheat substance, etc.) at least in part using information obtained from one or more label carriers to electronically access descriptors via a computer-based network (e.g. identifier located on a server accessed through the internet, etc.).

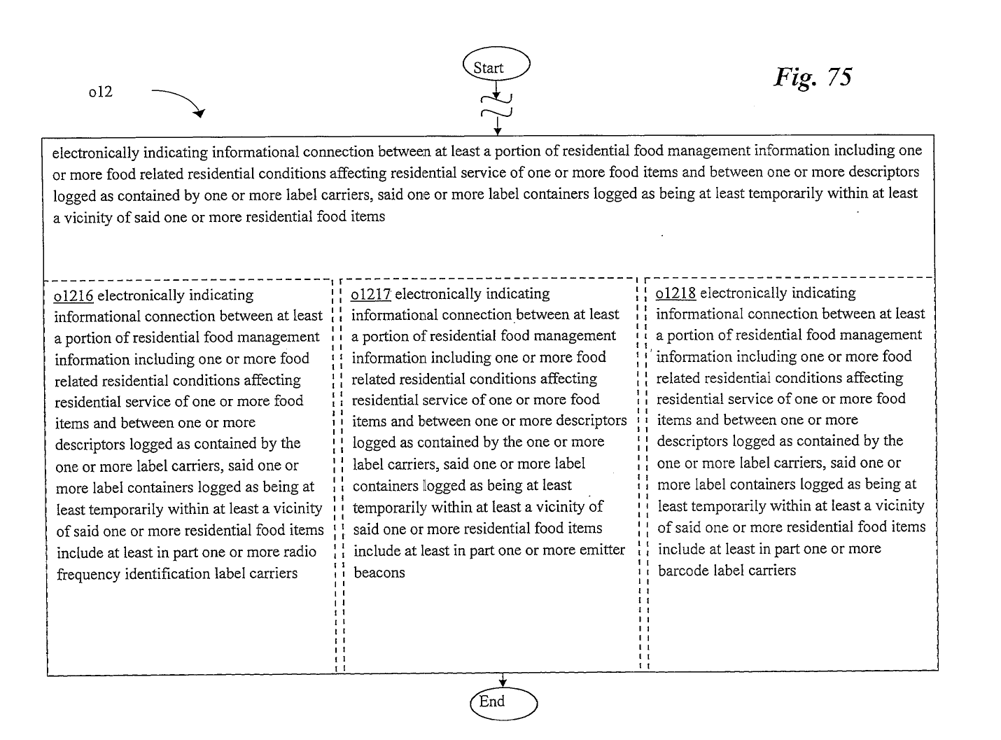

In one or more implementations, as shown in FIG. 75, operation o12 includes an operation o1216 for electronically indicating informational connection between at least a portion of residential food management information including one or more food related residential conditions affecting residential service of one or more food items and between one or more descriptors logged as contained by the one or more label carriers, said one or more label containers logged as being at least temporarily within at least a vicinity of said one or more residential food items include at least in part one or more radio frequency identification label carriers. Origination of an illustratively derived indicating radio identification component group can be accomplished through skilled in the art design choice selection of one or more of the above depicted components from one or more of the above depicted subsystems shown in FIG. 12. Components from the indicating radio identification component group can be used in implementing execution of the one or more indicating radio identification instructions i1216 of FIG. 33, can be used in performance of the indicating radio identification electrical circuitry arrangement e1216 of FIG. 26, and/or can be used in otherwise fulfillment of the operation o1216. An exemplary non-transitory signal bearing medium version of the information storage subsystem s200 is depicted in FIG. 33 as bearing the one or more indicating radio identification instructions i1216 that when executed will direct performance of the operation o1216. Furthermore, the indicating radio identification electrical circuitry arrangement (“elec circ arrange”) e1216, when activated, will perform the operation o1216. Also, the indicating radio identification module m1216, when executed and/or activated, will direct performance of and/or perform the operation o1216. For instance, in one or more exemplary implementations, the one or more indicating radio identification instructions i1216, when executed, direct performance of the operation o1216 in the illustrative depiction as follows, and/or the indicating radio identification electrical circuitry arrangement e1216, when activated, performs the operation o1216 in the illustrative depiction as follows, and/or the indicating radio identification module m1216, when executed and/or activated, directs performance of and/or performs the operation o1216 in the illustrative depiction as follows, and/or the operation o1216 is otherwise carried out in the illustrative depiction as follows: electronically indicating informational connection between (e.g. through foreign key search, etc.) at least a portion of residential food management information (e.g. AVI file format, etc.) including (e.g. presuppose, etc.) one or more food related residential conditions (e.g. instances of health violations in residential facilities, etc.) affecting (e.g. presuppose, etc.) residential service of (e.g. family buffet residential food item serving, etc.) one or more food items (e.g. chicken residential food item side dish, etc.) and between one or more descriptors (e.g. serial number, etc.) logged as contained by (e.g. through electromagnetic reception, etc.) the one or more label carriers, (e.g. low frequency RFID, etc.) said one or more label containers logged as (e.g. via relational database, etc.) being at least temporarily (e.g. time held in port for inspection period, etc.) within at least a vicinity of (e.g. embossed on container, etc.) said one or more residential food items (e.g. pork meat, etc.) include at least in part one or more radio frequency identification label carriers (e.g. separate RFID chips for each shipment carton of stock materials, etc.).

In one or more implementations, as shown in FIG. 75, operation o12 includes an operation o1217 for electronically indicating informational connection between at least a portion of residential food management information including one or more food related residential conditions affecting residential service of one or more food items and between one or more descriptors logged as contained by the one or more label carriers, said one or more label containers logged as being at least temporarily within at least a vicinity of said one or more residential food items include at least in part one or more emitter beacons. Origination of an illustratively derived indicating emitter beacons component group can be accomplished through skilled in the art design choice selection of one or more of the above depicted components from one or more of the above depicted subsystems shown in FIG. 12. Components from the indicating emitter beacons component group can be used in implementing execution of the one or more indicating emitter beacons instructions i1217 of FIG. 33, can be used in performance of the indicating emitter beacons electrical circuitry arrangement e1217 of FIG. 26, and/or can be used in otherwise fulfillment of the operation o1217. An exemplary non-transitory signal bearing medium version of the information storage subsystem s200 is depicted in FIG. 33 as bearing the one or more indicating emitter beacons instructions i1217 that when executed will direct performance of the operation o1217. Furthermore, the indicating emitter beacons electrical circuitry arrangement (“elec circ arrange”) e1217, when activated, will perform the operation o1217. Also, the indicating emitter beacons module m1217, when executed and/or activated, will direct performance of and/or perform the operation o1217. For instance, in one or more exemplary implementations, the one or more indicating emitter beacons instructions i1217, when executed, direct performance of the operation o1217 in the illustrative depiction as follows, and/or the indicating emitter beacons electrical circuitry arrangement e1217, when activated, performs the operation o1217 in the illustrative depiction as follows, and/or the indicating emitter beacons module m1217, when executed and/or activated, directs performance of and/or performs the operation o1217 in the illustrative depiction as follows, and/or the operation o1217 is otherwise carried out in the illustrative depiction as follows: electronically indicating informational connection between (e.g. through a hash table search, etc.) at least a portion of residential food management information (e.g. MP3 file format, etc.) including (e.g. related to, etc.) one or more food related residential conditions (e.g. purchasing patterns from wholesalers, etc.) affecting (e.g. related to, etc.) residential service of (e.g. fast residential food item serving, etc.) one or more food items (e.g. tofu residential food item side dish, etc.) and between one or more descriptors (e.g. barcode, etc.) logged as contained by (e.g. through search terms, etc.) the one or more label carriers, (e.g. ultrasonic tracker, etc.) said one or more label containers logged as (e.g. via ROM storage, etc.) being at least temporarily (e.g. time in holding bay, etc.) within at least a vicinity of (e.g. snapped onto container, etc.) said one or more residential food items (e.g. water, etc.) include at least in part one or more emitter beacons (e.g. radio frequency beacon for each shipment from farm to wholesaler to residential store, etc.).

In one or more implementations, as shown in FIG. 75, operation o12 includes an operation o1218 for electronically indicating informational connection between at least a portion of residential food management information including one or more food related residential conditions affecting residential service of one or more food items and between one or more descriptors logged as contained by the one or more label carriers, said one or more label containers logged as being at least temporarily within at least a vicinity of said one or more residential food items include at least in part one or more barcode label carriers. Origination of an illustratively derived indicating barcode label component group can be accomplished through skilled in the art design choice selection of one or more of the above depicted components from one or more of the above depicted subsystems shown in FIG. 12. Components from the indicating barcode label component group can be used in implementing execution of the one or more indicating barcode label instructions i1218 of FIG. 33, can be used in performance of the indicating barcode label electrical circuitry arrangement e1218 of FIG. 26, and/or can be used in otherwise fulfillment of the operation o1218. An exemplary non-transitory signal bearing medium version of the information storage subsystem s200 is depicted in FIG. 33 as bearing the one or more indicating barcode label instructions i1218 that when executed will direct performance of the operation o1218. Furthermore, the indicating barcode label electrical circuitry arrangement (“elec circ arrange”) e1218, when activated, will perform the operation o1218. Also, the indicating barcode label module m1218, when executed and/or activated, will direct performance of and/or perform the operation o1218. For instance, in one or more exemplary implementations, the one or more indicating barcode label instructions i1218, when executed, direct performance of the operation o1218 in the illustrative depiction as follows, and/or the indicating barcode label electrical circuitry arrangement e1218, when activated, performs the operation o1218 in the illustrative depiction as follows, and/or the indicating barcode label module m1218, when executed and/or activated, directs performance of and/or performs the operation o1218 in the illustrative depiction as follows, and/or the operation o1218 is otherwise carried out in the illustrative depiction as follows: electronically indicating informational connection between (e.g. via a SQL search, etc.) at least a portion of residential food management information (e.g. audio listening, etc.) including (e.g. relationship, etc.) one or more food related residential conditions (e.g. rodent infestation history, etc.) affecting (e.g. relationship, etc.) residential service of (e.g. fine dining residential food item serving, etc.) one or more food items (e.g. fish residential food item side dish, etc.) and between one or more descriptors (e.g. kanji character set, etc.) logged as contained by (e.g. through storage retrieval, etc.) the one or more label carriers, (e.g. high capacity color barcode, etc.) said one or more label containers logged as (e.g. via database table information, etc.) being at least temporarily (e.g. shipping time across Pacific Ocean, etc.) within at least a vicinity of (e.g. magnetically attached to container, etc.) said one or more residential food items (e.g. substance for beverage department product, etc.) include at least in part one or more barcode label carriers (e.g. dedicated barcode tag for each shipment container received by residential store, etc.).

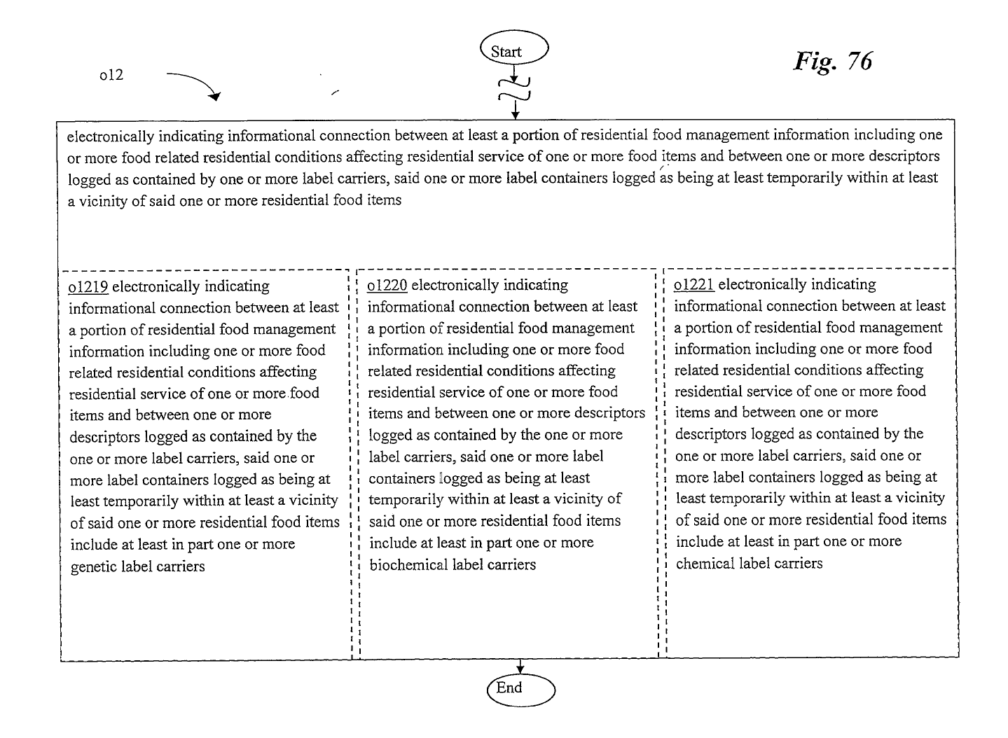

In one or more implementations, as shown in FIG. 76, operation o12 includes an operation o1219 for electronically indicating informational connection between at least a portion of residential food management information including one or more food related residential conditions affecting residential service of one or more food items and between one or more descriptors logged as contained by the one or more label carriers, said one or more label containers logged as being at least temporarily within at least a vicinity of said one or more residential food items include at least in part one or more genetic label carriers. Origination of an illustratively derived indicating genetic label component group can be accomplished through skilled in the art design choice selection of one or more of the above depicted components from one or more of the above depicted subsystems shown in FIG. 12. Components from the indicating genetic label component group can be used in implementing execution of the one or more indicating genetic label instructions i1219 of FIG. 33, can be used in performance of the indicating genetic label electrical circuitry arrangement e1219 of FIG. 26, and/or can be used in otherwise fulfillment of the operation o1219. An exemplary non-transitory signal bearing medium version of the information storage subsystem s200 is depicted in FIG. 33 as bearing the one or more indicating genetic label instructions i1219 that when executed will direct performance of the operation o1219. Furthermore, the indicating genetic label electrical circuitry arrangement (“elec circ arrange”) e1219, when activated, will perform the operation o1219. Also, the indicating genetic label module m1219, when executed and/or activated, will direct performance of and/or perform the operation o1219. For instance, in one or more exemplary implementations, the one or more indicating genetic label instructions i1219, when executed, direct performance of the operation o1219 in the illustrative depiction as follows, and/or the indicating genetic label electrical circuitry arrangement e1219, when activated, performs the operation o1219 in the illustrative depiction as follows, and/or the indicating genetic label module m1219, when executed and/or activated, directs performance of and/or performs the operation o1219 in the illustrative depiction as follows, and/or the operation o1219 is otherwise carried out in the illustrative depiction as follows: electronically indicating informational connection between (e.g. through a bitmap index, etc.) at least a portion of residential food management information (e.g. disobeying safety protocols, etc.) including (e.g. suggest, etc.) one or more food related residential conditions (e.g. recycling practices implemented, etc.) affecting (e.g. suggest, etc.) residential service of (e.g. fast residential food item preparation, etc.) one or more food items (e.g. pork residential food item side dish, etc.) and between one or more descriptors (e.g. matrix code, etc.) logged as contained by (e.g. through barcode scanning, etc.) the one or more label carriers, (e.g. expressed sequence tag, etc.) said one or more label containers logged as (e.g. via database object information, etc.) being at least temporarily (e.g. time in storage and display after unpacking, etc.) within at least a vicinity of (e.g. stamped onto container, etc.) said one or more residential food items (e.g. substance for pet food department, etc.) include at least in part one or more genetic label carriers (e.g. genetic label carriers imbedded in each stock item, etc.).

In one or more implementations, as shown in FIG. 76, operation o12 includes an operation o1220 for electronically indicating informational connection between at least a portion of residential food management information including one or more food related residential conditions affecting residential service of one or more food items and between one or more descriptors logged as contained by the one or more label carriers, said one or more label containers logged as being at least temporarily within at least a vicinity of said one or more residential food items include at least in part one or more biochemical label carriers. Origination of an illustratively derived indicating biochemical label component group can be accomplished through skilled in the art design choice selection of one or more of the above depicted components from one or more of the above depicted subsystems shown in FIG. 12. Components from the indicating biochemical label component group can be used in implementing execution of the one or more indicating biochemical label instructions i1220 of FIG. 34, can be used in performance of the indicating biochemical label electrical circuitry arrangement e1220 of FIG. 27, and/or can be used in otherwise fulfillment of the operation o1220. An exemplary non-transitory signal bearing medium version of the information storage subsystem s200 is depicted in FIG. 34 as bearing the one or more indicating biochemical label instructions i1220 that when executed will direct performance of the operation o1220. Furthermore, the indicating biochemical label electrical circuitry arrangement (“elec circ arrange”) e1220, when activated, will perform the operation o1220. Also, the indicating biochemical label module m1220, when executed and/or activated, will direct performance of and/or perform the operation o1220. For instance, in one or more exemplary implementations, the one or more indicating biochemical label instructions i1220, when executed, direct performance of the operation o1220 in the illustrative depiction as follows, and/or the indicating biochemical label electrical circuitry arrangement e1220, when activated, performs the operation o1220 in the illustrative depiction as follows, and/or the indicating biochemical label module m1220, when executed and/or activated, directs performance of and/or performs the operation o1220 in the illustrative depiction as follows, and/or the operation o1220 is otherwise carried out in the illustrative depiction as follows: electronically indicating informational connection between (e.g. through a dense index, etc.) at least a portion of residential food management information (e.g. residential occupant occupation rates, etc.) including (e.g. tangle, etc.) one or more food related residential conditions (e.g. demographics of residential customers, etc.) affecting (e.g. tangle, etc.) residential service of (e.g. fine dining residential food item preparation, etc.) one or more food items (e.g. beef residential food item side dish, etc.) and between one or more descriptors (e.g. SPARQCode, etc.) logged as contained by (e.g. through radiation detection, etc.) the one or more label carriers, (e.g. retrograde neuronal tracer, etc.) said one or more label containers logged as (e.g. via digital linear tape storage, etc.) being at least temporarily (e.g. shipping time from farm to residence, etc.) within at least a vicinity of (e.g. tied to container, etc.) said one or more residential food items (e.g. cat fish, etc.) include at least in part one or more biochemical label carriers (e.g. biochemical painted on to stock material supplied to the residential store, etc.).

In one or more implementations, as shown in FIG. 76, operation o12 includes an operation o1221 for electronically indicating informational connection between at least a portion of residential food management information including one or more food related residential conditions affecting residential service of one or more food items and between one or more descriptors logged as contained by the one or more label carriers, said one or more label containers logged as being at least temporarily within at least a vicinity of said one or more residential food items include at least in part one or more chemical label carriers. Origination of an illustratively derived indicating chemical label component group can be accomplished through skilled in the art design choice selection of one or more of the above depicted components from one or more of the above depicted subsystems shown in FIG. 12. Components from the indicating chemical label component group can be used in implementing execution of the one or more indicating chemical label instructions i1221 of FIG. 34, can be used in performance of the indicating chemical label electrical circuitry arrangement e1221 of FIG. 27, and/or can be used in otherwise fulfillment of the operation o1221. An exemplary non-transitory signal bearing medium version of the information storage subsystem s200 is depicted in FIG. 34 as bearing the one or more indicating chemical label instructions i1221 that when executed will direct performance of the operation o1221. Furthermore, the indicating chemical label electrical circuitry arrangement (“elec circ arrange”) e1221, when activated, will perform the operation o1221. Also, the indicating chemical label module m1221, when executed and/or activated, will direct performance of and/or perform the operation o1221. For instance, in one or more exemplary implementations, the one or more indicating chemical label instructions i1221, when executed, direct performance of the operation o1221 in the illustrative depiction as follows, and/or the indicating chemical label electrical circuitry arrangement e1221, when activated, performs the operation o1221 in the illustrative depiction as follows, and/or the indicating chemical label module m1221, when executed and/or activated, directs performance of and/or performs the operation o1221 in the illustrative depiction as follows, and/or the operation o1221 is otherwise carried out in the illustrative depiction as follows: electronically indicating informational connection between (e.g. through a sparse index, etc.) at least a portion of residential food management information (e.g. turnover in use of pre-packaged meals, etc.) including (e.g. exclude, etc.) one or more food related residential conditions (e.g. expenditure rates for various residential food items, etc.) affecting (e.g. exclude, etc.) residential service of (e.g. deli style residential food item sales, etc.) one or more food items (e.g. pasta residential food item main course, etc.) and between one or more descriptors (e.g. database records, etc.) logged as contained by (e.g. through isotope identification, etc.) the one or more label carriers, (e.g. macromolecule marker, etc.) said one or more label containers logged as (e.g. via server information, etc.) being at least temporarily (e.g. time since introduction of oxygen absorber, etc.) within at least a vicinity of (e.g. stapled to container, etc.) said one or more residential food items (e.g. green algae, etc.) include at least in part one or more chemical label carriers (e.g. chemical tag sprayed on to ingestible material before shipping from farm which is subsequently received by residential facility such as a house, etc.).

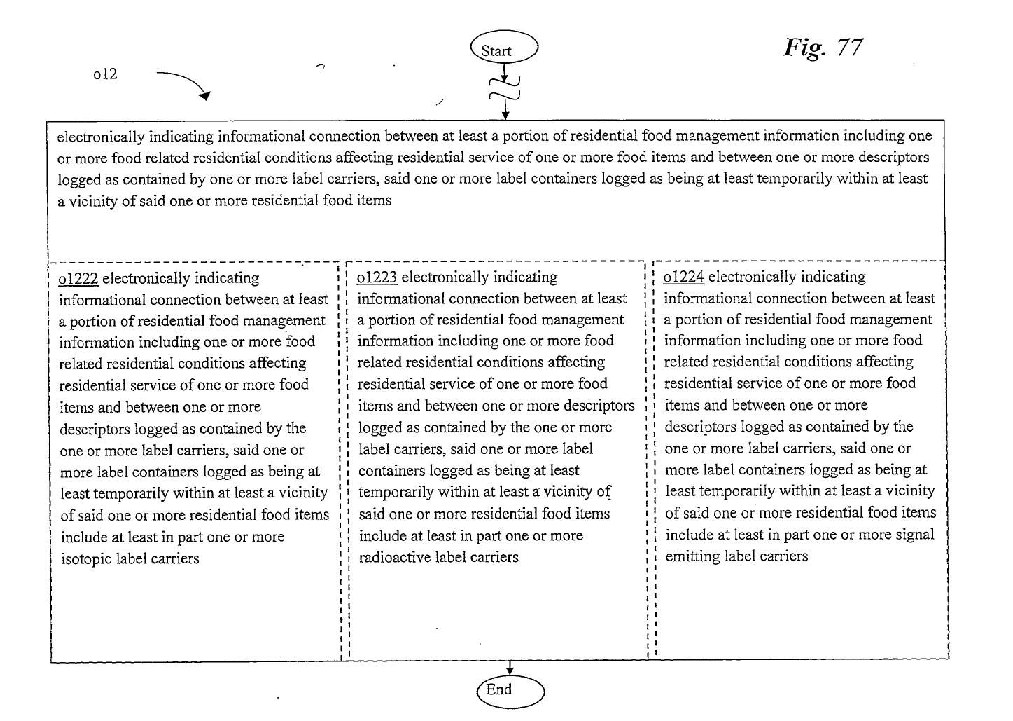

In one or more implementations, as shown in FIG. 77, operation o12 includes an operation o1222 for electronically indicating informational connection between at least a portion of residential food management information including one or more food related residential conditions affecting residential service of one or more food items and between one or more descriptors logged as contained by the one or more label carriers, said one or more label containers logged as being at least temporarily within at least a vicinity of said one or more residential food items include at least in part one or more isotopic label carriers. Origination of an illustratively derived indicating isotopic label component group can be accomplished through skilled in the art design choice selection of one or more of the above depicted components from one or more of the above depicted subsystems shown in FIG. 12. Components from the indicating isotopic label component group can be used in implementing execution of the one or more indicating isotopic label instructions i1222 of FIG. 34, can be used in performance of the indicating isotopic label electrical circuitry arrangement e1222 of FIG. 27, and/or can be used in otherwise fulfillment of the operation o1222. An exemplary non-transitory signal bearing medium version of the information storage subsystem s200 is depicted in FIG. 34 as bearing the one or more indicating isotopic label instructions i1222 that when executed will direct performance of the operation o1222. Furthermore, the indicating isotopic label electrical circuitry arrangement (“elec circ arrange”) e1222, when activated, will perform the operation o1222. Also, the indicating isotopic label module m1222, when executed and/or activated, will direct performance of and/or perform the operation o1222. For instance, in one or more exemplary implementations, the one or more indicating isotopic label instructions i1222, when executed, direct performance of the operation o1222 in the illustrative depiction as follows, and/or the indicating isotopic label electrical circuitry arrangement e1222, when activated, performs the operation o1222 in the illustrative depiction as follows, and/or the indicating isotopic label module m1222, when executed and/or activated, directs performance of and/or performs the operation o1222 in the illustrative depiction as follows, and/or the operation o1222 is otherwise carried out in the illustrative depiction as follows: electronically indicating informational connection between (e.g. through a reverse index, etc.) at least a portion of residential food management information (e.g. daylight hours of current climate, etc.) including (e.g. bound, etc.) one or more food related residential conditions (e.g. cost margins on various residential food items, etc.) affecting (e.g. bound, etc.) residential service of (e.g. in-home hospital residential food item sales, etc.) one or more food items (e.g. fat dominant residential food item main course, etc.) and between one or more descriptors (e.g. computer clock, etc.) logged as contained by (e.g. through beacon signal reception, etc.) the one or more label carriers, (e.g. carbon-12 marker, etc.) said one or more label containers logged as (e.g. via index information, etc.) being at least temporarily (e.g. shipping time on truck from distribution center to residence, etc.) within at least a vicinity of (e.g. snapped onto container, etc.) said one or more residential food items (e.g. cow heart, etc.) include at least in part one or more isotopic label carriers (e.g. individual isotopic label carriers assigned to separate shipping containers to be received at residence, etc.).

In one or more implementations, as shown in FIG. 77, operation o12 includes an operation o1223 for electronically indicating informational connection between at least a portion of residential food management information including one or more food related residential conditions affecting residential service of one or more food items and between one or more descriptors logged as contained by the one or more label carriers, said one or more label containers logged as being at least temporarily within at least a vicinity of said one or more residential food items include at least in part one or more radioactive label carriers. Origination of an illustratively derived indicating radioactive label component group can be accomplished through skilled in the art design choice selection of one or more of the above depicted components from one or more of the above depicted subsystems shown in FIG. 12. Components from the indicating radioactive label component group can be used in implementing execution of the one or more indicating radioactive label instructions i1223 of FIG. 34, can be used in performance of the indicating radioactive label electrical circuitry arrangement e1223 of FIG. 27, and/or can be used in otherwise fulfillment of the operation o1223. An exemplary non-transitory signal bearing medium version of the information storage subsystem s200 is depicted in FIG. 34 as bearing the one or more indicating radioactive label instructions i1223 that when executed will direct performance of the operation o1223. Furthermore, the indicating radioactive label electrical circuitry arrangement (“elec circ arrange”) e1223, when activated, will perform the operation o1223. Also, the indicating radioactive label module m1223, when executed and/or activated, will direct performance of and/or perform the operation o1223. For instance, in one or more exemplary implementations, the one or more indicating radioactive label instructions i1223, when executed, direct performance of the operation o1223 in the illustrative depiction as follows, and/or the indicating radioactive label electrical circuitry arrangement e1223, when activated, performs the operation o1223 in the illustrative depiction as follows, and/or the indicating radioactive label module m1223, when executed and/or activated, directs performance of and/or performs the operation o1223 in the illustrative depiction as follows, and/or the operation o1223 is otherwise carried out in the illustrative depiction as follows: electronically indicating informational connection between (e.g. via index concurrency control, etc.) at least a portion of residential food management information (e.g. carbon dioxide levels in residential facility rooms, etc.) including (e.g. requiring, etc.) one or more food related residential conditions (e.g. residential facility occupation statistics, etc.) affecting (e.g. requiring, etc.) residential service of (e.g. mobile kitchen residential food item sales, etc.) one or more food items (e.g. carbohydrate dominant residential food item main course, etc.) and between one or more descriptors (e.g. network protocol time indicator, etc.) logged as contained by (e.g. through image scanning, etc.) the one or more label carriers, (e.g. scintillation counter, etc.) said one or more label containers logged as (e.g. via body information, etc.) being at least temporarily (e.g. time spent unpackaged in residential environment, etc.) within at least a vicinity of (e.g. burned into material, etc.) said one or more residential food items (e.g. whole lobster, etc.) include at least in part one or more radioactive label carriers (e.g. radioactive tag to be assigned to general shipment vehicle to track through transportation check points from farm to wholesaler to residence, etc.).

In one or more implementations, as shown in FIG. 77, operation o12 includes an operation o1224 for electronically indicating informational connection between at least a portion of residential food management information including one or more food related residential conditions affecting residential service of one or more food items and between one or more descriptors logged as contained by the one or more label carriers, said one or more label containers logged as being at least temporarily within at least a vicinity of said one or more residential food items include at least in part one or more signal emitting label carriers. Origination of an illustratively derived indicating emitting label component group can be accomplished through skilled in the art design choice selection of one or more of the above depicted components from one or more of the above depicted subsystems shown in FIG. 12. Components from the indicating emitting label component group can be used in implementing execution of the one or more indicating emitting label instructions i1224 of FIG. 34, can be used in performance of the indicating emitting label electrical circuitry arrangement e1224 of FIG. 27, and/or can be used in otherwise fulfillment of the operation o1224. An exemplary non-transitory signal bearing medium version of the information storage subsystem s200 is depicted in FIG. 34 as bearing the one or more indicating emitting label instructions i1224 that when executed will direct performance of the operation o1224. Furthermore, the indicating emitting label electrical circuitry arrangement (“elec circ arrange”) e1224, when activated, will perform the operation o1224. Also, the indicating emitting label module m1224, when executed and/or activated, will direct performance of and/or perform the operation o1224. For instance, in one or more exemplary implementations, the one or more indicating emitting label instructions i1224, when executed, direct performance of the operation o1224 in the illustrative depiction as follows, and/or the indicating emitting label electrical circuitry arrangement e1224, when activated, performs the operation o1224 in the illustrative depiction as follows, and/or the indicating emitting label module m1224, when executed and/or activated, directs performance of and/or performs the operation o1224 in the illustrative depiction as follows, and/or the operation o1224 is otherwise carried out in the illustrative depiction as follows: electronically indicating informational connection between (e.g. through index locking, etc.) at least a portion of residential food management information (e.g. water usage, etc.) including (e.g. enveloped, etc.) one or more food related residential conditions (e.g. garbage disposal practices, etc.) affecting (e.g. enveloped, etc.) residential service of (e.g. outside delivery residential food item sales, etc.) one or more food items (e.g. protein dominant residential food item main course, etc.) and between one or more descriptors (e.g. server clock, etc.) logged as contained by (e.g. through audio reception, etc.) the one or more label carriers, (e.g. light emitting diode, etc.) said one or more label containers logged as (e.g. via food composition database, etc.) being at least temporarily (e.g. time spent on conveyor belt in residence, etc.) within at least a vicinity of (e.g. burned into container, etc.) said one or more residential food items (e.g. potato, etc.) include at least in part one or more signal emitting label carriers (e.g. radio frequency tag attached to each shipment container from farm to residence, etc.).

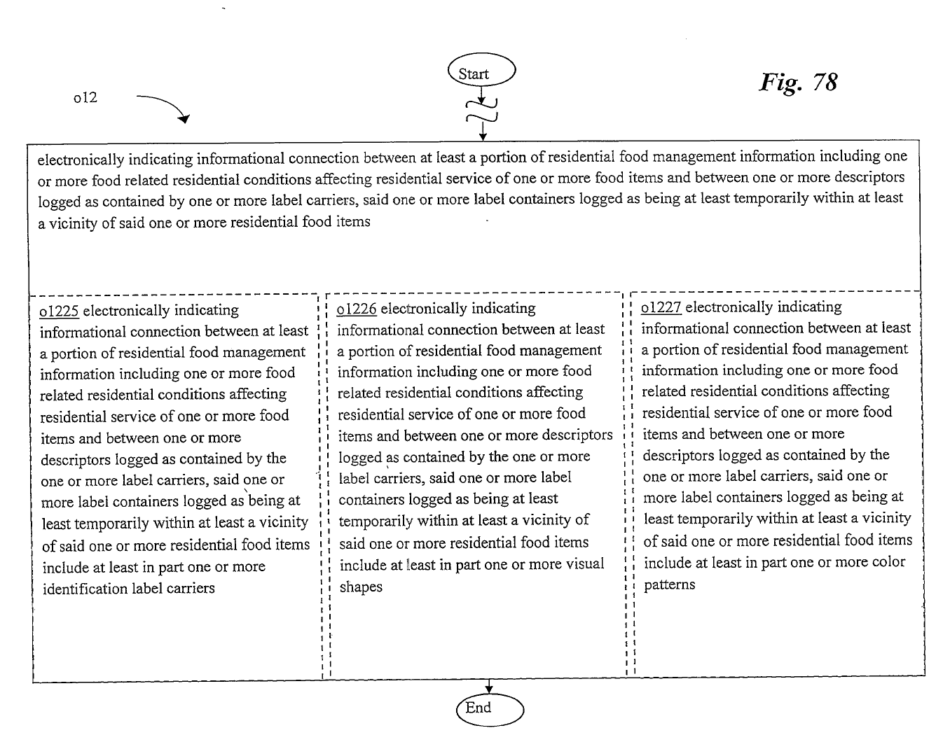

In one or more implementations, as shown in FIG. 78, operation o12 includes an operation o1225 for electronically indicating informational connection between at least a portion of residential food management information including one or more food related residential conditions affecting residential service of one or more food items and between one or more descriptors logged as contained by the one or more label carriers, said one or more label containers logged as being at least temporarily within at least a vicinity of said one or more residential food items include at least in part one or more identification label carriers. Origination of an illustratively derived indicating identification label component group can be accomplished through skilled in the art design choice selection of one or more of the above depicted components from one or more of the above depicted subsystems shown in FIG. 12. Components from the indicating identification label component group can be used in implementing execution of the one or more indicating identification label instructions i1225 of FIG. 34, can be used in performance of the indicating identification label electrical circuitry arrangement e1225 of FIG. 27, and/or can be used in otherwise fulfillment of the operation o1225. An exemplary non-transitory signal bearing medium version of the information storage subsystem s200 is depicted in FIG. 34 as bearing the one or more indicating identification label instructions i1225 that when executed will direct performance of the operation o1225. Furthermore, the indicating identification label electrical circuitry arrangement (“elec circ arrange”) e1225, when activated, will perform the operation o1225. Also, the indicating identification label module m1225, when executed and/or activated, will direct performance of and/or perform the operation o1225. For instance, in one or more exemplary implementations, the one or more indicating identification label instructions i1225, when executed, direct performance of the operation o1225 in the illustrative depiction as follows, and/or the indicating identification label electrical circuitry arrangement e1225, when activated, performs the operation o1225 in the illustrative depiction as follows, and/or the indicating identification label module m1225, when executed and/or activated, directs performance of and/or performs the operation o1225 in the illustrative depiction as follows, and/or the operation o1225 is otherwise carried out in the illustrative depiction as follows: electronically indicating informational connection between (e.g. through standardization of index, etc.) at least a portion of residential food management information (e.g. natural gas usage, etc.) including (e.g. envelope, etc.) one or more food related residential conditions (e.g. standards used to classify condition of residential stock received at the residential store, etc.) affecting (e.g. envelope, etc.) residential service of (e.g. in-home nursing residential food item sales, etc.) one or more food items (e.g. beverage residential food item main course, etc.) and between one or more descriptors (e.g. operating system time, etc.) logged as contained by (e.g. through visual identification, etc.) the one or more label carriers, (e.g. asset tag, etc.) said one or more label containers logged as (e.g. via DVD-ROM storage, etc.) being at least temporarily (e.g. shipping time from vessel to residence, etc.) within at least a vicinity of (e.g. riveted to container, etc.) said one or more residential food items (e.g. goat cheese, etc.) include at least in part one or more identification label carriers (e.g. tag containing textual description assigned to each food item received at residence at point of receipt, etc.).

In one or more implementations, as shown in FIG. 78, operation o12 includes an operation o1226 for electronically indicating informational connection between at least a portion of residential food management information including one or more food related residential conditions affecting residential service of one or more food items and between one or more descriptors logged as contained by the one or more label carriers, said one or more label containers logged as being at least temporarily within at least a vicinity of said one or more residential food items include at least in part one or more visual shapes. Origination of an illustratively derived indicating visual shapes component group can be accomplished through skilled in the art design choice selection of one or more of the above depicted components from one or more of the above depicted subsystems shown in FIG. 12. Components from the indicating visual shapes component group can be used in implementing execution of the one or more indicating visual shapes instructions i1226 of FIG. 34, can be used in performance of the indicating visual shapes electrical circuitry arrangement e1226 of FIG. 27, and/or can be used in otherwise fulfillment of the operation o1226. An exemplary non-transitory signal bearing medium version of the information storage subsystem s200 is depicted in FIG. 34 as bearing the one or more indicating visual shapes instructions i1226 that when executed will direct performance of the operation o1226. Furthermore, the indicating visual shapes electrical circuitry arrangement (“elec circ arrange”) e1226, when activated, will perform the operation o1226. Also, the indicating visual shapes module m1226, when executed and/or activated, will direct performance of and/or perform the operation o1226. For instance, in one or more exemplary implementations, the one or more indicating visual shapes instructions i1226, when executed, direct performance of the operation o1226 in the illustrative depiction as follows, and/or the indicating visual shapes electrical circuitry arrangement e1226, when activated, performs the operation o1226 in the illustrative depiction as follows, and/or the indicating visual shapes module m1226, when executed and/or activated, directs performance of and/or performs the operation o1226 in the illustrative depiction as follows, and/or the operation o1226 is otherwise carried out in the illustrative depiction as follows: electronically indicating informational connection between (e.g. through data structure, etc.) at least a portion of residential food management information (e.g. methane gas usage, etc.) including (e.g. associate with, etc.) one or more food related residential conditions (e.g. standards used to classify condition of residential food items stored, etc.) affecting (e.g. associate with, etc.) residential service of (e.g. large family cafeteria residential food item sales, etc.) one or more food items (e.g. blended residential food item main course, etc.) and between one or more descriptors (e.g. indicating electronically receiving sent as response to electronically transmitting, etc.) logged as contained by (e.g. through light reception, etc.) the one or more label carriers, (e.g. cylindrical, etc.) said one or more label containers logged as (e.g. via floppy disk storage, etc.) being at least temporarily (e.g. portion of time spent packaged with similar material, etc.) within at least a vicinity of (e.g. enveloping container, etc.) said one or more residential food items (e.g. beet pulp, etc.) include at least in part one or more visual shapes (e.g. database of stock material shapes for electronic shape recognition program, etc.).

In one or more implementations, as shown in FIG. 78, operation o12 includes an operation o1227 for electronically indicating informational connection between at least a portion of residential food management information including one or more food related residential conditions affecting residential service of one or more food items and between one or more descriptors logged as contained by the one or more label carriers, said one or more label containers logged as being at least temporarily within at least a vicinity of said one or more residential food items include at least in part one or more color patterns. Origination of an illustratively derived indicating color patterns component group can be accomplished through skilled in the art design choice selection of one or more of the above depicted components from one or more of the above depicted subsystems shown in FIG. 12. Components from the indicating color patterns component group can be used in implementing execution of the one or more indicating color patterns instructions i1227 of FIG. 34, can be used in performance of the indicating color patterns electrical circuitry arrangement e1227 of FIG. 27, and/or can be used in otherwise fulfillment of the operation o1227. An exemplary non-transitory signal bearing medium version of the information storage subsystem s200 is depicted in FIG. 34 as bearing the one or more indicating color patterns instructions i1227 that when executed will direct performance of the operation o1227. Furthermore, the indicating color patterns electrical circuitry arrangement (“elec circ arrange”) e1227, when activated, will perform the operation o1227. Also, the indicating color patterns module m1227, when executed and/or activated, will direct performance of and/or perform the operation o1227. For instance, in one or more exemplary implementations, the one or more indicating color patterns instructions i1227, when executed, direct performance of the operation o1227 in the illustrative depiction as follows, and/or the indicating color patterns electrical circuitry arrangement e1227, when activated, performs the operation o1227 in the illustrative depiction as follows, and/or the indicating color patterns module m1227, when executed and/or activated, directs performance of and/or performs the operation o1227 in the illustrative depiction as follows, and/or the operation o1227 is otherwise carried out in the illustrative depiction as follows: electronically indicating informational connection between (e.g. through common search terms, etc.) at least a portion of residential food management information (e.g. MPEG file format, etc.) including (e.g. embroil, etc.) one or more food related residential conditions (e.g. residential occupant exemplary behavior, etc.) affecting (e.g. embroil, etc.) residential service of (e.g. institutional residential food item sales, etc.) one or more food items (e.g. sous-vide residential food item main course, etc.) and between one or more descriptors (e.g. textual input, etc.) logged as contained by (e.g. through color spectrum identification, etc.) the one or more label carriers, (e.g. checkered, etc.) said one or more label containers logged as (e.g. via ROM storage, etc.) being at least temporarily (e.g. portion of time spent on shipping vessel, etc.) within at least a vicinity of (e.g. enveloping material, etc.) said one or more residential food items (e.g. substance for produce department product, etc.) include at least in part one or more color patterns (e.g. database of stock material colors for electronic color recognition program, etc.).

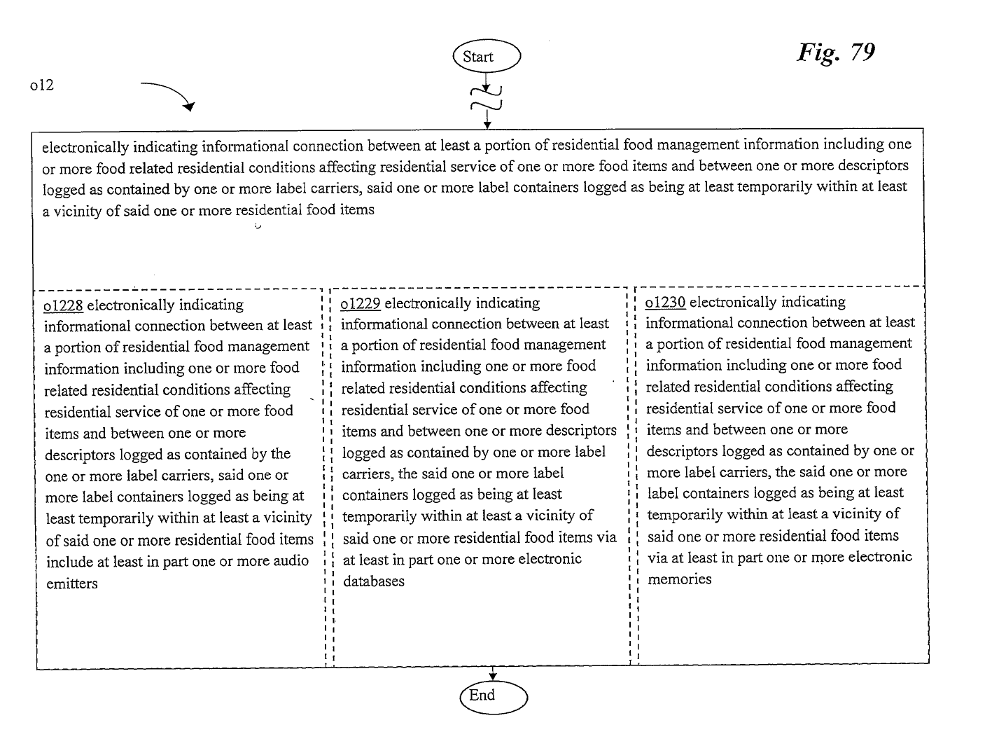

In one or more implementations, as shown in FIG. 79, operation o12 includes an operation o1228 for electronically indicating informational connection between at least a portion of residential food management information including one or more food related residential conditions affecting residential service of one or more food items and between one or more descriptors logged as contained by the one or more label carriers, said one or more label containers logged as being at least temporarily within at least a vicinity of said one or more residential food items include at least in part one or more audio emitters. Origination of an illustratively derived indicating audio emitters component group can be accomplished through skilled in the art design choice selection of one or more of the above depicted components from one or more of the above depicted subsystems shown in FIG. 12. Components from the indicating audio emitters component group can be used in implementing execution of the one or more indicating audio emitters instructions i1228 of FIG. 34, can be used in performance of the indicating audio emitters electrical circuitry arrangement e1228 of FIG. 27, and/or can be used in otherwise fulfillment of the operation o1228. An exemplary non-transitory signal bearing medium version of the information storage subsystem s200 is depicted in FIG. 34 as bearing the one or more indicating audio emitters instructions i1228 that when executed will direct performance of the operation o1228. Furthermore, the indicating audio emitters electrical circuitry arrangement (“elec circ arrange”) e1228, when activated, will perform the operation o1228. Also, the indicating audio emitters module m1228, when executed and/or activated, will direct performance of and/or perform the operation o1228. For instance, in one or more exemplary implementations, the one or more indicating audio emitters instructions i1228, when executed, direct performance of the operation o1228 in the illustrative depiction as follows, and/or the indicating audio emitters electrical circuitry arrangement e1228, when activated, performs the operation o1228 in the illustrative depiction as follows, and/or the indicating audio emitters module m1228, when executed and/or activated, directs performance of and/or performs the operation o1228 in the illustrative depiction as follows, and/or the operation o1228 is otherwise carried out in the illustrative depiction as follows: electronically indicating informational connection between (e.g. through access of ordered records, etc.) at least a portion of residential food management information (e.g. WAV file format, etc.) including (e.g. take in, etc.) one or more food related residential conditions (e.g. residential occupant poor behavior, etc.) affecting (e.g. take in, etc.) residential service of (e.g. mobile lifestyle residential food item sales, etc.) one or more food items (e.g. braised residential food item main course, etc.) and between one or more descriptors (e.g. audio input, etc.) logged as contained by (e.g. through RF reception, etc.) the one or more label carriers, (e.g. speaker, etc.) said one or more label containers logged as (e.g. via database table information, etc.) being at least temporarily (e.g. time spent in flight, etc.) within at least a vicinity of (e.g. placed inside material, etc.) said one or more residential food items (e.g. venison, etc.) include at least in part one or more audio emitters (e.g. audio emitter dedicated to each container received at residential facility, etc.).

In one or more implementations, as shown in FIG. 79, operation o12 includes an operation o1229 for electronically indicating informational connection between at least a portion of residential food management information including one or more food related residential conditions affecting residential service of one or more food items and between one or more descriptors logged as contained by one or more label carriers, the said one or more label containers logged as being at least temporarily within at least a vicinity of said one or more residential food items via at least in part one or more electronic databases. Origination of an illustratively derived indicating electronic databases component group can be accomplished through skilled in the art design choice selection of one or more of the above depicted components from one or more of the above depicted subsystems shown in FIG. 12. Components from the indicating electronic databases component group can be used in implementing execution of the one or more indicating electronic databases instructions i1229 of FIG. 34, can be used in performance of the indicating electronic databases electrical circuitry arrangement e1229 of FIG. 27, and/or can be used in otherwise fulfillment of the operation o1229. An exemplary non-transitory signal bearing medium version of the information storage subsystem s200 is depicted in FIG. 34 as bearing the one or more indicating electronic databases instructions i1229 that when executed will direct performance of the operation o1229. Furthermore, the indicating electronic databases electrical circuitry arrangement (“elec circ arrange”) e1229, when activated, will perform the operation o1229. Also, the indicating electronic databases module m1229, when executed and/or activated, will direct performance of and/or perform the operation o1229. For instance, in one or more exemplary implementations, the one or more indicating electronic databases instructions i1229, when executed, direct performance of the operation o1229 in the illustrative depiction as follows, and/or the indicating electronic databases electrical circuitry arrangement e1229, when activated, performs the operation o1229 in the illustrative depiction as follows, and/or the indicating electronic databases module m1229, when executed and/or activated, directs performance of and/or performs the operation o1229 in the illustrative depiction as follows, and/or the operation o1229 is otherwise carried out in the illustrative depiction as follows: electronically indicating informational connection between (e.g. via functions, etc.) at least a portion of residential food management information (e.g. visual observation, etc.) including (e.g. comprised of, etc.) one or more food related residential conditions (e.g. identified issues regarding food quality from one or more wholesalers, etc.) affecting (e.g. comprised of, etc.) residential service of (e.g. family buffet residential food item sales, etc.) one or more food items (e.g. rotisserie residential food item main course, etc.) and between one or more descriptors (e.g. e-mail record, etc.) logged as contained by (e.g. through scanning, etc.) one or more label carriers, (e.g. UHF emitter, etc.) the said one or more label containers logged as (e.g. via database object information, etc.) being at least temporarily (e.g. time spent in cold storage, etc.) within at least a vicinity of (e.g. placed inside container, etc.) said one or more residential food items (e.g. edible frog, etc.) via at least in part one or more electronic databases (e.g. electronic database at residential facility to report details regarding shipments received, etc.).

In one or more implementations, as shown in FIG. 79, operation o12 includes an operation o1234 for electronically indicating informational connection between at least a portion of residential food management information including one or more food related residential conditions affecting residential service of one or more food items and between one or more descriptors logged as contained by one or more label carriers, said one or more label containers logged as being at least temporarily the within at least a vicinity of said one or more residential food items including at least in part logged as affixed to one or more residential food items. Origination of an illustratively derived indicating affixed items component group can be accomplished through skilled in the art design choice selection of one or more of the above depicted components from one or more of the above depicted subsystems shown in FIG. 12. Components from the indicating affixed items component group can be used in implementing execution of the one or more indicating affixed items instructions i1234 of FIG. 34, can be used in performance of the indicating affixed items electrical circuitry arrangement e1234 of FIG. 27, and/or can be used in otherwise fulfillment of the operation o1234. An exemplary non-transitory signal bearing medium version of the information storage subsystem s200 is depicted in FIG. 34 as bearing the one or more indicating affixed items instructions i1234 that when executed will direct performance of the operation o1234. Furthermore, the indicating affixed items electrical circuitry arrangement (“elec circ arrange”) e1234, when activated, will perform the operation o1234. Also, the indicating affixed items module m1234, when executed and/or activated, will direct performance of and/or perform the operation o1234. For instance, in one or more exemplary implementations, the one or more indicating affixed items instructions i1234, when executed, direct performance of the operation o1234 in the illustrative depiction as follows, and/or the indicating affixed items electrical circuitry arrangement e1234, when activated, performs the operation o1234 in the illustrative depiction as follows, and/or the indicating affixed items module m1234, when executed and/or activated, directs performance of and/or performs the operation o1234 in the illustrative depiction as follows, and/or the operation o1234 is otherwise carried out in the illustrative depiction as follows: electronically indicating informational connection between (e.g. through unique exclusions of data, etc.) at least a portion of residential food management information (e.g. cold storage data for stored food materials, etc.) including (e.g. argue, etc.) one or more food related residential conditions (e.g. identified issues regarding one or more types of dishes used by the residential facility, etc.) affecting (e.g. argue, etc.) residential service of (e.g. mobile kitchen residential food item preparation, etc.) one or more food items (e.g. microwaved main course, etc.) and between one or more descriptors (e.g. as being recorded thereafter due in part to application response delay, etc.) logged as contained by (e.g. through barcode scanning, etc.) one or more label carriers, (e.g. gyroscope, etc.) said one or more label containers logged as (e.g. via CD-ROM storage, etc.) being at least temporarily (e.g. partial time spent on retail display, etc.) the within at least a vicinity of (e.g. welded onto container, etc.) said one or more residential food items (e.g. feed grain, etc.) including at least in part logged as affixed to one or more residential food items (e.g. label adhesively attached to whole vegetable, etc.).

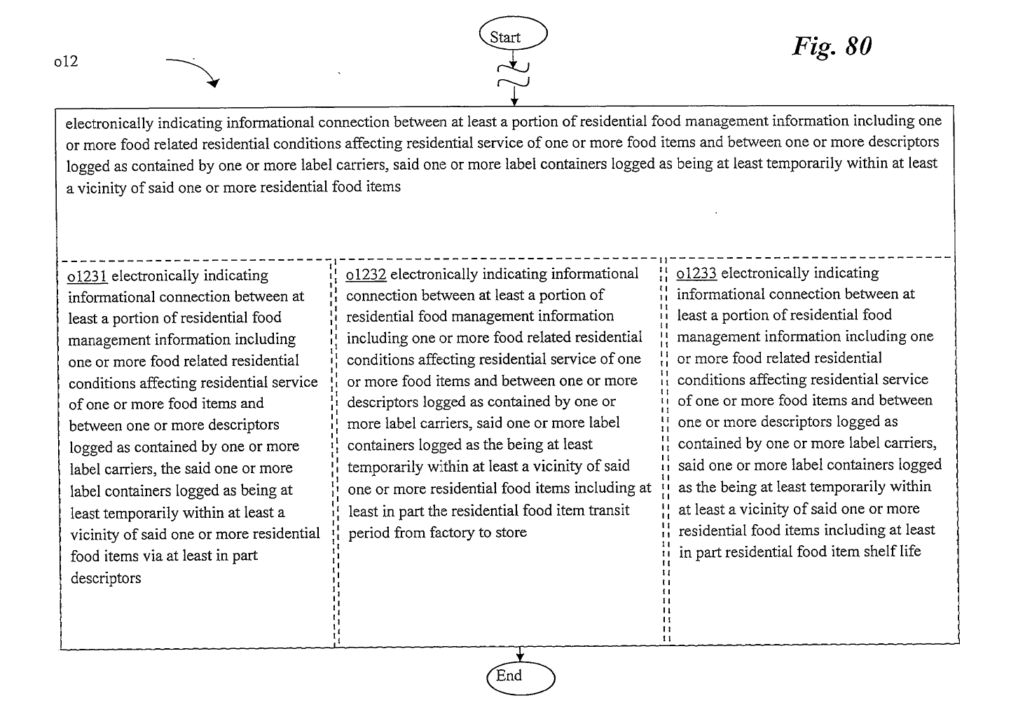

In one or more implementations, as shown in FIG. 80, operation o12 includes an operation o1231 for electronically indicating informational connection between at least a portion of residential food management information including one or more food related residential conditions affecting residential service of one or more food items and between one or more descriptors logged as contained by one or more label carriers, the said one or more label containers logged as being at least temporarily within at least a vicinity of said one or more residential food items via at least in part descriptors. Origination of an illustratively derived indicating items descriptors component group can be accomplished through skilled in the art design choice selection of one or more of the above depicted components from one or more of the above depicted subsystems shown in FIG. 12. Components from the indicating items descriptors component group can be used in implementing execution of the one or more indicating items descriptors instructions i1231 of FIG. 34, can be used in performance of the indicating items descriptors electrical circuitry arrangement e1231 of FIG. 27, and/or can be used in otherwise fulfillment of the operation o1231. An exemplary non-transitory signal bearing medium version of the information storage subsystem s200 is depicted in FIG. 34 as bearing the one or more indicating items descriptors instructions i1231 that when executed will direct performance of the operation o1231. Furthermore, the indicating items descriptors electrical circuitry arrangement (“elec circ arrange”) e1231, when activated, will perform the operation o1231. Also, the indicating items descriptors module m1231, when executed and/or activated, will direct performance of and/or perform the operation o1231. For instance, in one or more exemplary implementations, the one or more indicating items descriptors instructions i1231, when executed, direct performance of the operation o1231 in the illustrative depiction as follows, and/or the indicating items descriptors electrical circuitry arrangement e1231, when activated, performs the operation o1231 in the illustrative depiction as follows, and/or the indicating items descriptors module m1231, when executed and/or activated, directs performance of and/or performs the operation o1231 in the illustrative depiction as follows, and/or the operation o1231 is otherwise carried out in the illustrative depiction as follows: electronically indicating informational connection between (e.g. via sub-linear time lookup, etc.) at least a portion of residential food management information (e.g. document validation, etc.) including (e.g. associated, etc.) one or more food related residential conditions (e.g. identified issues regarding one or more residential occupants, etc.) affecting (e.g. associated, etc.) residential service of (e.g. fine dining residential food item sales, etc.) one or more food items (e.g. boiled residential food item main course, etc.) and between one or more descriptors (e.g. identifying as being recorded immediately thereafter one or more events, etc.) logged as contained by (e.g. through electromagnetic reception, etc.) one or more label carriers, (e.g. microwave emitter, etc.) the said one or more label containers logged as (e.g. via relational database, etc.) being at least temporarily (e.g. portion of time spent in ice bath, etc.) within at least a vicinity of (e.g. embossed on container, etc.) said one or more residential food items (e.g. cow liver, etc.) via at least in part descriptors (e.g. one or more identifiers containing textual descriptions of stock material contained therein, etc.).

In one or more implementations, as shown in FIG. 80, operation o12 includes an operation o1232 for electronically indicating informational connection between at least a portion of residential food management information including one or more food related residential conditions affecting residential service of one or more food items and between one or more descriptors logged as contained by one or more label carriers, said one or more label containers logged as the being at least temporarily within at least a vicinity of said one or more residential food items including at least in part the residential food item transit period from factory to store. Origination of an illustratively derived indicating transit period component group can be accomplished through skilled in the art design choice selection of one or more of the above depicted components from one or more of the above depicted subsystems shown in FIG. 12. Components from the indicating transit period component group can be used in implementing execution of the one or more indicating transit period instructions i1232 of FIG. 34, can be used in performance of the indicating transit period electrical circuitry arrangement e1232 of FIG. 27, and/or can be used in otherwise fulfillment of the operation o1232. An exemplary non-transitory signal bearing medium version of the information storage subsystem s200 is depicted in FIG. 34 as bearing the one or more indicating transit period instructions i1232 that when executed will direct performance of the operation o1232. Furthermore, the indicating transit period electrical circuitry arrangement (“elec circ arrange”) e1232, when activated, will perform the operation o1232. Also, the indicating transit period module m1232, when executed and/or activated, will direct performance of and/or perform the operation o1232. For instance, in one or more exemplary implementations, the one or more indicating transit period instructions i1232, when executed, direct performance of the operation o1232 in the illustrative depiction as follows, and/or the indicating transit period electrical circuitry arrangement e1232, when activated, performs the operation o1232 in the illustrative depiction as follows, and/or the indicating transit period module m1232, when executed and/or activated, directs performance of and/or performs the operation o1232 in the illustrative depiction as follows, and/or the operation o1232 is otherwise carried out in the illustrative depiction as follows: electronically indicating informational connection between (e.g. through linear search, etc.) at least a portion of residential food management information (e.g. missed scheduled deliveries of residential food items, etc.) including (e.g. affected, etc.) one or more food related residential conditions (e.g. identified issues regarding residential equipment, etc.) affecting (e.g. affected, etc.) residential service of (e.g. deli style residential food item preparation, etc.) one or more food items (e.g. smoked residential food item main course, etc.) and between one or more descriptors (e.g. as being recording thereafter one or more events due to server delay, etc.) logged as contained by (e.g. through search terms, etc.) one or more label carriers, (e.g. laser ranging tracker, etc.) said one or more label containers logged as (e.g. via database management layer, etc.) the being at least temporarily (e.g. shipping time from farm to residential storage, etc.) within at least a vicinity of (e.g. debossed on material, etc.) said one or more residential food items (e.g. goat milk, etc.) including at least in part the residential food item transit period from factory to store (e.g. transit period between farm and wholesaler and residential facility, etc.).

In one or more implementations, as shown in FIG. 80, operation o12 includes an operation o1233 for electronically indicating informational connection between at least a portion of residential food management information including one or more food related residential conditions affecting residential service of one or more food items and between one or more descriptors logged as contained by one or more label carriers, said one or more label containers logged as the being at least temporarily within at least a vicinity of said one or more residential food items including at least in part residential food item shelf life. Origination of an illustratively derived indicating shelf life component group can be accomplished through skilled in the art design choice selection of one or more of the above depicted components from one or more of the above depicted subsystems shown in FIG. 12. Components from the indicating shelf life component group can be used in implementing execution of the one or more indicating shelf life instructions i1233 of FIG. 34, can be used in performance of the indicating shelf life electrical circuitry arrangement e1233 of FIG. 27, and/or can be used in otherwise fulfillment of the operation o1233. An exemplary non-transitory signal bearing medium version of the information storage subsystem s200 is depicted in FIG. 34 as bearing the one or more indicating shelf life instructions i1233 that when executed will direct performance of the operation o1233. Furthermore, the indicating shelf life electrical circuitry arrangement (“elec circ arrange”) e1233, when activated, will perform the operation o1233. Also, the indicating shelf life module m1233, when executed and/or activated, will direct performance of and/or perform the operation o1233. For instance, in one or more exemplary implementations, the one or more indicating shelf life instructions i1233, when executed, direct performance of the operation o1233 in the illustrative depiction as follows, and/or the indicating shelf life electrical circuitry arrangement e1233, when activated, performs the operation o1233 in the illustrative depiction as follows, and/or the indicating shelf life module m1233, when executed and/or activated, directs performance of and/or performs the operation o1233 in the illustrative depiction as follows, and/or the operation o1233 is otherwise carried out in the illustrative depiction as follows: electronically indicating informational connection between (e.g. through database constraints, etc.) at least a portion of residential food management information (e.g. storage room temperature. profiles, etc.) including (e.g. affecting, etc.) one or more food related residential conditions (e.g. identified issues regarding one or more types of food materials used to prepare one or more residential food items to be used, etc.) affecting (e.g. affecting, etc.) residential service of (e.g. in-home hospital residential food item preparation, etc.) one or more food items (e.g. convection oven prepared residential food item main course, etc.) and between one or more descriptors (e.g. as being thereafter due in part to database retrieval times, etc.) logged as contained by (e.g. through storage retrieval, etc.) one or more label carriers, (e.g. ultrasonic emitter, etc.) said one or more label containers logged as (e.g. via flat database, etc.) the being at least temporarily (e.g. time spent in laboratory for testing, etc.) within at least a vicinity of (e.g. embossed on material, etc.) said one or more residential food items (e.g. whole king crab, etc.) including at least in part residential food item shelf life (e.g. including shelf life of steak packed with dry ice, etc.).

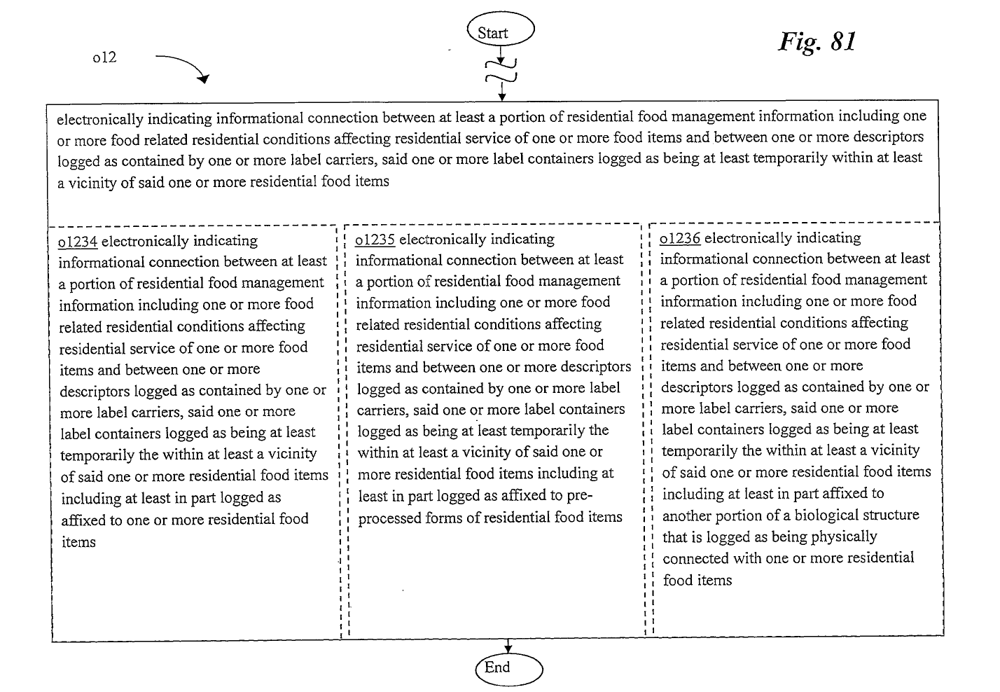

In one or more implementations, as shown in FIG. 81, operation o12 includes an operation o1234 for electronically indicating informational connection between at least a portion of residential food management information including one or more food related residential conditions affecting residential service of one or more food items and between one or more descriptors logged as contained by one or more label carriers, said one or more label containers logged as being at least temporarily the within at least a vicinity of said one or more residential food items including at least in part logged as affixed to one or more residential food items. Origination of an illustratively derived indicating affixed items component group can be accomplished through skilled in the art design choice selection of one or more of the above depicted components from one or more of the above depicted subsystems shown in FIG. 12. Components from the indicating affixed items component group can be used in implementing execution of the one or more indicating affixed items instructions i1234 of FIG. 34, can be used in performance of the indicating affixed items electrical circuitry arrangement e1234 of FIG. 27, and/or can be used in otherwise fulfillment of the operation o1234. An exemplary non-transitory signal bearing medium version of the information storage subsystem s200 is depicted in FIG. 34 as bearing the one or more indicating affixed items instructions i1234 that when executed will direct performance of the operation o1234. Furthermore, the indicating affixed items electrical circuitry arrangement (“elec circ arrange”) e1234, when activated, will perform the operation o1234. Also, the indicating affixed items module m1234, when executed and/or activated, will direct performance of and/or perform the operation o1234. For instance, in one or more exemplary implementations, the one or more indicating affixed items instructions i1234, when executed, direct performance of the operation o1234 in the illustrative depiction as follows, and/or the indicating affixed items electrical circuitry arrangement e1234, when activated, performs the operation o1234 in the illustrative depiction as follows, and/or the indicating affixed items module m1234, when executed and/or activated, directs performance of and/or performs the operation o1234 in the illustrative depiction as follows, and/or the operation o1234 is otherwise carried out in the illustrative depiction as follows: electronically indicating informational connection between (e.g. through unique exclusions of data, etc.) at least a portion of residential food management information (e.g. cold storage data for stored food materials, etc.) including (e.g. argue, etc.) one or more food related residential conditions (e.g. identified issues regarding one or more types of dishes used by the residential facility, etc.) affecting (e.g. argue, etc.) residential service of (e.g. mobile kitchen residential food item preparation, etc.) one or more food items (e.g. microwaved main course, etc.) and between one or more descriptors (e.g. as being recorded thereafter due in part to application response delay, etc.) logged as contained by (e.g. through barcode scanning, etc.) one or more label carriers, (e.g. gyroscope, etc.) said one or more label containers logged as (e.g. via CD-ROM storage, etc.) being at least temporarily (e.g. partial time spent on retail display, etc.) the within at least a vicinity of (e.g. welded onto container, etc.) said one or more residential food items (e.g. feed grain, etc.) including at least in part logged as affixed to one or more residential food items (e.g. label adhesively attached to whole vegetable, etc.).

In one or more implementations, as shown in FIG. 81, operation o12 includes an operation o1235 for electronically indicating informational connection between at least a portion of residential food management information including one or more food related residential conditions affecting residential service of one or more food items and between one or more descriptors logged as contained by one or more label carriers, said one or more label containers logged as being at least temporarily the within at least a vicinity of said one or more residential food items including at least in part logged as affixed to pre-processed forms of residential food items. Origination of an illustratively derived indicating affixed pre-processed component group can be accomplished through skilled in the art design choice selection of one or more of the above depicted components from one or more of the above depicted subsystems shown in FIG. 12. Components from the indicating affixed pre-processed component group can be used in implementing execution of the one or more indicating affixed pre-processed instructions i1235 of FIG. 34, can be used in performance of the indicating affixed pre-processed electrical circuitry arrangement e1235 of FIG. 27, and/or can be used in otherwise fulfillment of the operation o1235. An exemplary non-transitory signal bearing medium version of the information storage subsystem s200 is depicted in FIG. 34 as bearing the one or more indicating affixed pre-processed instructions i1235 that when executed will direct performance of the operation o1235. Furthermore, the indicating affixed pre-processed electrical circuitry arrangement (“elec circ arrange”) e1235, when activated, will perform the operation o1235. Also, the indicating affixed pre-processed module m1235, when executed and/or activated, will direct performance of and/or perform the operation o1235. For instance, in one or more exemplary implementations, the one or more indicating affixed pre-processed instructions i1235, when executed, direct performance of the operation o1235 in the illustrative depiction as follows, and/or the indicating affixed pre-processed electrical circuitry arrangement e1235, when activated, performs the operation o1235 in the illustrative depiction as follows, and/or the indicating affixed pre-processed module m1235, when executed and/or activated, directs performance of and/or performs the operation o1235 in the illustrative depiction as follows, and/or the operation o1235 is otherwise carried out in the illustrative depiction as follows: electronically indicating informational connection between (e.g. through primary key, etc.) at least a portion of residential food management information (e.g. stove maintenance operation, etc.) including (e.g. connected, etc.) one or more food related residential conditions (e.g. identified issues regarding one or more types of food items used by the residential facility, etc.) affecting (e.g. connected, etc.) residential service of (e.g. outside delivery residential food item preparation, etc.) one or more food items (e.g. chilled main course, etc.) and between one or more descriptors (e.g. as being recorded thereafter due in part to network transmission delays, etc.) logged as contained by (e.g. through radiation detection, etc.) one or more label carriers, (e.g. inertial sensor, etc.) said one or more label containers logged as (e.g. via digital linear tape storage, etc.) being at least temporarily (e.g. time on train between two terminals, etc.) the within at least a vicinity of (e.g. bolted to container, etc.) said one or more residential food items (e.g. sturgeon eggs, etc.) including at least in part logged as affixed to pre-processed forms of residential food items (e.g. RFID tag clipped to raw steak, etc.).

In one or more implementations, as shown in FIG. 81, operation o12 includes an operation o1236 for electronically indicating informational connection between at least a portion of residential food management information including one or more food related residential conditions affecting residential service of one or more food items and between one or more descriptors logged as contained by one or more label carriers, said one or more label containers logged as being at least temporarily the within at least a vicinity of said one or more residential food items including at least in part affixed to another portion of a biological structure that is logged as being physically connected with one or more residential food items. Origination of an illustratively derived indicating affixed physically component group can be accomplished through skilled in the art design choice selection of one or more of the above depicted components from one or more of the above depicted subsystems shown in FIG. 12. Components from the indicating affixed physically component group can be used in implementing execution of the one or more indicating affixed physically instructions i1236 of FIG. 34, can be used in performance of the indicating affixed physically electrical circuitry arrangement e1236 of FIG. 27, and/or can be used in otherwise fulfillment of the operation o1236. An exemplary non-transitory signal bearing medium version of the information storage subsystem s200 is depicted in FIG. 34 as bearing the one or more indicating affixed physically instructions i1236 that when executed will direct performance of the operation o1236. Furthermore, the indicating affixed physically electrical circuitry arrangement (“elec circ arrange”) e1236, when activated, will perform the operation o1236. Also, the indicating affixed physically module m1236, when executed and/or activated, will direct performance of and/or perform the operation o1236. For instance, in one or more exemplary implementations, the one or more indicating affixed physically instructions i1236, when executed, direct performance of the operation o1236 in the illustrative depiction as follows, and/or the indicating affixed physically electrical circuitry arrangement e1236, when activated, performs the operation o1236 in the illustrative depiction as follows, and/or the indicating affixed physically module m1236, when executed and/or activated, directs performance of and/or performs the operation o1236 in the illustrative depiction as follows, and/or the operation o1236 is otherwise carried out in the illustrative depiction as follows: electronically indicating informational connection between (e.g. through foreign key search, etc.) at least a portion of residential food management information (e.g. electricity usage, etc.) including (e.g. commit to, etc.) one or more food related residential conditions (e.g. identified issues regarding one or more procedures used to prepare one or more residential food items by the residential facility, etc.) affecting (e.g. commit to, etc.) residential service of (e.g. in-home nursing residential food item preparation, etc.) one or more food items (e.g. steamed residential food item main course, etc.) and between one or more descriptors (e.g. via application records, etc.) logged as contained by (e.g. through genetic testing, etc.) one or more label carriers, (e.g. accelerometer, etc.) said one or more label containers logged as (e.g. via hard disk drive storage, etc.) being at least temporarily (e.g. time held in port for inspection period, etc.) the within at least a vicinity of (e.g. stapled to container, etc.) said one or more residential food items (e.g. shrimp, etc.) including at least in part affixed to another portion of a biological structure that is logged as being physically connected with one or more residential food items (e.g. label carriers attached to apple stem, etc.).

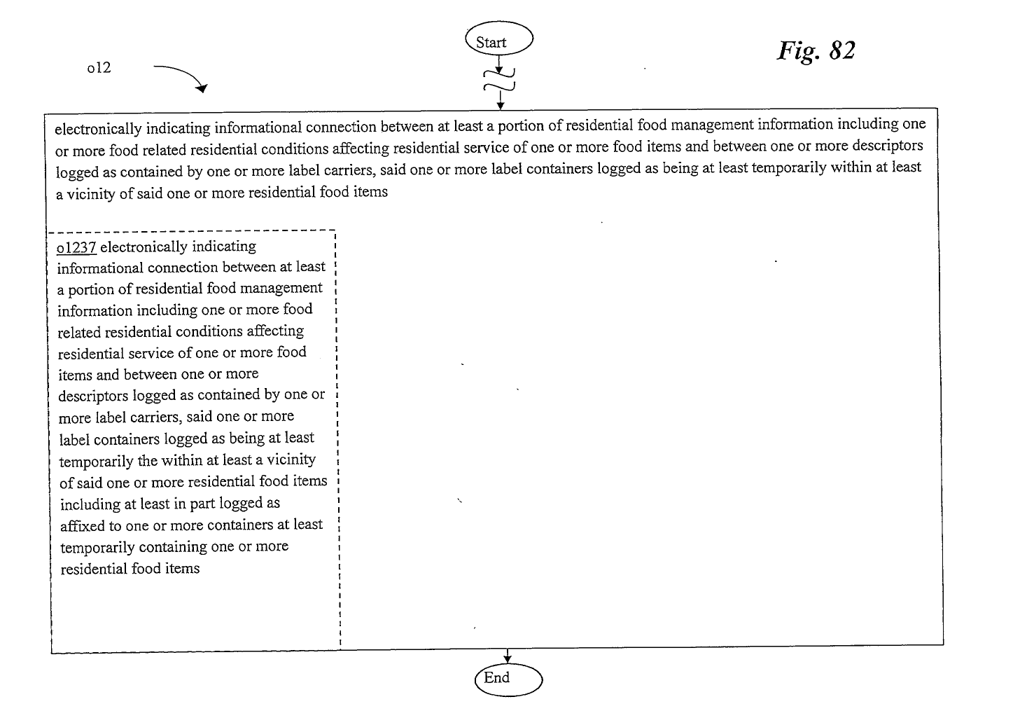

In one or more implementations, as shown in FIG. 82, operation o12 includes an operation o1237 for electronically indicating informational connection between at least a portion of residential food management information including one or more food related residential conditions affecting residential service of one or more food items and between one or more descriptors logged as contained by one or more label carriers, said one or more label containers logged as being at least temporarily the within at least a vicinity of said one or more residential food items including at least in part logged as affixed to one or more containers at least temporarily containing one or more residential food items. Origination of an illustratively derived indicating affixed containers component group can be accomplished through skilled in the art design choice selection of one or more of the above depicted components from one or more of the above depicted subsystems shown in FIG. 12. Components from the indicating affixed containers component group can be used in implementing execution of the one or more indicating affixed containers instructions i1237 of FIG. 34, can be used in performance of the indicating affixed containers electrical circuitry arrangement e1237 of FIG. 27, and/or can be used in otherwise fulfillment of the operation o1237. An exemplary non-transitory signal bearing medium version of the information storage subsystem s200 is depicted in FIG. 34 as bearing the one or more indicating affixed containers instructions i1237 that when executed will direct performance of the operation o1237. Furthermore, the indicating affixed containers electrical circuitry arrangement (“elec circ arrange”) e1237, when activated, will perform the operation o1237. Also, the indicating affixed containers module m1237, when executed and/or activated, will direct performance of and/or perform the operation o1237. For instance, in one or more exemplary implementations, the one or more indicating affixed containers instructions i1237, when executed, direct performance of the operation o1237 in the illustrative depiction as follows, and/or the indicating affixed containers electrical circuitry arrangement e1237, when activated, performs the operation o1237 in the illustrative depiction as follows, and/or the indicating affixed containers module m1237, when executed and/or activated, directs performance of and/or performs the operation o1237 in the illustrative depiction as follows, and/or the operation o1237 is otherwise carried out in the illustrative depiction as follows: electronically indicating informational connection between (e.g. through a hash table search, etc.) at least a portion of residential food management information (e.g. customer accident reports, etc.) including (e.g. absorbed by, etc.) one or more food related residential conditions (e.g. age profile of equipment used, etc.) affecting (e.g. absorbed by, etc.) residential service of (e.g. large family cafeteria residential food item preparation, etc.) one or more food items (e.g. grilled residential food item main, etc.) and between one or more descriptors (e.g. via operating system records, etc.) logged as contained by (e.g. through beacon signal reception, etc.) one or more label carriers, (e.g. compass, etc.) said one or more label containers logged as (e.g. via index information, etc.) being at least temporarily (e.g. time in holding bay, etc.) the within at least a vicinity of (e.g. snapped onto container, etc.) said one or more residential food items (e.g. domestic goose, etc.) including at least in part logged as affixed to one or more containers at least temporarily containing one or more residential food items (e.g. label carriers embedded into shipping container, etc.).

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The one or more instructions discussed herein may be, for example, computer executable and/or logic-implemented instructions. In some implementations, signal-bearing medium as articles of manufacture may store the one or more instructions. In some implementations, the signal bearing medium may include a computer-readable medium. In some implementations, the signal-bearing medium may include a recordable medium. In some implementations, the signal-bearing medium may include a communication medium.

Those having skill in the art will recognize that the state of the art has progressed to the point where there is little distinction left between hardware and software implementations of aspects of systems; the use of hardware or software is generally (but not always, in that in certain contexts the choice between hardware an d software can become significant) a design choice representing cost vs. efficiency tradeoffs. Those having skill in the art will appreciate that there are various vehicles by which processes and/or systems and/or other technologies described herein can be effected (e.g., hardware, software, and/or firmware in one or more machines or articles of manufacture), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation that is implemented in one or more machines or articles of manufacture; or, yet again alternatively, the implementer may opt for some combination of hardware, software, and/or firmware in one or more machines or articles of manufacture (limited to patentable subject matter under 35 USC 101). Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware in one or more machines or articles of manufacture.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof (limited to patentable subject matter under 35 U.S.C. 101). In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure (limited to patentable subject matter under 35 USC 101). In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, (e.g., transmitter, receiver, transmission logic, reception logic, etc.), etc.).

### Electro-Mechanical System Support

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

### Electrical Circuitry Support

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

### Image Processing System Support

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

### Data Processing System Support

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

### Software as Patentable Subject Matter Support

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “o11000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

### Mote System Support

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

### Licensing System Support Language

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

### Extraterritorial Use Language

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

### Residual Incorporation Language

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

### Not Limited to Implementations Described Language

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

### Not Limited to Human User Language

Although user XXX is shown/described herein as a single illustrated figure, those skilled in the art will appreciate that user XXX may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

### Plural Terms Language

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

### Operably-Coupled Language

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

### Active/Inactive Component Language

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

### Cloud Computing Standard Language

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scalable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

### Use of Trademarks in Specification Language

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

### Caselaw-Driven Clarification Language

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

1.-122. (canceled)

123. A system comprising:
an electronically receiving module configured to operate in accordance with electronically receiving domestic meal operation information including one or more food related residential conditions associated with support of domestic preparation of one or more domestic meals; and
an electronically relating module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation.

124. The system of claim 123, wherein the electronically receiving module configured to operate in accordance with electronically receiving domestic meal operation information including one or more food related residential conditions associated with support of domestic preparation of one or more domestic meals comprises:
a receiving wireless module configured to operate in accordance with the electronically receiving domestic meal operation information including one or more food related residential conditions associated with support of domestic preparation of one or more domestic meals by at least in part one or more wireless communication protocols.

125.-126. (canceled)

127. The system of claim 123, wherein the electronically receiving module configured to operate in accordance with electronically receiving domestic meal operation information including one or more food related residential conditions associated with support of domestic preparation of one or more domestic meals comprises:
a receiving LAN module configured to operate in accordance with the electronically receiving domestic meal operation information including one or more food related residential conditions associated with support of domestic preparation of one or more domestic meals by at least in part one or more local area network (LAN) implementations.

128.-129. (canceled)

130. The system of claim 123, wherein the electronically receiving module configured to operate in accordance with electronically receiving domestic meal operation information including one or more food related residential conditions associated with support of domestic preparation of one or more domestic meals comprises:
a receiving cell phone module configured to operate in accordance with the electronically receiving domestic meal operation information including one or more food related residential conditions associated with support of domestic preparation of one or more domestic meals as at least in part cell phone system traffic.

131.-132. (canceled)

133. The system of claim 123, wherein the electronically receiving module configured to operate in accordance with electronically receiving domestic meal operation information including one or more food related residential conditions associated with support of domestic preparation of one or more domestic meals comprises:
a receiving file transfers module configured to operate in accordance with the electronically receiving domestic meal operation information including one or more food related residential conditions associated with support of domestic preparation of one or more domestic meals by at least in part one or more file transfers.

134.-135. (canceled)

136. The system of claim 123, wherein the electronically receiving module configured to operate in accordance with electronically receiving domestic meal operation information including one or more food related residential conditions associated with support of domestic preparation of one or more domestic meals comprises:
a receiving audio content module configured to operate in accordance with electronically receiving the domestic meal operation information including one or more food related residential conditions associated with support of domestic preparation of one or more domestic meals at least in part as audio content information.

137.-138. (canceled)

139. The system of claim 123, wherein the electronically receiving module configured to operate in accordance with electronically receiving domestic meal operation information including one or more food related residential conditions associated with support of domestic preparation of one or more domestic meals comprises:
a receiving forbidden human module configured to operate in accordance with electronically receiving the domestic meal operation information including one or more food related residential conditions associated with support of domestic preparation of one or more domestic meals at least in part including information with respect to forbidden human behavior as associated with one or more standards as logged.

140.-141. (canceled)

142. The system of claim 123, wherein the electronically receiving module configured to operate in accordance with electronically receiving domestic meal operation information including one or more food related residential conditions associated with support of domestic preparation of one or more domestic meals comprises:
a receiving consumer behavior module configured to operate in accordance with electronically receiving the domestic meal operation information including one or more food related residential conditions associated with support of domestic preparation of one or more domestic meals at least in part including information regarding consumer behavior with respect to one or more standards as logged.

143.-144. (canceled)

145. The system of claim 123, wherein the electronically receiving module configured to operate in accordance with electronically receiving domestic meal operation information including one or more food related residential conditions associated with support of domestic preparation of one or more domestic meals comprises:
a receiving item use module configured to operate in accordance with electronically receiving the domestic meal operation information including one or more food related residential conditions associated with support of domestic preparation of one or more domestic meals at least in part including test information regarding permitted domestic meal operation related item use involved with support of domestic preparation of domestic meals.

146.-147. (canceled)

148. The system of claim 123, wherein the electronically receiving module configured to operate in accordance with electronically receiving domestic meal operation information including one or more food related residential conditions associated with support of domestic preparation of one or more domestic meals comprises:
a receiving chemical related module configured to operate in accordance with electronically receiving the domestic meal operation information including one or more food related residential conditions associated with support of domestic preparation of one or more domestic meals at least in part including chemical test information regarding domestic meal operation related items.

149.-150. (canceled)

151. The system of claim 123, wherein the electronically receiving module configured to operate in accordance with electronically receiving domestic meal operation information including one or more food related residential conditions associated with support of domestic preparation of one or more domestic meals comprises:
a receiving test behavior module configured to operate in accordance with electronically receiving the domestic meal operation information including one or more food related residential conditions associated with support of domestic preparation of one or more domestic meals at least in part including test information regarding one or more occurrences of domestic occupant behavior with respect to one or more guidelines as logged.

152.-153. (canceled)

154. The system of claim 123, wherein the electronically receiving module configured to operate in accordance with electronically receiving domestic meal operation information including one or more food related residential conditions associated with support of domestic preparation of one or more domestic meals comprises:
a receiving test observation module configured to operate in accordance with electronically receiving the domestic meal operation information including one or more food related residential conditions associated with support of domestic preparation of one or more domestic meals at least in part including test information regarding human observation.

155.-156. (canceled)

157. The system of claim 123, wherein the electronically receiving module configured to operate in accordance with electronically receiving domestic meal operation information including one or more food related residential conditions associated with support of domestic preparation of one or more domestic meals comprises:
a receiving protein use module configured to operate in accordance with electronically receiving domestic meal operation information including the one or more food related residential conditions associated with support of domestic preparation of one or more domestic meals including at least in part one or more protein use factors involved with one or more food related residential conditions.

158.-159. (canceled)

160. The system of claim 123, wherein the electronically receiving module configured to operate in accordance with electronically receiving domestic meal operation information including one or more food related residential conditions associated with support of domestic preparation of one or more domestic meals comprises:
a receiving stock rotation module configured to operate in accordance with electronically receiving domestic meal operation information including the one or more food related residential conditions associated with support of domestic preparation of one or more domestic meals including at least in part one or more stock rotation factors involved with one or more food related residential conditions.

161.-162. (canceled)

163. The system of claim 123, wherein the electronically receiving module configured to operate in accordance with electronically receiving domestic meal operation information including one or more food related residential conditions associated with support of domestic preparation of one or more domestic meals comprises:
a receiving heat treating module configured to operate in accordance with electronically receiving domestic meal operation information including the one or more food related residential conditions associated with support of domestic preparation of one or more domestic meals including at least in part one or more heat treating factors involved with one or more food related residential conditions.

164.-165. (canceled)

166. The system of claim 123, wherein the electronically receiving module configured to operate in accordance with electronically receiving domestic meal operation information including one or more food related residential conditions associated with support of domestic preparation of one or more domestic meals comprises:
a receiving deli preparation module configured to operate in accordance with electronically receiving domestic meal operation information including the one or more food related residential conditions associated with support of domestic preparation of one or more domestic meals including at least in part one or more deli style food preparation support factors involved with one or more food related residential conditions.

167.-168. (canceled)

169. The system of claim 123, wherein the electronically receiving module configured to operate in accordance with electronically receiving domestic meal operation information including one or more food related residential conditions associated with support of domestic preparation of one or more domestic meals comprises:
a receiving aspects locations module configured to operate in accordance with electronically receiving domestic meal operation information including the one or more food related residential conditions associated with support of domestic preparation of one or more domestic meals including at least in part one or more aspects regarding one or more locations involved with one or more food related residential conditions.

170.-171. (canceled)

172. The system of claim 123, wherein the electronically receiving module configured to operate in accordance with electronically receiving domestic meal operation information including one or more food related residential conditions associated with support of domestic preparation of one or more domestic meals comprises:
a receiving butcher factors module configured to operate in accordance with electronically receiving domestic meal operation information including the one or more food related residential conditions associated with support of domestic preparation of one or more domestic meals including at least in part one or more butcher related factors involved with one or more food related residential conditions.

173.-174. (canceled)

175. The system of claim 123, wherein the electronically receiving module configured to operate in accordance with electronically receiving domestic meal operation information including one or more food related residential conditions associated with support of domestic preparation of one or more domestic meals comprises:
a receiving genetically modified module configured to operate in accordance with electronically receiving domestic meal operation information including the one or more food related residential conditions associated with support of domestic preparation of one or more domestic meals including at least in part one or more genetically modified organism factors involved with one or more food related residential conditions.

176.-177. (canceled)

178. The system of claim 123, wherein the electronically receiving module configured to operate in accordance with electronically receiving domestic meal operation information including one or more food related residential conditions associated with support of domestic preparation of one or more domestic meals comprises:
a receiving food contamination module configured to operate in accordance with electronically receiving domestic meal operation information including the one or more food related residential conditions associated with support of domestic preparation of one or more domestic meals including at least in part one or more food contamination aspects related activities involved with one or more food related residential conditions.

179.-180. (canceled)

181. The system of claim 123, wherein the electronically receiving module configured to operate in accordance with electronically receiving domestic meal operation information including one or more food related residential conditions associated with support of domestic preparation of one or more domestic meals comprises:
a receiving food combining module configured to operate in accordance with electronically receiving domestic meal operation information including the one or more food related residential conditions associated with support of domestic preparation of one or more domestic meals including at least in part one or more food combining related aspects involved with one or more food related residential conditions.

182.-183. (canceled)

184. The system of claim 123, wherein the electronically receiving module configured to operate in accordance with electronically receiving domestic meal operation information including one or more food related residential conditions associated with support of domestic preparation of one or more domestic meals comprises:
a receiving dispensing prepackaged module configured to operate in accordance with electronically receiving domestic meal operation information including one or more food related residential conditions associated with the support of domestic preparation of one or more domestic meals including at least in part dispensing one or more prepackaged domestic meals as a domestic kitchen operation.

185.-186. (canceled)

187. The system of claim 123, wherein the electronically receiving module configured to operate in accordance with electronically receiving domestic meal operation information including one or more food related residential conditions associated with support of domestic preparation of one or more domestic meals comprises:
a receiving shipped items module configured to operate in accordance with electronically receiving domestic meal operation information including one or more food related residential conditions associated with the support of domestic preparation of one or more domestic meals including at least in part receiving shipped one or more domestic items to one or more remote domestic inhabitants.

188.-189. (canceled)

190. The system of claim 123, wherein the electronically receiving module configured to operate in accordance with electronically receiving domestic meal operation information including one or more food related residential conditions associated with support of domestic preparation of one or more domestic meals comprises:
a receiving mobile dispensaries module configured to operate in accordance with electronically receiving domestic meal operation information including one or more food related residential conditions associated with the support of domestic preparation of one or more domestic meals including at least in part receiving domestic meals through one or more mobile dispensaries of domestic meals.

191.-192. (canceled)

193. The system of claim 123, wherein the electronically receiving module configured to operate in accordance with electronically receiving domestic meal operation information including one or more food related residential conditions associated with support of domestic preparation of one or more domestic meals comprises:
a receiving frozen dinners module configured to operate in accordance with electronically receiving domestic meal operation information including one or more food related residential conditions associated with support of domestic preparation of the one or more domestic meals including at least in part one or more frozen dinners.

194.-195. (canceled)

196. The system of claim 123, wherein the electronically receiving module configured to operate in accordance with electronically receiving domestic meal operation information including one or more food related residential conditions associated with support of domestic preparation of one or more domestic meals comprises:
a receiving seafood meals module configured to operate in accordance with electronically receiving domestic meal operation information including one or more food related residential conditions associated with support of domestic preparation of the one or more domestic meals including at least in part one or more seafood meals.

197.-198. (canceled)

199. The system of claim 123, wherein the electronically receiving module configured to operate in accordance with electronically receiving domestic meal operation information including one or more food related residential conditions associated with support of domestic preparation of one or more domestic meals comprises:
a receiving animal items module configured to operate in accordance with electronically receiving domestic meal operation information including one or more food related residential conditions associated with support of domestic preparation of the one or more domestic meals including at least in part one or more whole animal items.

200.-201. (canceled)

202. The system of claim 123, wherein the electronically receiving module configured to operate in accordance with electronically receiving domestic meal operation information including one or more food related residential conditions associated with support of domestic preparation of one or more domestic meals comprises:
a receiving sandwich items module configured to operate in accordance with electronically receiving domestic meal operation information including one or more food related residential conditions associated with support of domestic preparation of the one or more domestic meals including at least in part one or more sandwich items.

203.-204. (canceled)

205. The system of claim 123, wherein the electronically relating module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation comprises:
a relating computer-based pointers module configured to operate in accordance with the electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation via at least in part one or more computer-based pointers.

206.-207. (canceled)

208. The system of claim 123, wherein the electronically relating module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation comprises:
a relating lookup tables module configured to operate in accordance with the electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation via at least in part one or more computer-based lookup tables.

209.-210. (canceled)

211. The system of claim 123, wherein the electronically relating module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation comprises:
a relating naming information module configured to operate in accordance with electronically relating between at least a portion of domestic meal operation information including one or more food related residential conditions associated with support of domestic preparation of one or more domestic meals the and between identifying information recorded as retrievable from one or more tracking accessories said one or more tracking accessories recorded as being at least during some point within a region of said support of said domestic preparation including at least in part one or more computer-based naming information.

212.-213. (canceled)

214. The system of claim 123, wherein the electronically relating module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation comprises:
a relating radio frequency module configured to operate in accordance with electronically relating between at least a portion of domestic meal operation information including one or more food related residential conditions associated with support of domestic preparation of one or more domestic meals the and between identifying information recorded as retrievable from one or more tracking accessories said one or more tracking accessories recorded as being at least during some point within a region of said support of said domestic preparation including at least in part one or more radio frequency identifying information.

215.-216. (canceled)

217. The system of claim 123, wherein the electronically relating module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation comprises:
a relating computer servers module configured to operate in accordance with electronically relating between at least a portion of domestic meal operation information including one or more food related residential conditions associated with support of domestic preparation of one or more domestic meals and between identifying information the recorded as retrievable from one or more tracking accessories said one or more tracking accessories recorded as being at least during some point within a region of said support of said domestic preparation at least in part obtaining identifying information from one or more electronic computer servers.

218.-219. (canceled)

220. The system of claim 123, wherein the electronically relating module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation comprises:
a relating emitter beacons module configured to operate in accordance with electronically relating between at least a portion of domestic meal operation information including one or more food related residential conditions associated with support of domestic preparation of one or more domestic meals and between identifying information recorded as retrievable from the one or more tracking accessories said one or more tracking accessories recorded as being at least during some point within a region of said support of said domestic preparation include at least in part one or more emitter beacons.

221.-222. (canceled)

223. The system of claim 123, wherein the electronically relating module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation comprises:
a relating biochemical tracking module configured to operate in accordance with electronically relating between at least a portion of domestic meal operation information including one or more food related residential conditions associated with support of domestic preparation of one or more domestic meals and between identifying information recorded as retrievable from the one or more tracking accessories said one or more tracking accessories recorded as being at least during some point within a region of said support of said domestic preparation include at least in part one or more biochemical tracking accessories.

224.-225. (canceled)

226. The system of claim 123, wherein the electronically relating module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation comprises:
a relating radioactive tracking module configured to operate in accordance with electronically relating between at least a portion of domestic meal operation information including one or more food related residential conditions associated with support of domestic preparation of one or more domestic meals and between identifying information recorded as retrievable from the one or more tracking accessories said one or more tracking accessories recorded as being at least during some point within a region of said support of said domestic preparation include at least in part one or more radioactive tracking accessories.

227.-228. (canceled)

229. The system of claim 123, wherein the electronically relating module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation comprises:
a relating visual shapes module configured to operate in accordance with electronically relating between at least a portion of domestic meal operation information including one or more food related residential conditions associated with support of domestic preparation of one or more domestic meals and between identifying information recorded as retrievable from the one or more tracking accessories said one or more tracking accessories recorded as being at least during some point within a region of said support of said domestic preparation include at least in part one or more visual shapes.

230.-231. (canceled)

232. The system of claim 123, wherein the electronically relating module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation comprises:
a relating electronic databases module configured to operate in accordance with electronically relating between at least a portion of domestic meal operation information including one or more food related residential conditions associated with support of domestic preparation of one or more domestic meals and between identifying information recorded as retrievable from one or more tracking accessories the said one or more tracking accessories recorded as being at least during some point within a region of said support of said domestic preparation via at least in part one or more electronic databases.

233.-234. (canceled)

235. The system of claim 123, wherein the electronically relating module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation comprises:
a relating transit period module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as the being at least during some point within a region of said support of said domestic preparation including at least in part the domestic item transit period from factory to store.

236.-237. (canceled)

238. The system of claim 123, wherein the electronically relating module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation comprises:
a relating affixed pre-processed module configured to operate in accordance with electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point the within a region of said support of said domestic preparation including at least in part logged as affixed to pre-processed forms of domestic items.

239.-240. (canceled)

241. An article of manufacture comprising:
one or more non-transitory signal bearing storage medium bearing:
one or more electronically receiving instructions for electronically receiving domestic meal operation information including one or more food related residential conditions associated with support of domestic preparation of one or more domestic meals; and
one or more electronically relating instructions for electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation.

242.-245. (canceled)

246. A system comprising:
one or more computing devices; and
one or more instructions when executed on the one or more computing devices cause the one or more computing devices to perform electronically receiving domestic meal operation information including one or more food related residential conditions associated with support of domestic preparation of one or more domestic meals; and
electronically relating between at least a portion of domestic meal operation information including one or more food related residential conditions associated with support of domestic preparation of one or more domestic meals and between identifying information recorded as retrievable from one or more tracking accessories said one or more tracking accessories recorded as being at least during some point within a region of said support of said domestic preparation.

247. (canceled)
